(19) United States
(12) Patent Application Publication
(10) Pub. No.: US 2026/0292305 A1
(43) Pub. Date: Sep. 24, 2026

(54) USER INTERFACES FOR PLAYBACK OF LIVE CONTENT ITEMS

(71) Applicant: Apple Inc., Cupertino, CA (US)

(72) Inventors: Christopher J. ELLINGFORD, Alameda, CA (US); Lucio MORENO RUFO, San Jose, CA (US); Fredric R. VINNA, San Francisco, CA (US); Policarpo B. WOOD, San Jose, CA (US); Antonio ALLEN, San Jose, CA (US); William D. CARPENTER, Pacifica, CA (US); Anton M. DAVYDOV, Gilroy, CA (US); Jonathan SILVIO, Piedmont, CA (US); Brian K. SHIRAISHI, Belmont, CA (US); Gregory T. SCOTT, Soquel, CA (US); Kaitlyn E. CHU, Irvine, CA (US)

(21) Appl. No.: 19/642,129

(22) Filed: Apr. 8, 2026

Related U.S. Application Data
(63) Continuation of application No. 18/473,244, filed on Sep. 23, 2023.
(60) Provisional application No. 63/377,018, filed on Sep. 24, 2022.
(60) Provisional application No. 63/506,087, filed on Jun. 4, 2023.
(60) Provisional application No. 63/584,860, filed on Sep. 22, 2023.

(51) Int. Cl. H04N 21/472; G06F 3/0488; H04N 21/4722

(52) U.S. Cl. CPC H04N 21/47217; G06F 3/0488; H04N 21/47202; H04N 21/4722

(57) ABSTRACT

Some embodiments described in this disclosure are directed to one or more electronic devices that facilitate control of playback of a live content item displayed in a playback user interface. Some embodiments described in this disclosure are directed to one or more electronic devices that facilitate display of key content corresponding to a live content item in a key content user interface. Some embodiments described in this disclosure are directed to one or more electronic devices that facilitate concurrently display of multiple content items in a Multiview user interface. Some embodiments described in this disclosure are directed to one or more electronic devices that facilitate display of insights corresponding to a content item displayed in a playback user interface.

### CROSS-REFERENCE TO RELATED APPLICATIONS

This application is a continuation of U.S. patent application Ser. No. 18/473,244, filed Sep. 23, 2023, published on Mar. 28, 2024 as U.S. Publication No. 2024-0107118, which claims the benefit of U.S. Provisional Application No. 63/377,018, filed Sep. 24, 2022, U.S. Provisional Application No. 63/506,087, filed Jun. 4, 2023, and U.S. Provisional Application No. 63/584,860, filed Sep. 22, 2023, the contents of which are herein incorporated by reference in their entireties for all purposes.

### FIELD OF THE DISCLOSURE

This relates generally to user interfaces that present information and one or more controls for controlling playback of live content items on an electronic device.

### BACKGROUND

User interaction with electronic devices has increased significantly in recent years. These devices can be devices such as computers, tablet computers, televisions, multimedia devices, mobile devices, and the like.

In some circumstances, such a device presents an item of live-broadcast content. In some circumstances, the electronic device presents information about the item of live-broadcast content in a user interface specific to the item of live-broadcast content. In some circumstances, users wish to control playback of the live-broadcast content item efficiently. Enhancing these interactions improves the user's experience with the device and decreases user interaction time, which is particularly important where input devices are battery-operated.

### SUMMARY

Some embodiments described in this disclosure are directed to one or more electronic devices that facilitate control of playback of a live content item displayed in a playback user interface. Some embodiments described in this disclosure are directed to one or more electronic devices that facilitate display of key content corresponding to a live content item in a key content user interface. Some embodiments described in this disclosure are directed to one or more electronic devices that facilitate concurrently display of multiple content items in a Multiview user interface. Some embodiments described in this disclosure are directed to one or more electronic devices that facilitate display of insights corresponding to a content item displayed in a playback user interface. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIGS. 5A-5C illustrate block diagrams of exemplary architectures for devices according to some embodiments of the disclosure.

FIGS. 6A-6OOO illustrate exemplary ways in which an electronic device facilitates control of playback of a live content item displayed in a playback user interface in accordance with some embodiments of the disclosure.

FIG. 7 is a flow diagram illustrating a method of facilitating control of playback of a live content item displayed in a playback user interface in accordance with some embodiments.

FIGS. 8A-8BB illustrate exemplary ways in which an electronic device facilitates interactions with key content corresponding to a live content item displayed in a key content user interface in accordance with some embodiments of the disclosure.

FIGS. 9A-9B is a flow diagram illustrating a method of facilitating interactions with key content corresponding to a live content item displayed in a key content user interface in accordance with some embodiments of the disclosure.

FIGS. 10A-10T illustrate exemplary ways in which an electronic device facilitates display of insights corresponding to a content item displayed in a playback user interface in accordance with some embodiments of the disclosure.

FIG. 11 is a flow diagram illustrating a method of facilitating interactions with content items displayed in a multi-view viewing mode in accordance with some embodiments of the disclosure.

FIGS. 12A-12B are a flow diagram illustrating a method 1200 of facilitating display of insights corresponding to a content item displayed in a playback user interface in accordance with some embodiments of the disclosure.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods for facilitating control of playback of a live content item displayed in a playback user interface. In some embodiments, the electronic device displays a live content item in a playback user interface that is configured to playback content. In some embodiments, while the live content item is displayed in the playback user interface, the electronic device receives a first input corresponding to a request to display one or more controls for controlling playback of the live content item. In some embodiments, in response to receiving the first input, the electronic device concurrently displays a scrubber bar and a visual indicator in the playback user interface overlaid on the live content item. In some embodiments, while the scrubber bar and the visual indicator are displayed in the playback user interface, the electronic device receives a second input corresponding to a request to scrub through the live content item. In some embodiments, in response to receiving the second input, the electronic device updates a current playback position within the live content item in accordance with the input and changes a visual state in which the visual indicator is displayed in the playback user interface. Such techniques can reduce the cognitive burden on a user who uses such devices. Further, such techniques can reduce processor and battery power otherwise wasted on redundant user inputs.

There is a need for electronic devices that provide efficient methods for facilitating interactions with key content corresponding to a content item. In some embodiments, the electronic device displays a user interface associated with playback of the content item. In some embodiments, while displaying the user interface, the electronic device receives an input corresponding to a request to display key content corresponding to the content item. In some embodiments, the key content corresponding to the content item includes a sequence of key content associated with a sequence of playback positions within the content item. In some embodiments, in response to receiving the input, the electronic device displays first key content corresponding to the content item in a key content user interface. In some embodiments, while the first key content is displayed in the key content user interface, the electronic device detects that an event has occurred. In some embodiments, in response to detecting that the event has occurred, in accordance with a determination that the detected event includes an input corresponding to a request to navigate forward in the sequence of key content, the electronic device transitions from displaying the first key content to displaying second key content in the key content user interface. In some embodiments, in accordance with a determination that the detected event includes an input corresponding to a request to play the content item, the electronic device initiates playback of the content item from a predetermined playback position within the live content item. Such techniques can reduce the cognitive burden on a user who uses such devices. Further, such techniques can reduce processor and battery power otherwise wasted on redundant user inputs.

There is a need for electronic devices that provide efficient methods for facilitating concurrent display of content items in a Multiview user interface. In some embodiments, the electronic device displays a firs live content item in a playback user interface that is configured to playback content. In some embodiments, while the first live content item is displayed in the playback user interface, the electronic device receives a sequence of one or more inputs corresponding to a request to view the first live content item and a second live content item in a Multiview user interface. In some embodiments, in response to receiving the sequence of one or more inputs, the electronic device concurrently displays the first live content item at a first size and the second live content item at a second size in a playback region of the Multiview user interface. In some embodiments, while concurrently displaying the first live content item and the second live content item in the Multiview user interface, the electronic device detects that a threshold amount of time has elapsed since displaying the first live content item and the second live content item in the Multiview user interface and without detecting any intervening inputs. In some embodiments, in response to detecting that the threshold amount of time has elapsed, the electronic device updates display of the first live content item and the second live content item in the playback region to have a third size, different from the first size and the second size. Such techniques can reduce the cognitive burden on a user who uses such devices. Further, such techniques can reduce processor and battery power otherwise wasted on redundant user inputs.

There is a need for electronic devices that provide efficient methods for facilitating display of insights corresponding to a content item playback of a live content item displayed in a playback user interface. In some embodiments, the electronic device displays a live content item in a playback user interface that is configured to playback content. In some embodiments, while the live content item is displayed in the playback user interface, the electronic device receives a first input corresponding to a request to display one or more controls for controlling playback of the live content item. In some embodiments, in response to receiving the first input, the electronic device concurrently displays a scrubber bar and a first option that is selectable to display information corresponding to the live the live content item. In some embodiments, while the scrubber bar and the first option are displayed in the playback user interface, the electronic device receives a second input corresponding to a selection of the first option. In some embodiments, in response to receiving the second input, the electronic device displays first information corresponding to the live content item in the playback user interface. In some embodiments, while displaying the first information in the playback user interface, the electronic device receives a third input corresponding to a request to scroll in the playback user interface. In some embodiments, in response to receiving the third input, the electronic device displays the live content item in a minimized state in the playback user interface and updates the first information to include insights corresponding to the live content item. Such techniques can reduce the cognitive burden on a user who uses such devices. Further, such techniques can reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

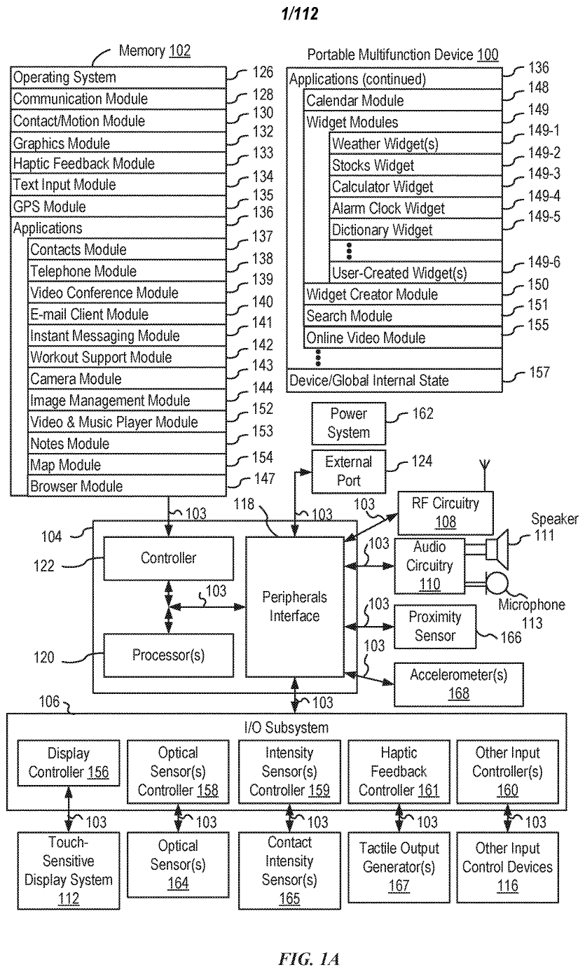

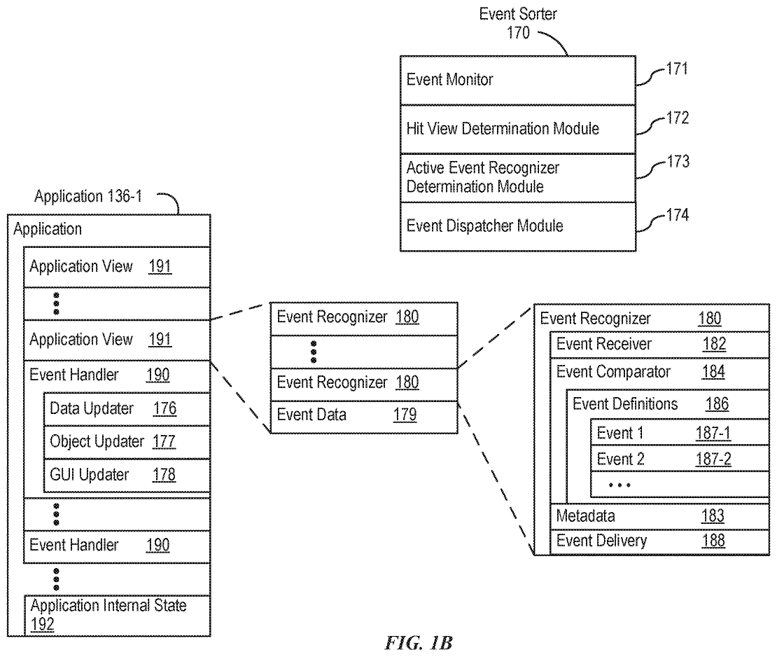

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

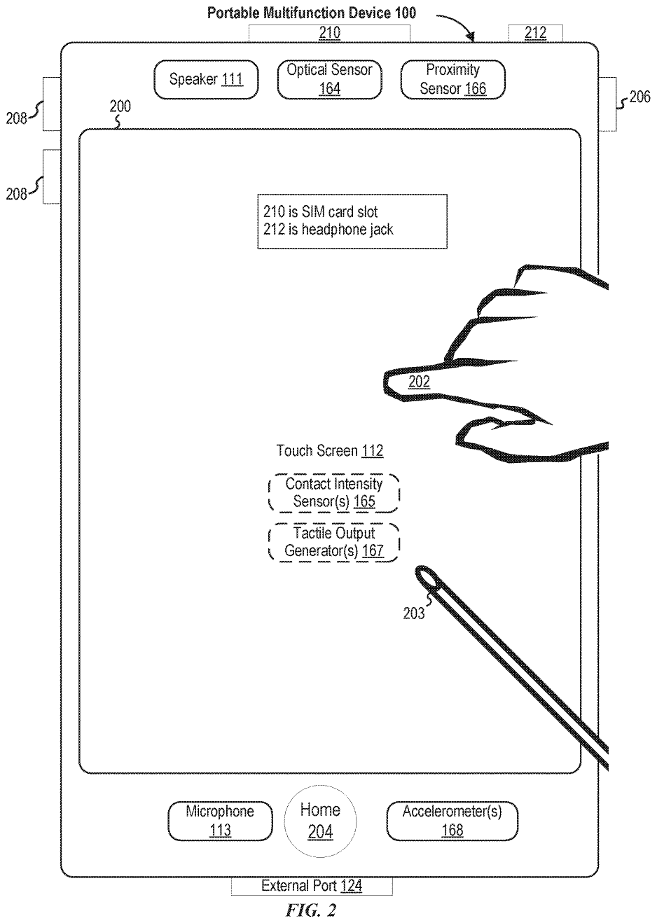

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, device 100 is a portable computing system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system (e.g., an integrated display, touch screen 112, etc.). In some embodiments, the display generation component is separate from the computer system (e.g., an external monitor, a projection system, etc.). As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

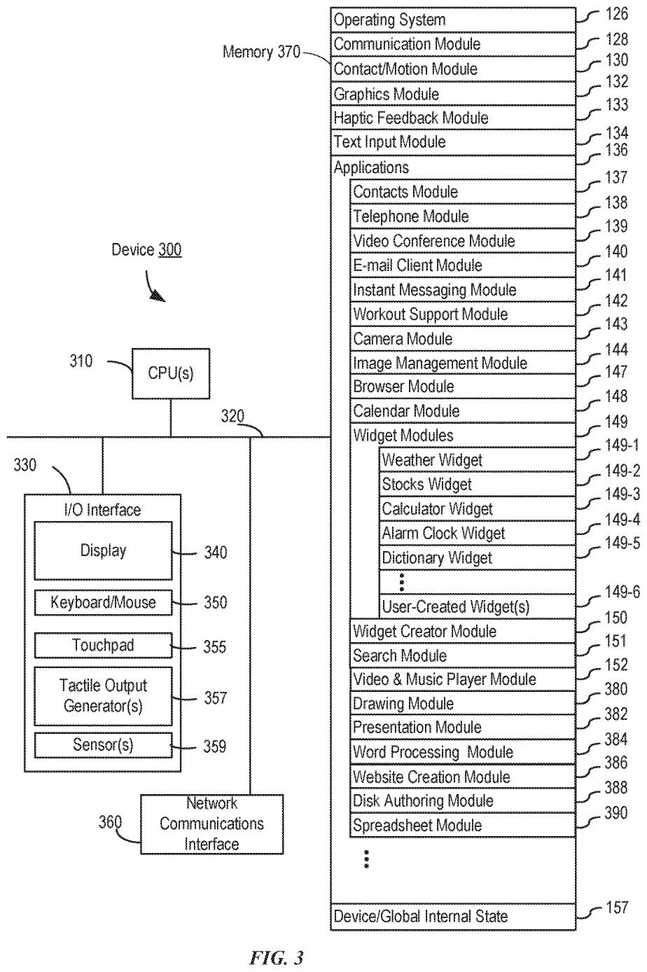

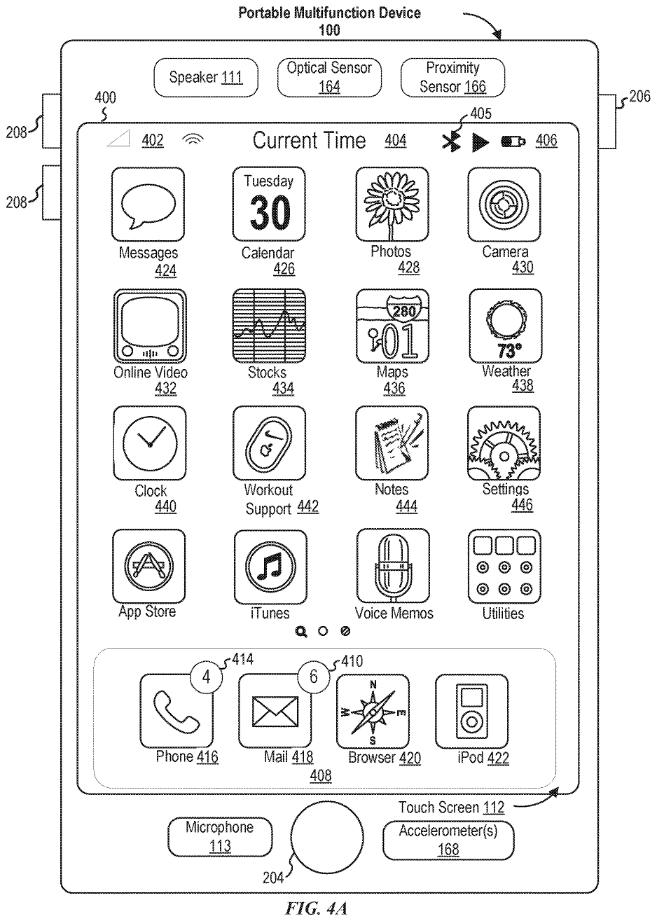

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail module 140, IM 141, browser 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail module 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

In some embodiments, stylus 203 is an active device and includes one or more electronic circuitry. For example, stylus 203 includes one or more sensors, and one or more communication circuitry (such as communication module 128 and/or RF circuitry 108). In some embodiments, stylus 203 includes one or more processors and power systems (e.g., similar to power system 162). In some embodiments, stylus 203 includes an accelerometer (such as accelerometer 168), magnetometer, and/or gyroscope that is able to determine the position, angle, location, and/or other physical characteristics of stylus 203 (e.g., such as whether the stylus is placed down, angled toward or away from a device, and/or near or far from a device). In some embodiments, stylus 203 is in communication with an electronic device (e.g., via communication circuitry, over a wireless communication protocol such as Bluetooth) and transmits sensor data to the electronic device. In some embodiments, stylus 203 is able to determine (e.g., via the accelerometer or other sensors) whether the user is holding the device. In some embodiments, stylus 203 can accept tap inputs (e.g., single tap or double tap) on stylus 203 (e.g., received by the accelerometer or other sensors) from the user and interpret the input as a command or request to perform a function or change to a different input mode.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

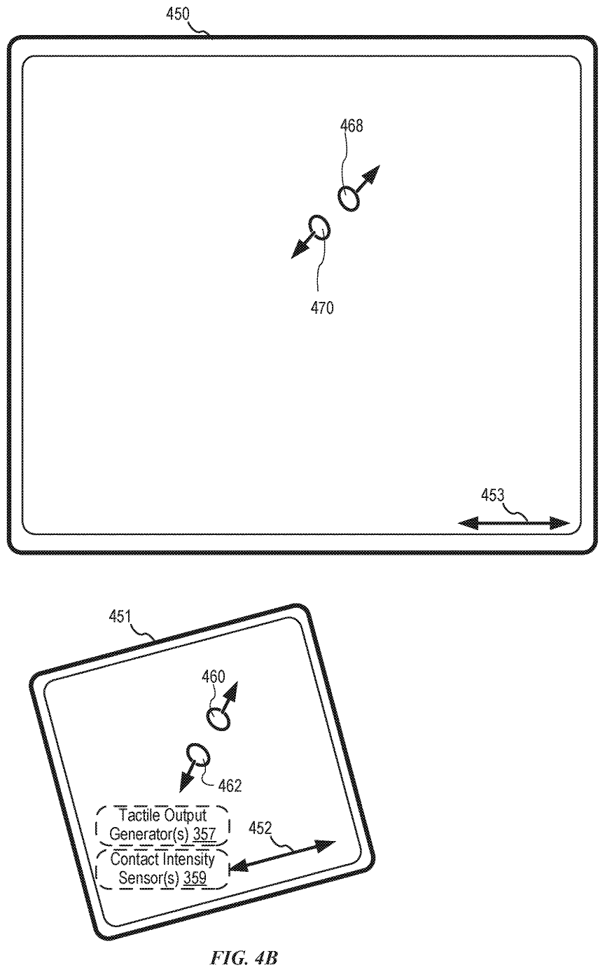

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

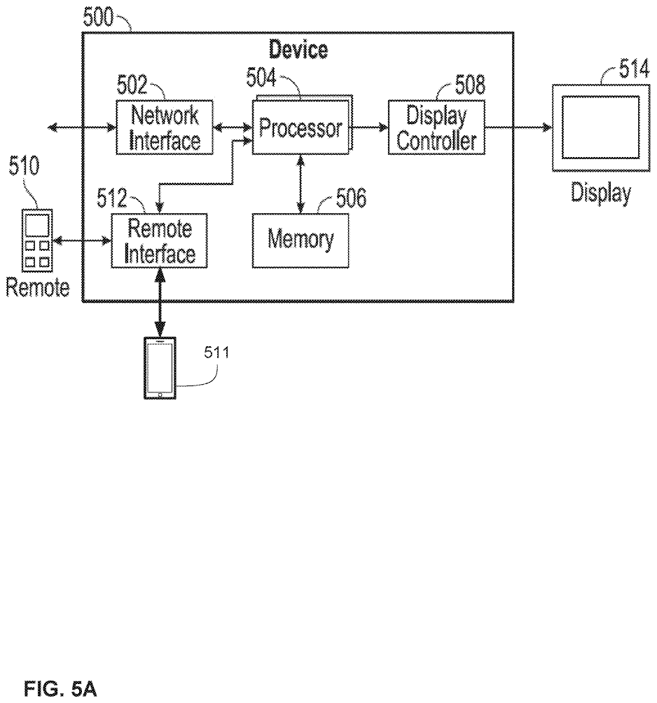

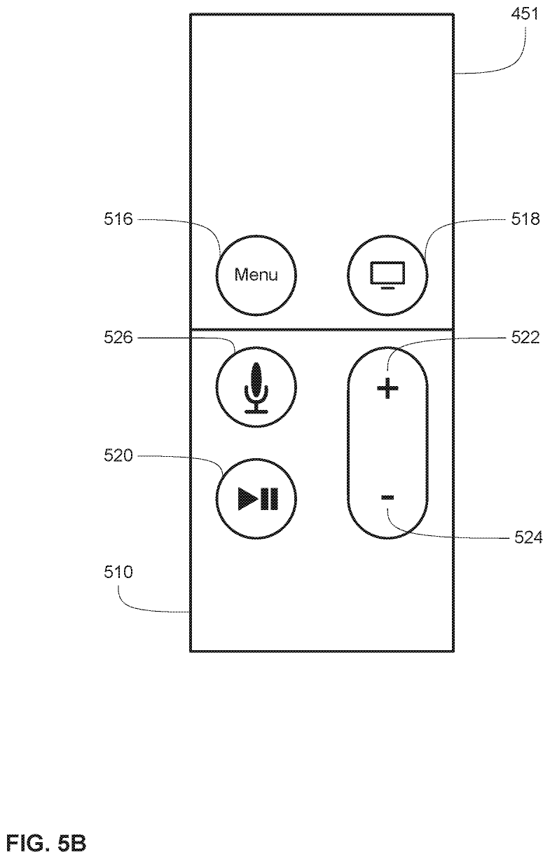

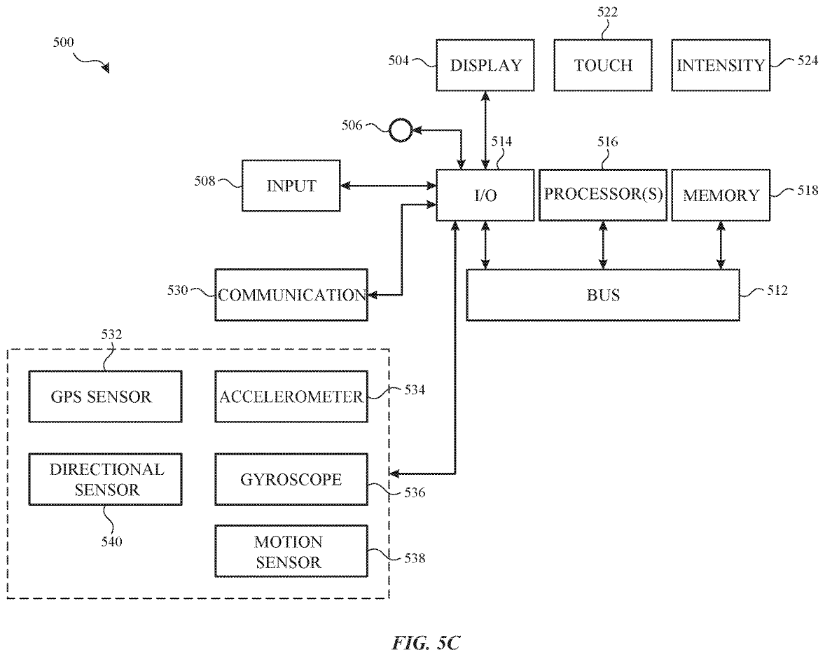

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 504 optionally execute any number of programs stored in memory 506 or storage, which optionally includes instructions to perform one or more of the methods and/or processes described herein (e.g., methods 700, 900, 1100 and 1200).

In some embodiments, display controller 508 causes the various user interfaces of the disclosure to be displayed on display 514. Further, input to device 500 is optionally provided by remote 510 via remote interface 512, which is optionally a wireless or a wired connection. In some embodiments, input to device 500 is provided by a multifunction device 511 (e.g., a smartphone) on which a remote control application is running that configures the multifunction device to simulate remote control functionality, as will be described in more detail below. In some embodiments, multifunction device 511 corresponds to one or more of device 100 in FIGS. 1A and 2, and device 300 in FIG. 3. It is understood that the embodiment of FIG. 5A is not meant to limit the features of the device of the disclosure, and that other components to facilitate other features described in the disclosure are optionally included in the architecture of FIG. 5A as well. In some embodiments, device 500 optionally corresponds to one or more of multifunction device 100 in FIGS. 1A and 2 and device 300 in FIG. 3; network interface 502 optionally corresponds to one or more of RF circuitry 108, external port 124, and peripherals interface 118 in FIGS. 1A and 2, and network communications interface 360 in FIG. 3; processor 504 optionally corresponds to one or more of processor(s) 120 in FIG. 1A and CPU(s) 310 in FIG. 3; display controller 508 optionally corresponds to one or more of display controller 156 in FIG. 1A and I/O interface 330 in FIG. 3; memory 506 optionally corresponds to one or more of memory 102 in FIG. 1A and memory 370 in FIG. 3; remote interface 512 optionally corresponds to one or more of peripherals interface 118, and I/O subsystem 106 (and/or its components) in FIG. 1A, and I/O interface 330 in FIG. 3; remote 512 optionally corresponds to and or includes one or more of speaker 111, touch-sensitive display system 112, microphone 113, optical sensor(s) 164, contact intensity sensor(s) 165, tactile output generator(s) 167, other input control devices 116, accelerometer(s) 168, proximity sensor 166, and I/O subsystem 106 in FIG. 1A, and keyboard/mouse 350, touchpad 355, tactile output generator(s) 357, and contact intensity sensor(s) 359 in FIG. 3, and touch-sensitive surface 451 in FIG. 4; and, display 514 optionally corresponds to one or more of touch-sensitive display system 112 in FIGS. 1A and 2, and display 340 in FIG. 3.

FIG. 5B illustrates an exemplary structure for remote 510 according to some embodiments of the disclosure. In some embodiments, remote 510 optionally corresponds to one or more of multifunction device 100 in FIGS. 1A and 2 and device 300 in FIG. 3. Remote 510 optionally includes touch-sensitive surface 451. In some embodiments, touch-sensitive surface 451 is edge-to-edge (e.g., it extends to the edges of remote 510, such that little or no surface of remote 510 exists between the touch-sensitive surface 451 and one or more edges of remote 510, as illustrated in FIG. 5B). Touch-sensitive surface 451 is optionally able to sense contacts as well as contact intensities (e.g., clicks of touch-sensitive surface 451), as previously described in this disclosure. Further, touch-sensitive surface 451 optionally includes a mechanical actuator for providing physical button click functionality (e.g., touch-sensitive surface 451 is “clickable” to provide corresponding input to device 500). Remote 510 also optionally includes buttons 516, 518, 520, 522, 524 and 526. Buttons 516, 518, 520, 522, 524 and 526 are optionally mechanical buttons or mechanical button alternatives that are able to sense contact with, or depression of, such buttons to initiate corresponding action(s) on, for example, device 500. In some embodiments, selection of “menu” button 516 by a user navigates device 500 backwards in a currently-executing application or currently-displayed user interface (e.g., back to a user interface that was displayed previous to the currently-displayed user interface), or navigates device 500 to a one-higher-level user interface than the currently-displayed user interface. In some embodiments, selection of “home” button 518 by a user navigates device 500 to a main, home, or root user interface from any user interface that is displayed on device 500 (e.g., to a home screen of device 500 that optionally includes one or more applications accessible on device 500). In some embodiments, selection of the “home” button 518 causes the electronic device to navigate to a unified media browsing application. In some embodiments, selection of “play/pause” button 520 by a user toggles between playing and pausing a currently-playing content item on device 500 (e.g., if a content item is playing on device 500 when “play/pause” button 520 is selected, the content item is optionally paused, and if a content item is paused on device 500 when “play/pause” button 520 is selected, the content item is optionally played). In some embodiments, selection of “+” 522 or “−” 524 buttons by a user increases or decreases, respectively, the volume of audio reproduced by device 500 (e.g., the volume of a content item currently-playing on device 500). In some embodiments, selection of “audio input” button 526 by a user allows the user to provide audio input (e.g., voice input) to device 500, optionally, to a voice assistant on the device. In some embodiments, remote 510 includes a microphone via which the user provides audio input to device 500 upon selection of “audio input” button 526. In some embodiments, remote 510 includes one or more accelerometers for detecting information about the motion of the remote.

FIG. 5C depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

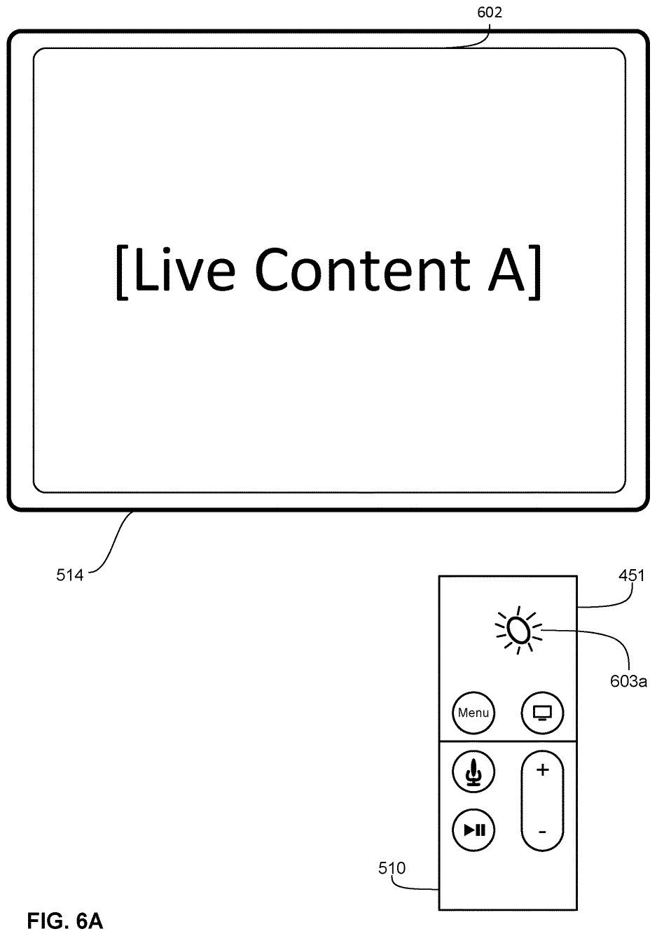

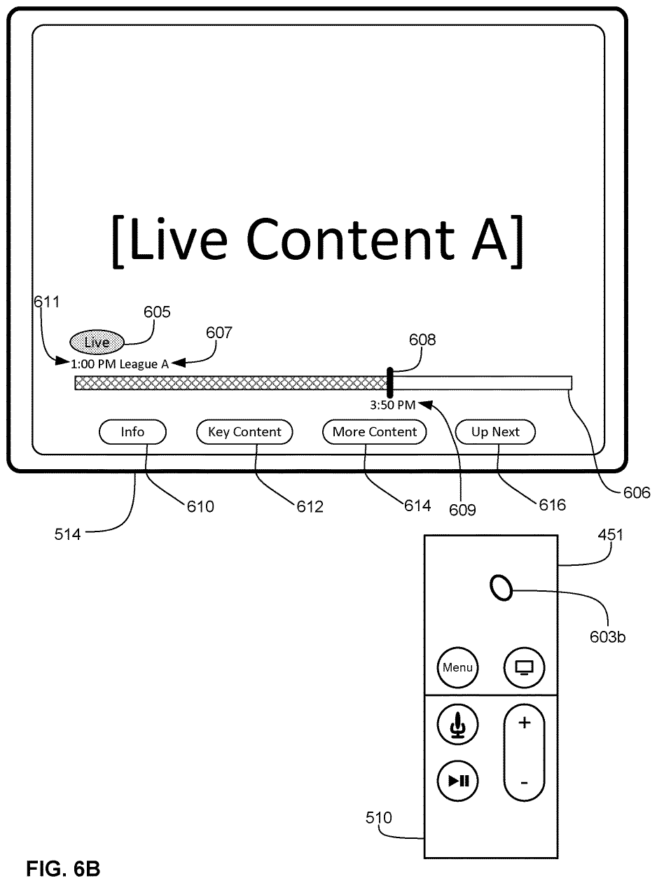

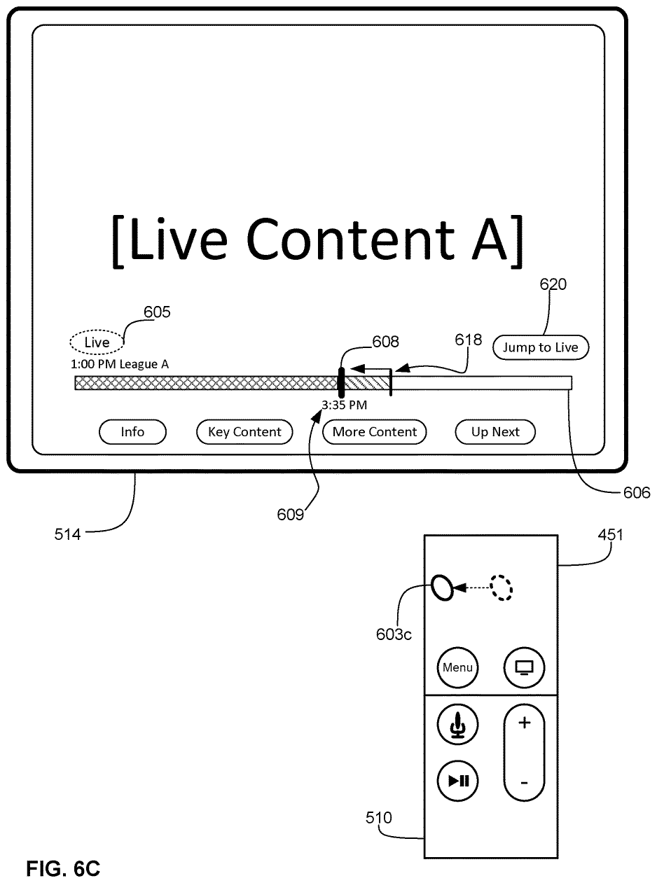

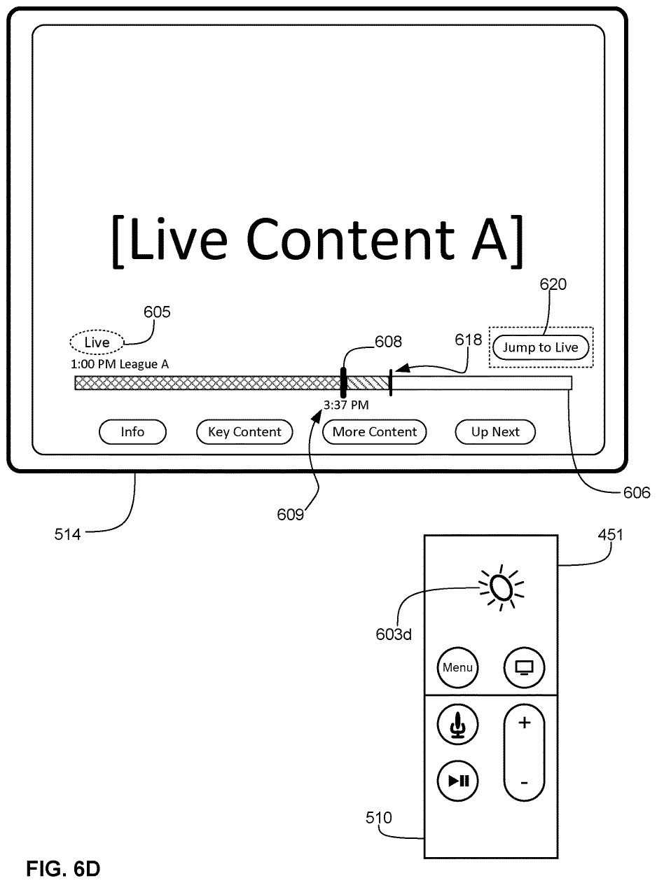

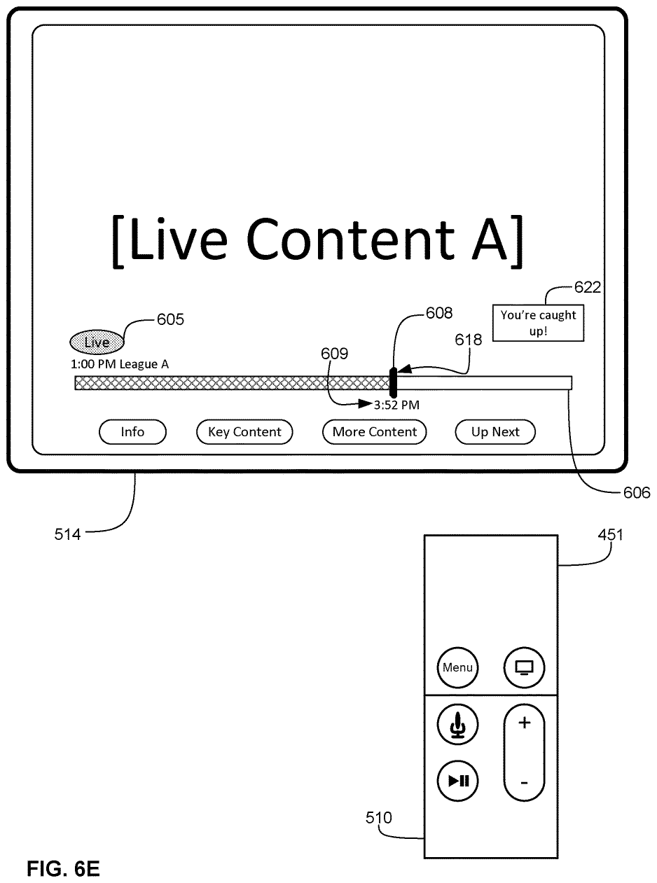

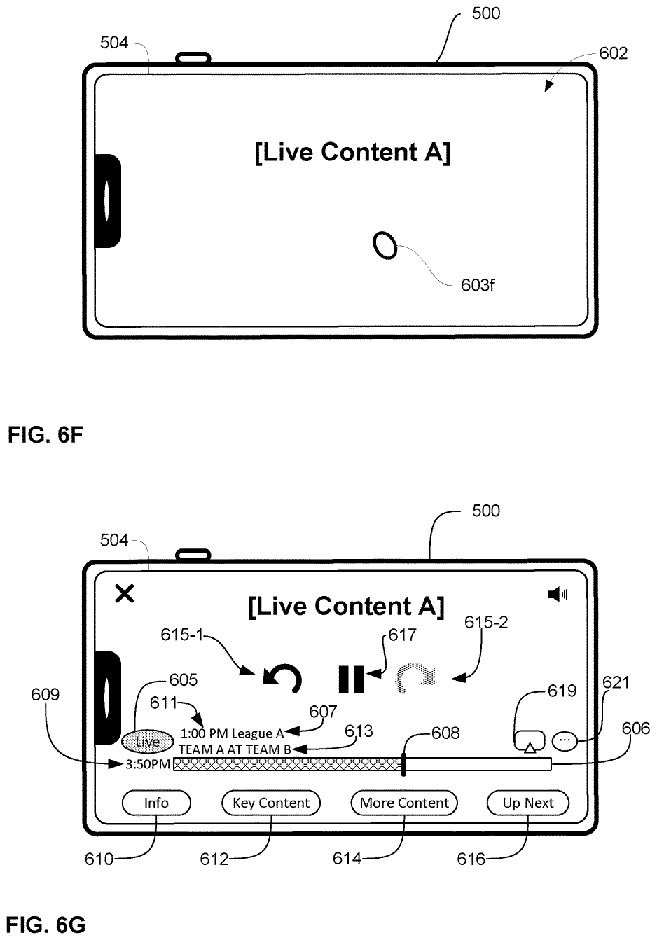

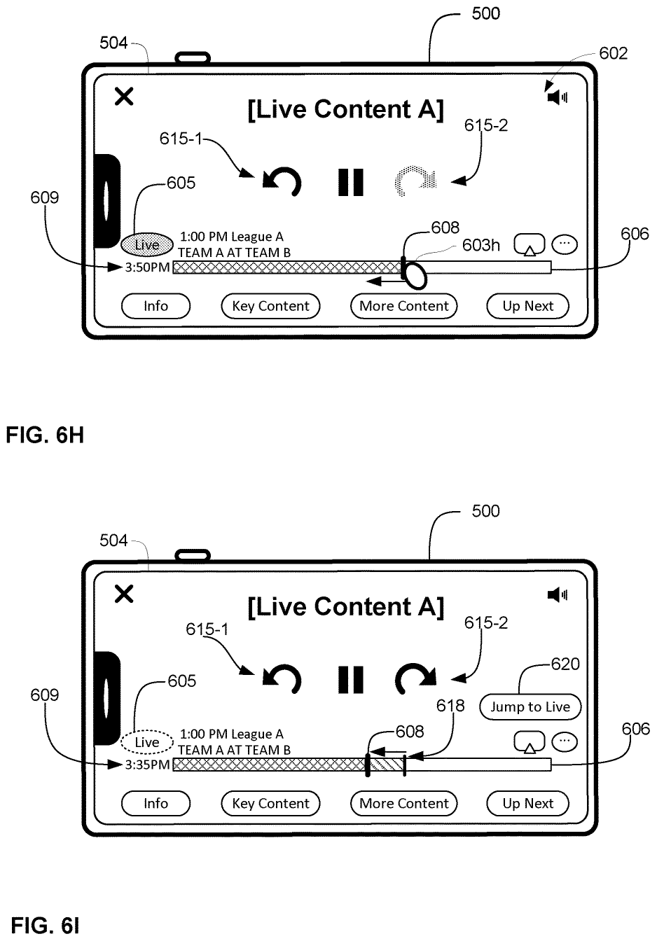

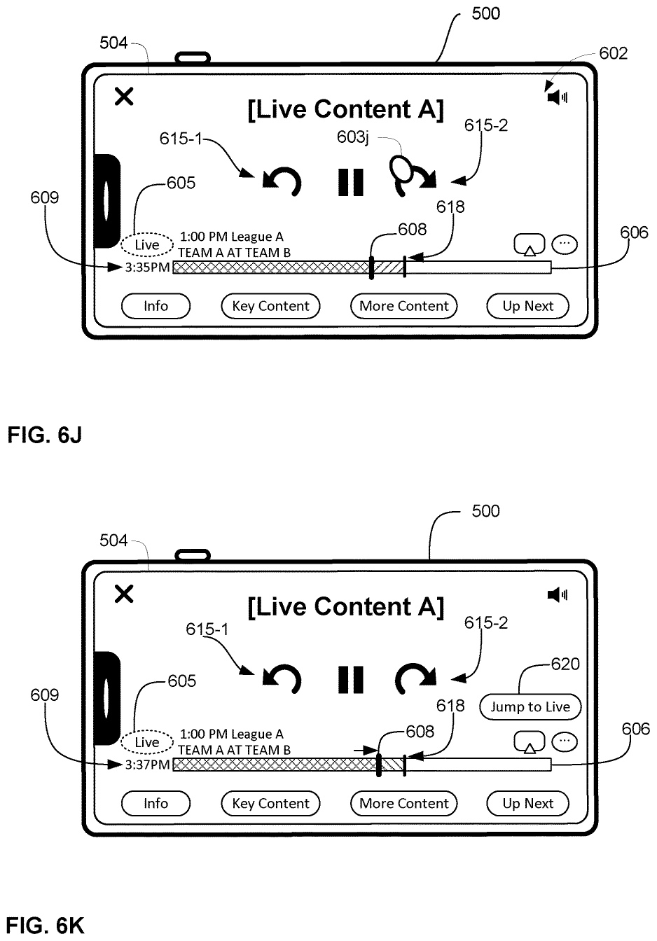

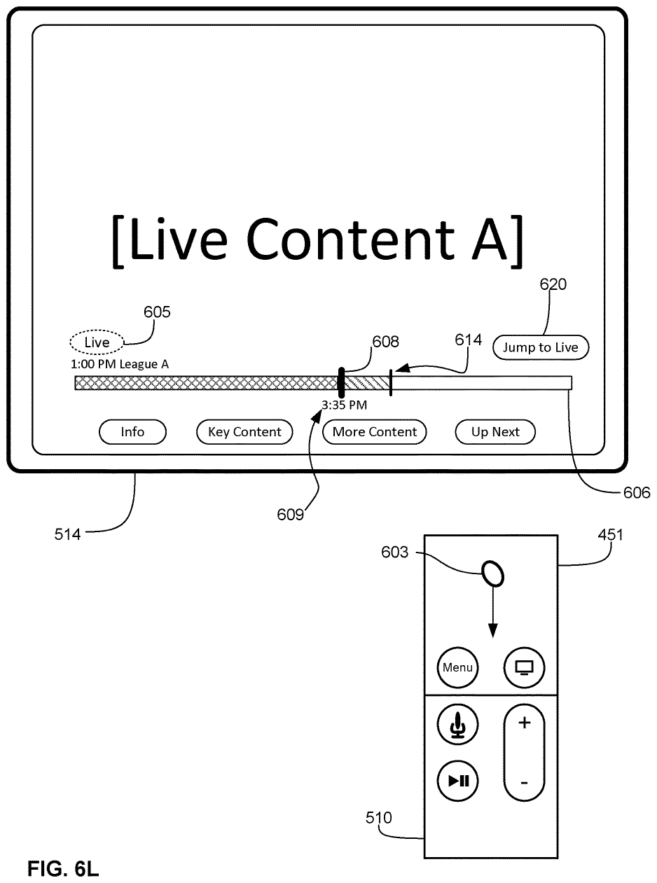

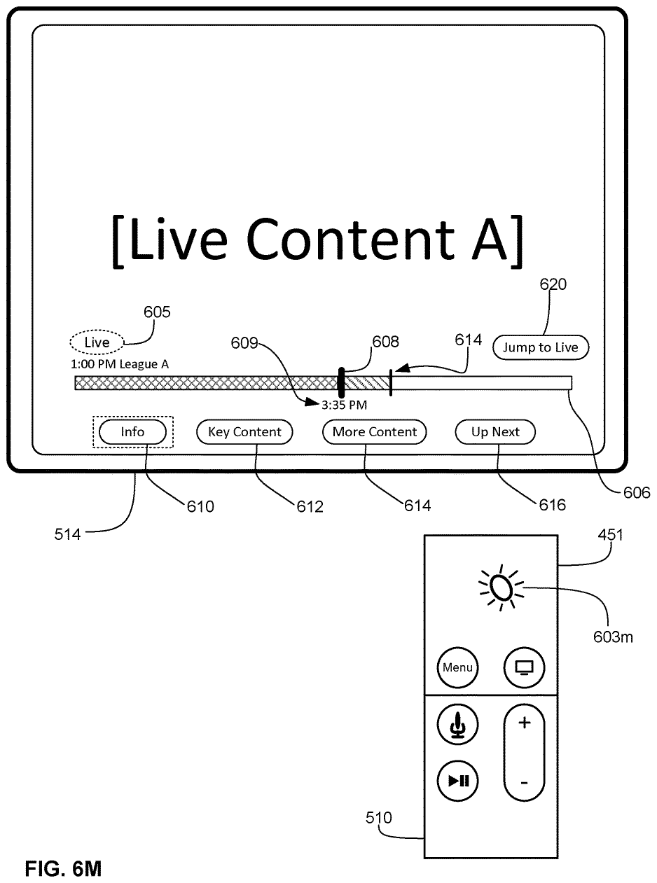

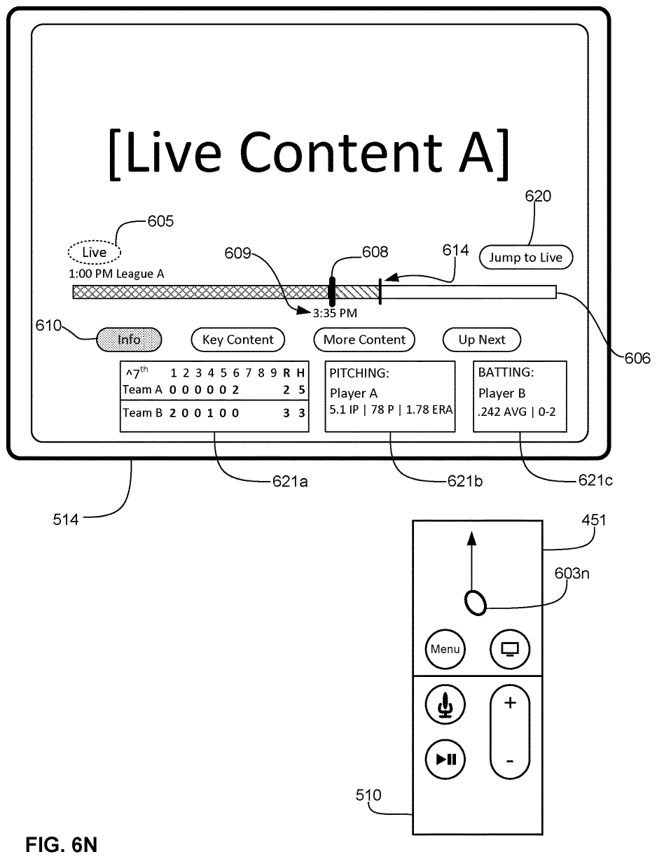

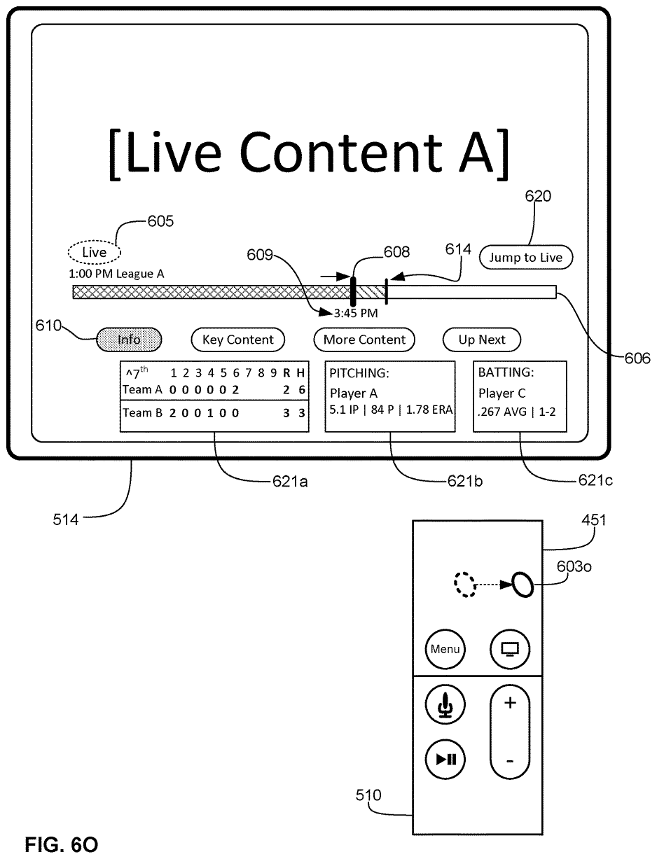

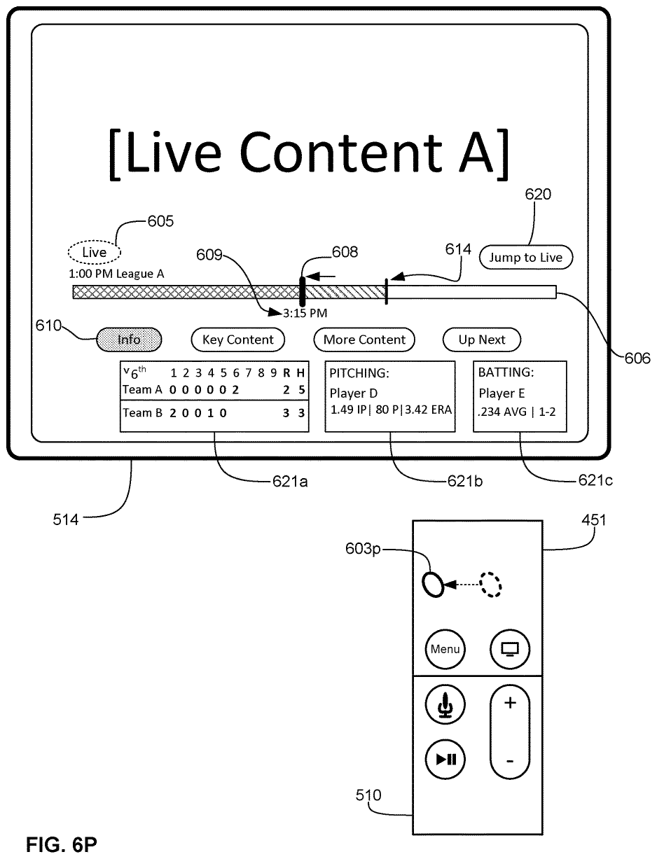

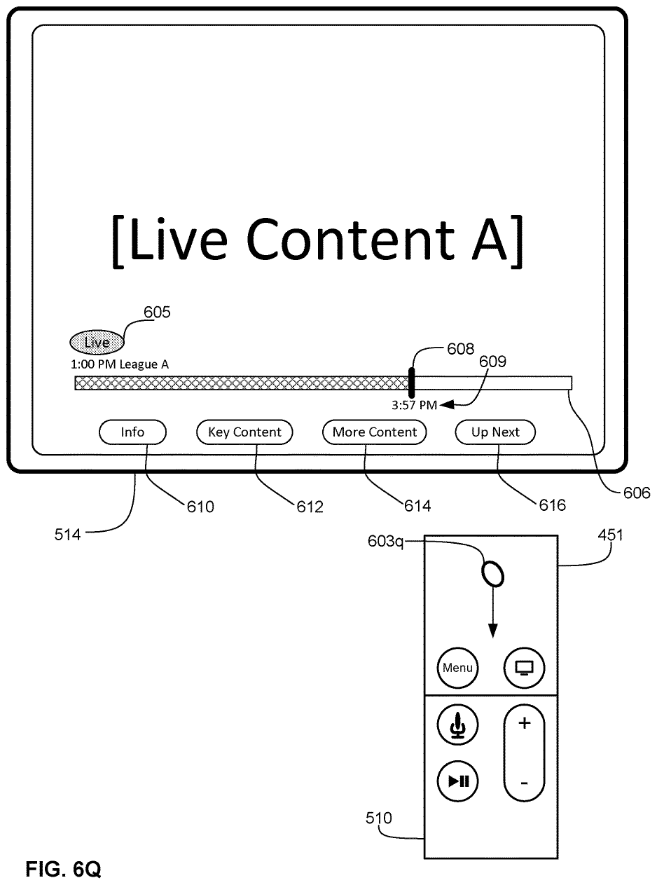

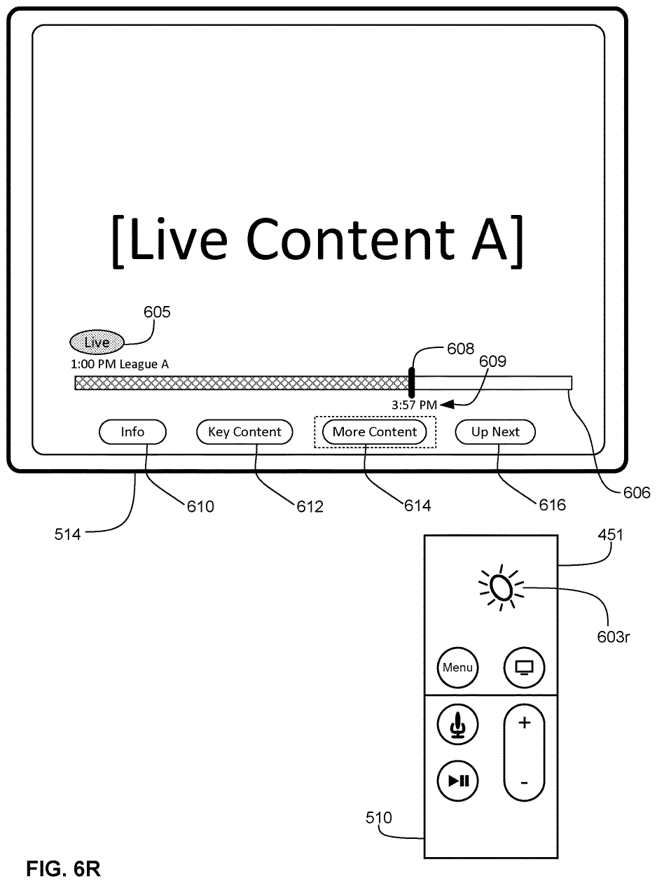

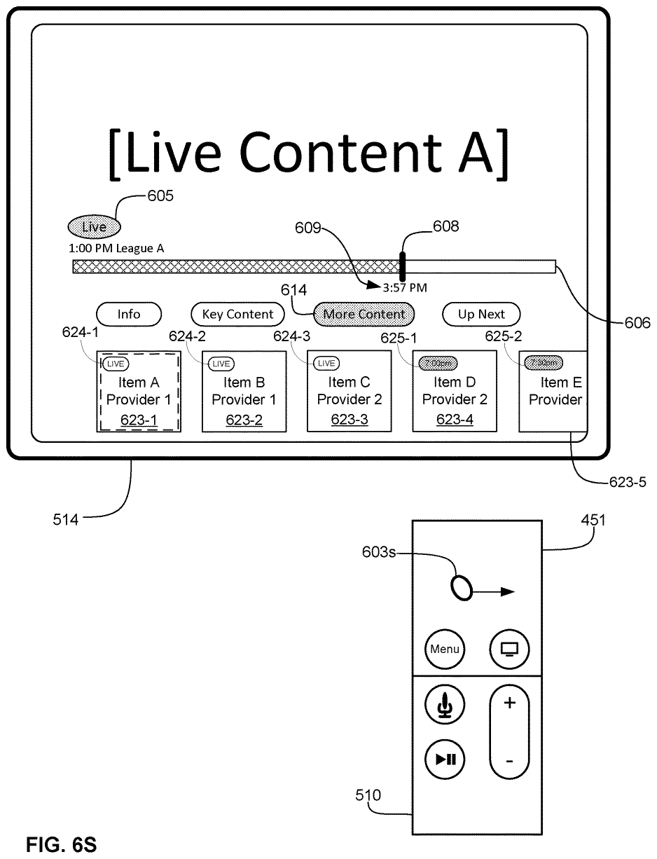

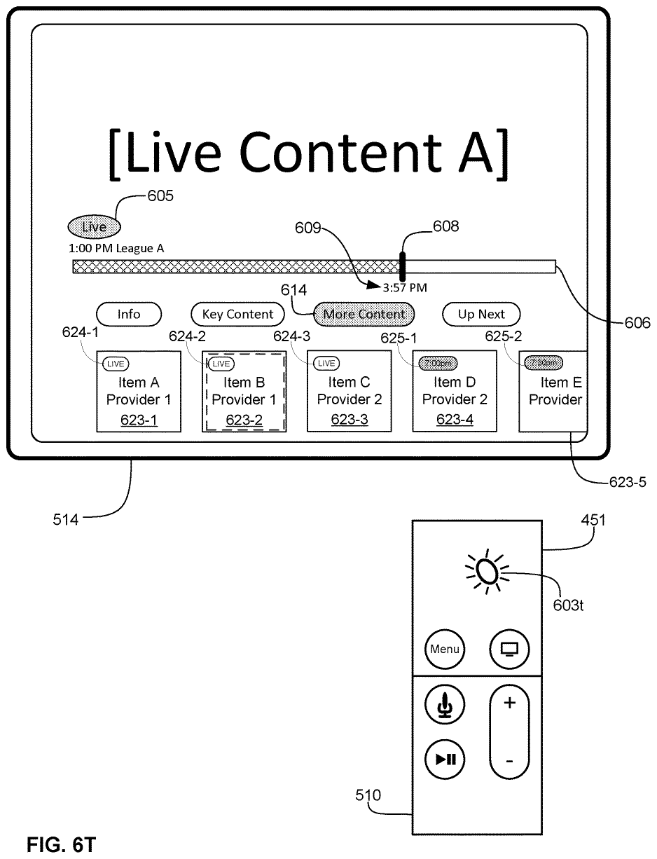

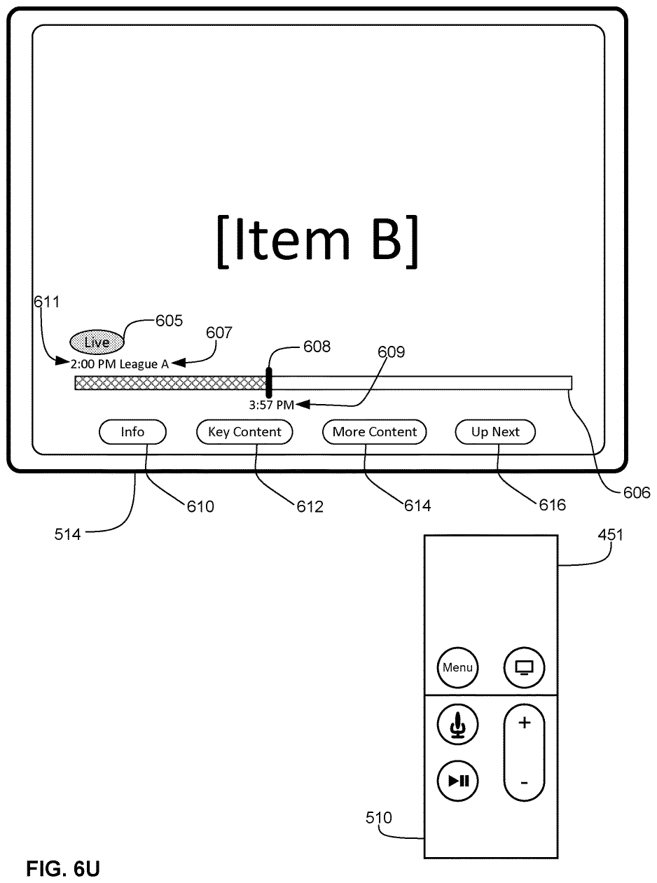

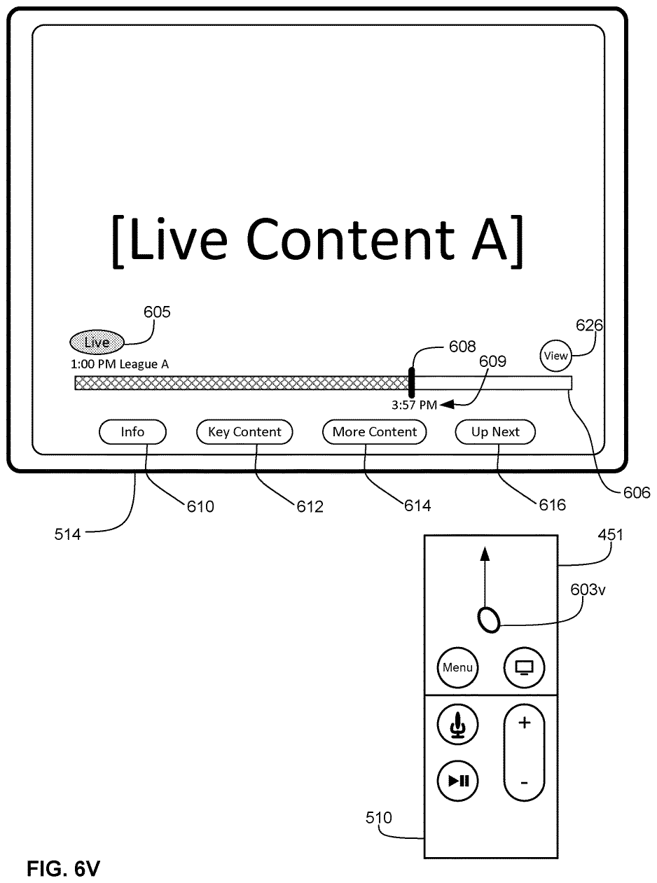

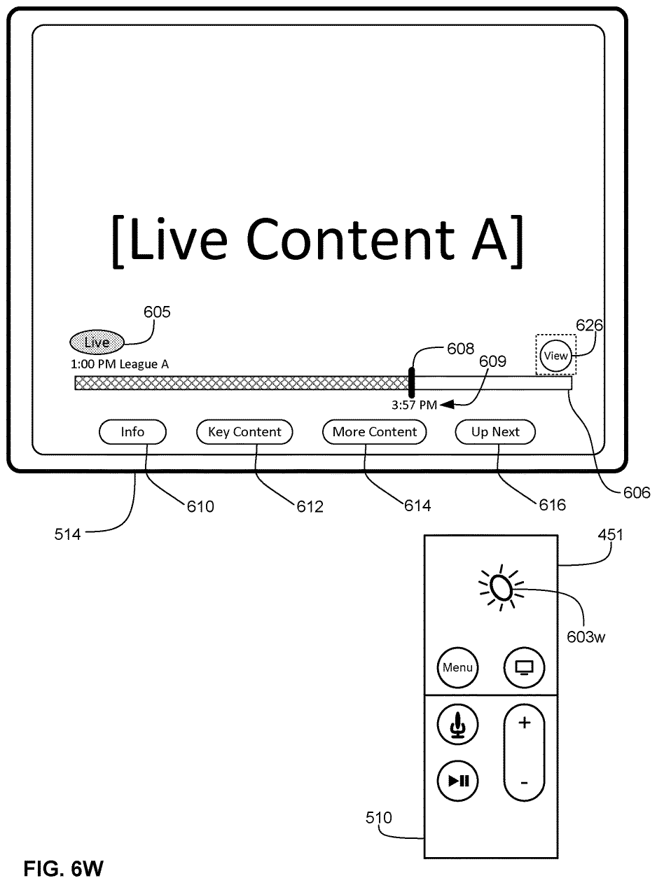

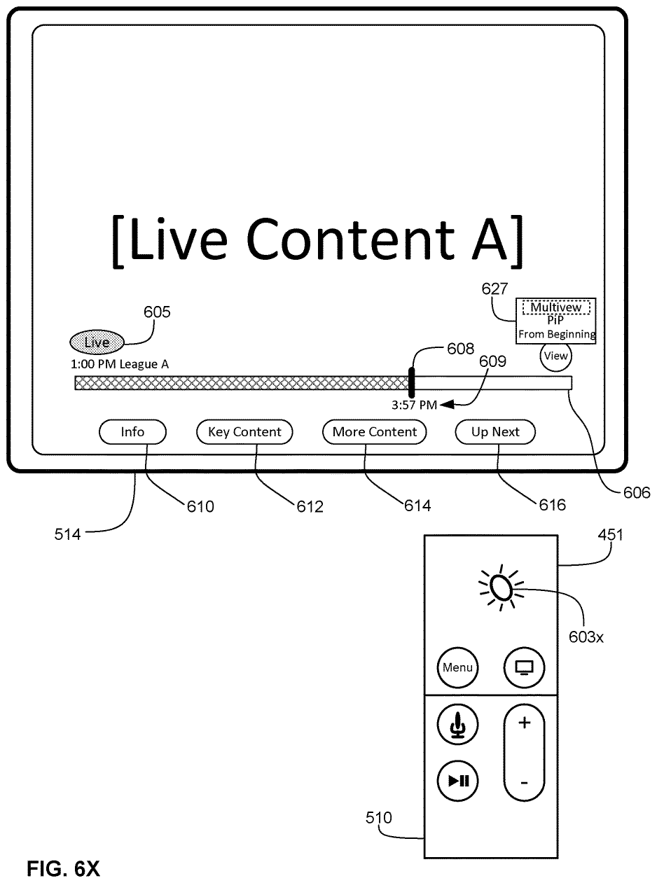

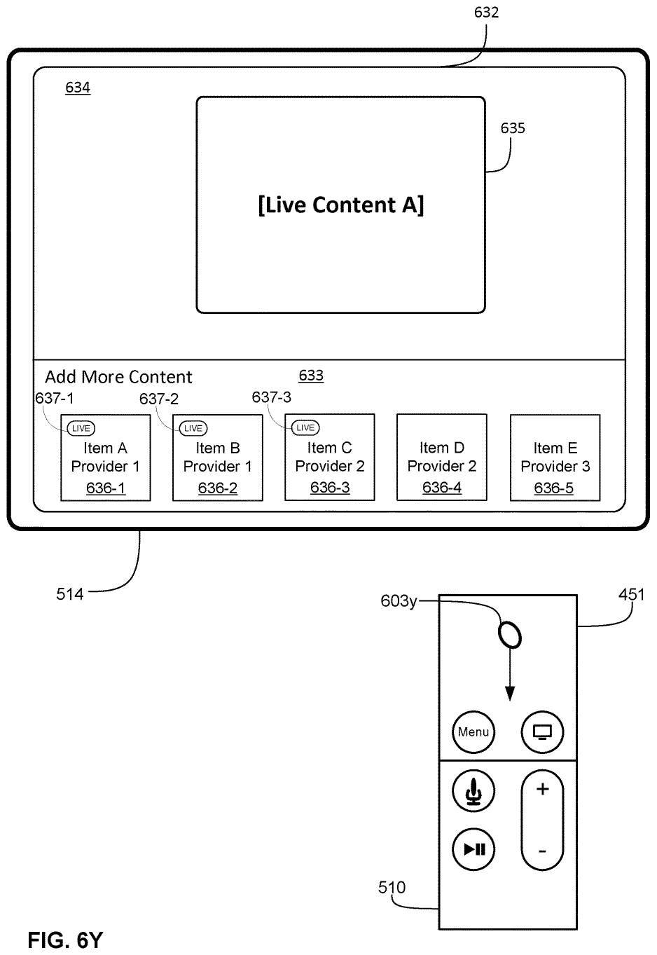

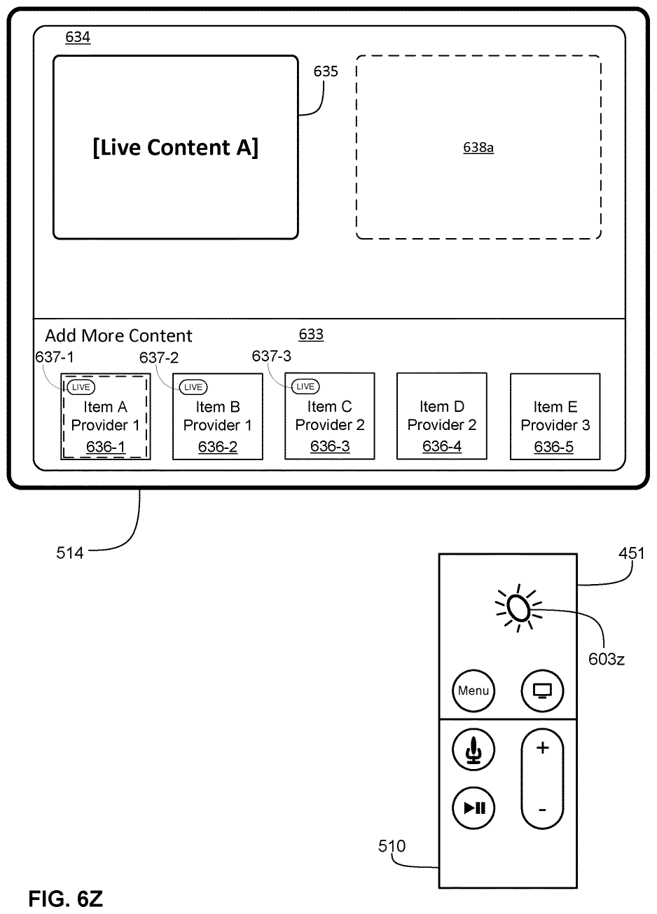

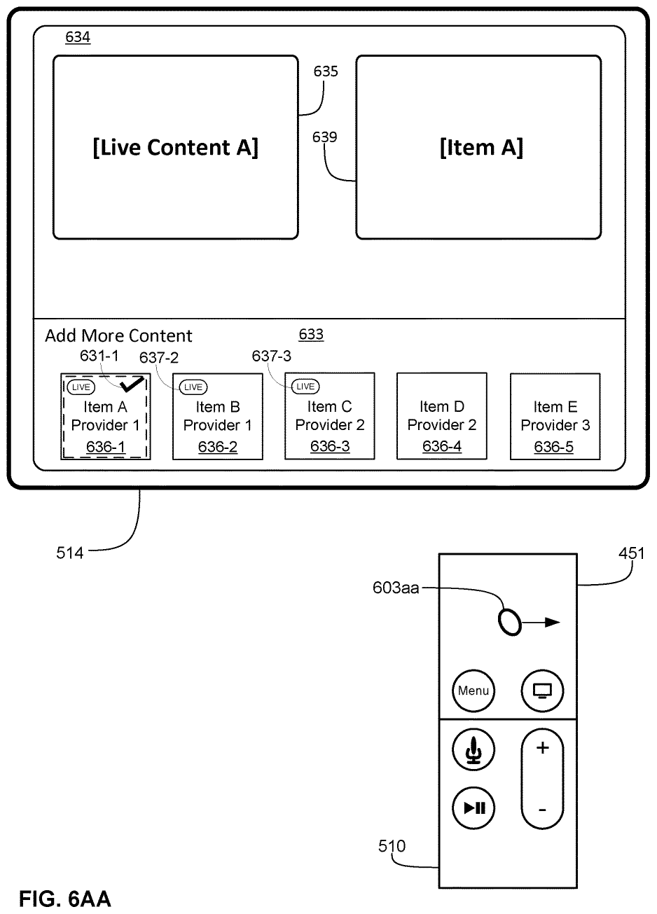

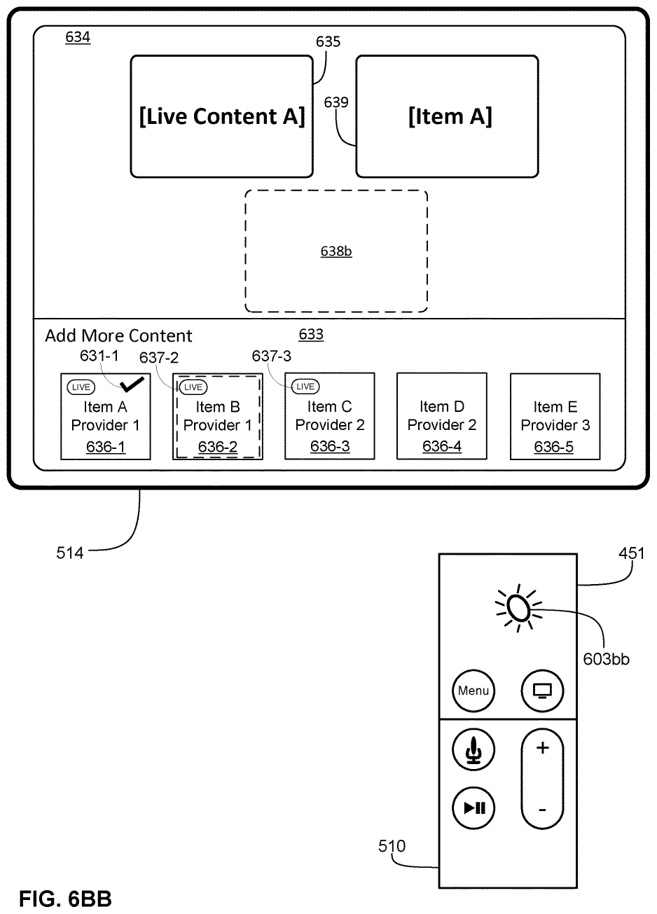

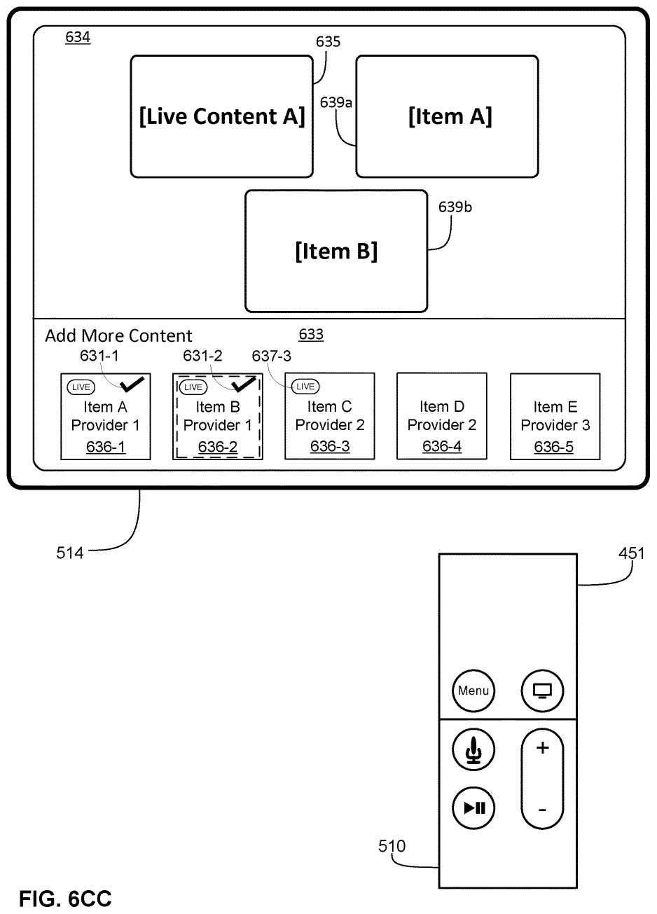

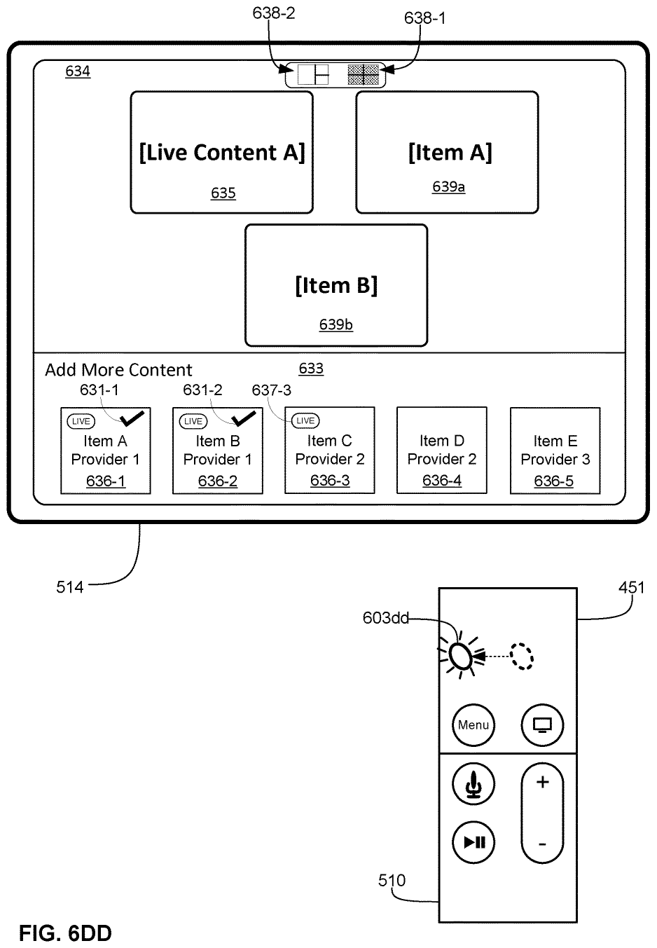

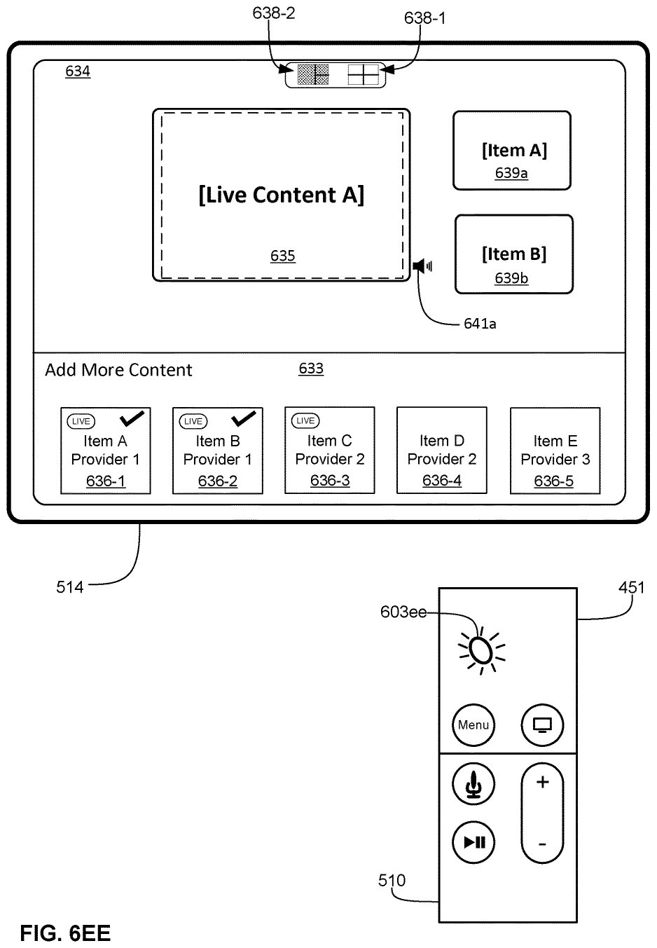

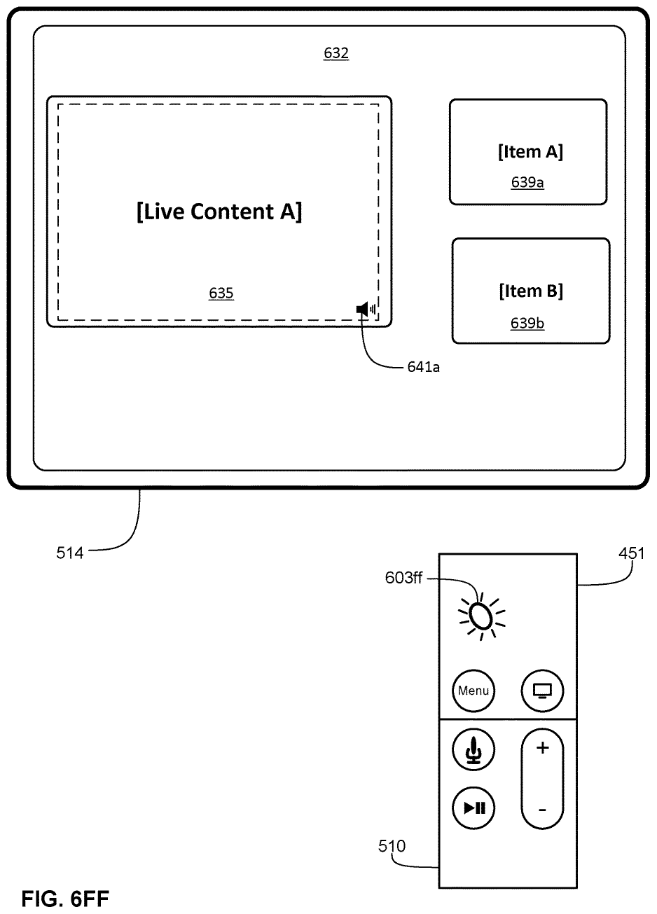

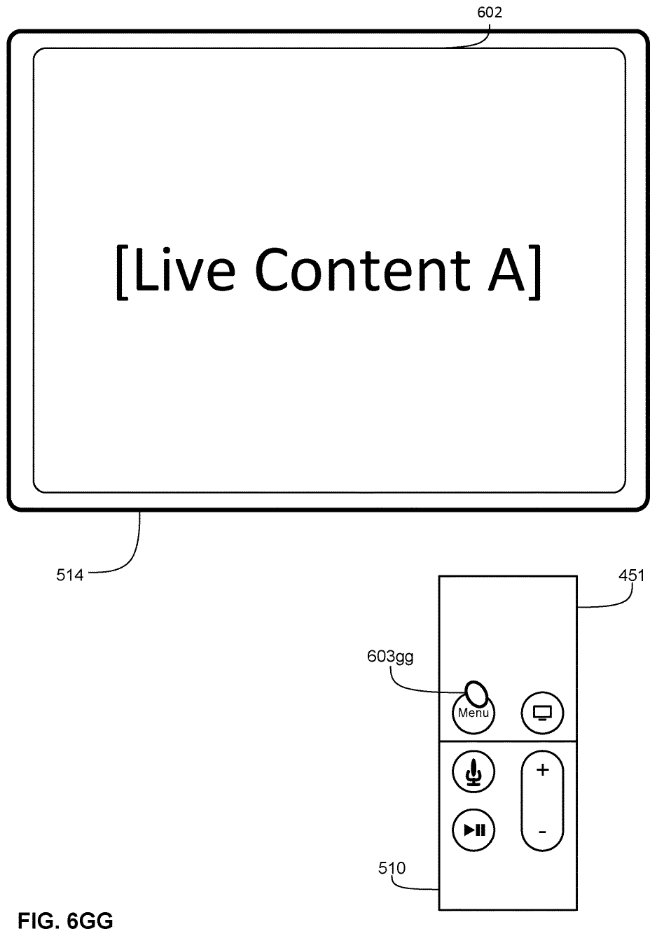

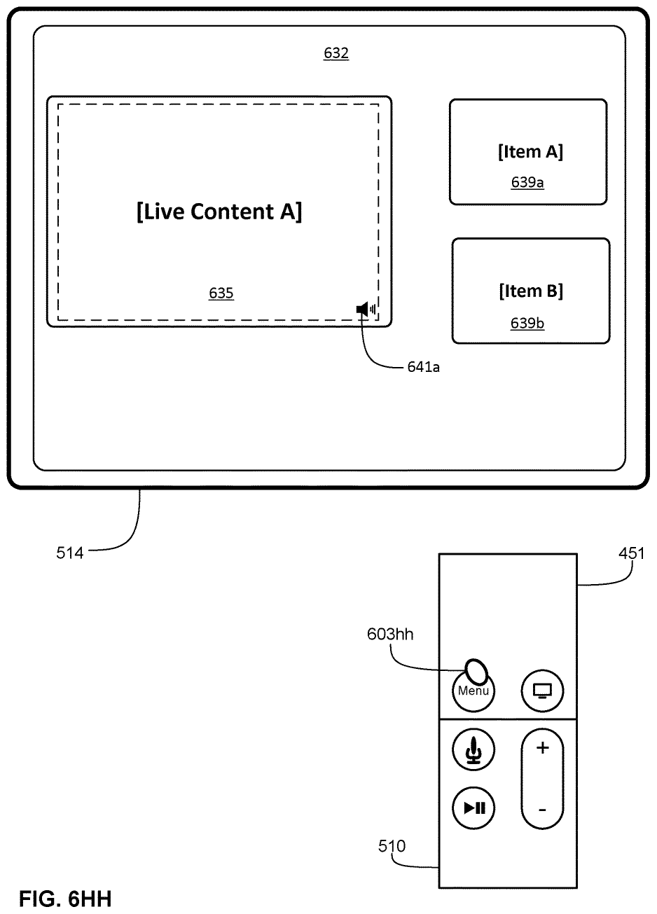

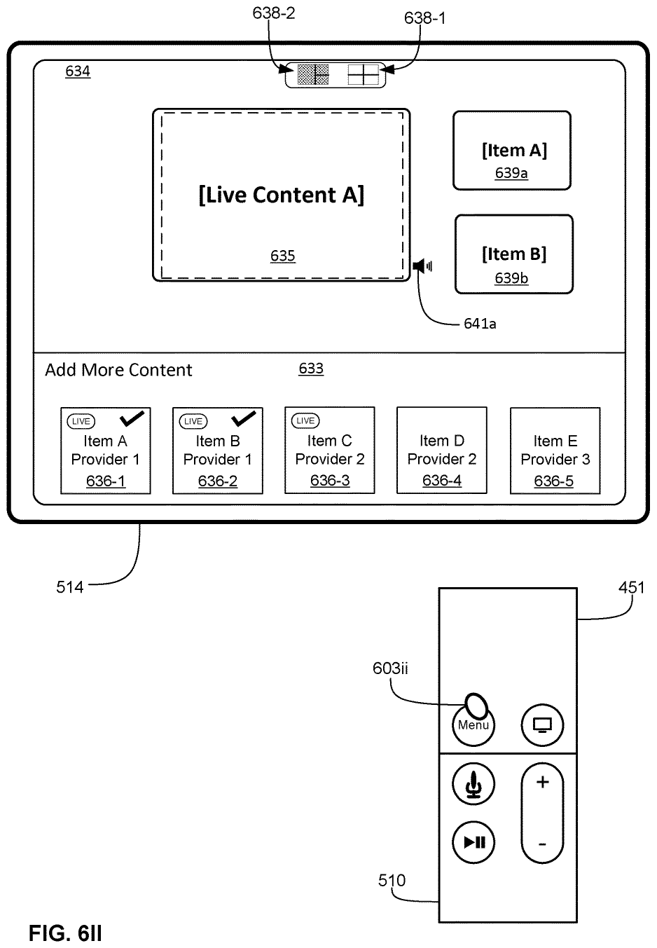

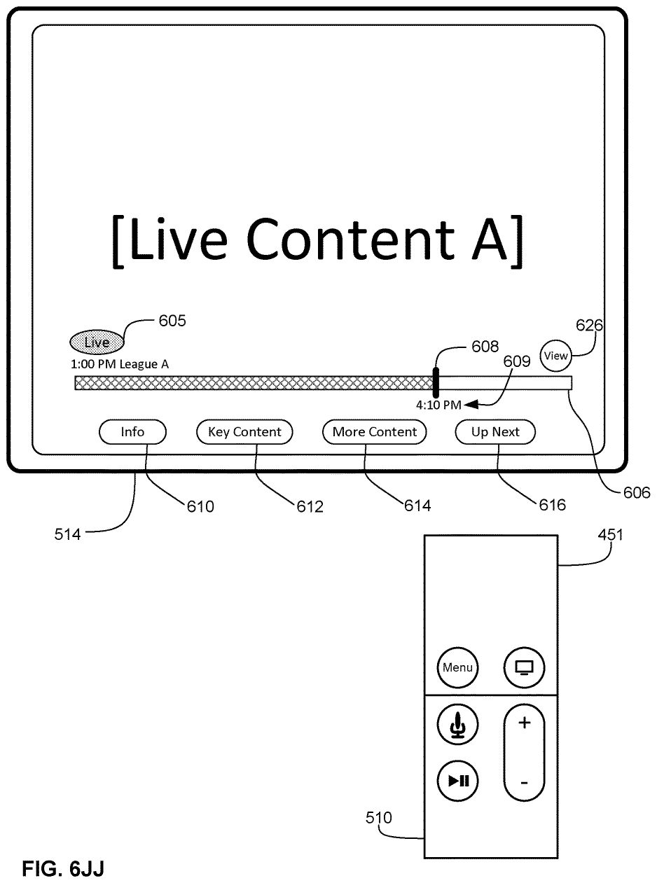

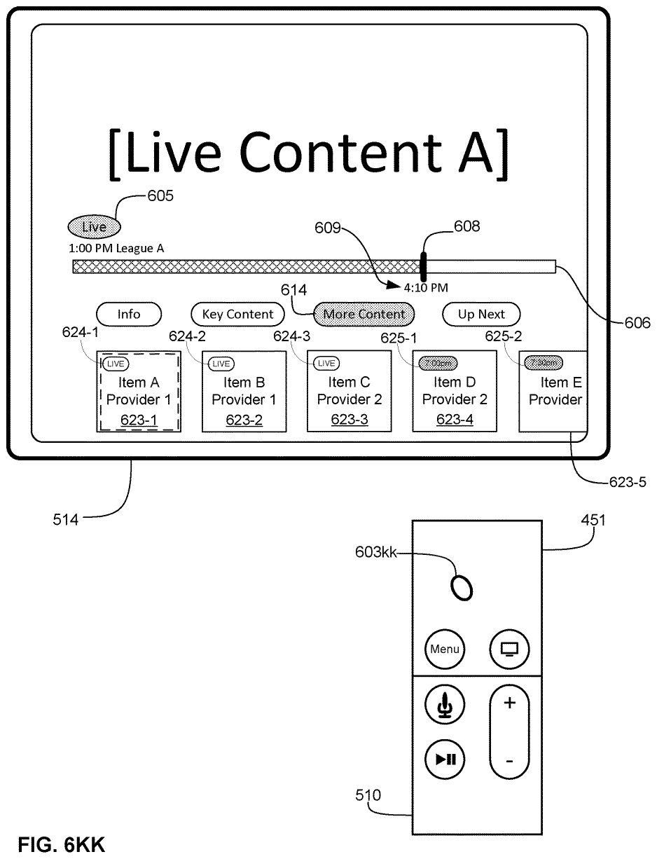

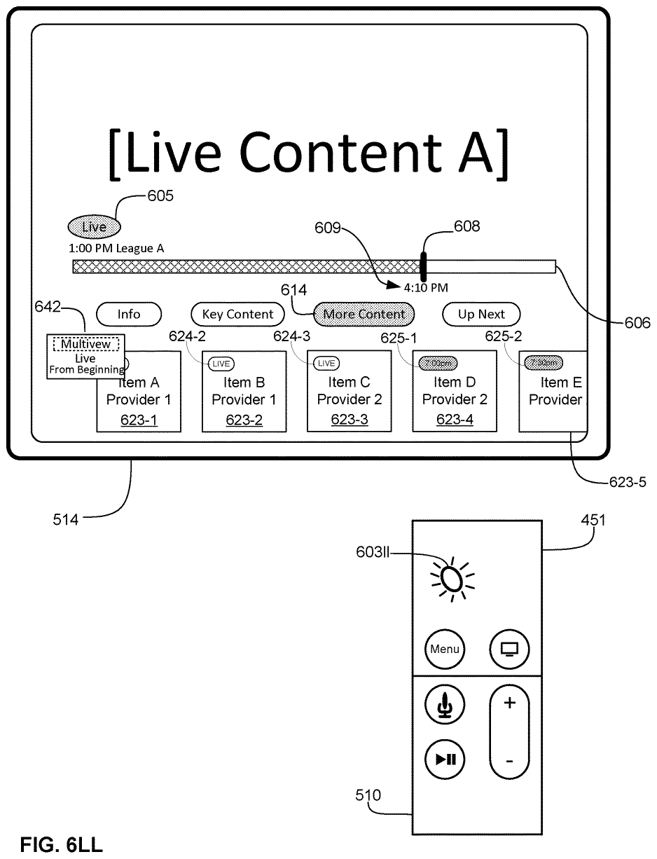

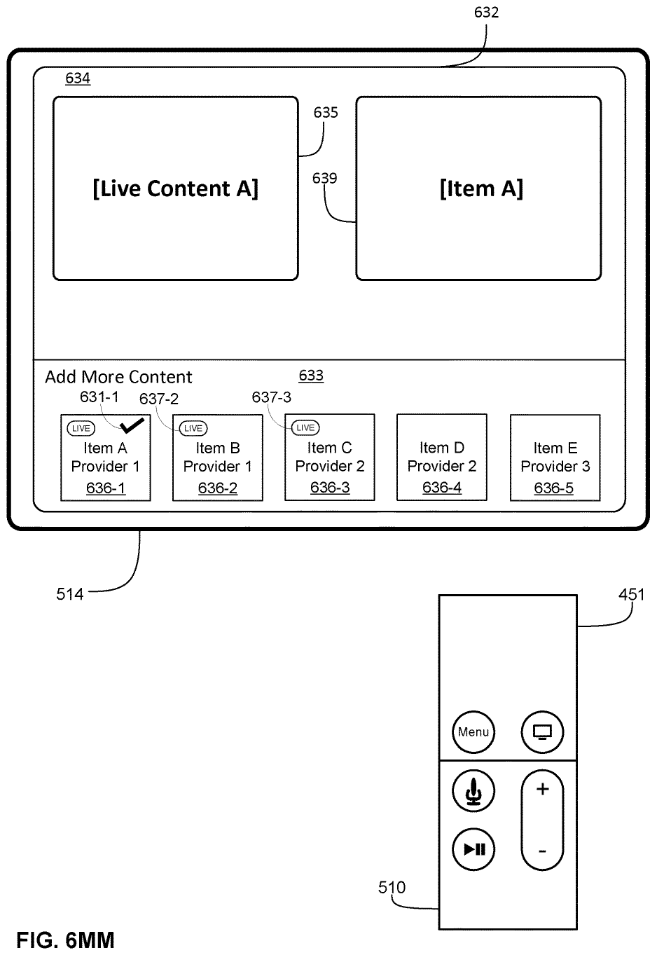

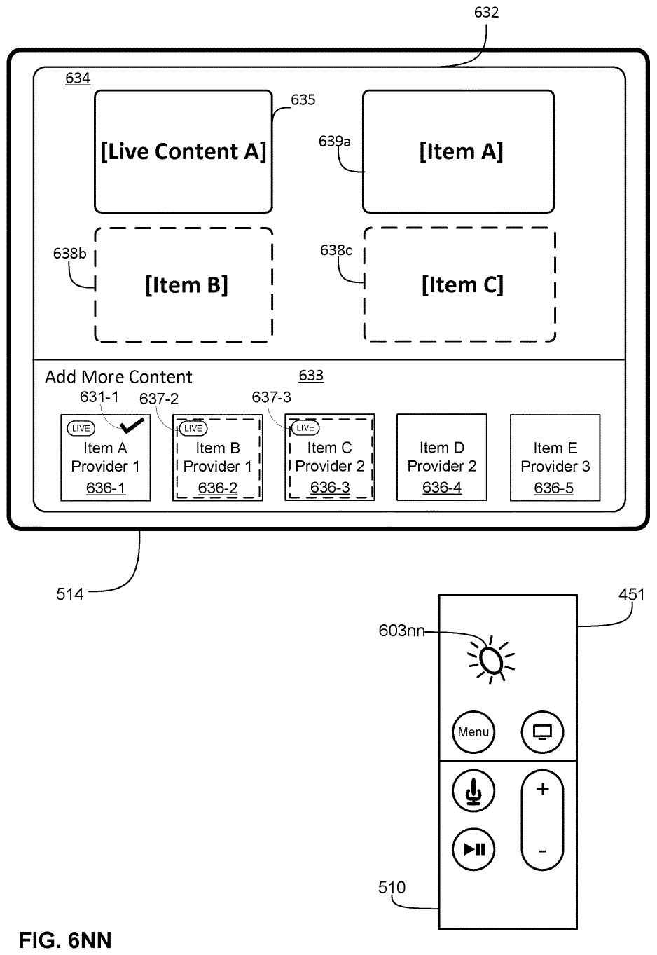

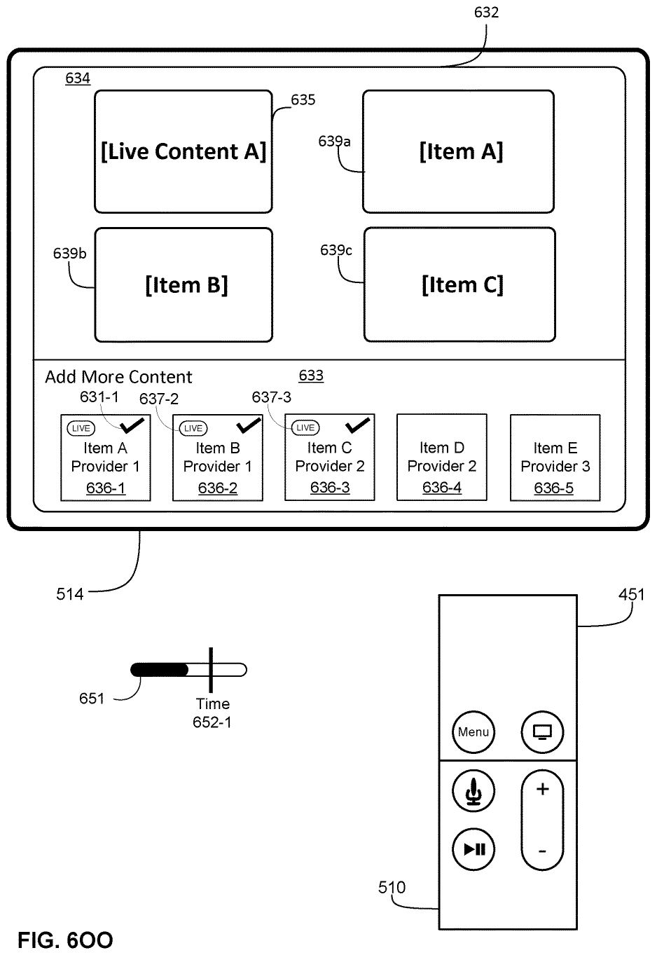

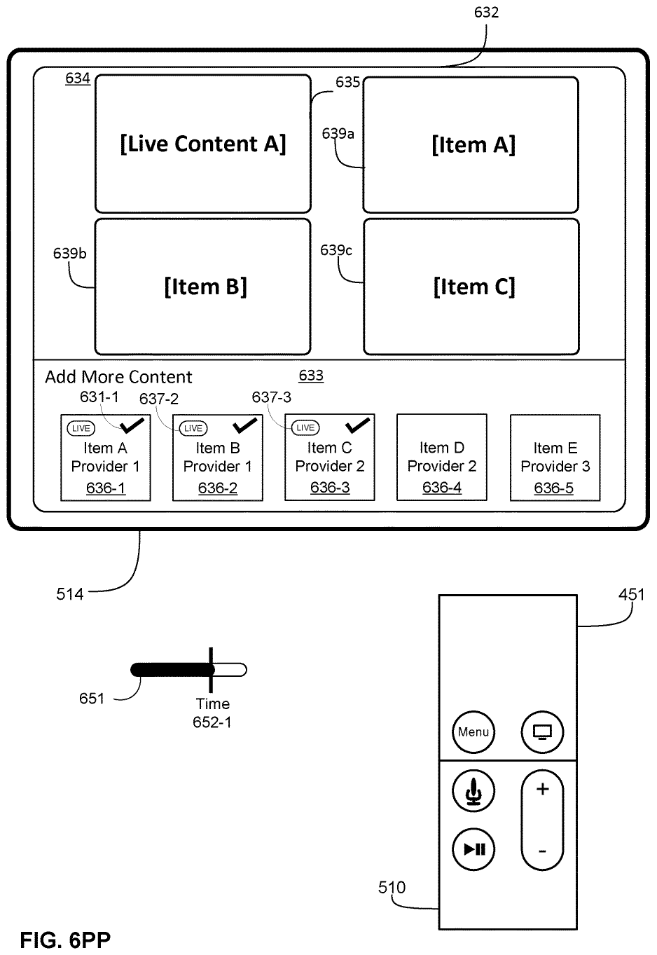

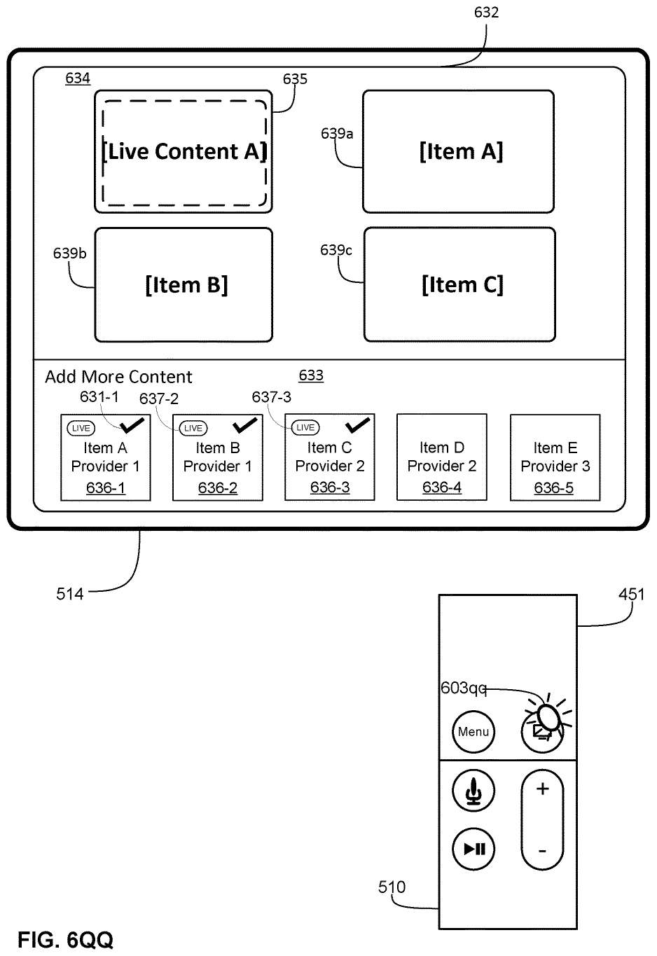

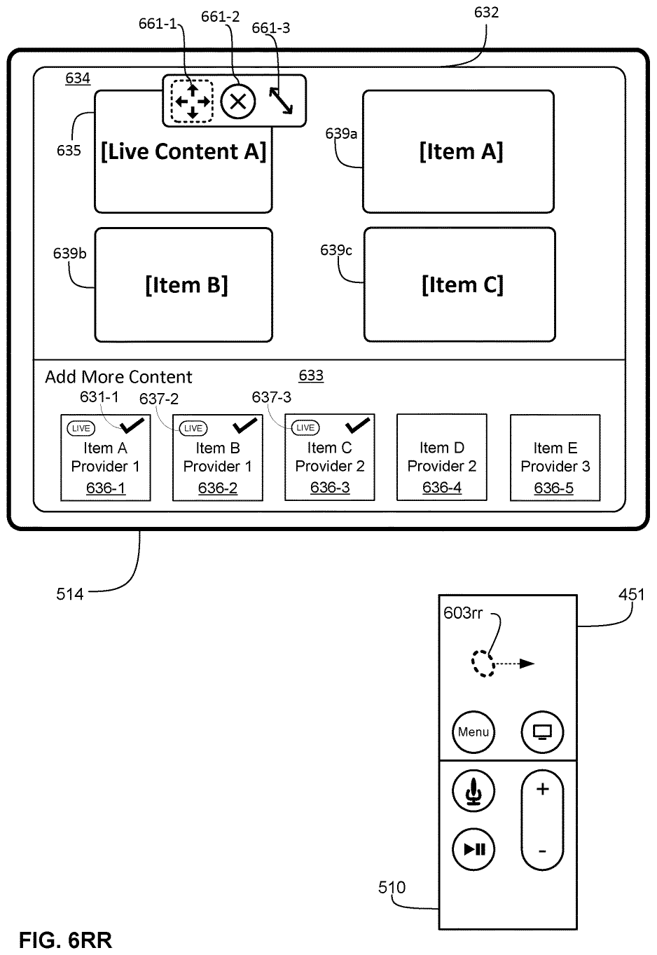

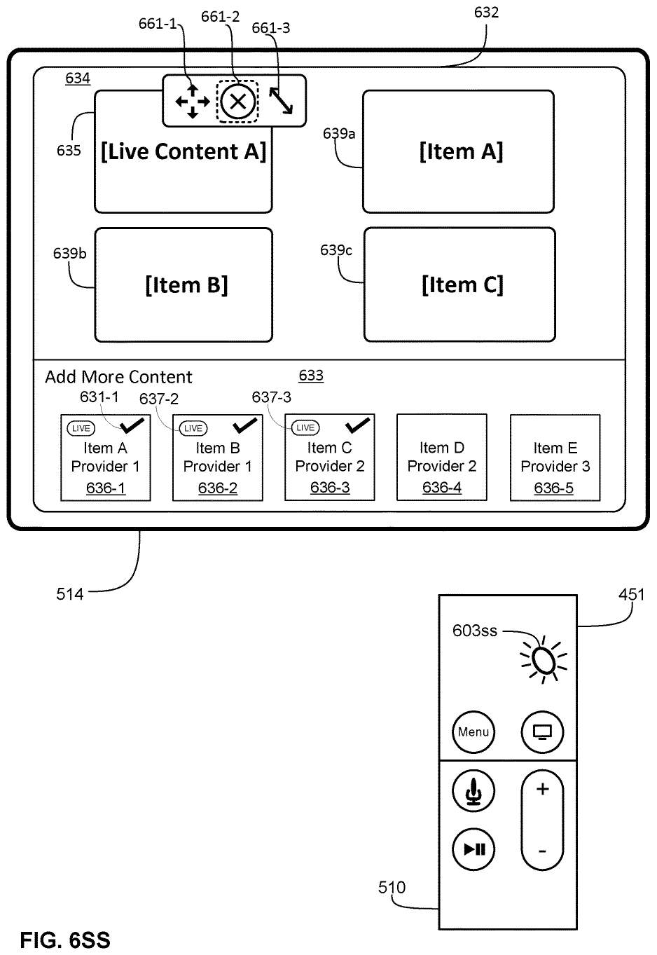

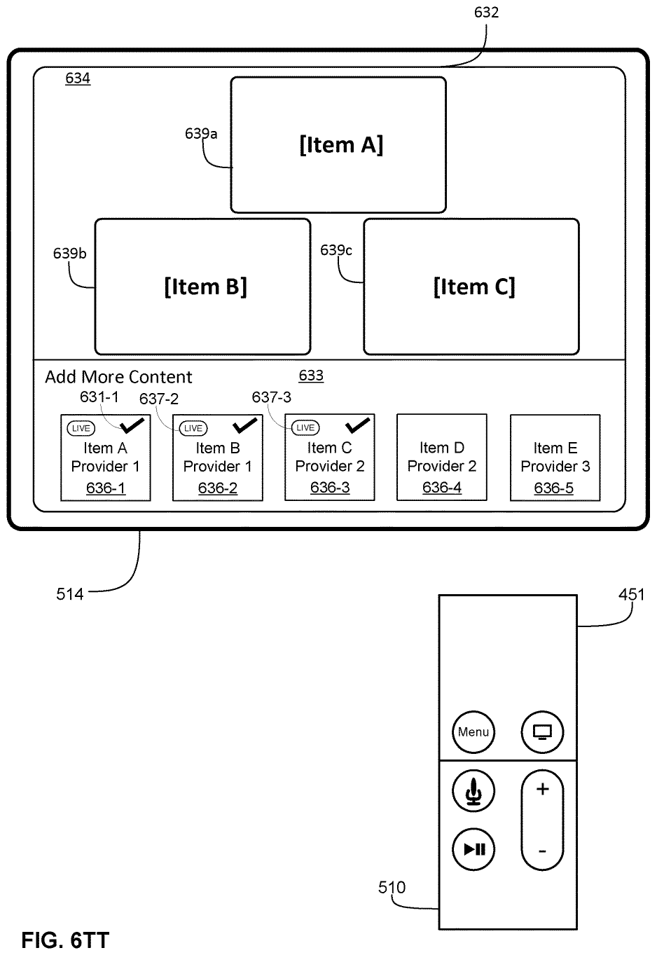

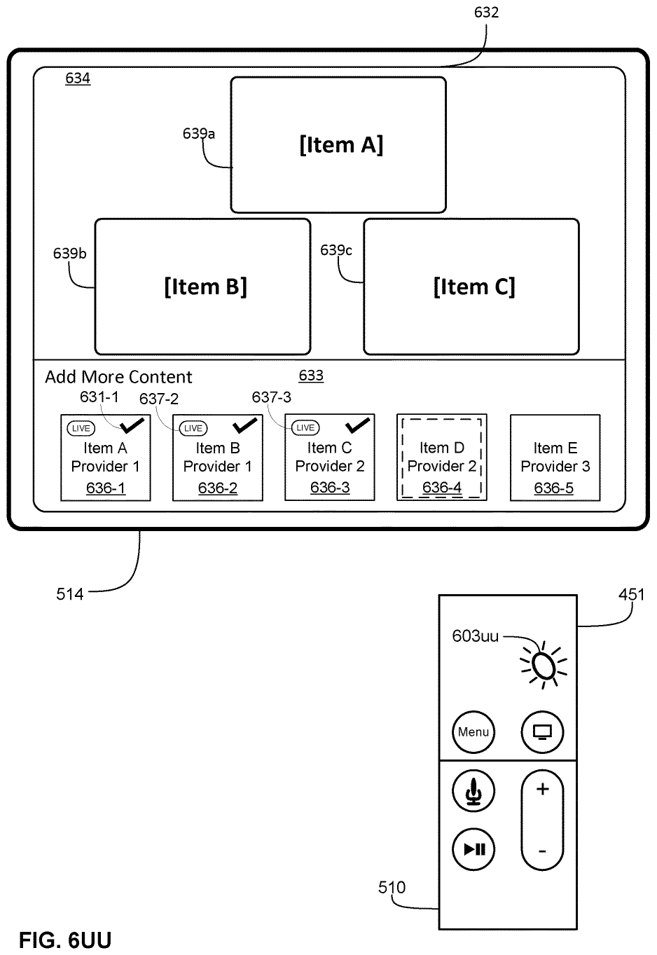

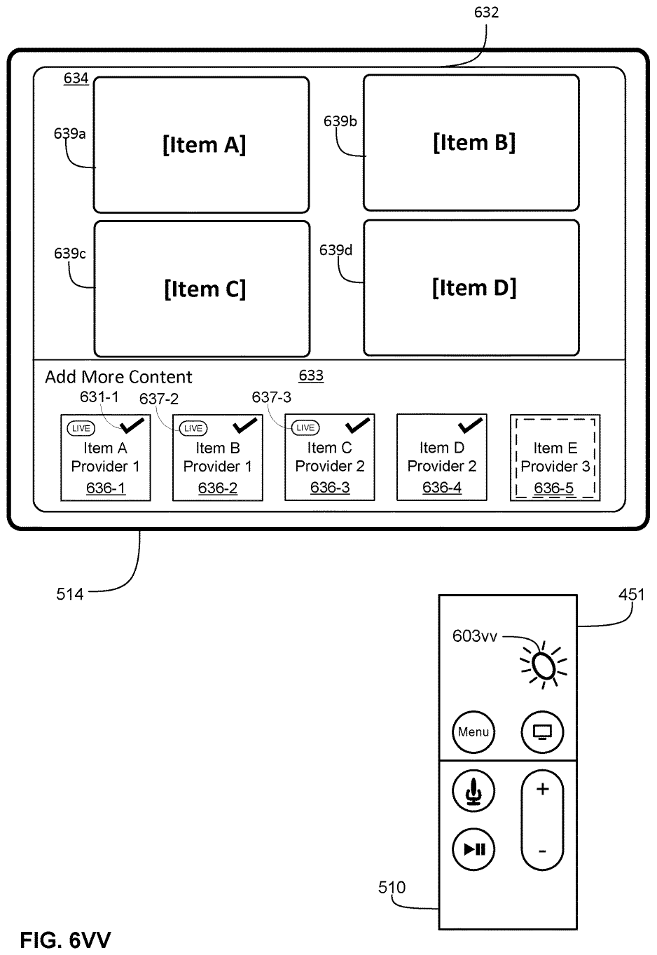

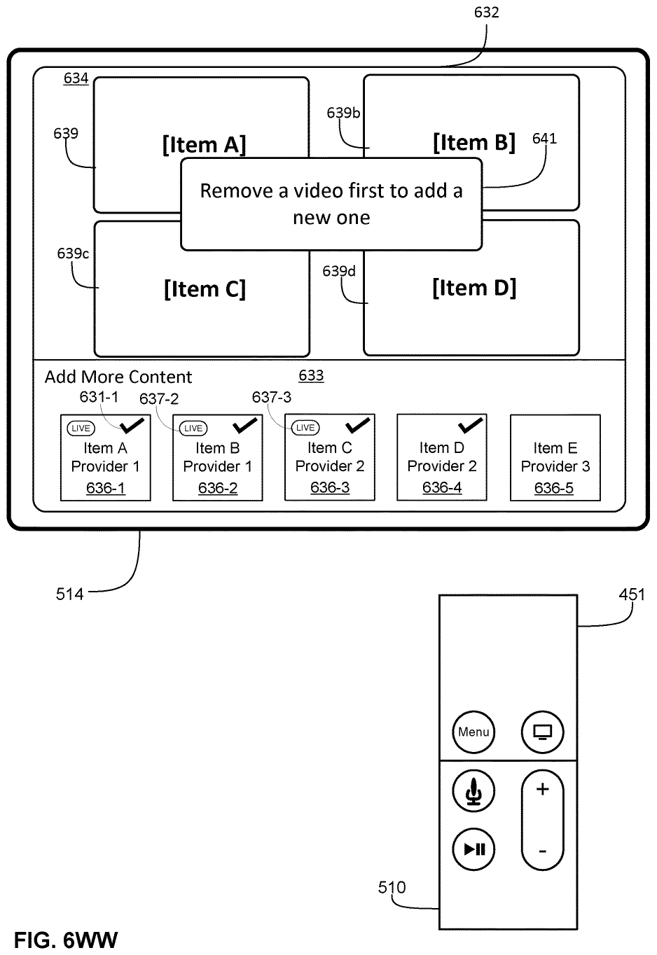

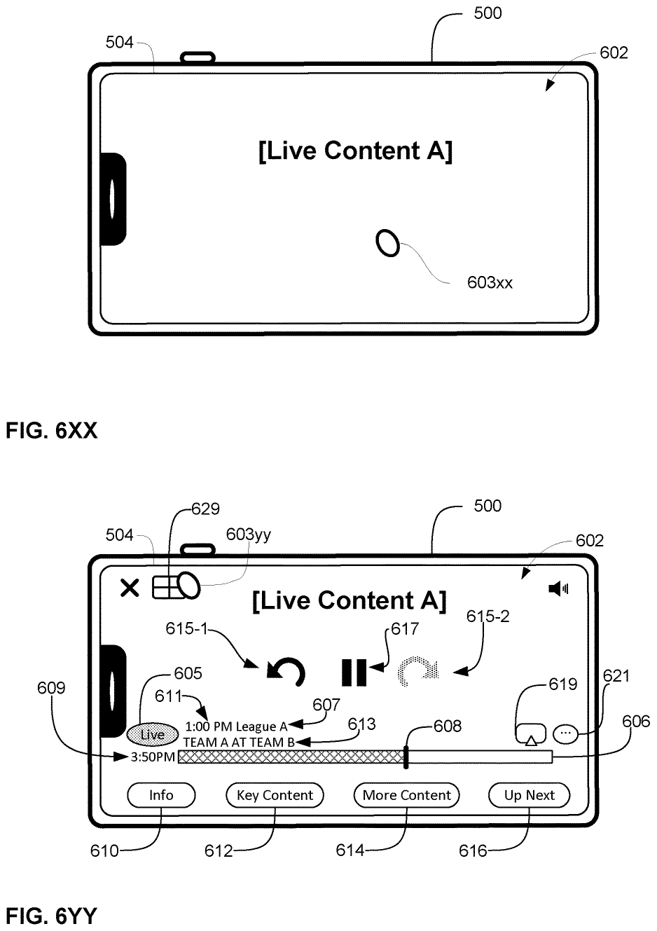

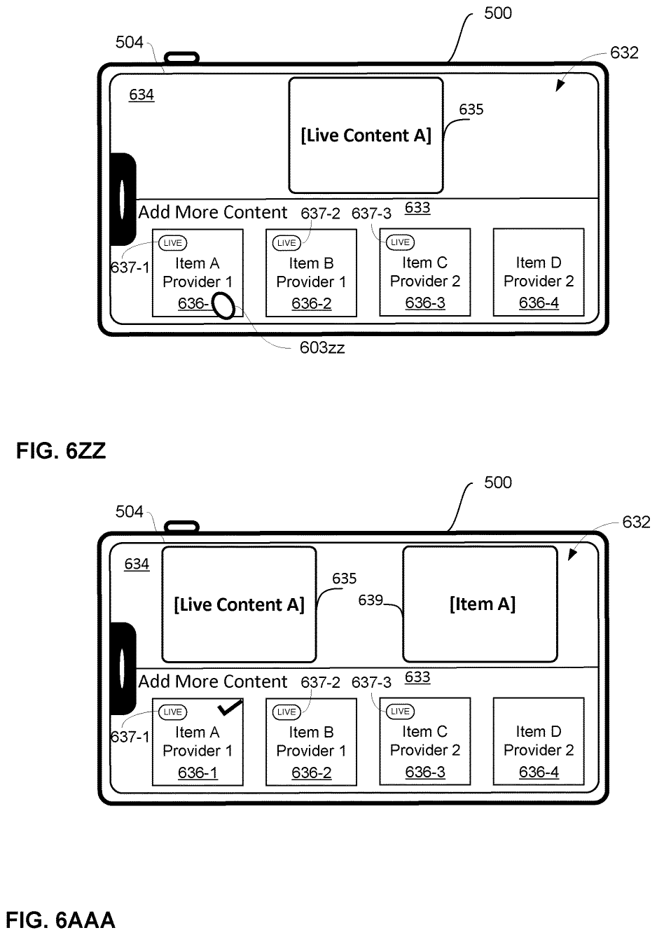

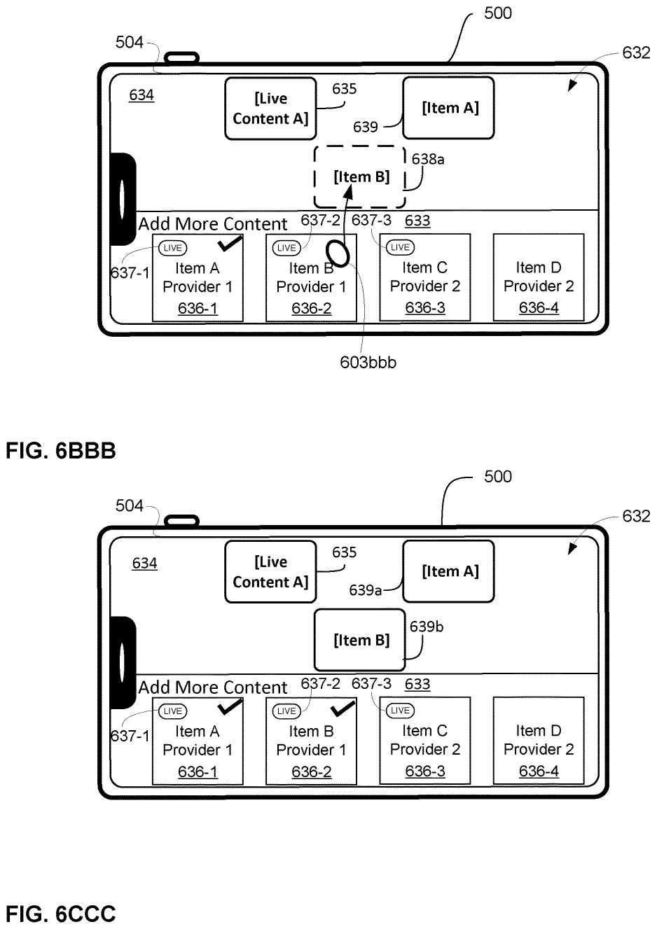

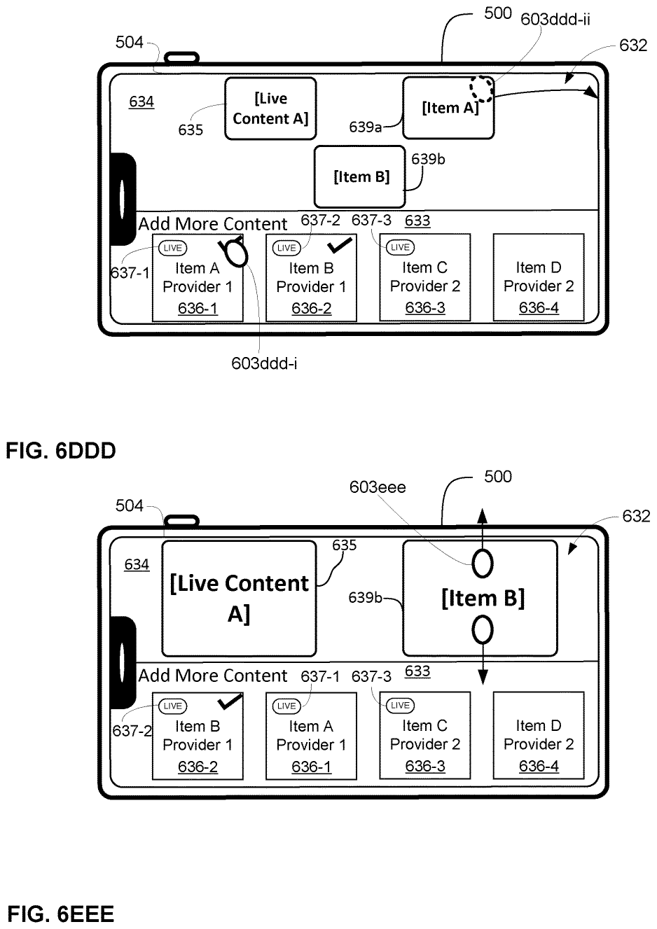

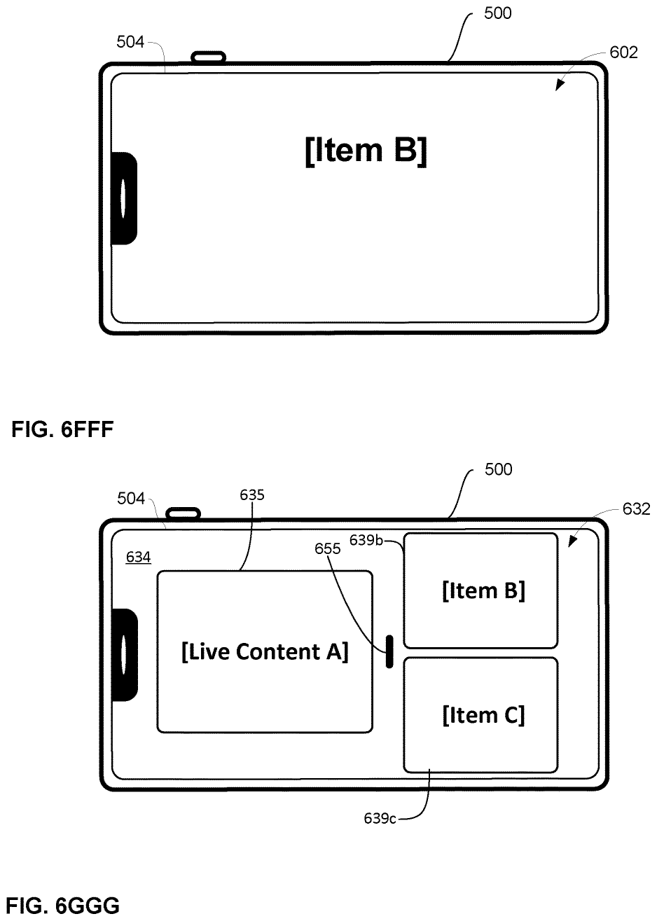

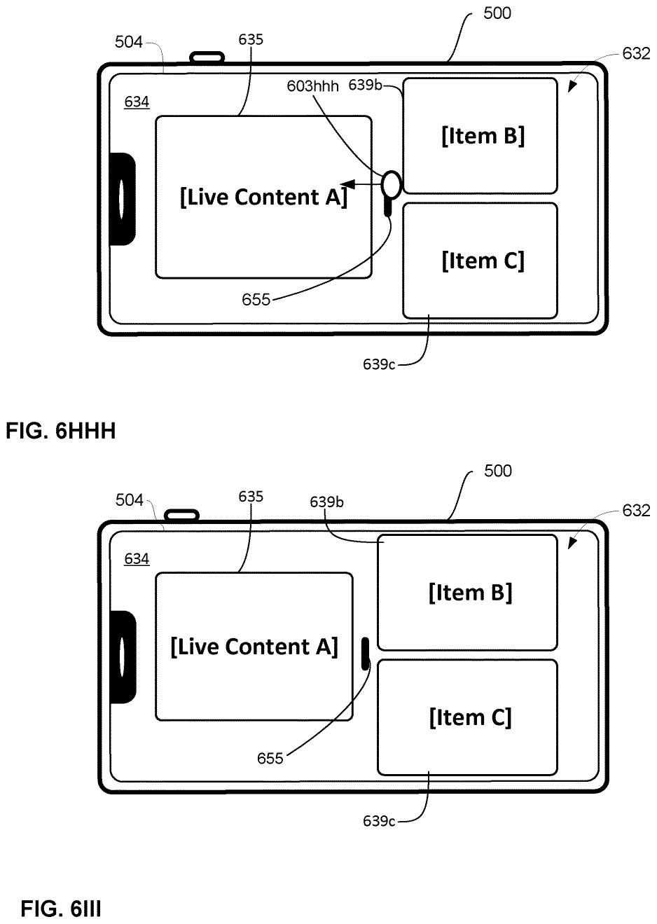

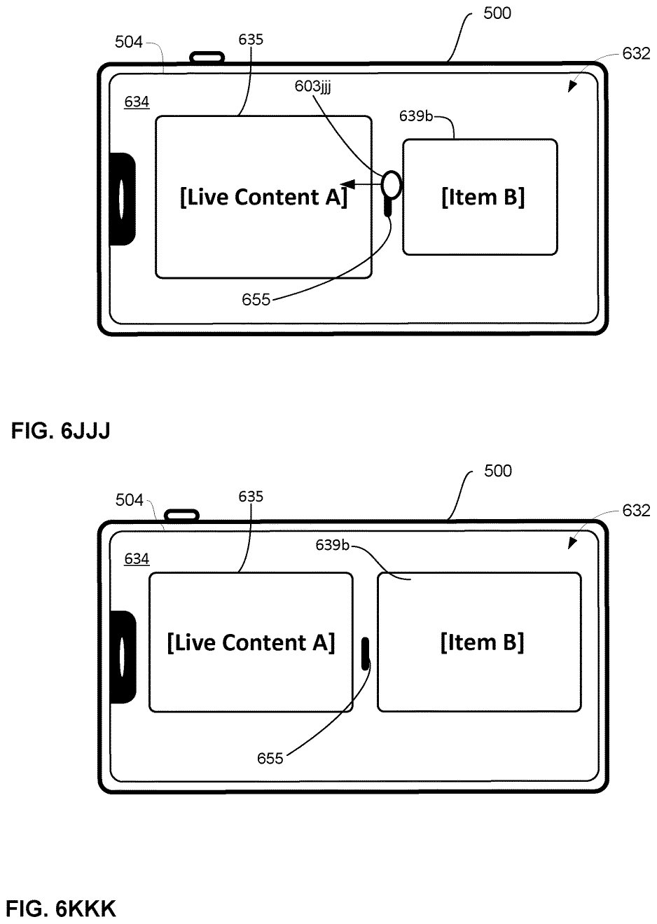

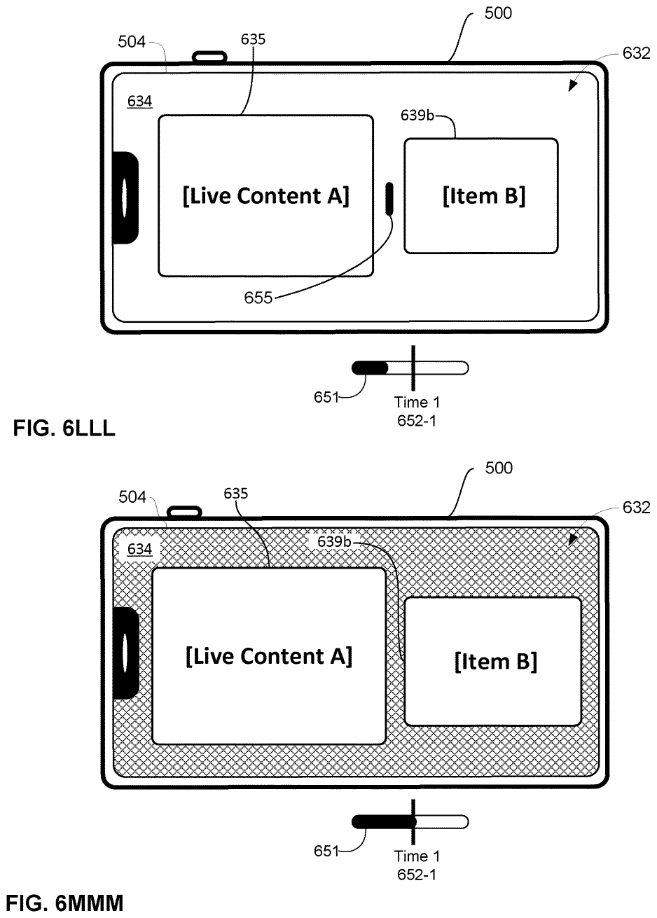

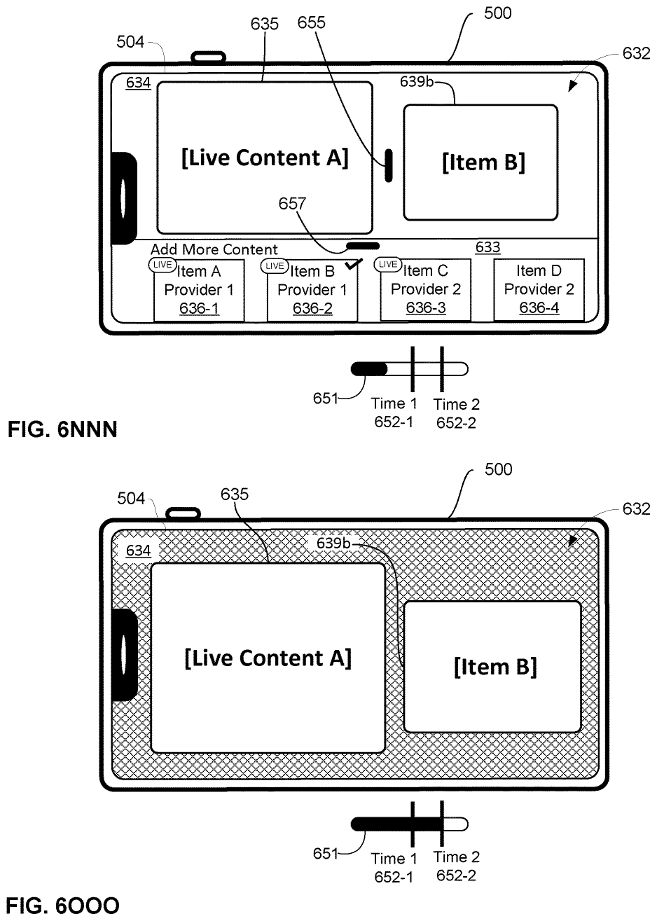

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes described with reference to FIGS. 6-11. A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5C, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

One or more of the embodiments disclosed herein optionally include one or more of the features disclosed in the following patent applications: “User Interfaces For Interacting with Channels that Provide Content that Plays in a Media Browsing Application” (Attorney Docket No.: 106843171600 (P42089USP1), filed Mar. 24, 2019), “User Interfaces For a Media Browsing Application” (Attorney Docket No.: 106843171700 (P42090USP1), filed Mar. 24, 2019), and “User Interfaces Including Selectable Representations of Content Items” (Attorney Docket No.: 106843171800 (P42091USP1), filed Mar. 24, 2019), each of which is hereby incorporated by reference.

Attention is now directed towards embodiments of user interfaces (“UI”) and associated processes that are implemented on an electronic device, such as portable multifunction device 100, device 300, or device 500.

### User Interfaces and Associated Processes

Content Player Bar for Interacting with Live Content

Users interact with electronic devices in many different manners, including using an electronic device to control playback of items of content, including live content, in a playback user interface. In some embodiments, an electronic device is configurable to display a content player bar that is interactive to control playback of a live content item that is currently displayed in the playback user interface. The embodiments described below provide ways in which an electronic device controls playback of a live content item, in a playback user interface, using a content player bar and associated controls. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

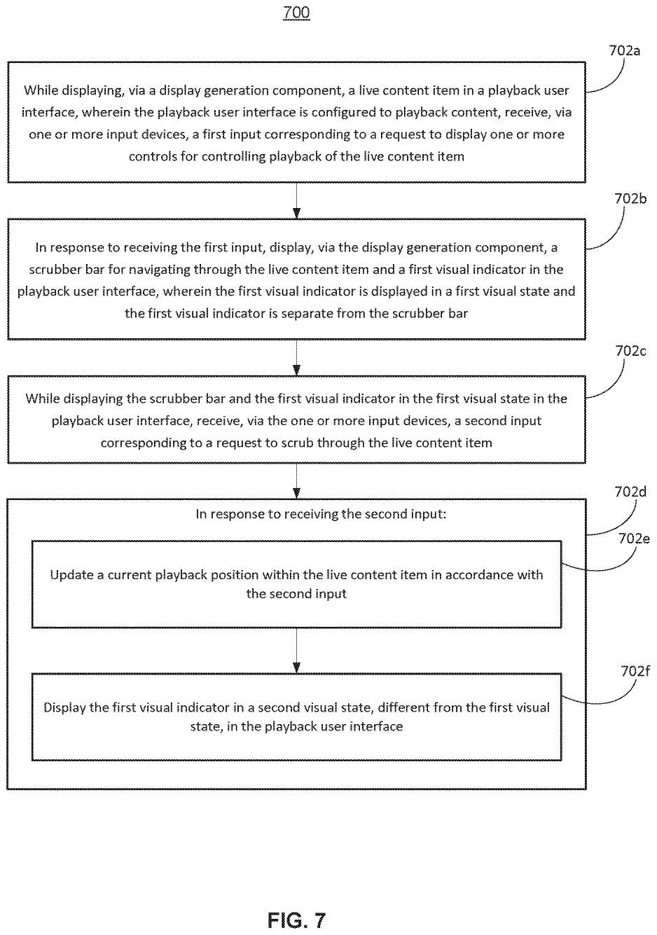

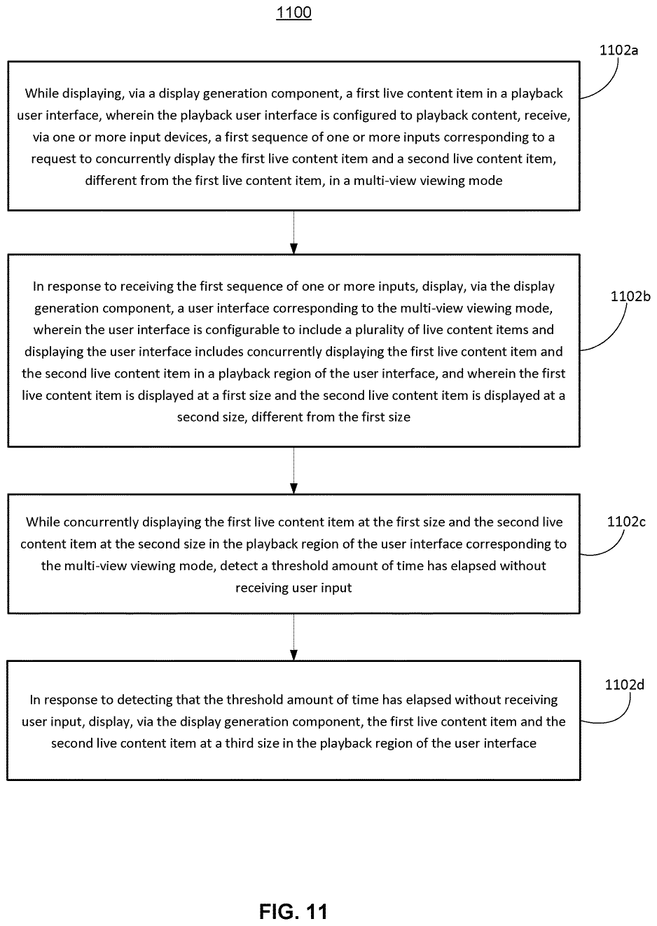

FIGS. 6A-6FFF illustrate exemplary ways in which an electronic device facilitates control of playback of a live content item displayed in a playback user interface in accordance with some embodiments of the disclosure. The embodiments in these figures are used to illustrate the processes described below, including the processes described with reference to FIGS. 7 and 11.

FIGS. 6A-6K illustrate an electronic device 514 presenting user interfaces associated with scrubbing through a live content item displayed in a playback user interface. FIG. 6A illustrates a playback user interface 602 (e.g., displayed via a display of the electronic device 524). As shown in FIG. 6A, the playback user interface 602 is optionally displaying a live content item (“Live Content A”). In some embodiments, the live content item corresponds to a sports game, such as a baseball game. In some embodiments, the live content item corresponds to a live-broadcast content item that is being broadcast to the electronic device 514 via a respective media provider of the live-broadcast content item. For example, the live content item corresponds to a sports game, a movie, a television show, a news program, or other content that is not available for playback at the electronic device 514 until it is broadcast/streamed by the respective media provider for consumption at the electronic device 514. In some embodiments, the playback user interface 602 is displaying the live content item because a user of the electronic device 514 is entitled to consume (e.g., view) the live content item at the electronic device 514 from the respective media provider of the live content item. For example, a user account associated with the user of the electronic device 514 is logged in on the electronic device 514, and the user account is authorized (e.g., via a subscription, a purchase, a rental, or other form of entitlement) to consume the live content item from the respective media provider. It should be understood that, in some embodiments, the playback user interface 602 is configurable to display content items other than live content items, such as on-demand content. Additional examples of live content items that can be displayed in the playback user interface 602 are provided below with reference to method 700.

As shown in FIG. 6A, the user provides a selection (e.g., with contact 603a) directed to the live content item in the playback user interface 602. For example, as shown in FIG. 6A, the electronic device 514 detects a tap, touch, press, or other input on touch-sensitive surface 451 of remote input device 510 while the live content item is displayed in the playback user interface 602. In some embodiments, the selection corresponds to a request to display one or more controls for controlling playback of the live content item in the playback user interface 602.

In some embodiments, as shown in FIG. 6B, in response to receiving the selection directed to the live content item in the playback user interface, the electronic device 514 displays one or more controls for controlling playback of the live content item in the playback user interface 602. For example, as shown in FIG. 6B, the electronic device 514 displays content player bar 606 in the playback user interface (e.g., concurrently with the live content item in the playback user interface). In some embodiments, the electronic device 514 displays the content player bar 606 overlaid on the live content item as playback of the live content item continues to progress in the playback user interface. For example, as shown in FIG. 6B, the electronic device 514 displays the content player bar 606 overlaid on a bottom portion of the live content item in the playback user interface. In some embodiments, the content player bar 606 includes a scrubber bar 608 that corresponds to a current playback position within the live content item. In some embodiments, as discussed in more detail below, input directed to the scrubber bar 608 and/or the content player bar 606 causes the electronic device 514 to navigate (e.g., scrub) through the live content item in the playback user interface. As shown in FIG. 6B, the scrubber bar 608 is optionally displayed with a real-world time indicator 609 that indicates a time of day at the electronic device 514 that corresponds to the current playback position of the scrubber bar 608. For example, as shown in FIG. 6B, the real-world time indicator 609 includes text expressing the time of day (“3:30 PM”) corresponding to the current playback position. In some embodiments, because the current playback position of the scrubber bar 608 within the live content item is at a live edge within the live content item (e.g., a most up to date playback position in the live content item provided (e.g., broadcasted) by the respective media provider of the live content item), the time of day indicated by the real-world time indicator 609 is a current time of day at the electronic device 514.

In some embodiments, the content player bar 606 further includes information associated with the live content item. For example, as shown in FIG. 6B, the content player bar 606 is displayed with an indication of a start time 611 (“1:00 PM”) of the live content item (e.g., a time of day at the electronic device 514 at which the live content was first aired/broadcasted). Additionally, as shown in FIG. 6B, the electronic device 514 optionally displays an indication of a sports league 607 (“League A”) with which the live content item, which is optionally a sports game, is associated. It should be understood that, for different live content items, the indication of the sports league 607 is optionally replaced with different information and/or is not displayed with the content player bar 606. For example, if the live content item is a live-broadcast news program, television show, or movie, the indication 607 includes a media provider (e.g., channel, network, application, etc.) for the live content item.

In some embodiments, the content player bar 606 includes a visual indication of an amount of the live content item that has been played back and/or that has elapsed since the live content item was first aired/broadcasted. For example, as shown in FIG. 6B, the content player bar 606 includes bubbling/shading from a first end of the content player bar 606 (e.g., a left end of the content player bar 606) up to the scrubber bar 608, visually indicating the amount of time that has elapsed since the live content item was first aired/broadcasted (e.g., since 1:00 PM as discussed above). As used herein, a live edge within the content player bar 606 corresponds to the live playback position within the live content item discussed above. In FIG. 6B, two hours and fifty minutes have optionally elapsed since the live content item was first aired/broadcasted (e.g., the current time of day is two hours and fifty minutes past 1:00 PM).

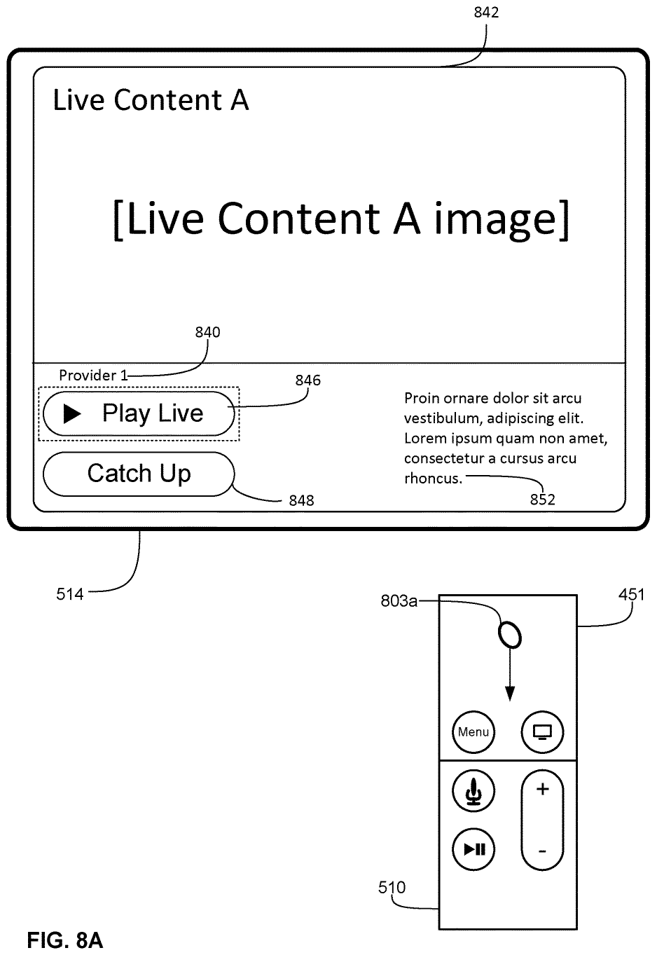

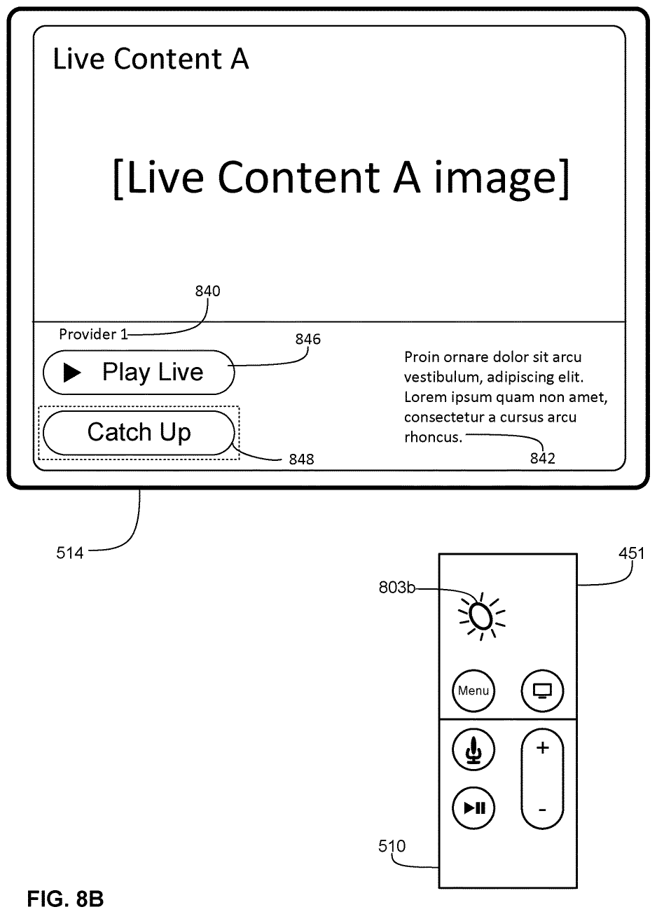

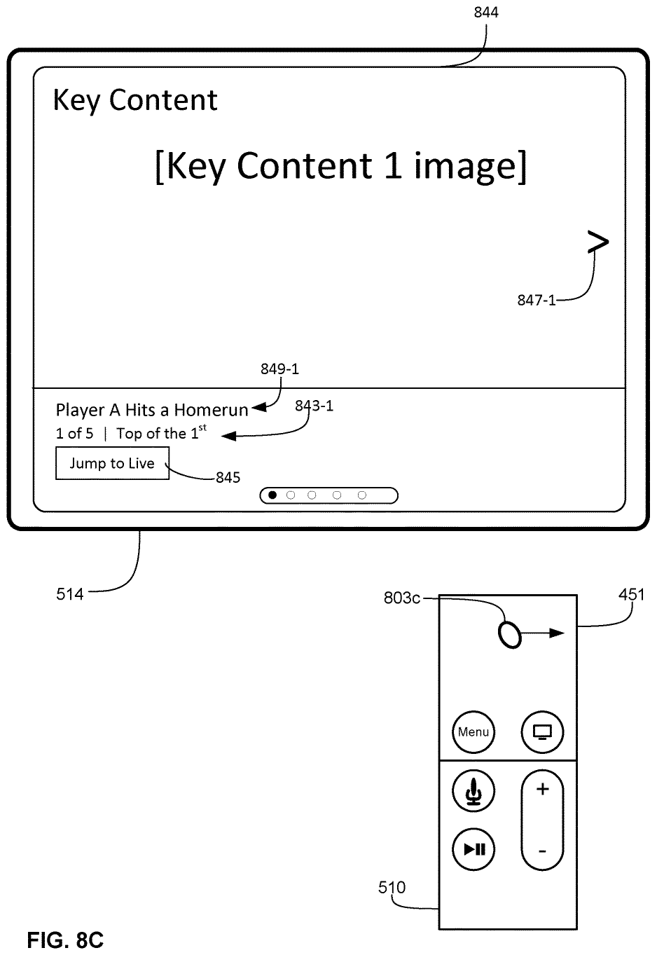

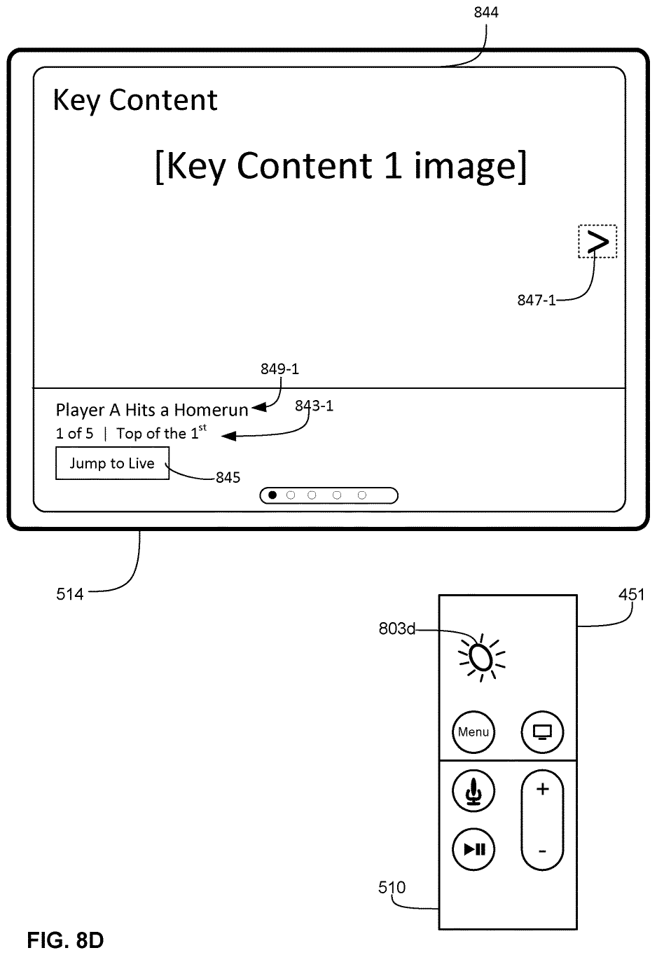

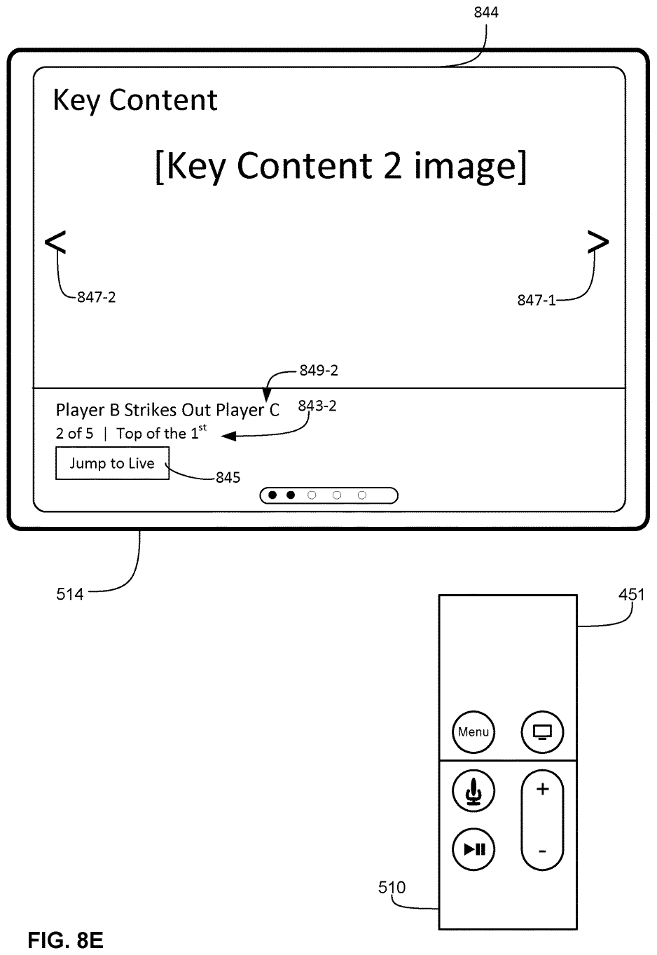

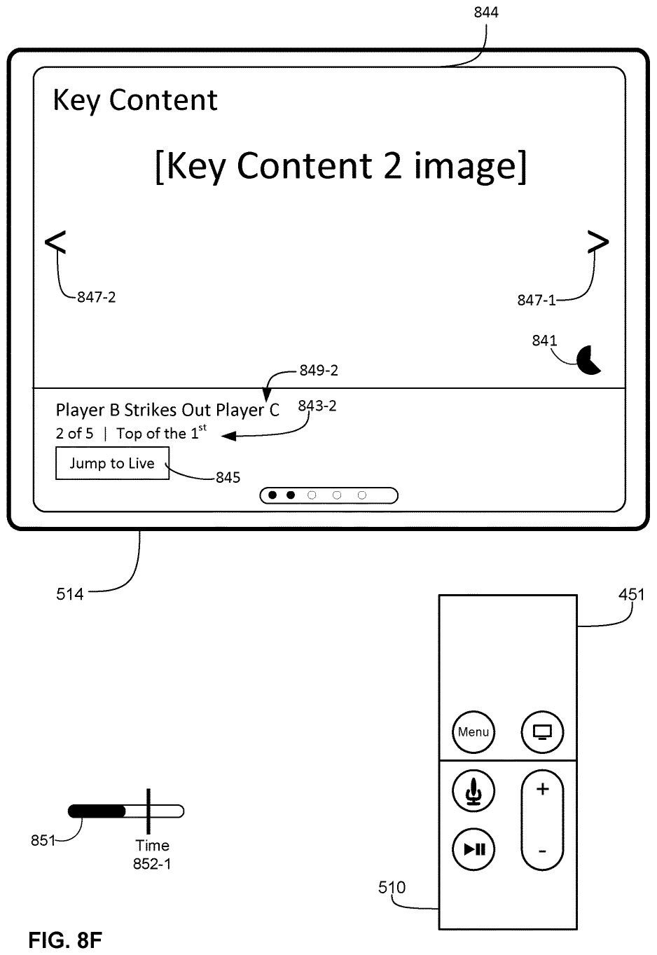

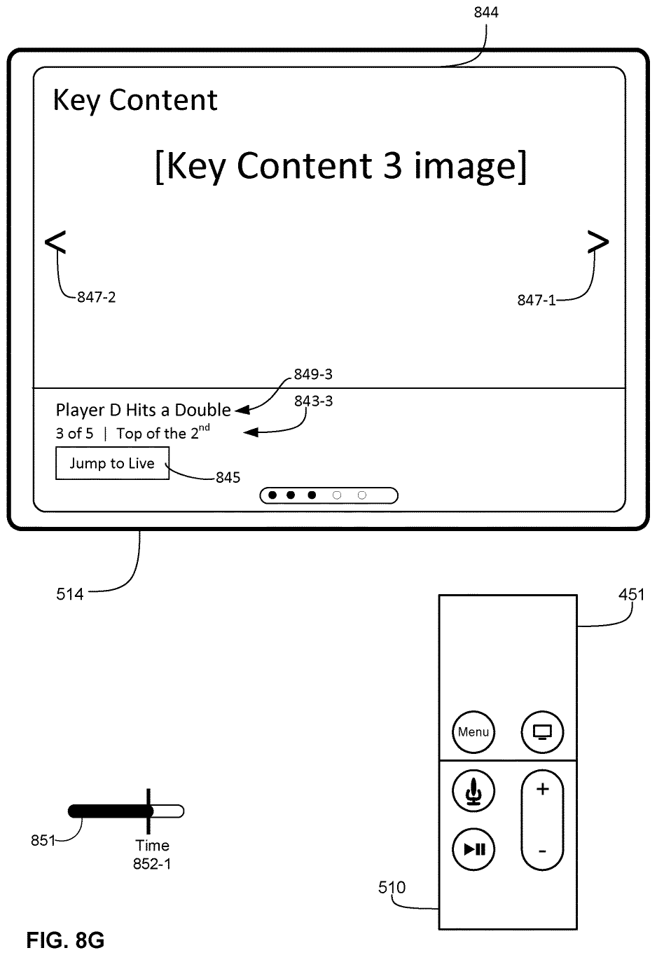

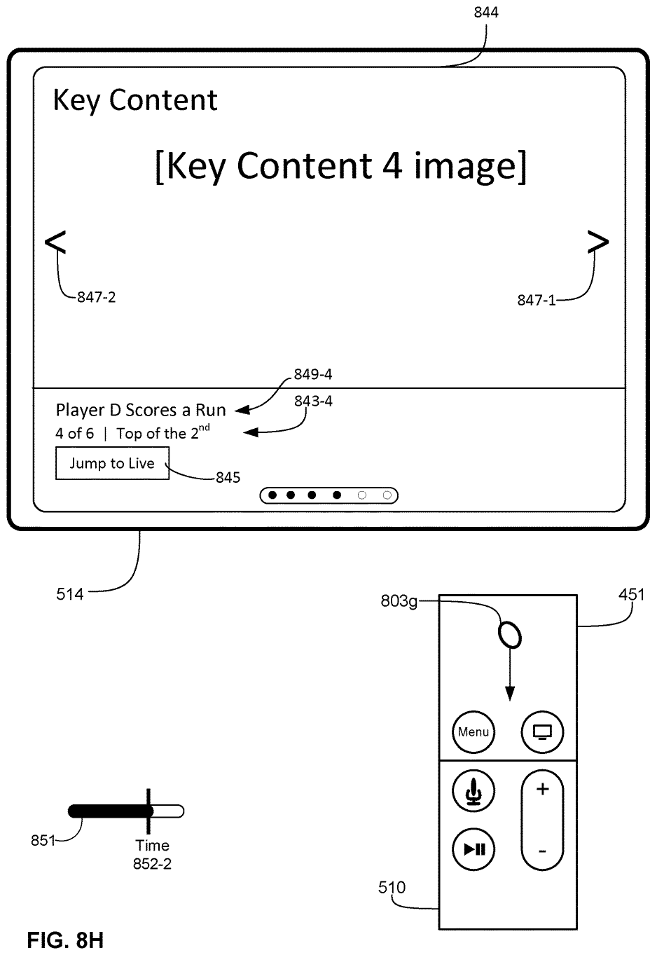

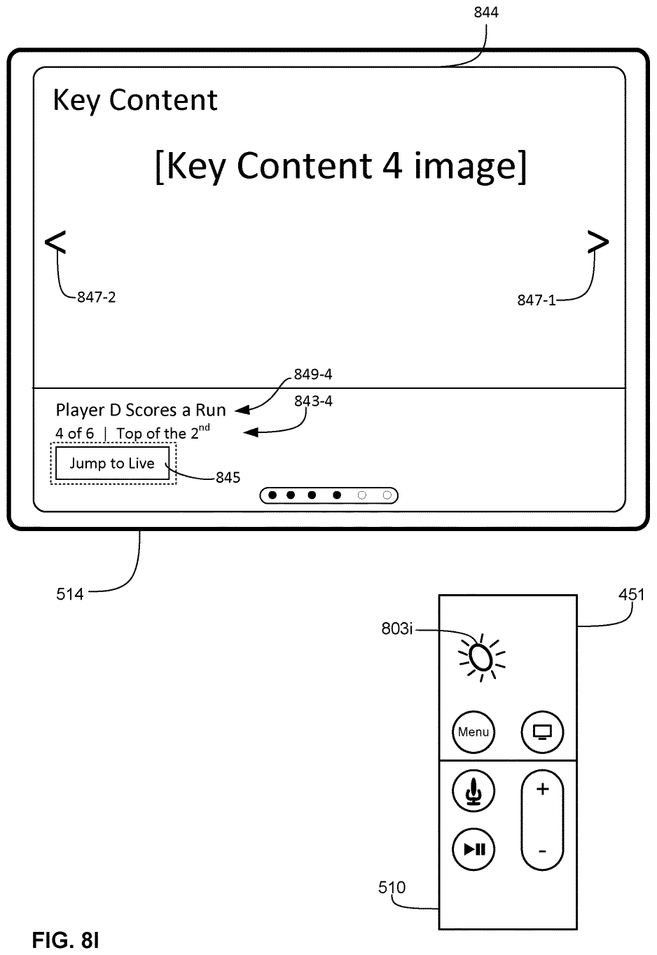

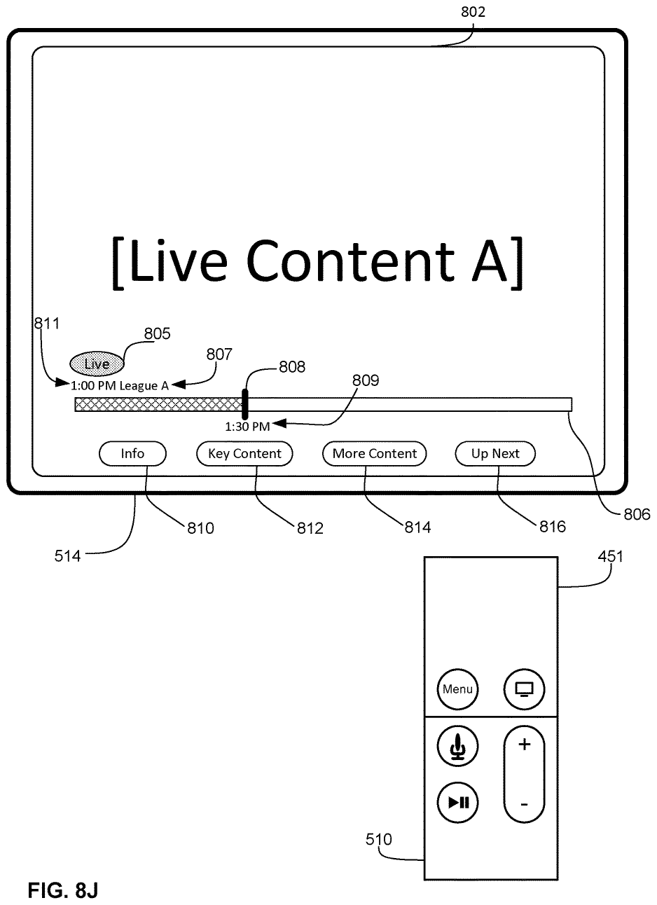

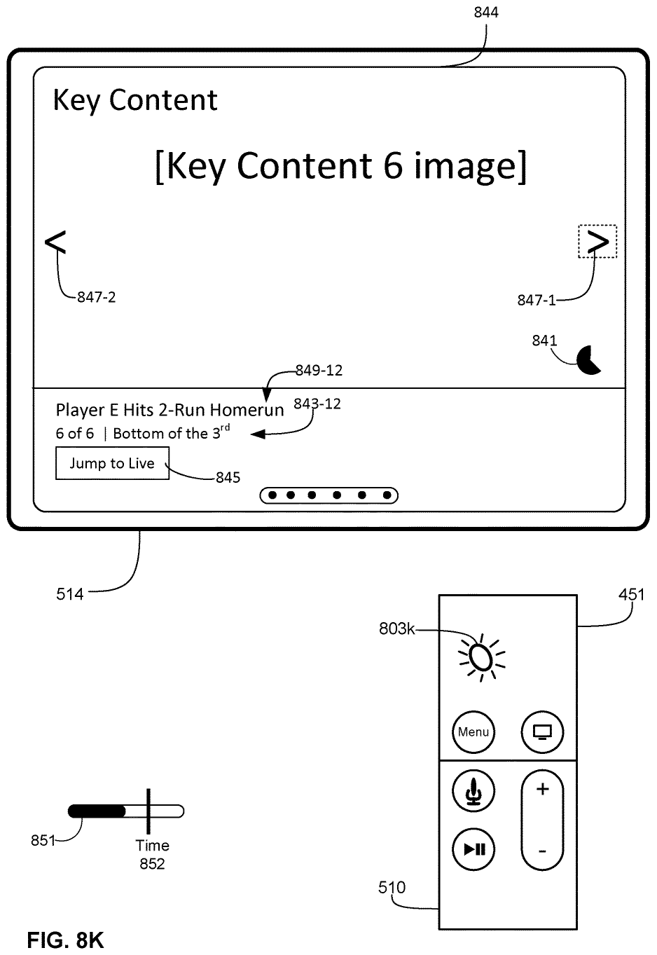

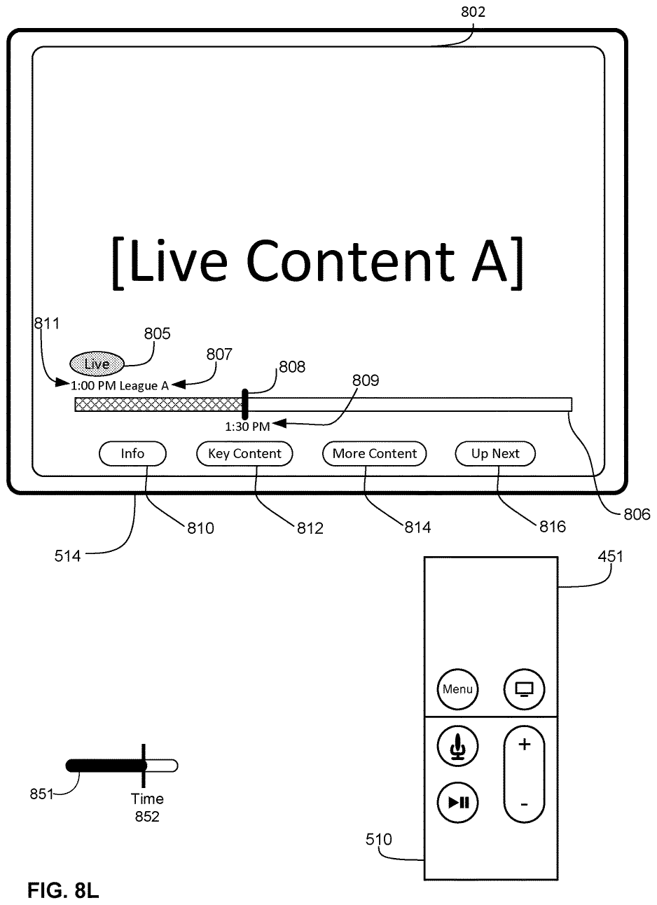

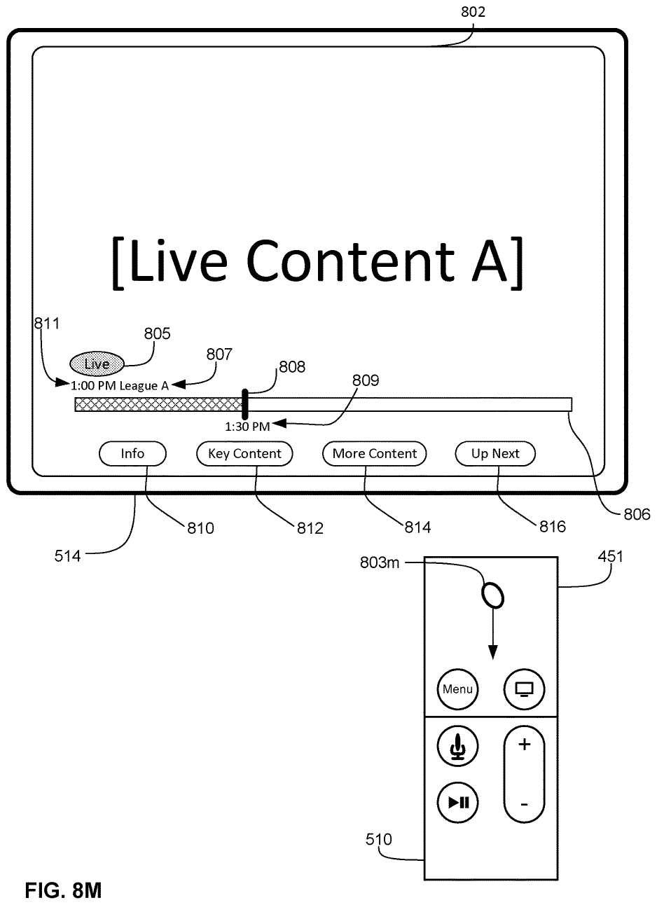

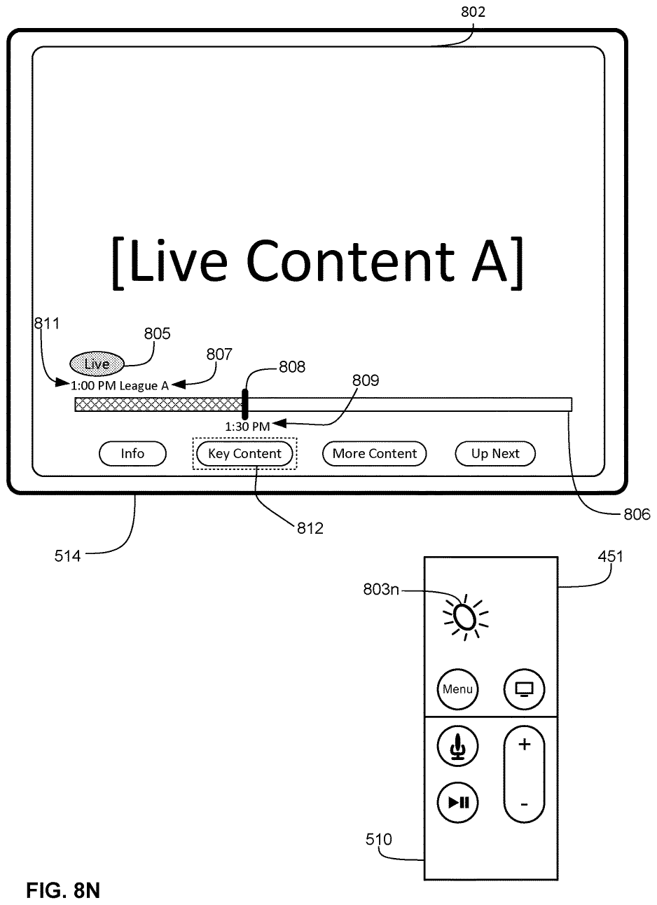

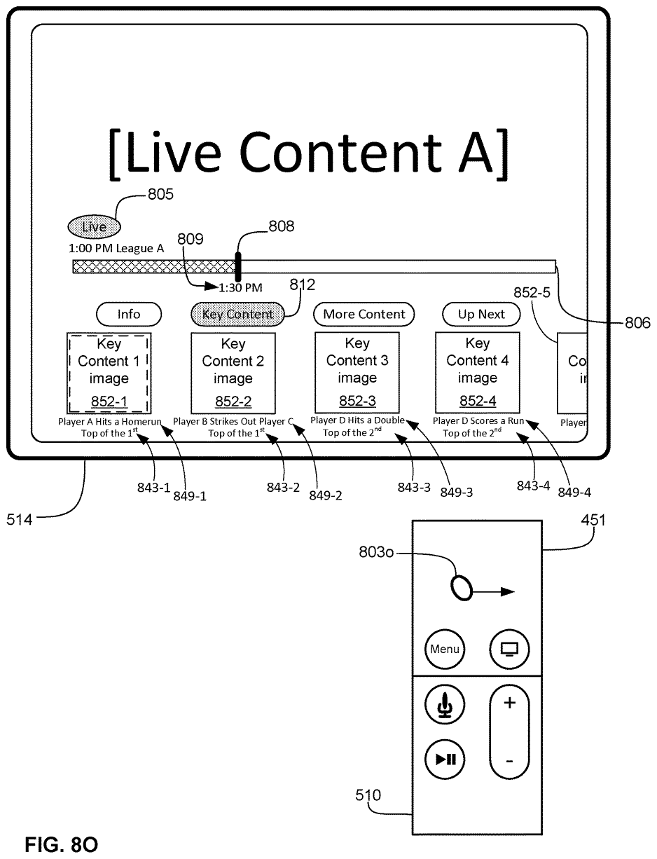

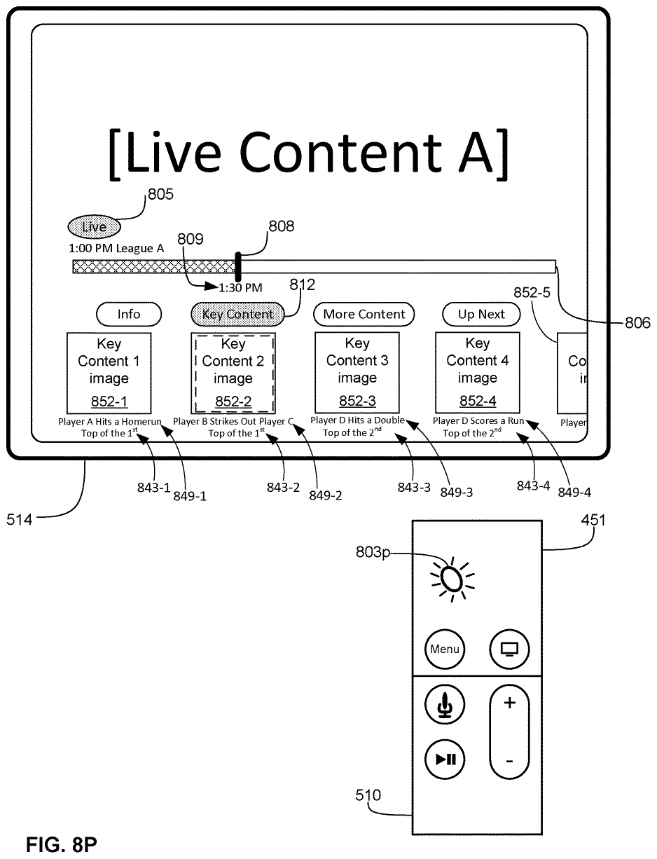

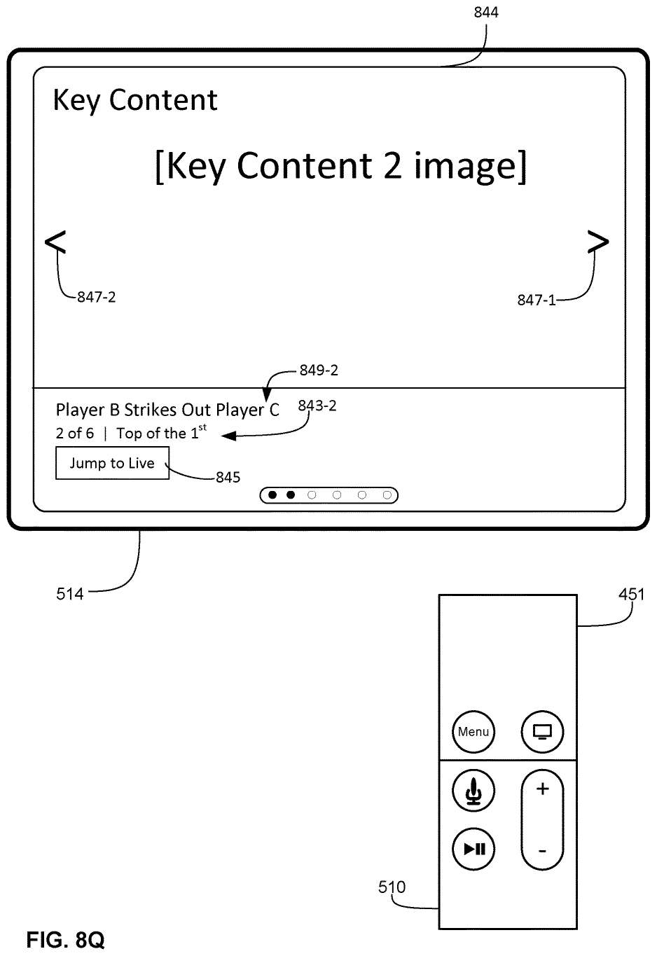

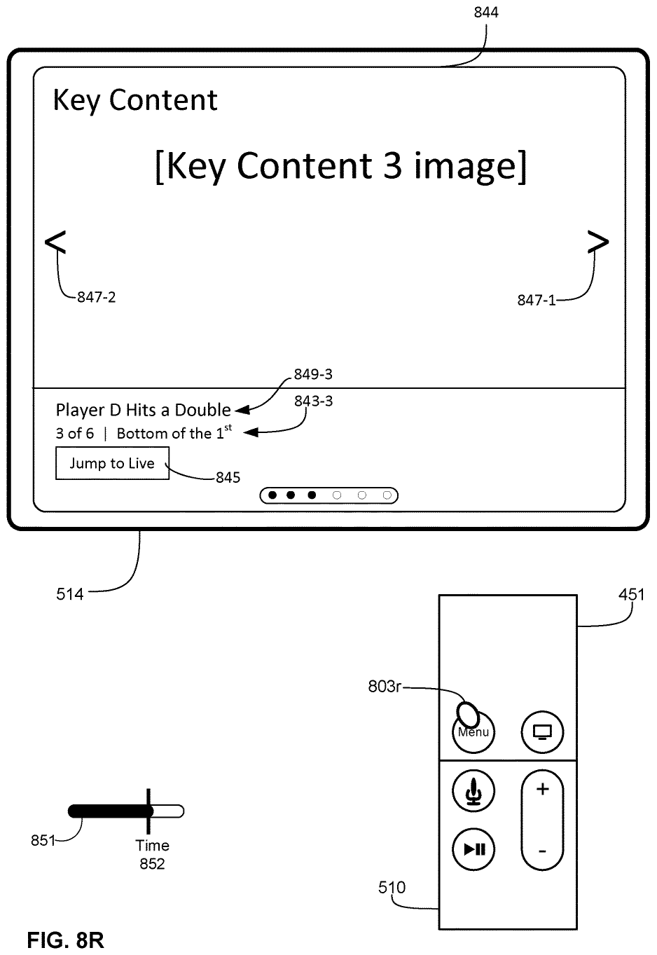

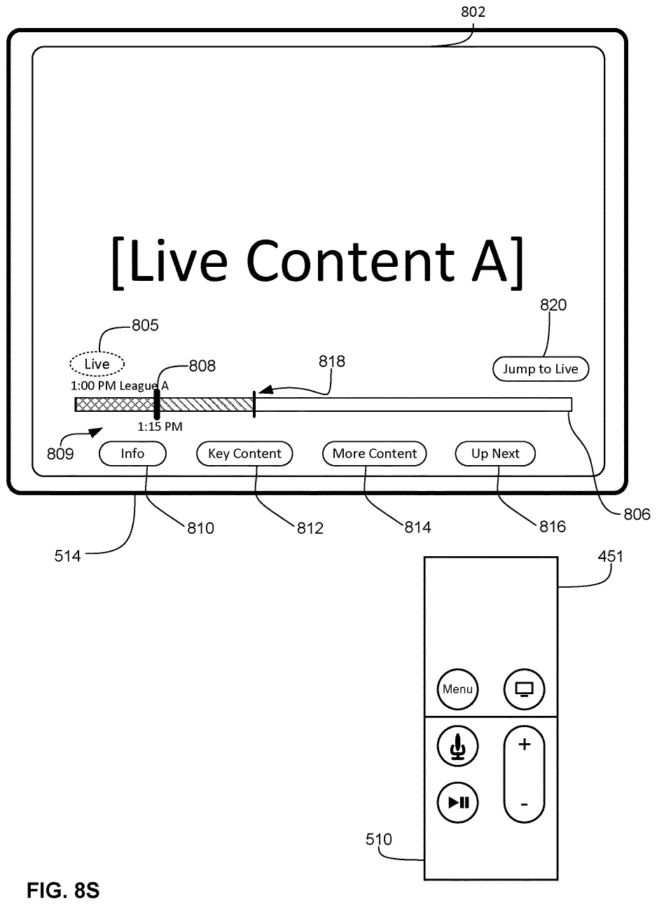

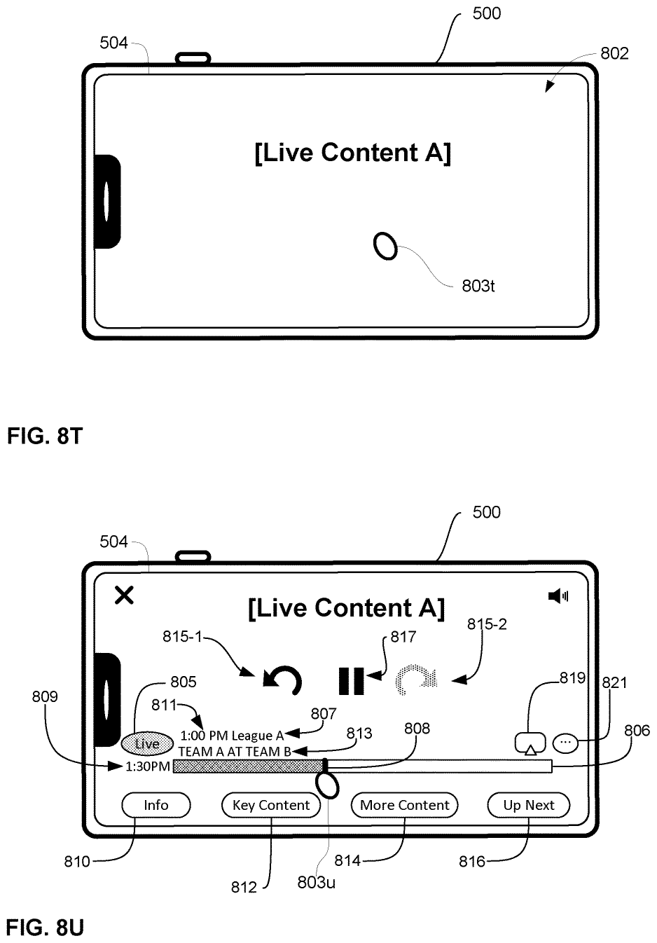

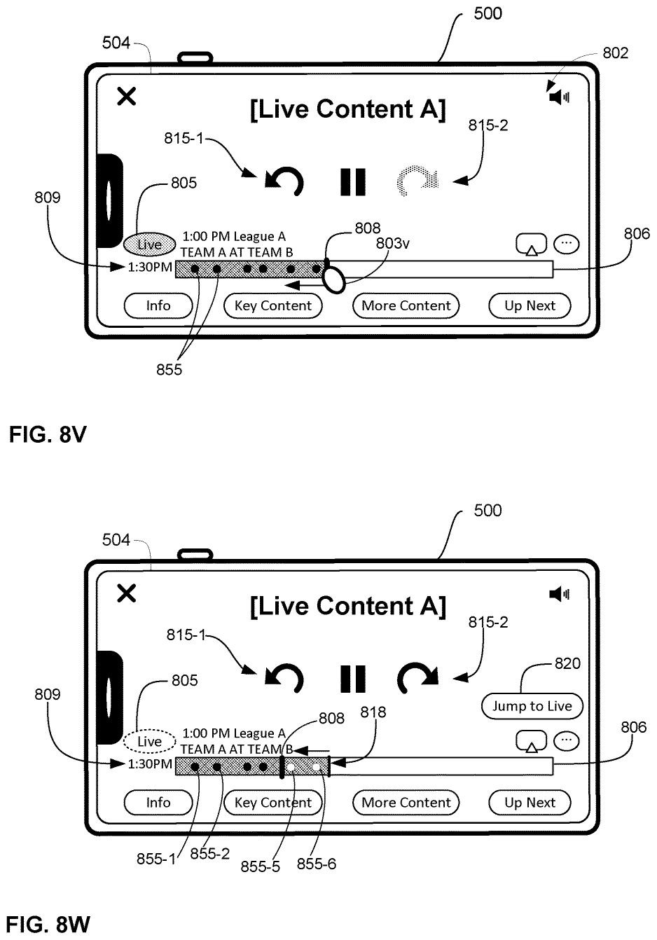

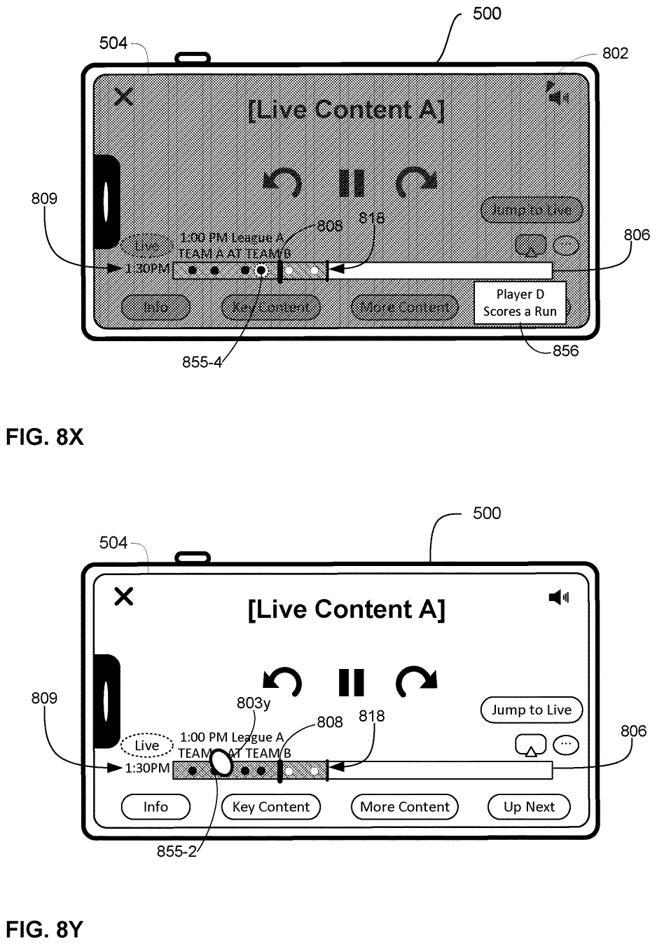

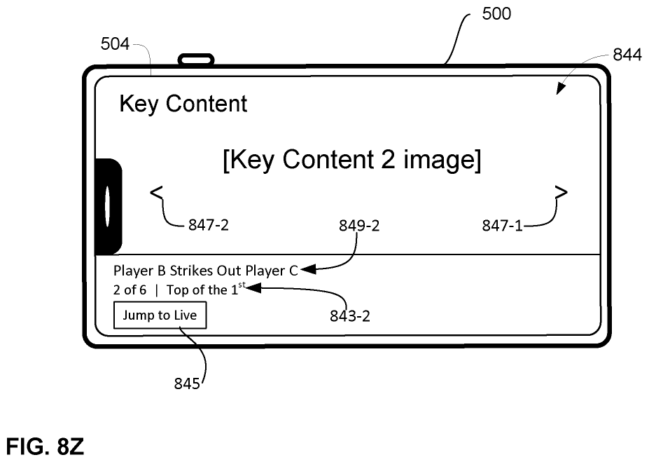

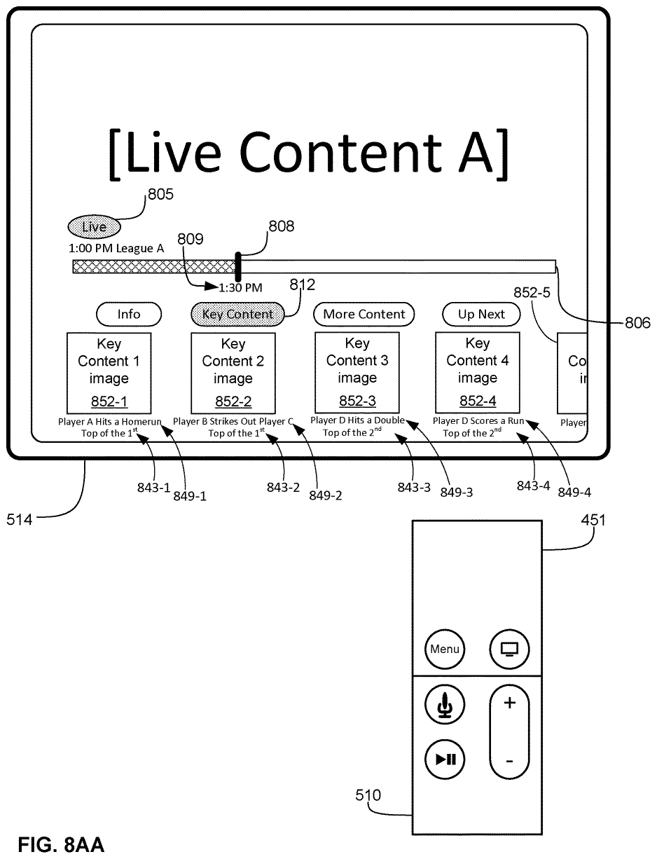

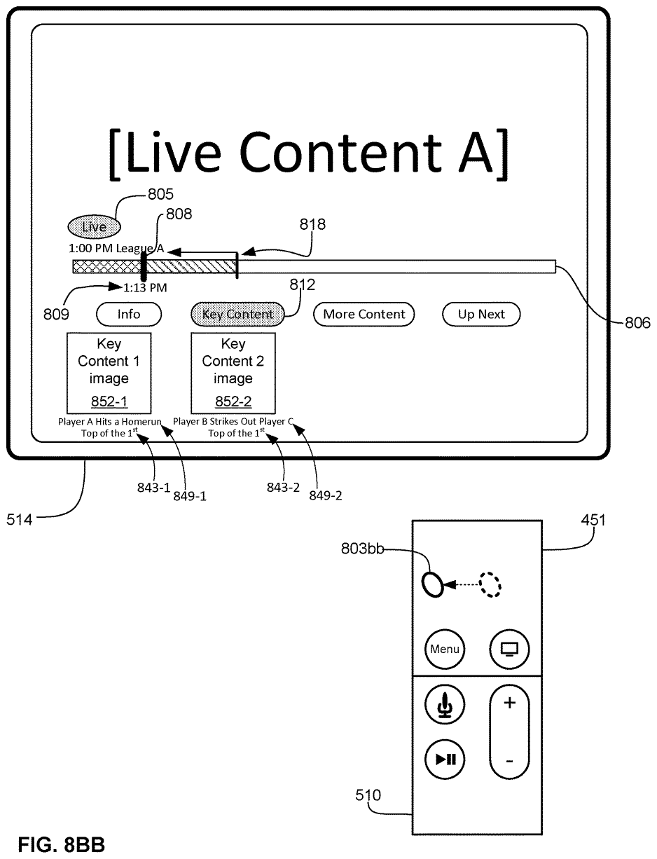

In some embodiments, as shown in FIG. 6B, the electronic device 514 displays a plurality of selectable options (e.g., tabs) with the content player bar 606 in the playback user interface. For example, as shown in FIG. 6B, the electronic device 514 displays the selectable options 610-616 below the content player bar 606 in the playback user interface. In some embodiments, the plurality of selectable options includes a first selectable option 610, a second selectable option 612, a third selectable option 614, and/or a fourth selectable option 616. In some embodiments, the first selectable option 610 is selectable to display information associated with the current playback position within the live content item (e.g., indicated by the location of the scrubber bar 608 in the content player bar 606), such as statistics and other information, as described in more detail below. In some embodiments, the second selectable option 612 is selectable to display key content associated with the live content item, such as highlights within the live content item. Additional details regarding key content are provided below with reference to the FIG. 8 series and/or method 900. In some embodiments, the third selectable option 614 is selectable to display additional content (e.g., sports games, news programs, movies, television shows, etc.) that is available and/or will be available for playback on the electronic device 514, as described in more detail below. In some embodiments, the fourth selectable option 616 is selectable to display content items that are in a queue (e.g., an “Up Next” queue) of content items that are suggested for viewing for the user. For example, the content items categorized under “Up Next” are items related to particular content that the user has previously interacted with (e.g., watched), and/or items that the user has partially watched.

In some embodiments, as shown in FIG. 6B, the content player bar 606 is displayed with a live indicator 605. As shown in FIG. 6B, the live indicator 605 is optionally displayed in a first visual state in the playback user interface. For example, the live indicator 605 is displayed with a first visual appearance, such as a first color, brightness, shading, boldness, etc. In some embodiments, the live indicator 605 indicates that a live content item (e.g., a live-broadcast content item) is currently displayed in the playback user interface. For example, if a non-live content item is displayed in the playback user interface, such as an on-demand content item, the electronic device 514 forgoes displaying the live indicator 605 with the content player bar 606 in the playback user interface. In some embodiments, the live indicator 605 is displayed with the first visual appearance when the current playback position within the live content item corresponds to the live playback position within the live content item. For example, as shown in FIG. 6B, the electronic device 514 displays the live indicator 605 in the first visual state because the location of the scrubber bar 608 in the content player bar 606 is at the live edge within the content player bar 606 discussed above. In some embodiments, as described below, if the electronic device 514 receives input directed to the content player bar 606 that causes the current playback position within the live content item to no longer correspond to the live playback position within the live content item, the live indicator 605 is no longer displayed in the first visual state.

In FIG. 6B, while the content player bar 606 is displayed in the playback user interface, the user provides an input (e.g., with contact 603b) corresponding to a request to scrub through the live content item displayed in the playback user interface. For example, as shown in FIG. 6B, the electronic device 514 detects a tap, touch, press, or other input on touch-sensitive surface 451 of remote input device 510, followed by leftward movement of contact 603c on the touch-sensitive surface 451 as shown in FIG. 6C.

In some embodiments, in response to receiving the input corresponding to the request to scrub through the live content item, the electronic device 514 scrubs through the live content item in accordance with the input. For example, as shown in FIG. 6C, the electronic device 514 moves the scrubber bar 608 leftward within the content player bar 606 based on the leftward movement of the contact 603c. In some embodiments, the leftward movement of the scrubber bar 608 within the content player bar 606 corresponds to backward movement of the current playback position within the live content item to a previous (occurring in the past) playback position within the live content item. In some embodiments, when the electronic device 514 scrubs leftward/backward in the live content item, the electronic device 514 updates the current playback position within the live content item, which includes displaying the live content item from the updated current playback position, which is no longer at the live edge 618 in the content player bar 606. As shown in FIG. 6B, the electronic device 514 optionally adjusts display of the visual indication of the amount of the live content item that has elapsed since the live content item was first aired/broadcasted. For example, the bubbling/shading within the content player bar 606 between the first end (e.g., left end) of the content player bar 606 and the updated location of the scrubber bar 608 has a different visual appearance (e.g., different type of shading, brightness, coloration, etc.) than the bubbling/shading within the content player bar 606 between the updated location of the scrubber bar 608 and the live edge 618 within the content player bar 606. In some embodiments, the visual distinction between the portions of the bubbling/shading before the scrubber bar 608 and after the scrubber bar 608 further visually indicates that the updated current playback position within the live content item does not correspond to the live playback position within the live content item.

In some embodiments, the electronic device 514 updates the real-world time indicator 609 when the current playback position within the live content item is updated in accordance with the scrubbing input. For example, as shown in FIG. 6C, the electronic device 514 moves the real-world time indicator 609 with the scrubber bar 608 in the playback user interface. Additionally, as shown in FIG. 6C, the electronic device 514 optionally updates the time of day indicated in the real-world time indicator 609. As described previously above, before receiving the scrubbing input, the time of day indicated in the real-world time indicator 609 was the current time of day (3:50 PM) at the electronic device 514 because the current playback position within the live content item was the live playback position within the live content item. In some embodiments, in response to receiving the scrubbing input, in accordance with the determination that the updated current playback position within the live content item no longer corresponds to the live playback position within the live content item, the electronic device 514 updates the real-world time indicator 609 to express a time of day that corresponds to the updated current playback position. For example, as shown in FIG. 6C, the electronic device 514 updates the real-world time indicator 609 to typographically express 3:35 PM, which corresponds to the time of day at which the portion of the live content item at the updated current playback position was first aired/broadcasted to the electronic device 514.

Additionally, in some embodiments, the electronic device 514 updates display of the live indicator 605 in the playback user interface. As shown in FIG. 6C, in response to receiving the scrubbing input, in accordance with the determination that the updated current playback position within the live content item no longer corresponds to the live playback position within the live content item, the electronic device 514 optionally displays the live indicator 605 in a second visual state, different from the first visual state discussed above. For example, the electronic device 514 adjusts display of the color, brightness, shading, boldness, etc. of the live indicator 605. In some embodiments, the electronic device 514 displays the live indicator 605 in the second visual state because the playback of the live content item in the playback user interface is no longer truly “live” due to the leftward/backward scrubbing through the live content item. Further, in some embodiments, the electronic device 514 displays selectable option 620 (e.g., “Jump to Live” button) with the content player bar 606 (e.g., above the content player bar 606) in the playback user interface. In some embodiments, the selectable option 620 is displayed because the updated current playback position within the live content item does not correspond to the live playback position within the live content item. In some embodiments, the selectable option 620 is selectable to move the current playback position to the live playback position within the live content item, as discussed in more detail below.

In FIG. 6D, the user has moved a current focus to the selectable option 620 (e.g., using the remote input device 510). As shown in FIG. 6D, while the selectable option 620 has the current focus, the user provides a selection (e.g., with contact 603d) directed to the selectable option 620 in the playback user interface. For example, as similarly discussed above, the electronic device 514 detects a tap, touch, press, or other input on the touch-sensitive surface 451 of the remote input device 510.

In some embodiments, as shown in FIG. 6E, in response to receiving the selection of the selectable option 620 in the playback user interface, the electronic device 514 updates the current playback position within the live content item to correspond to the live playback position within the live content item. For example, as shown in FIG. 6E, the electronic device 514 moves (e.g., displays) the scrubber bar 608 to the live edge 618 within the content player bar 606. In some embodiments, when the electronic device 514 updates the current playback position within the live content item, the electronic device 514 ceases display of the selectable option 620 in the playback user interface, as shown in FIG. 6E. For example, the electronic device 514 ceases display of the selectable option 620 because the updated current playback position within the live content item corresponds to the live playback position within the live content item. Additionally, in some embodiments, the electronic device 514 displays a message 622 (e.g., “You're caught up!”) indicating that the updated current playback position within the live content item corresponds to the live playback position within the live content item. Additionally, as shown in FIG. 6E, the electronic device 514 optionally redisplays the live indicator 605 in the first visual state described above (e.g., and no longer displays the live indicator 605 in the second visual state). For example, as shown in FIG. 6E, the electronic device 514 redisplays the live indicator 605 in the first visual state because the updated current playback position within the live content item corresponds to the live playback position within the live content item.

In some embodiments, when the electronic device 514 updates the current playback position within the live content item to correspond to the live playback position within the live content item, the electronic device 514 updates the real-world time indicator 609 in the playback user interface. For example, the electronic device 514 displays the real-world time indicator 609 at the updated location of the scrubber bar 608 in the content player bar 606, as shown in FIG. 6E. Additionally, in some embodiments, the electronic device 514 updates the time of day expressed by the real-world time indicator 609. For example, as shown in FIG. 6E, the electronic device 514 updates the time of day expressed by the real-world time indicator 609 to be the current time of day (“3:52 PM”) at the electronic device 514 because the scrubber bar 608 is at the live edge 618 within the content player bar 606. As shown in FIG. 6E, the live edge 618 has optionally advanced in the content player bar 606 compared to when the scrubber bar 608 was last located at the live edge in FIG. 6B (e.g., corresponding to an increase of the time of day at the electronic device by two minutes from 3:50 PM in FIG. 6B to 3:52 PM in FIG. 6E).

FIGS. 6F-6K illustrate exemplary interactions with a live content item displayed in a playback user interface on a second electronic device 500. FIG. 6F illustrates an electronic device 500 displaying a live content item (“Live Content A”) in a playback user interface 602 (e.g., via display 504). In some embodiments, the live content item corresponds to the live content item described above. In some embodiments, the playback user interface 602 has one or more characteristics of the playback user interface 602 described above. In some embodiments, the electronic device 500 is different from the electronic device 514 described above. For example, the electronic device 500 is a mobile electronic device, such as a smartphone. In some embodiments, the display 504 is a touch screen of the electronic device 500.

In FIG. 6F, the electronic device 500 receives an input by contact 603f (e.g., a tap or touch provided by an object, such as a finger or stylus) on the touch screen 504 directed to the live content item displayed in the playback user interface 602. In some embodiments, in response to receiving the input directed to the live content item on the touch screen 504, the electronic device 500 displays one or more controls for controlling playback of the live content item in the playback user interface, as similarly discussed above. As shown in FIG. 6G, the electronic device 500 displays content player bar 606 with the live content item (e.g., optionally an image of the live content item) in the playback user interface. In some embodiments, the content player bar 606 has one or more characteristics of the content player bar 606 described above. As shown in FIG. 6G, the content player bar 606 optionally includes scrubber bar 608. In some embodiments, the scrubber bar 608 has one or more characteristics of the scrubber bar 608 described above. In some embodiments, the electronic device 500 displays a title 613 of the live content item with the content player bar 606 in the playback user interface. For example, the electronic device 500 displays the title “Team A at Team B” of the live content item above the content player bar 606 in the playback user interface. Additionally as shown in FIG. 6G, the electronic device 500 optionally displays an indication of a start time 611 (“1:00 PM”) of the live content item and/or an indication of a sports league 607 (“League A”) within the content player bar 606 in the playback user interface. In some embodiments, the indications 611 and 607 have one or more characteristics of the indications 611 and 607 described above.

Additionally, in some embodiments, the electronic device 500 displays real-world time indicator 609 with the content player bar 606 in the playback user interface. In some embodiments, the real-world time indicator 609 has one or more characteristics of the real-world time indicator 609 described above. In some embodiments, as shown in FIG. 6G, the electronic device 500 displays the real-world time indicator 609 adjacent to a first end (e.g., left end) of the content player bar 606 in the playback user interface. In some embodiments, the electronic device 500 selectable option 619 with the content player bar 606 in the playback user interface. In some embodiments, the selectable option 619 is selectable to initiate a process for displaying the live content item on a separate electronic device (e.g., having a display), such as electronic device 514 described above. Additionally, as shown in FIG. 6G, the electronic device 500 optionally displays selectable option 626 with the content player bar 606 in the playback user interface. In some embodiments, the selectable option 626 is selectable to display one or more viewing options for the live content item on the electronic device 500. For example, as described in more detail herein later, the one or more viewing options include options for displaying the live content item in a picture-in-picture (PiP) mode, from a beginning (e.g., a starting point) of the live content item, and/or in a Multiview mode.

In some embodiments, as shown in FIG. 6G, the electronic device 500 displays selectable options 610-616 with the content player bar 606 in the playback user interface. In some embodiments, the selectable options 610-616 have one or more characteristics of the selectable options 610-616 described above. Additionally, the electronic device 500 optionally displays the live indicator 605 with the content player bar 606 in the playback user interface. As shown in FIG. 6G and as similarly discussed above, the electronic device 500 optionally displays the live indicator 605 in a first visual appearance because the current playback position within the live content item corresponds to the live playback position within the live content item. In some embodiments, the live indicator 605 has one or more characteristics of the live indicator 605 described above.

In some embodiments, as shown in FIG. 6G, the electronic device 500 displays one or more playback controls with the content player bar 606 in the playback user interface. For example, as shown in FIG. 6G, the electronic device 500 displays a first navigation affordance 615-1, a playback affordance 617, and/or a second navigation affordance 615-2. In some embodiments, the first navigation affordance 615-1 is selectable to scrub backward in the live content item by a predetermined amount of time (e.g., 1, 3, 5, 10, 15, 30, 60, 90, 120, etc. seconds), and the second navigation affordance 615-2 is selectable to scrub forward in the live content item by the predetermined amount of time. In some embodiments, the playback affordance 617 is selectable to, while the live content item is being played back in the playback user interface, pause the live content item, and/or while the live content item is paused in the playback user interface, resume playback of the live content item in the playback user interface.

In some embodiments, the electronic device 500 modifies the second navigation affordance 615-2 based on the current playback position within the live content item. For example, as described above, the second navigation affordance 615-2 is selectable to move the current playback position forward in the live content item by the predetermined amount of time. As shown in FIG. 6G, the current playback position within the live content item optionally corresponds to the live playback position within the live content item (e.g., indicated by the position of the scrubber bar 608 within the content player bar 606). In some embodiments, because portions of the live content item beyond (e.g., ahead of) the live playback position are not yet available (e.g., because such portions have not yet occurred and/or have not yet been broadcasted/aired by the respective media provider of the live content item), the electronic device 500 is unable to scrub forward in the live content item when the current playback position is the live playback position in the live content item. Accordingly, in some embodiments, the electronic device 500 deactivates the second navigation affordance 615-2 in the playback user interface. For example, the electronic device 500 adjusts display of the second navigation affordance 615-2 in the playback user interface, such as fading an appearance of (e.g., reducing brightness, coloration, opacity, etc. of) the second navigation affordance 615-2 and/or reducing a visual prominence of the second navigation affordance 615-2 relative to the first navigation affordance 615-1. In some embodiments, in FIG. 6G, while the second navigation affordance 615-2 is deactivated in the playback user interface, the electronic device 500 forgoes scrubbing forward through the live content item by the predetermined amount of time in response to receiving a selection of the second navigation affordance 615-2. For example, the electronic device 500 does not perform any operation in response to receiving the selection of the second navigation affordance 615-2.

In FIG. 6H, while the content player bar 606 is displayed and while the second navigation affordance is deactivated in the playback user interface, the electronic device 500 receives an input corresponding to a request to scrub through the live content item. For example, as shown in FIG. 6H, the electronic device 500 receives contact 603h (e.g., a tap or touch provided by an object) on the touch screen 504 corresponding to a location of the scrubber bar 608 in the playback user interface, followed by movement of the contact 603h leftward on the touch screen 504.

In some embodiments, as shown in FIG. 6I, in response to receiving the input scrubbing through the live content item, the electronic device 500 scrubs backward through the live content item in accordance with the input. For example, as shown in FIG. 6I, the electronic device 500 moves the scrubber bar 608 leftward within the content player bar 606 based on the leftward movement of the contact 603h. In some embodiments, as similarly discussed above, the electronic device 500 updates the current playback position within the live content item based on the movement of the scrubber bar 608 within the content player bar 606. For example, because the scrubber bar 608 is moved leftward and away from the live edge 618 within the content player bar 606, the electronic device 500 the updated current playback position does not correspond to the live playback position within the live content item. Accordingly, as similarly discussed above, the electronic device 500 optionally displays the live indicator 605 in the second visual state and displays selectable option 620 in the playback user interface. In some embodiments, the selectable option 620 has one or more characteristics of the selectable option 620 described above. Additionally, as shown in FIG. 6I, the electronic device 500 updates display of the real-world time indicator 609 in the playback user interface. For example, as similarly described above, the real-world time indicator 609 is optionally updated to express a time of day that corresponds to the updated current playback position within the live content item (e.g., 3:35 PM).

Additionally, in some embodiments, the electronic device 500 activates the second navigation affordance 615-2 in the playback user interface. For example, as shown in FIG. 6I, the electronic device 500 adjusts display of the second navigation affordance 615-2 to indicate that the second navigation affordance 615-2 is active, such as displaying the second navigation affordance 615-2 with visual characteristics (e.g., brightness, color, opacity, etc.) similar to or same as those of the first navigation affordance 615-1. In some embodiments, as described below, while the second navigation affordance 615-2 is active in the playback user interface, the second navigation affordance 615-2 is selectable to scrub forward in the live content item by the predetermined amount. For example, because the updated current playback position is not the live playback position within the live content item and the portions of the live content item ahead of the updated current playback position and the live playback position are available (e.g., have already been broadcasted), the electronic device 500 is able to scrub forward in the live content item (by the predetermined amount of 1, 3, 5, 10, 15, 30, 60, 90, 120, etc. seconds).

In FIG. 6J, the electronic device 500 receives a selection of the second navigation affordance 615-2 in the playback user interface. For example, the electronic device 500 detects contact 603j (e.g., a tap or touch of an object) on the touch screen 504 at a location corresponding to the second navigation affordance 615-2 in the playback user interface. In some embodiments, in response to receiving the selection of the second navigation affordance 615-2, the electronic device 500 scrubs forward in the live content item by the predetermined amount of time, as shown in FIG. 6K. For example, as shown in FIG. 6K, the electronic device 500 moves the scrubber bar 608 to the right within the content player bar 606 by an amount corresponding to the predetermined amount of time. Additionally, in some embodiments, the electronic device 500 updates display of the real-world time indicator 609 based on the predetermined amount of time. For example, in FIG. 6K, the predetermined amount of time is two minutes, so when the electronic device 500 scrubs forward in the live content item by two minutes, the electronic device 500 updates the time of day expressed by the real-world time indicator to increase by two minutes (e.g., from 3:35 PM in FIG. 6J to 3:37 PM in FIG. 6K). As shown in FIG. 6K, because the updated current playback position is still not the live playback position within the live content item, the second navigation affordance 615-2 is still active in the playback user interface. Further, as shown in FIG. 6K, the electronic device 500 optionally maintains display of the live indicator 605 in the second visual state and/or maintains display of the selectable option 620 in the playback user interface.

FIGS. 6L-6P illustrate examples of electronic device 514 presenting user interfaces that include information associated with a live content item displayed in a playback user interface. In FIG. 6L, the electronic device 514 is concurrently displaying the content player bar 606 with the live content item (Live Content A) in the playback user interface. As shown in FIG. 6L, the current playback position within the live content item optionally is not the live playback position within the content item. For example, in FIG. 6L, the scrubber bar 608 is not located at the live edge 618 within the content player bar 606 in the playback user interface. Accordingly, as shown in FIG. 6L, the electronic device 514 is optionally displaying the live indicator 605 in the second visual state described previously above and/or is displaying the selectable option 620 in the playback user interface. Additionally, in some embodiments, as similarly described above, the time of day expressed by the real-world time indicator 609 corresponds to the current playback position within the live content item, and not the live playback position within the live content item.

In FIG. 6L, the electronic device 514 detects the user scroll (e.g., using contact 603l) downward in the playback user interface. For example, as shown in FIG. 6L, the electronic device 514 detects the contact 603l (e.g., a tap, touch, selection, or other input) on the touch-sensitive surface 451 of the remote input device 510, followed by downward movement of the contact 603l while the content player bar 606 (and related user interface objects) is concurrently displayed with the live content item in the playback user interface.

In some embodiments, in response to receiving the downward scroll, the electronic device 514 moves a current focus to the selectable option 610, as shown in FIG. 6M. In some embodiments, the electronic device 514 displays the selectable option 610 with an indication of focus (e.g., a visual boundary, highlighting, shading, bolding, etc.). In FIG. 6M, while the selectable option 610 has the current focus in the playback user interface, the electronic device 514 detects a selection of the selectable option 610. For example, as shown in FIG. 6M, the electronic device 514 detects contact 603m (e.g., a tap, touch, selection, or other input) on the touch-sensitive surface 451 of the remote input device 510.

In some embodiments, in response to receiving the selection of the selectable option 610, the electronic device 514 displays information 621 associated with the live content item in the playback user interface. For example, as shown in FIG. 6N, the electronic device 514 shifts the content player bar 606 (and associated user interface objects) upward in the playback user interface and displays a first information element 621a, a second information element 621b, and/or a third information element 621c. As previously described above with reference to FIG. 6A, the live content item optionally corresponds to a sports game. In FIG. 6N, the live content item optionally corresponds to a baseball game. Accordingly, in some embodiments, the information 621 includes statistics corresponding to the baseball game and/or one or more players actively participating in the baseball game. For example, as shown in FIG. 6N, the first information element 621a includes statistics corresponding to the baseball game, such as the inning (e.g., top of the 7th inning) for which the statistics are accounted, the teams participating in the baseball game (e.g., Team A and Team B), total runs scored by the respective teams (e.g., two runs for Team A and three runs for Team B), the innings the runs were scored (e.g., Team A scored two runs in the 6th inning and Team B scored two runs in the 1st inning and one run in the 4th inning), and/or total hits for the respective teams (e.g., five hits for Team A and three hits for Team B).

In some embodiments, as shown in FIG. 6N, the second information element 621b includes pitching statistics for a first player actively participating in the baseball game. For example, as shown in FIG. 6N, the second information element 621b includes one or more pitching statistics (e.g., total innings pitched, total pitches thrown thus far, etc.) for the first player (Player A) who is the current pitcher in the baseball game (e.g., based on the current playback position within the live content item, as discussed in more detail below). Additionally, in some embodiments, the third information element 621c includes batting statistics for a second payer actively participating in the baseball game. For example, as shown in FIG. 6N, the third information element 621c includes one or more batting statistics (e.g., overall batting average, current hitting count, etc.) for the second player (Player B) who is the current batter in the baseball game (e.g., based on the current playback position within the live content item, as discussed in more detail below). In some embodiments, the information elements 621a-621c are horizontally scrollable in the playback user interface (e.g., in response to input scrolling through the information elements 621a-621c) to reveal additional information associated with the live content item. It should be understood that the information illustrated in FIG. 6N is exemplary and that additional or alternative types of information can be presented for different types of live content items.

In some embodiments, as mentioned above, the information 621 associated with the live content item is based on the current playback position within the live content item. For example, as discussed previously above, in FIG. 6N, the current playback position does not correspond to the live playback position within the live content item. Accordingly, the statistics shown in the information elements 621a-621c optionally do not reflect (e.g., do not wholly reflect) the statistics of the baseball game at the live playback position within the live content item. For example, as shown in FIG. 6N and as discussed above, the statistics corresponding to the baseball game shown in the information elements 621a-621c are for the top of the 7th inning (particularly at time 3:35 PM in the top of the 7th inning). Accordingly, the live playback position in the live content item is optionally after (e.g., later than) 3:35 PM in the top of the 7th inning, such as a time during the bottom of the 7th inning, the top of the 8th inning, etc. In some embodiments, as described below, changing the current playback position within the live content item changes the information associated with the live content item that is displayed in the playback user interface.

In FIG. 6N, the electronic device detects the user scroll (e.g., using contact 603n) upward in the playback user interface. For example, as shown in FIG. 6N, the electronic device 514 detects the contact 603n (e.g., a tap, touch, selection, or other input) on the touch-sensitive surface 451 of the remote input device 510, followed by movement of the contact 603n upward on the touch-sensitive surface 451. In some embodiments, in response to receiving the upward scroll, the electronic device 514 moves the current focus to the content player bar 606 in the playback user interface. In FIG. 6O, while the content player bar 606 has the current focus, the electronic device receives an input (e.g., using contact 603o) corresponding to a request to scrub forward through the live content item, such as the scrubbing inputs described previously above.

In some embodiments, in response to receiving the input scrubbing through the live content item, the electronic device 514 scrubs forward through the live content item in accordance with the input. For example, as shown in FIG. 6O, the electronic device 514 moves the scrubber bar 608 rightward within the content player bar 606 based on the rightward movement of the contact 603o. Accordingly, as similarly described above, the electronic device 514 optionally updates the current playback position within the live content item to correspond to a playback position that is forward in the live content item (e.g., relative to the current playback position in FIG. 6N). As shown in FIG. 6O, the updated current playback position within the live content item optionally corresponds to 3:45 PM in the live broadcasting of the live content item, as expressed by updated real-world time indicator 609.

Additionally, in some embodiments, as shown in FIG. 6O, the electronic device 514 updates display of the information 621 associated with the live content item based on the updated current playback position within the live content item. For example, as shown in the first information element 621a, the statistics corresponding to the baseball game are still for the top of the 7th inning, but the total hit count for Team A has increased by one (e.g., a player on Team A has hit the baseball) in the time that has elapsed since the input scrubbing forward in the live content item was received (e.g., via the contact 603o). Additionally, as shown in FIG. 6O, the electronic device 514 optionally updates the pitching statistics included in the second information element 621b. For example, as shown in FIG. 6O, the total pitch count for Player A has increased to 84 pitches (e.g., from 78 pitches in FIG. 6N) in the time that has elapsed since the input scrubbing forward in the live content item was received. Similarly, as shown in FIG. 6O, the electronic device 514 optionally updates the batting statistics included in the third information element 621c. For example, as shown in FIG. 6O, a third player (Player C) is now batting instead of the second player (Player B) discussed above. Accordingly, the third information element 621c includes updated batting statistics that correspond to the third player, rather than the second player in FIG. 6N.

In some embodiments, if the electronic device 514 alternatively receives an input scrubbing backward in the live content item, such as in FIG. 6P, the electronic device 514 similarly updates the information associated with the live content item based on the updated current playback position within the live content item. For example, in FIG. 6P, the electronic device 514 receives an input (e.g., using contact 603p) scrubbing backward in the live content item. As shown in FIG. 6P, the electronic device 514 moves the scrubber bar 608 leftward within the content player bar 606 in accordance with the input and updates the current playback position within the live content item. For example, the updated current playback position within the live content item corresponds to 3:15 PM in the live broadcasting of the live content item, as expressed by updated real-world time indicator 609. As similarly described above, in some embodiments, because the updated current playback position is not the live playback position within the live content item, the electronic device 514 maintains display of the live indicator 605 in the second visual state and maintains display of the selectable option 620.

As similarly discussed above, in some embodiments, as shown in FIG. 6P, the electronic device 514 updates display of the information 621 associated with the live content item based on the updated current playback position within the live content item. For example, as shown in the first information element 621a, the statistics corresponding to the baseball game are now for the bottom of the 6th inning, instead of the top of the 7th inning as described above with reference to FIG. 6N. Additionally, as shown in FIG. 6P, the electronic device 514 optionally updates the pitching statistics included in the second information element 621b. For example, as shown in FIG. 6P, a fourth player (Player D) is now pitching instead of the first player (Player A) discussed above. Accordingly, the second information element 621b includes updated pitching statistics that correspond to the fourth player, rather than the first player in FIG. 6N. Similarly, as shown in FIG. 6P, the electronic device 514 optionally updates the batting statistics included in the third information element 621c. For example, as shown in FIG. 6P, a fifth player (Player E) is now batting instead of the second player (Player B) discussed above with reference to FIG. 6N. Accordingly, the third information element 621c includes updated batting statistics that correspond to the fifth player, rather than the second player in FIG. 6N.

FIGS. 6Q-6U illustrate examples of electronic device 514 presenting user interfaces that include additional content items for playback in a playback user interface. In FIG. 6Q, the electronic device 514 is concurrently displaying the content player bar 606 with the live content item (Live Content A) in the playback user interface. As shown in FIG. 6Q, the current playback position within the live content item optionally corresponds to the live playback position within the content item. For example, in FIG. 6Q, the scrubber bar 608 is located at the live edge within the content player bar 606 in the playback user interface. Accordingly, as shown in FIG. 6Q, the electronic device 514 is optionally displaying the live indicator 605 in the first visual state described previously above in the playback user interface. Additionally, in some embodiments, as similarly described above, the time of day (3:57 PM) expressed by the real-world time indicator 609 corresponds to the live playback position within the live content item, and thus is the current time of day at the electronic device 514.

In FIG. 6Q, the electronic device 514 detects the user scroll (e.g., using contact 603q) downward in the playback user interface. For example, as shown in FIG. 6Q, the electronic device 514 detects the contact 603q (e.g., a tap, touch, selection, or other input) on the touch-sensitive surface 451 of the remote input device 510, followed by downward movement of the contact 603q while the content player bar 606 (and related user interface objects) is concurrently displayed with the live content item in the playback user interface.

In some embodiments, in response to receiving the downward scroll, the electronic device 514 moves a current focus to the selectable option 614, as shown in FIG. 6R. In some embodiments, the electronic device 514 displays the selectable option 614 with an indication of focus (e.g., a visual boundary, highlighting, shading, bolding, etc.). In FIG. 6R, while the selectable option 614 has the current focus in the playback user interface, the electronic device 514 detects a selection of the selectable option 614. For example, as shown in FIG. 6R, the electronic device 514 detects contact 603r (e.g., a tap, touch, press, or other input) on the touch-sensitive surface 451 of the remote input device 510.

In some embodiments, in response to receiving the selection of the selectable option 610, the electronic device 514 displays a plurality of representations of content items in the playback user interface. For example, as shown in FIG. 6S, the electronic device 514 shifts the content player bar 606 (and associated user interface objects) upward in the playback user interface and displays a representation 623-1 of a first content item (“Item A”), a representation 623-2 of a second content item (“Item B”), a representation 623-3 of a third content item (“Item C”), a representation 623-4 of a fourth content item (“Item D”), and/or a representation 623-5 of a fifth content item (“Item E”). In some embodiments, the representations 623-1 to 623-5 include a representative image corresponding to the respective content items (e.g., such as a poster corresponding to the content item or image (e.g., still or screenshot) taken from the content item). In some embodiments, the representations 623-1 to 623-5 include an indication of a content provider for the respective content items. For example, as shown in FIG. 6S, the first content item (Item A) and the second content item (Item B) are provided by a first media provider (“Provider 1”), and the third content item (Item C) and the fourth content item (Item D) are provided by a second media provider (“Provider 2”).

In some embodiments, the content items included in the plurality of content items are live content items. In some embodiments, the live content items include live content items that are currently available for playback in the playback user interface and live content items that will be available for playback in the playback user interface. In some embodiments, the representations of the live content items that are available for playback in the playback user interface are displayed with a live icon (including text “LIVE”). For example, as shown in FIG. 6S, the representation 623-1 of the first content item includes live icon 624-1, the representation 623-2 of the second content item includes live icon 624-2, and the representation 623-3 of the third content item includes live icon 624-3. In some embodiments, as described in more detail below, selection of one of the representations of the live content items that are currently available for playback initiates playback of the live content item in the playback user interface. In some embodiments, the representations of the live content items that will be available for playback in the playback user interface are displayed with a time icon. In some embodiments, the time icon indicates a time of day at the electronic device 514 that a respective content item will be available for playback at the electronic device 514 (e.g., from the media provider of the respective content item). For example, as shown in FIG. 6S, the representation 623-4 of the fourth content item includes time icon 625-1 (e.g., indicating that the fourth content item will be available for playback at 7:00 pm) and the representation 623-5 of the fifth content item includes time icon 625-2 (e.g., indicating that the fifth content item will be available for playback at 7:30 pm). In some embodiments, selection of one of the live content items that will be available for playback in the playback user interface initiates a process for adding the live content item to a watchlist (e.g., the “Up Next” queue described above) that enables the user to initiate playback of the selected live content item when the live content item becomes available.

In some embodiments, the user of the electronic device 514 is entitled to watch the plurality of content items displayed in the playback user interface. For example, as similarly discussed previously herein, a user account associated with the user of the electronic device 514 that the user is logged into on the electronic device 514 is authorized (e.g., via a subscription, rental, purchase, etc.) to consume (e.g., view) the content items. In some embodiments, the representations of the plurality of content items are displayed with a predetermined arrangement in the playback user interface. For example, the representations of the live content items that are currently available for playback are positioned first within the plurality of content items, followed by the representations of the live content items that will be available for playback in the playback user interface, as shown in FIG. 6S. In some embodiments, the representations of the plurality of content items are horizontally scrollable within the playback user interface. For example, input scrolling rightward through the representations of the plurality of content items causes additional representations to be displayed in the playback user interface, such as a representation of a sixth content item and/or a representation of a seventh content item.

In some embodiments, as shown in FIG. 6S, the representation 623-1 of the first content item has a current focus in the playback user interface. In FIG. 6S, the electronic device 514 receives an input (e.g., via contact 603s) scrolling through the representations of the plurality of content items in the playback user interface. For example, as shown in FIG. 6S, the electronic device 514 detects the contact 603s on the touch-sensitive surface 451 of the remote input device, followed by movement of the contact 603s rightward on the touch-sensitive surface while the representations 623-1 of the first content item has the current focus.

In some embodiments, as shown in FIG. 6T, in response to receiving the input scrolling through the representations of the plurality of content item, the electronic device 514 moves the current focus from the representation 623-1 of the first content item to the representation 623-2 of the second content item in the playback user interface. In some embodiments, as similarly discussed above, the representation 623-2 of the second content item is displayed with an indication of focus in the playback user interface. In FIG. 6T, while the representation 623-2 of the second content item has the current focus, the electronic device 514 receives a selection (e.g., via contact 603t) of the representation 623-2 of the second content item in the playback user interface. For example, the electronic device 514 detects a tap, touch, press, or other input on the touch-sensitive surface 451 of the remote input device 510.

In some embodiments, in response to receiving the selection of the representation 623-2 of the second content item, the electronic device 514 initiates display of the second content item (Item B) in the playback user interface, as shown in FIG. 6U. In some embodiments, the electronic device 514 concurrently displays the content player bar 606 with (e.g., overlaid on) the second content item in the playback user interface. As discussed previously above, the second content item is optionally a live content item. Accordingly, as shown in FIG. 6U, when the electronic device 514 displays the second content item in the playback user interface, the electronic device 514 initiates playback of the second content item from the live playback position within the second content item. Additionally, as shown in FIG. 6U, because the current playback position within the second content item is the live playback position, the electronic device 514 displays the live indicator 605 in the first visual state described previously above. Further, in some embodiments, the time of day expressed by the real-world time indicator 609 is the current time of day at the electronic device 514 because the current playback position within the second content item is the live playback position.

As shown in FIG. 6U, when the electronic device 514 displays the second content item in the playback user interface, the electronic device 514 displays the user interface objects displayed previously with the live content item (e.g., in FIG. 6Q). For example, as shown in FIG. 6U, the electronic device 514 displays an indication of the start time 611 (e.g., 2:00 PM) of the second content item and/or an indication of a sports league 607 associated with the second content item (e.g., because the second content item is a sports game). Additionally, as shown in FIG. 6U, the electronic device 514 optionally displays the selectable options 610-616.

FIGS. 6V-6MM illustrate examples of electronic device 514 presenting user interfaces associated with a Multiview viewing mode on the electronic device 514. In FIG. 6V, the electronic device 514 is concurrently displaying the content player bar 606 with the live content item (Live Content A) in the playback user interface. As shown in FIG. 6V, the current playback position within the live content item optionally corresponds to the live playback position within the content item. For example, in FIG. 6V, the scrubber bar 608 is located at the live edge within the content player bar 606 in the playback user interface. Accordingly, as shown in FIG. 6V, the electronic device 514 is optionally displaying the live indicator 605 in the first visual state described previously above in the playback user interface. Additionally, in some embodiments, as similarly described above, the time of day (3:57 PM) expressed by the real-world time indicator 609 corresponds to the live playback position within the live content item, and thus is the current time of day at the electronic device 514.

In some embodiments, the content player bar 606 includes selectable option 626 (e.g., located above a second end (e.g., right end) of the content player bar 606) in the playback user interface. In some embodiments, the selectable option 626 is selectable to display one or more viewing options for the live content item in the playback user interface. In FIG. 6V, the electronic device 514 detects the user scroll (e.g., using contact 603v) upward in the playback user interface. For example, as shown in FIG. 6V, the electronic device 514 detects the contact 603v (e.g., a tap, touch, press, or other input) on the touch-sensitive surface 451 of the remote input device 510, followed by upward movement of the contact 603v while the content player bar 606 (and related user interface objects) is concurrently displayed with the live content item in the playback user interface.

In some embodiments, in response to upward the downward scroll, the electronic device 514 moves a current focus to the selectable option 626, as shown in FIG. 6W. In FIG. 6W, while the selectable option 626 has the current focus in the playback user interface, the electronic device 514 detects a selection of the selectable option 626. For example, as shown in FIG. 6W, the electronic device 514 detects contact 603w (e.g., a tap, touch, press, or other input) on the touch-sensitive surface 451 of the remote input device 510.

In some embodiments, in response to receiving the selection of the selectable option 626, the electronic device 514 displays menu element 627 (e.g., above and/or overlaid on a portion of the selectable option) that includes one or more viewing options for the live content item in the playback user interface, as shown in FIG. 6X. For example, as shown in FIG. 6X, the menu element 627 includes a Multiview viewing option, a PiP viewing option, and/or an option for viewing the second content item from the beginning (e.g., when the live content item was first aired/broadcasted). As shown in FIG. 6X, the Multiview option optionally has the current focus in the menu element 627.

In FIG. 6X, while the Multiview option has the current focus in the menu element 627 in the playback user interface, the electronic device 514 receives a selection (e.g., via contact 603x) of the Multiview option in the menu element 627. For example, the electronic device 514 detects a tap, touch, press, or other input on the touch-sensitive surface 451 of the remote input device 510.

In some embodiments, as shown in FIG. 6Y, in response to receiving the selection of the Multiview option in the menu element 627, the electronic device 514 displays Multiview user interface 632. For example, as shown in FIG. 6Y, the electronic device 514 replaces display of the playback user interface of FIG. 6X with the Multiview user interface 632. In some embodiments, the Multiview user interface 632 includes a playback region 634, as shown in FIG. 6Y. In some embodiments, the electronic device 514 displays the live content item (Content A) of FIG. 6X in the playback region 634 when the Multiview user interface 632 is displayed. For example, as shown in FIG. 6Y, the electronic device 514 displays the live content item in a first viewing window 635 in the playback region 634 of the Multiview user interface 632. In some embodiments, the electronic device 514 continues playback of the live content item (e.g., at the current playback position within the live content item in FIG. 6X) in the first viewing window 635 in the playback region 634. In some embodiments, as shown in FIG. 6Y, the first viewing window 635 displaying the live content item is displayed in a primary position within the playback region 634. For example, the first viewing window 635 is displayed centrally in the playback region 634 and/or is displayed at a first size in the playback region 634 that occupies a substantial portion (e.g., 40, 50, 60, 70, 80, etc. %) of the playback region 634.

In some embodiments, while the Multiview user interface 632 is displayed on the electronic device 514, the user is able to select additional content items for concurrent display with the live content item in the playback region 634. As shown in FIG. 6Y, the Multiview user interface 632 optionally includes an available content region 633 (“Add More Content”) below the playback region 634. In some embodiments, the available content region 633 includes representations of a plurality of content items that are currently available for playback on the electronic device 514. For example, the available content region 633 includes a representation 636-1 of a first content item (“Item A”), a representation 636-2 of a second content item (“Item B”), a representation 636-3 of a third content item (“Item C”), a representation 636-4 of a fourth content item (“Item D”), and/or a representation 636-5 of a fifth content item (“Item E”). In some embodiments, as similarly discussed previously above, the representations of the plurality of content items include representative content (e.g., images) corresponding to the plurality of content items. Additionally, in some embodiments, the representations of the plurality of content items include an indication of the media provider of the content items, such as “Provider 1,” “Provider 2,” and/or “Provider 3” as shown in FIG. 6Y.

In some embodiments, the plurality of content items includes live content items that are currently available for playback and/or on-demand content items that are currently available for playback. In some embodiments, the live content items of the plurality of content items are displayed with a live icon (“LIVE”) indicating that the content items are live content items. For example, as shown in FIG. 6Y, the representation 636-1 of the first content item includes live icon 637-1, the representation 636-2 of the second content item includes live icon 637-2, and the representation 636-3 of the third content item includes live icon 637-3 in the available content region 633. In some embodiments, the non-live content items (e.g., on-demand content items) of the plurality of content items are not displayed with the live icon in the available content region 633. For example, as shown in FIG. 6Y, the representation 636-4 of the fourth content item 636-4 and the representation 636-5 of the fifth content item are not displayed with the live indicator, indicating that the fourth content item and the fifth content item are non-live content items (e.g., are available via an application running on the electronic device 514 that provides on-demand access to the content items). In some embodiments, as described below, the representations of the plurality of content items in the available content region 633 are selectable to add the selected content items for playback in the playback region 633 with the live content item (Content A).

In FIG. 6Y, the electronic device 514 detects the user scroll (e.g., using contact 603y) downward in the playback user interface. For example, as shown in FIG. 6Y, the electronic device 514 detects the contact 603y (e.g., a tap, touch, press, or other input) on the touch-sensitive surface 451 of the remote input device 510, followed by downward movement of the contact 603y while the Multiview user interface 632 is displayed. In some embodiments, in response to receiving the downward scroll, the electronic device 514 moves a current focus to the representation 636-1 of the first content item (Item A) in the available content region 633 of the Multiview user interface, as shown in FIG. 6Z. For example, the electronic device 514 displays the representation 636-1 of the first content item with an indication of focus in the available content region 633.

In some embodiments, when the representation 636-1 of the first content item receives the current focus, the electronic device 514 displays a visual indication 638a (e.g., a preview or hint) of the first content item in the playback region 634 in the Multiview user interface, as shown in FIG. 6Z. For example, as shown in FIG. 6Z, the electronic device 514 displays the visual indication 638a adjacent to the first viewing window 635 that is displaying the live content item in the playback region 634. In some embodiments, a placement of the visual indication 638a in the playback region 634 indicates a location in the playback region 634 at which the first content item will be displayed in response to further input (e.g., a selection of the representation 636-1 of the first content item in the available content region 633). As shown in FIG. 6Z, the electronic device 514 optionally adjusts display of the first viewing window 635 when the visual indication 638a is displayed in the playback region 634. For example, as shown in FIG. 6Z, the first viewing window 635 is no longer displayed at the primary position within the playback region 634 and is shifted leftward in the playback region 634 to account for the display of the visual indication 638a. Additionally, in some embodiments, the first viewing window 635 is no longer displayed at the first size described above in the playback region 634. For example, as shown in FIG. 6Z, the electronic device 514 decreases a size of the first viewing window 635 in the playback region 634 to account for the display of the visual indication 638a. In some embodiments, the electronic device 514 displays the first viewing window 635 and the visual indication 638a at a same size in the playback region 634. In some embodiments, the electronic device 514 continues playback of the live content item in the first viewing window 635 while the visual indication 638a is displayed.

In FIG. 6Z, while the representation 636-1 of the first content item has the current focus and the visual indication 638a is displayed in the playback region 634, the electronic device 514 receives a selection (e.g., via contact 603z) of the representation 636-1 of the first content item in the available content region 633. For example, as shown in FIG. 6Z, the electronic device 514 detects a tap, touch, press, or other input on the touch-sensitive surface 451 of the remote input device 510.

In some embodiments, in response to receiving the selection of the representation 636-1 of the first content item, the electronic device 514 displays the first content item (Item A) concurrently with the live content item in the playback region 634, as shown in FIG. 6AA. For example, as shown in FIG. 6AA, the electronic device 514 replaces display of the visual indication 638a of FIG. 6Z with a second viewing window 639 that is displaying (e.g., playing back) the first content item in the playback region 634. In some embodiments, because the first content item is optionally a live content item, as described above, the electronic device 514 initiates playback of the first content item from the live playback position within the first content item in the second viewing window 639. As shown in FIG. 6AA, the electronic device 514 optionally displays the second viewing window 639 that is displaying the first content item at the location of the visual indication 638a in FIG. 6Z and/or at the size of the visual indication 638a in FIG. 6Z.

Additionally, in some embodiments, when the electronic device 514 displays the first content item in the second viewing window 639 in the playback region 634, the electronic device 514 updates display of the representation 636-1 of the first content item in the available content region 633. For example, as shown in FIG. 6AA, the electronic device 514 displays visual element 631-1 (e.g., a checkmark element) overlaid on the representation 636-1 of the first content item indicating that the first content item has successfully been added for playback to the playback region 634. In some embodiments, the electronic device 514 changes a visual appearance of the representation 636-1 of the first content item to indicate that the first content item has successfully been added for playback to the playback region 634. For example, the electronic device 514 adjusts a brightness, opacity, coloration, saturation, etc. of the representation 636-1 in the available content region 633. In some embodiments, the user is able to cease display of the second viewing window 639 that is displaying the first content item in the playback region 634. For example, the electronic device 514 ceases display of the second viewing window 639 in the playback region 634 in the electronic device 514 receives a (e.g., subsequent) selection of the representation 636-1 of the first content item in the available content region 633.

In FIG. 6AA, while the first content item is concurrently displayed with the live content item in the playback region 634 and the representation 636-1 of the first content item has the current focus in the available content region 634, the electronic device 514 receives an input (e.g., via contact 603aa) scrolling through the representations of the plurality of content items in the available content region 634. For example, as shown in FIG. 6AA, the electronic device 514 detects the contact 603aa (e.g., a tap, touch, press, or other input) on the touch-sensitive surface 451 of the remote input device 510, followed by movement of the contact 603aa in a rightward direction on the touch-sensitive surface 451.

In some embodiments, as shown in FIG. 6BB, in response to receiving the scrolling input, the electronic device 514 moves the current focus from the representation 636-1 of the first content item to the representation 636-2 of the second content item (Item B) in the available content region 633. In some embodiments, as similarly described above, the electronic device 514 displays the representation 636-2 of the second content item with an indication of the focus in the available content region 633. As similarly described above, when the representation 636-2 of the second content item receives the current focus, the electronic device 514 optionally displays a visual indication 638b (e.g., preview, hint, etc.) of the second content item in the playback region 634 of the Multiview user interface, as shown in FIG. 6BB. For example, as shown in FIG. 6B, the electronic device 514 displays the visual indication 638b concurrently with the first viewing window 635 that is displaying the live content item (Content A) and the second viewing window 639 that is displaying the first content item (Item A) in the playback region 634.

In some embodiments, as similarly discussed above, the electronic device 514 displays the visual indication 638b at a location in the playback region 634 that the second content item will be displayed in response to further input (e.g., a selection of the representation 636-2 in the available content region 633). In some embodiments, as shown in FIG. 6BB, when the electronic device 514 displays the visual indication 638b in the playback region 634, the electronic device 514 adjusts display of the first viewing window 635 and the second viewing window 639 in the playback region 634. For example, as shown in FIG. 6BB, the first viewing window 635 and the second viewing window 639 are shifted upward in the playback region 634 to account for the display of the visual indication 638b. Additionally, in some embodiments, the electronic device 514 reduces the sizes at which the first viewing window 635 and the second viewing window 639 are displayed in the playback region 634 (e.g., compared to the sizes of the first viewing window 635 and the second viewing window 639 in FIG. 6AA). For example, as shown in FIG. 6BB, the first viewing window 635 and the second viewing window 639 are displayed at reduced sizes to account for the display of the visual indication 638b. In some embodiments, the size of the visual indication 638b is a size at which the second content item will be displayed in the playback region 634 in response to further input. In some embodiments, as shown in FIG. 6BB, the visual indication 638b is displayed at a same size as the first viewing window 635 and/or the second viewing window 639 in the playback region 634.

In FIG. 6BB, while the visual indication 638b is displayed in the playback region 634 and the representation 636-2 of the second content item has the current focus in the available content region 633, the electronic device 514 receives a selection (e.g., via contact 603bb) of the representation 636-2 of the second content item. For example, as shown in FIG. 6BB, the electronic device 514 detects a touch, tap, press, or other input on the touch-sensitive surface 451 of the remote input device 510.

In some embodiments, in response to receiving the selection of the representation 636-2 of the second content item, the electronic device 514 displays the second content item (Item B) concurrently with the live content item (Content A) and the first content item (Item A) in the playback region 634 of the Multiview user interface, as shown in FIG. 6CC. For example, as shown in FIG. 6CC, the electronic device 514 displays a third viewing window 639b that is displaying the second content item concurrently with the first viewing window 635 that is displaying the live content item and the second viewing window 639a that is displaying the first content item in the playback region 634. In some embodiments, as described above, the second content item is a live content item. Accordingly, in FIG. 6CC, the electronic device 514 initiates playback of the third content item from the live playback position within the third viewing window 639b.

In some embodiments, the electronic device 514 replaces display of the visual indication 638b of the second content item in FIG. 6BB with the third viewing window 639b that is displaying the second content item. For example, as shown in FIG. 6CC, the electronic device 514 displays the third viewing window 639b at the location of the visual indication 638b in the playback region 634 (e.g., and ceases display of the visual indication 638b). Additionally, in some embodiments, the electronic device 514 displays the third viewing window 639b at the same size of the visual indication 638b in FIG. 6BB in the playback region 634, as shown in FIG. 6CC. For example, as shown in FIG. 6CC, the first viewing window 635, the second viewing window 639a, and the third viewing window 639b are displayed at the same size in the playback region 634 of the Multiview user interface. Additionally, in some embodiments, when the electronic device 514 displays the third viewing window 639b in the playback region 634, the electronic device 514 adjusts display of the representation 636-2 of the second content item in the available content region 633. For example, as shown in FIG. 6CC, the electronic device 514 displays visual element 631-2 (e.g., checkmark element) overlaid on the representation 636-2 of the second content item in the available playback region 633 indicating that the second content item has successfully been added for playback to the playback region 634 in the Multiview user interface.

In some embodiments, the content items are displayed in a predetermined arrangement in the playback region 634. In some embodiments, the predetermined arrangement is based on an order in which the content items were added for playback in the playback region 634. For example, in FIG. 6CC, the live content item (Content A) was added first for playback in the playback region 634, as shown previously in FIG. 6YY. Accordingly, the first viewing window 635 that is displaying the live content item is displayed in an upper left location of the playback region 634. The first content item (Item A) was optionally added second for playback in the playback region 634, as shown previously in FIG. 6AA. Accordingly, in some examples, the second viewing window 639a that is displaying the first content item is displayed adjacent to the first viewing window 635 in an upper right location of the playback region 634, as shown in FIG. 6CC. Finally, as shown in FIG. 6CC, because the second content item (Item B) was added third (last) for playback in the playback region 634, the electronic device 514 optionally displays the third viewing window 639b that is displaying the second content item (e.g., centrally) below the first viewing window 635 and the second viewing window 639a.

In some embodiments, the user is able to modify the predetermined arrangement described above for the content items that are currently displayed (e.g., being played back) in the playback region 634. For example, as shown in FIG. 6DD, the Multiview user interface includes a first arrangement option 638-1 and a second arrangement option 638-2. In some embodiments, the first arrangement option 638-1 and the second arrangement option 638-2 are displayed in an upper portion of the playback region 634 (e.g., above the viewing window 635, 639a, and 639b). As shown in FIG. 6DD, the first arrangement option 638-1 is optionally currently selected (e.g., as indicated by the shading of the first arrangement option 638-1). In some embodiments, the user is able to change the predetermined arrangement from the first arrangement (shown in FIG. 6DD) to a second arrangement, different from the first arrangement, by selecting the second arrangement option 638-2, as described below.

In FIG. 6DD, while the first arrangement option 638-1 is currently selected (e.g., and has the current focus), the electronic device 514 receives an input (e.g., via contact 603dd) selecting the second arrangement option 638-2. For example, as shown in FIG. 6DD, the electronic device 514 detects a scroll of the contact 603dd leftward on the touch-sensitive surface 451, followed by a selection input (e.g., a tap, touch, press, or other input) on the touch-sensitive surface 451.

In some embodiments, in response to receiving the selection of the second arrangement option 638-2, the electronic device 514 changes the predetermined arrangement of the content items displayed in the playback region 634 according to the second arrangement, as shown in FIG. 6EE. For example, as shown in FIG. 6EE, the electronic device 514 updates display of the first viewing window 635, the second viewing window 639a, and the third viewing window 639b in the playback region 634. In some embodiments, as shown in FIG. 6EE, the second arrangement corresponds to a columnar arrangement, with the live content item (Content A) being displayed in a primary position within the columnar arrangement. For example, as shown in FIG. 6EE, the first viewing window 635 that is displaying the live content item is displayed at a first size and is occupying a left-side portion of the playback region 634. In some embodiments, as similarly discussed above, the electronic device 514 displays the first viewing window 635 in the primary position because the live content item was added first for playback in the playback region 634. Additionally, as shown in FIG. 6EE, the electronic device 514 optionally displays the first content item (Item A) and the second content item (Item B) in a column adjacent to (e.g., to the right of) the live content item in the playback region 634. For example, the electronic device 514 displays the second viewing window 639a and the third viewing window 639b in a column that occupies a right-side portion of the playback region 634. In some embodiments, as shown in FIG. 6EE, the second viewing window 639a and the third viewing window 639b are displayed at a second size, smaller than the first size, in the column adjacent to the first viewing window 635.

In some embodiments, the live content item in the first viewing window 635 is displayed at the largest size in the playback region 634 because the first viewing window 635 has the current focus in the Multiview user interface. For example, in FIG. 6EE, if the electronic device 514 receives an input moving the current focus to a different viewing window, such as the second viewing window 639a, the electronic device 514 would display the second viewing window 639a that is displaying the first content item at the largest size in the playback region 634 (e.g., at the size of the first viewing window 635 shown in FIG. 6EE). Additionally, the electronic device 514 would optionally maintain display of the content items in the predetermined arrangement (e.g., the second arrangement associated with the second arrangement option 638-2 discussed above) shown in FIG. 6EE, with the second viewing window 639a displayed at the largest size in the playback region 634.

In some embodiments, the electronic device 514 outputs audio (e.g., accompanying the live broadcast of a respective content item) corresponding to a respective content item that is being played back in the playback region 634. As shown in FIG. 6EE, the electronic device 514 is concurrently displaying three content items in the playback region 634 (Content A, Item A, and Item B). In some embodiments, the electronic device 514 outputs audio based on a location of the current focus in the playback region 634. For example, as shown in FIG. 6EE, the live content item (Content A) has the current focus in the playback region 634. Accordingly, in some embodiments, the electronic device 514 outputs audio corresponding to the live content item, without outputting audio corresponding to the first content item (Item A) and the second content item (Item B). It should be understood that the electronic device 514 continues to playback the first content item and the second content item but does not output audio corresponding to either.

In some embodiments, the electronic device 514 displays an audio indicator 641a indicating the content item in the playback region 634 that the electronic device 514 is currently outputting audio for. For example, as shown in FIG. 6EE, the electronic device 514 displays the audio indicator 641a adjacent to the first viewing window 635 because the electronic device 514 is outputting audio corresponding to the live content item (e.g., because the live content item has the current focus). In some embodiments, as described below, the electronic device 514 alternatively displays the audio indicator 641a overlaid on a portion of the first viewing window 635 in the playback region 634.

In FIG. 6EE, while the first viewing window 635 that is displaying the live content item has the current focus, the electronic device 514 receives a selection (e.g., via contact 603ee) of the first viewing window 635 in the playback region 634. For example, as shown in FIG. 6EE, the electronic device 514 detects a tap, touch, press, or other input on the touch-sensitive surface 451 of the remote input device 510.

In some embodiments, in response to receiving the selection of the first viewing window 635 in the playback region 634, the electronic device 514 ceases display of the available content region 633 in the Multiview user interface, as shown in FIG. 6FF. For example, as shown in FIG. 6FF, the electronic device 514 is no longer displaying the representations of the plurality of content items that are available for playback in the available content region 633 of FIG. 6EE. In some embodiments, as shown in FIG. 6FF, the electronic device 514 maintains display of the playback region 634 in response to receiving the selection of the first viewing window 635. For example, as shown in FIG. 6FF, the electronic device 514 continues to concurrently display (e.g., playback) the live content item (Content A) in the first viewing window 635, the first content item (Item A) in the second viewing window 639a, and the second content item (Item B) in the third viewing window 639b. In some embodiments, as shown in FIG. 6FF, the electronic device 514 maintains display of the content items in the predetermined arrangement (e.g., the second arrangement described above) of FIG. 6EE when the available content region 633 is no longer displayed in the Multiview user interface.

In some embodiments, when the electronic device 514 ceases display of the available content region 633 in the Multiview user interface, the electronic device 514 increases sizes of the content items displayed in the playback region 634. For example, as shown in FIG. 6FF, the electronic device 514 increases the sizes of the first viewing window 635, the second viewing window 639a, and the third viewing window 639b in the playback region 634 (e.g., compared to the sizes shown in FIG. 6EE), such that the display of the content items occupies a larger portion of the Multiview user interface (e.g., compared to the occupancy shown in FIG. 6EE). Additionally, as shown in FIG. 6FF, the first viewing window 635 that is displaying the live content item has the current focus in the playback region 634. Accordingly, as similarly discussed above, in some embodiments, the electronic device 514 outputs audio corresponding to the live content item without outputting audio corresponding to the first content item and the second content item. Additionally, in some embodiments, because the electronic device 514 is outputting audio corresponding to the live content item, the electronic device 514 displays the audio indicator 641a in the playback region 634. For example, as shown in FIG. 6FF, the electronic device 514 displays the audio indicator overlaid on a portion of the first viewing window 635 to indicate that the electronic device 514 is outputting audio corresponding to the live content item.

In FIG. 6FF, while the first viewing window 635 has the current focus in the playback region 634, the electronic device 514 receives a selection (e.g., via contact 603ff) of the first viewing window 635. For example, as shown in FIG. 6FF, the electronic device 514 detects a tap, touch, press, or other input on the touch-sensitive surface 451 of the remote input device 510.

In some embodiments, as shown in FIG. 6GG, in response to receiving the selection of the first viewing window 635 in the playback region 634, the electronic device 514 initiates playback of the live content item in full-screen on the electronic device 514. For example, as shown in FIG. 6GG, the electronic device 514 ceases display of the Multiview user interface of FIG. 6FF and displays the playback user interface 602 described previously herein above. As shown in FIG. 6GG, the playback user interface 602 is displaying the live content item (Content A). In some embodiments, the electronic device 514 continues the playback of the live content item from the current playback position of the live content item when the live content item was displayed in the first viewing window 635 in FIG. 6FF (optionally at the live playback position within the live content item).

In some embodiments, the user is able to navigate back to the Multiview user interface described above by providing an input corresponding to a request to navigate away from the playback user interface 602 in FIG. 6GG. For example, as shown in FIG. 6GG, the electronic device 514 receives a selection (e.g., via contact 603gg) of the Menu button of the remote input device 510. In some embodiments, the electronic device 514 detects a button press (e.g., via an object, such as a finger) of the Menu button of the remote input device 510.

In some embodiments, in response to receiving the selection of the Menu button, the electronic device 514 redisplays the Multiview user interface of FIG. 6FF, as shown in FIG. 6HH. For example, as shown in FIG. 6HH, the electronic device 514 ceases display of the playback user interface 602 that is displaying the live content item and redisplays the Multiview user interface that includes the playback region 634. In some embodiments, as shown in FIG. 6HH, the electronic device 514 redisplays the first viewing window 635 that is displaying the live content item (Content A), the second viewing window 639a that is displaying the first content item (Item A), and the third viewing window 639b that is displaying the second content item (Item B). Additionally, as shown in FIG. 6HH, the electronic device 514 optionally displays the content items in the predetermined arrangement (e.g., the second arrangement described previously above) in the playback region 634 that was selected prior to the display of the live content item in the playback user interface 602 in FIG. 6GG. In some embodiments, the electronic device 514 displays the live content item in the first viewing window 635 with the current focus when the Multiview user interface is redisplayed (e.g., because the first viewing window 635 had the current focus when the input causing display of the live content item in the playback user interface 602 in FIG. 6GG was received). Accordingly, as similarly discussed above, the electronic device 514 displays the first viewing window 635 with the audio indication 641a indicating that the electronic device 514 is outputting audio corresponding to the live content item.

It should be understood that the electronic device 514 continues playback of the live content item in the first viewing window 635 from the current playback position within the live content item when the live content item was displayed in the playback user interface 602 in FIG. 6GG (optionally the live playback position within the live content item). In some embodiments, when the electronic device 514 redisplays the first content item (Item A) and the second content item (Item B) in the playback region 634, the electronic device 514 initiates playback of the first content item and the second content item from the live playback position within the content items (e.g., because the first content item and the second content items are optionally live content item as discussed previously above).

As shown in FIG. 6HH, the Multiview user interface optionally does not include the available content region 633 when the electronic device 514 redisplays the Multiview user interface. In some embodiments, the user is able to redisplay the additional content region 633 in the Multiview user interface by providing an input corresponding to a request to navigate backward in the Multiview user interface. For example, in FIG. 6HH, the electronic device 514 receives a selection (e.g., a button press provided by contact 603hh) of the Menu button of the remote input device 510, as similarly described above.

In some embodiments, as shown in FIG. 6II, in response to receiving the selection of the Menu button of the remote input device 510, the electronic device 514 redisplays the available content region 633 in the Multiview user interface. For example, as shown in FIG. 6II, the electronic device 514 displays the available content region 633 below the playback region 634 in the Multiview user interface. Additionally, as shown in FIG. 6II, the electronic device 514 optionally redisplays the representations 636-1 to 636-5 of the plurality of content items available for playback on the electronic device 514 in the available content region 633. In some embodiments, the user is able to add additional content items for playback in the playback region 634 while the available content region 633 is displayed in the Multiview user interface following the process described previously above.

In some embodiments, the user is able to cease display of the Multiview user interface (e.g., and redisplay the live content item in the playback user interface 602) by providing an input corresponding to a request to navigate backward in the Multiview user interface. For example, in FIG. 6HH, while the Multiview user interface that includes the playback region 634 and the available content region 633 is displayed, the electronic device 514 receives a selection (e.g., a button press provided by contact 603ii) of the Menu button of the remote input device 510, as similarly described above.

In some embodiments, in response to receiving the selection of the Menu button of the remote input device 510, the electronic device 514 ceases display of the Multiview user interface, as shown in FIG. 6JJ. For example, as shown in FIG. 6JJ, the electronic device 514 replaces display of the Multiview user interface with the playback user interface described previously herein above. In some embodiments, the electronic device 514 displays the live content item (Content A) in the playback user interface. For example, as shown in FIG. 6JJ, the electronic device 514 initiates playback of the live content item from the live playback position within the live content item (e.g., corresponding to 4:10 PM within the live content item, as indicated by real-world time indicator 609). Additionally, because the electronic device 514 is displaying the live content item at the live playback position within the live content item, the playback user interface optionally includes the live indicator 605 that is displayed in the first visual state, as shown in FIG. 6JJ. In some embodiments, the electronic device 514 displays the live content item in the playback user interface, as opposed to the first content item and the second content item in FIG. 6II, because the live content item was displayed in the playback user interface before the Multiview user interface was displayed (e.g., as shown previously in FIG. 6X).

In some embodiments, the user is able to access the Multiview user interface described above via one or more content items included under the More Content tab in the playback user interface. For example, in FIG. 6KK, while the live content item is displayed in the playback user interface, the selectable option 614 (corresponding to More Content) has been selected in the playback user interface. Accordingly, as shown in FIG. 6KK, the electronic device 514 is displaying the representations 623-1 to 623-5 of the plurality of content items that are currently available and/or will be available for playback on the electronic device 514, as previously described herein above. In some embodiments, as shown in FIG. 6KK, the representation 623-1 of a first content item (Item A) has the current focus in the playback user interface.

In FIG. 6KK, while the representation 623-1 of the first content item has the current focus, the electronic device 514 receives a selection and hold (e.g., via contact 603kk) of the representation 623-1 in the playback user interface. For example, as shown in FIG. 6KK, the electronic device 514 detects a tap, touch, or press and hold (e.g., for a threshold amount of time, such as 1, 2, 3, 4, 5, 8, 10, 15, etc. seconds) on the touch-sensitive surface 451 of the remote input device 510.

In some embodiments, in response to receiving the selection and hold of the representation 623-1 of the first content item (Item A), the electronic device 514 displays one or more viewing options for the first content item in the playback user interface. For example, as shown in FIG. 6LL, the electronic device displays menu element 642 with (e.g., overlaid on) the representation 623-1 of the first content item in the playback user interface. As shown in FIG. 6LL, the menu element 642 optionally includes a Multiview viewing option, a Live viewing option (e.g., initiating playback of the first content item at the live playback position within the first content item), and/or an option to view the first content item from the beginning (e.g., a starting time at which the first content item was first aired/broadcasted by a media provider of the first content item (Provider 1)). In some embodiments, as shown in FIG. 6LL, the Multiview viewing option has the current focus in the menu element 642 in the playback user interface.

In FIG. 6LL, while the Multiview viewing option has the current focus in the menu element 642, the electronic device 514 receives a selection (e.g., via contact 603ll) of the Multiview viewing option. For example, as shown in FIG. 6LL, the electronic device 514 detects a tap, touch, press, or other input on the touch-sensitive surface 451 of the remote input device 510.

In some embodiments, as shown in FIG. 6MM, in response to receiving the selection of the Multiview viewing option, the electronic device 514 displays the Multiview user interface 632 as similarly discussed above. For example, as shown in FIG. 6MM, the electronic device 514 replaces display of the playback user interface of FIG. 6LL with the Multiview user interface 632. As similarly discussed above, in some embodiments, the Multiview user interface 632 includes the playback region 634 and the available content region 633, as shown in FIG. 6LL.

In some embodiments, as similarly discussed above, the electronic device 514 displays the live content item (Content A) that was being played back in the playback user interface in FIG. 6LL in a first viewing window 635 in the playback region 634. In some embodiments, as previously discussed above, the electronic device 514 initiates playback of the live content item from the current playback position (optionally the live playback position) within the live content item when the input was received in FIG. 6LL. Additionally, as shown in FIG. 6MM, the electronic device 514 concurrently displays the first content item (Item A) in a second viewing window 639 with the first viewing window 635 in the playback region 634. For example, the electronic device 514 automatically populates the playback region 634 with the first content item (in the second viewing window 639) because the user selected the viewing option in the menu element 642 for viewing the first content item in the Multiview. Accordingly, the electronic device 514 optionally concurrently displays the live content item and the first content item in the playback region 634 of the Multiview user interface 632. As similarly discussed above, in some embodiments, the electronic device 514 initiates playback of the first content item, which is optionally a live content item, from the live playback position within the first content item in the second viewing window 639.

Additionally, in some embodiments, because the first content item is displayed in the playback region 634, the electronic device 514 adjusts display of the representation 636-1 of the first content item in the available content region 633. For example, as similarly discussed above, the electronic device 514 displays visual element 631-1 (e.g., checkmark element) overlaid on the representation 636-1 of the first content item in the available content region 633 to indicate that the first content item has successfully been added for playback to the playback region 634. In some embodiments, as similarly discussed above, the user is able to add additional content item for playback in the playback region 634 by interacting with (e.g., selecting) the representations (e.g., representations 636-2 to 636-5) of the content items available for playback in the available content region 633.

It should be understood that the interactions illustrated in and described with reference to FIGS. 6V-6MM above are optionally applicable to electronic devices other than the electronic device 514. For example, the user interfaces illustrated in FIGS. 6V-6MM are displayable on electronic device 500 illustrated in and described with reference to FIGS. 6F-6K above.

From FIGS. 6MM-6NN the electronic device 514 detects a sequence of one or more inputs corresponding to a request to add additional content items for playback in the Multiview user interface 632. For example, the electronic device 514 detects, via contact 603nn on the touch-sensitive surface 451 of the remote input device 510, a sequence of one or more inputs corresponding to a request to add a second content item (e.g., Item B), corresponding to representation 636-2 in the available content region 633, and a third content item (e.g., Item C), corresponding to representation 636-3 in the available content region 633. In some embodiments, as similarly discussed above, before selecting the representation 636-2 and/or the representation 636-3 in the available content region 633, and while the representation 636-2 and/or the representation 636-3 has the current focus in the available content region 633, the electronic device 514 displays a visual indication 638b (e.g., preview, hint, etc.) of the second content item in the playback region 634 of the Multiview user interface 632 and/or a visual indication 638c of the third content item in the playback region 634.

In some embodiments, as shown in FIG. 6OO and as similarly discussed above, in response to detecting the sequence of one or more inputs, the electronic device 514 adds the second content item and the third content item for playback in the playback region 634 in the Multiview user interface 632. For example, as similarly discussed above, the electronic device 514 displays the second content item in a third viewing window 639b and the third content item in a fourth viewing window 639c in the playback region 634, as shown in FIG. 6OO. In some embodiments, while displaying the content items in the playback region 634 of the Multiview user interface 632, if the electronic device 514 determines that a threshold amount of time (e.g., 1, 2, 5, 10, 15, 30, 60, etc. seconds) elapses since detecting the last input (e.g., the sequence of one or more inputs discussed above), the electronic device 514 changes a size of the viewing windows in the playback region 634 of the Multiview user interface 632. For example, as shown in FIG. 6OO, the viewing windows 639a-639c are displayed at a first size (optionally the same size) in the playback region 634 before determining the threshold amount of time, represented by time 652-1 in time bar 651, elapses.

In FIG. 6PP, the electronic device 514 determines that the threshold amount of time, represented by the time 652-1 in the time bar 651, has elapsed since detecting the last input (e.g., the sequence of one or more inputs discussed above) without detecting any intervening inputs (e.g., via the remote input device 510). In some embodiments, in response to determining that the threshold amount of time has elapsed, the electronic device 514 changes a size of the viewing windows in the playback region 634. For example, as shown in FIG. 6PP, the sizes of the live content item 635 and the viewing windows 639a-639c are displayed at a second size (optionally the same size), greater than the first size in FIG. 6OO.

In FIG. 6QQ, while the live content item 635 has the current focus (e.g., after detecting an input moving the current focus to the live content item 635), the electronic device 514 detects a press and hold of the TV button on the remote input device 510. For example, the electronic device 514 detects a press and hold of contact 603qq on the TV button for a threshold amount of time (e.g., 0.25, 0.5, 0.75, 1, 1.5, 2, etc. seconds).

In some embodiments, as shown in FIG. 6RR, in response to detecting the press and hold of the TV button on the remote input device 510 while the live content item in the first viewing window 635 has the current focus, the electronic device 514 displays a plurality of viewing controls for the live content item in the first viewing window 635. For example, as shown in FIG. 6RR, the electronic device 514 displays a first option 661-1 that is selectable to initiate rearrangement of the live content item in the first viewing window 635 in the playback region 634, a second option 661-2 that is selectable to remove the live content item in the first viewing window 635 from the playback region 634, and a third option 661-3 that is selectable to display the live content item in the first viewing window 635 in a full screen mode (e.g., display the live content item in the first viewing window 635 in the playback user interface 602 discussed above). In some embodiments, as shown in FIG. 6RR, the plurality of viewing controls is displayed overlaid on a portion of the live content item in the first viewing window 635 in the playback region 634.

In FIG. 6RR, while the first option 661-1 has the current focus, the electronic device 514 detects an input corresponding to a request to move the current focus to the second option 661-2. For example, as shown in FIG. 6RR, the electronic device 514 detects a rightward swipe of contact 603rr on the touch-sensitive surface 451 of the remote input device 510.

In some embodiments, as shown in FIG. 6SS, in response to detecting the swipe of the contact 603rr, the electronic device 514 moves the current focus from the first option 661-1 to the second option 661-2. In FIG. 6SS, while the second option 661-2 has the current focus, the electronic device 514 detects a selection of the second option 661-2. For example, as shown in FIG. 6SS, the electronic device 514 detects a tap or press of contact 603ss on the touch-sensitive surface 451 of the remote input device 510.

In some embodiments, as shown in FIG. 6TT, in response to detecting the selection of the second option 661-2, the electronic device 514 removes the live content item in the first viewing window 635 from the playback region 634 of the Multiview user interface 632. For example, as shown in FIG. 6TT, the electronic device 514 ceases playback of the live content item in the first viewing window 635 in the Multiview user interface 632.

In FIG. 6UU, the electronic device 514 detects a sequence of one or more inputs corresponding to a request to add one or more content items for playback in the playback region 634 of the Multiview user interface 632. For example, in FIG. 6UU, the electronic device 514 detects input provided by contact 603uu on the touch-sensitive surface 451 of the remote input device 510 for adding a fourth content item (e.g., Item D), represented by representation 636-4 in the available content region 633, for playback in the Multiview user interface.

In some embodiments, as shown in FIG. 6VV, in response to detecting the input provided by the contact 603uu, the electronic device 514 adds the fourth content item for playback in the Multiview user interface 632. For example, as shown in FIG. 6VV, the electronic device 514 displays a fifth viewing window 639d that is playing back the fourth content item in the playback region 634 of the Multiview user interface 632.

In FIG. 6VV, the electronic device detects a sequence of one or more inputs corresponding to a request to add a fifth content item (e.g., Item E) for playback in the playback region 634 of the Multiview user interface 632. For example, the electronic device 514 has moved the current focus to representation 636-5 corresponding to the fifth content item and, while the representation 636-5 has the current focus, the electronic device 514 detects a tap of contact 603vv on the touch-sensitive surface 451 of the remote input device 510.

In some embodiments, in accordance with a determination that selecting the fifth content item for playback in the Multiview user interface 632 causes a number of content item being played back in the Multiview user interface 632 to exceed a maximum number of content items, the electronic device 514 forgoes adding the fifth content item for playback in the Multiview user interface. For example, in FIG. 6WW, the maximum number of content items is four content items (however, it should be understood that, in some embodiments, the maximum number is a different number, such as three, five, six, ten, etc.). Accordingly, in FIG. 6WW, the electronic device 514 determines that the maximum number of content items that is able to be concurrently played back in the Multiview user interface 632 has been reached, and thus, forgoes adding the fifth content item for playback in the playback region 634 of the Multiview user interface 632. Additionally, in some embodiments, the electronic device 514 displays notification 641 in the Multiview user interface 632. In some embodiments, as shown in FIG. 6WW, the notification 641 informs the user of the electronic device 514 that the maximum number of content items for playback in the Multiview user interface 632 has been reached, and provides an indication of a means for adding the fifth content item for playback. For example, the user of the electronic device 514 can delete/remove one of the four content items currently being played back in the Multiview user interface 632 to add the fifth content item for playback in the Multiview user interface 632.

FIGS. 6XX-6FFF illustrate exemplary interactions with content items concurrently displayed in a Multiview user interface on a second electronic device 500. In some embodiments, the second electronic device 500 corresponds to electronic device 500 discussed above. In some embodiments, the Multiview user interface discussed herein below corresponds to the Multiview user interface 632 discussed above.

In FIG. 6XX, the electronic device 500 is displaying, via touchscreen 504, a live content item (e.g., Live Content A) in a playback user interface 602, as previously discussed above. In some embodiments, the playback user interface 602 corresponds to the playback user interface 602 discussed above. In FIG. 6XX, while displaying the live content item in the playback user interface 602, the electronic device 500 detects an input corresponding to a request to display playback controls associated with the playback user interface 602. For example, as shown in FIG. 6XX, the electronic device 500 detects a tap of contact 603xx on the touchscreen 504.

In some embodiments, as shown in FIG. 6YY, in response to detecting the tap of contact 603xx on the touchscreen 504, the electronic device 500 displays the playback controls for controlling playback of the live content item (e.g., overlaid on the live content item), such as the content player bar 606, selectable options 610-616, the first navigation affordance 615-1, the playback affordance 617, the second navigation affordance 615-2, etc., as previously discussed above. In some embodiments, as shown in FIG. 6YY, in response to detecting the tap of the contact 603xx on the touchscreen 504, the electronic device 500 also displays Multiview viewing option 629 in the playback user interface 602. In some embodiments, the Multiview viewing option 629 is selectable to cause the electronic device 500 to display the Multiview user interface discussed previously above.

In FIG. 6YY, while displaying the playback controls in the playback user interface 602, the electronic device 514 detects a selection of the Multiview viewing option 629. For example, the electronic device 514 detects a tap of contact 603yy directed to the Multiview viewing option 629 via the touchscreen 504.

In some embodiments, as shown in FIG. 6ZZ, in response to detecting the selection of the Multiview viewing option 629, the electronic device 514 displays the Multiview user interface 632 described previously above. For example, as shown in FIG. 6ZZ, the electronic device 514 initiates playback of the live content item in the first viewing window 635 in playback region 634 of the Multiview user interface 632. Additionally, as shown in FIG. 6ZZ and as similarly discussed above, the electronic device 500 is displaying, in available content region 633, a plurality of representations 636-1 to 636-4 corresponding to a plurality of content items that are available to add for playback in the Multiview user interface 632.

In FIG. 6ZZ, while displaying the Multiview user interface, the electronic device 500 detects a selection of a first representation 636-1 corresponding to a first content item (e.g., Item A). For example, as shown in FIG. 6ZZ, the electronic device 500 detects a tap of contact 603zz directed to the first representation 636-1 on the touchscreen 504.

In some embodiments, as shown in FIG. 6AAA, in response to detecting the selection of the first representation 637-1, the electronic device 500 adds the first content item for playback in the playback region 634 of the Multiview user interface 632. For example, as shown in FIG. 6AAA, the electronic device 500 displays second viewing window 639 that is playing back the first content item in the playback region 634. Additionally, as previously discussed herein, the electronic device 500 optionally updates the first representation 637-1 with a visual indication (e.g., checkmark) that indicates the first content item has successfully been added for playback in the Multiview user interface 632.

In FIG. 6BBB, while displaying the live content item in the first viewing window 635 and the first content item in the second viewing window 639 in the playback region 634 of the Multiview user interface 632 (e.g., while less than the maximum number (e.g., discussed previously with reference to FIG. 6WW) of content items is displayed in the Multiview user interface 632), the electronic device 500 detects a request to add a third content item for playback in the Multiview user interface 632. For example, as shown in FIG. 6BBB, the electronic device 500 detects a tap and hold (e.g., without detecting liftoff) of contact 603bbb directed to second representation 636-2 corresponding to the second content item (e.g., Item B) in the available content region 633. Additionally, as shown in FIG. 6BBB, the electronic device 500 detects movement of the contact 603bbb on the touch screen 504. For example, as shown in FIG. 6BBB, the electronic device 500 detects movement of the contact 603bbb upward on the touchscreen 504 toward the playback region 634 in the Multiview user interface 632.

In some embodiments, as shown in FIG. 6BBB, while detecting the tap and hold of the contact 603bbb and/or the movement of the contact 603bbb (and before detecting liftoff of the contact 603bbb from the touchscreen 504), the electronic device 500 displays a visual indication 638a (e.g., preview, hint, etc.) of the second content item in the playback region 634. In some embodiments, in FIG. 6BBB, the electronic device 500 displays the visual indication 638a at one or more locations in the playback region 634 at which the second content item is able to be displayed when adding the second content item for playback in the Multiview user interface 632. In some embodiments, as shown in FIG. 6BBB, the movement of the contact 603bbb corresponds to movement of the second representation 636-2 corresponding to the second content item from the available content region 633 to a location over the visual indication 638a in the playback region 634.

In some embodiments, as shown in FIG. 6CCC, in response to detecting the movement of the contact 603bbb from the second representation 636-2 to the playback region 634, the electronic device 500 displays the second content item (e.g., Item B) in the playback region 634 of the Multiview user interface 632. For example, as shown in FIG. 6CCC, the electronic device 500 displays a third viewing window 639b in the playback region 634 (e.g., at the location of the visual indication 638a) in which the second content item is played back, as similarly discussed previously above.

In some embodiments, different user experiences may happen if the maximum number of content items (e.g., four content items, as discussed previously with reference to FIG. 6WW) is displayed in the Multiview user interface 632 when movement of the contact 603bbb from the second representation 636-2 to the playback region 634 is detected. For example, if the movement corresponds to movement over an existing content item in the playback region 634, the electronic device 500 is configured to replace display of the existing content item with the content item corresponding to the second representation 636-2. As shown in FIG. 6BBB, if the maximum number of content items is displayed in the Multiview user interface 632 and the movement of the contact 603bbb corresponds to movement of the second representation 636-2 over the second viewing window 639 (e.g., that is displaying the first content item), the electronic device 500 replaces display of the first content item in the second viewing window 639 with the second content item (e.g., Item B) that corresponds to the second representation 636-2. Additionally, in FIG. 6CCC, the electronic device 500 updates the first representation 636-1 and the second representation 636-2 in the available content region 633. For example, the electronic device 500 ceases display of the checkmark on the first representation 636-1 and displays a checkmark on the second representation 636-2, signifying that the first content item is no longer being played back in the Multiview user interface 632 and that the second content item is now being played back in the Multiview user interface 632, as previously discussed herein.

In FIG. 6DDD, while displaying the live content item in the first viewing window 635, the first content item in the second viewing window 639a and the second content item in the third viewing window 639b in the playback region 634 of the Multiview user interface 632, the electronic device 500 detects an input corresponding to a request to remove the first content item from display in the Multiview user interface 632. For example, as shown in FIG. 6DDD, the electronic device 500 detects a tap of contact 603ddd-i directed to first representation 636-1 corresponding to the first content item (optionally directed to the checkmark affordance of the first representation 636-1) on the touchscreen 504. Alternatively, in some embodiments, the electronic device 500 detects a tap and hold (e.g., without detecting liftoff) of contact 603ddd-ii directed to the second viewing window 639a in which the first content item is displayed in the playback region 634, followed by movement of the contact 603ddd-ii toward an edge of the touchscreen 504. For example, as shown in FIG. 6DDD, the electronic device 500 detects the contact 603ddd-ii move from the second viewing window 639a toward a right edge/boundary of the Multiview user interface 632 on the touchscreen 504.

In some embodiments, as shown in FIG. 6EEE, in response to detecting the input corresponding to a request to remove the first content item from display in the Multiview user interface 632 as discussed above, the electronic device 500 ceases display of the first content item in the Multiview user interface 632. For example, as shown in FIG. 6EEE, the electronic device 500 removes the second viewing window 639a in which the first content item was being played back from the playback region 634. Additionally, as shown in FIG. 6EEE and as previously discussed herein, when the electronic device 500 removes the first content item from the playback region 634 of the Multiview user interface 632, the sizes of the live content item in the first viewing window 635 and the third viewing window 639b in which the second content item is displayed are increased in the playback region 634 (optionally to the same size).

In FIG. 6EEE, while displaying the live content item in the first viewing window 635 and the third viewing window 639b in which the second content item is displayed in the Multiview user interface 632, the electronic device 500 detects an input corresponding to a request to view the second content item in a full screen mode on the touchscreen 504. For example, as shown in FIG. 6EEE, the electronic device 500 detects two contacts 603eee directed to the third viewing window 639b in which the second content item is being played back on the touchscreen 504, followed by movement of the two contacts 603eee in opposite directions on the touchscreen 504 (e.g., mimicking a reverse pinching motion by the two contacts).

In some embodiments, as shown in FIG. 6FFF, in response to detecting the input corresponding to the request to view the second content item in the full screen mode, the electronic device 500 displays the second content item (e.g., Item B) in full screen in the playback user interface 602 discussed previously above. For example, as shown in FIG. 6FFF, the electronic device 500 ceases display of the Multiview user interface 632 and displays the second content item in the playback user interface 602.

FIGS. 6GGG-6KKK illustrate examples of updating sizes of content items displayed within the Multiview user interface 632 displayed on the electronic device 500. As shown in FIG. 6GGG, the electronic device 500 is displaying first viewing window 635 (e.g., playing back the live content item (e.g., Live Content A)), third viewing window 639b (e.g., playing back the second content item (e.g., Item B)), and fourth viewing window 639c (e.g., playing back a third content item (e.g., Item C) corresponding to representation 636-3 in FIG. 6EEE)) in the playback region 634 of the Multiview user interface 632. In some embodiments, as shown in FIG. 6GGG, the Multiview user interface 632 includes handle affordance 655 (e.g., a handlebar or grabber bar). In some embodiments, the handle affordance 655 is selectable to initiate updating sizes of the content items within the Multiview user interface 632 (e.g., the sizes the viewing window 635, 639b, and 639c). In some embodiments, as shown in FIG. 6GGG, the handle affordance 655 is displayed at a predetermined location within the playback region 634 of the Multiview user interface 634. For example, as shown in FIG. 6GGG, the handlebar affordance 655 is displayed at a center position between the viewing window that is in the primary display position (e.g., the first viewing window 635 that is displaying the live content item (e.g., Live Content A)) and the other viewing window(s) displayed in the column arrangement adjacent to the primary viewing window (e.g., the third viewing window 639b and the fourth viewing window 639c).

As alluded to above, in some embodiments, the handle affordance 655 is selectable to initiate updating of the sizes of the viewing windows in the Multiview user interface 632, which thus causes the sizes of the content items to be updated as well. In FIG. 6HHH, while the handle affordance 655 is displayed with the second viewing window 639b, the electronic device 500 detects an input directed to the handle affordance 655. For example, as shown in FIG. 6HHH, the electronic device 500 detects a tap of contact 603hhh (e.g., a finger, stylus, or other input mechanism) on touchscreen 504 directed to the handle affordance 655, followed by movement of the contact 603hhh on the touchscreen 504 (e.g., leftward in the direction of the first viewing window 635).

In some embodiments, in response to detecting the movement of the contact 603hhh on the touchscreen 504, the electronic device 500 moves the handle affordance 655 in the Multiview user interface 632 in accordance with the movement of the contact 603hhh. For example, as shown in FIG. 6III, the electronic device 500 moves the handle affordance 655 leftward in the Multiview user interface 634. Additionally, as shown in FIG. 6III, when the electronic device 500 moves the handle affordance 655 in accordance with the input, the electronic device 500 updates the sizes of the viewing windows in the Multiview user interface based on the movement of the handle affordance 655 (e.g., based on a distance and/or speed with which the handle affordance 655 is moved). For example, as shown in FIG. 6III, the movement of the handle affordance 655 leftward in the Multiview user interface 634 causes the sizes of the third viewing window 639b and the fourth viewing window 639c to increase in the Multiview user interface 632, which correspondingly causes the scale at which the second content item (e.g., Item B) and the third content item (e.g., Item C) are displayed in their respective viewing windows to increase as well. In some embodiments, as shown in FIG. 6III, because the third viewing window 639b and the fourth viewing window 639c are arranged in a column format within the playback region 634 as discussed above, the movement of the handle affordance 655 causes the third viewing window 639b (e.g., and thus the second content item) and the fourth viewing window 639c (e.g., and thus the third content item) to be increased in size by the same amount.

Additionally, in some embodiments, as shown in FIG. 6III, when the handle affordance 655 is moved leftward in the Multiview user interface 632, the electronic device 500 decreases the size of the first viewing window 635, which thus causes the scale at which the live content item (e.g., Live Content A) is being played back to decrease as well. In some embodiments, if the movement of the contact 603hhh in FIG. 6HHH were alternatively rightward on the touchscreen 504, causing the handle affordance 655 to be moved rightward in the Multiview user interface 632, the electronic device 500 would alternatively decrease the sizes of the third viewing window 639b and the fourth viewing window 639c and increase the size of the first viewing window 635 within the playback region 634. In some embodiments, the handle affordance 655 is able to be moved leftward or rightward a predetermined amount in the Multiview user interface 632 (e.g., based on a physical size of the touchscreen 504 and thus). For example, the electronic device 500 decreases the size of the first viewing window 635 (or the current primary viewing window) in accordance with leftward movement of the handle affordance 655 to a minimum size (and thus increases the sizes of the third viewing window 639b and the fourth viewing window 639c to a maximum size), at which point the electronic device 500 forgoes further movement of the handle affordance 655 leftward in the Multiview user interface 634. In some embodiments, the opposite is true for rightward movement of the handle affordance 655 in the Multiview user interface 634 (e.g., the third viewing window 639b and the fourth viewing window 639c are decreased to a minimum size).

In some embodiments, the minimum size and the maximum size to which sizes of particular content items are able to be updated to in accordance with movement of the handle affordance 655 are equal when there are two content items being concurrently played back in the Multiview user interface 632. For example, in FIG. 6JJJ, the Multiview user interface 632 includes the first viewing window 635 that is displaying the live content item and the third viewing window 639b that is displaying the second content item within the playback region 634. As discussed above, the Multiview user interface 632 optionally includes the handle affordance 655 that is displayed centrally between the first viewing window 635 and the third viewing window 639b. As shown in FIG. 6JJJ, the electronic device 500 detects an input corresponding to a request to move the handle affordance 655 in the Multiview user interface 632. For example, as shown in FIG. 6JJJ, the electronic device 500 detects a tap of contact 603jjj (e.g., a finger, stylus, or other input mechanism) on touchscreen 504 directed to the handle affordance 655, followed by movement of the contact 603jjj on the touchscreen 504 (e.g., leftward in the direction of the first viewing window 635), as similarly discussed above.

In some embodiments, the movement of the handle affordance 655 corresponds to a maximum movement (e.g., a maximum amount, such as a maximum distance), such that, as shown in FIG. 6KKK, the third viewing window 639b is increased to a maximum size in the Multiview user interface 632. In some embodiments, the maximum size of the third viewing window 639b in FIG. 6KKK is larger than the maximum size discussed above with reference to the third viewing window 639b and the fourth viewing window 639c in FIG. 6III (e.g., due to fewer content items being displayed in the Multiview user interface 632 in FIG. 6KKK). Additionally, as shown in FIG. 6KKK, when the third viewing window 639b is increased to the maximum size in the Multiview user interface 632, the first viewing window 635 is decreased to a minimum size in the Multiview user interface 632. As shown in FIG. 6KKK, because there are two content items displayed in the Multiview user interface 632, the first viewing window 635 and the third viewing window 639b are updated to be displayed at the same size when the handle affordance 655 is moved the maximum amount in the Multiview user interface 632. As similarly discussed above with reference to FIG. 6III, while the first viewing window 635 and the third viewing window 639b are displayed at the same size in the Multiview user interface 632 after the movement of the handle affordance 655, further movement of the handle affordance 655 leftward in the Multiview user interface 632 is restricted and/or prevented. For example, because the live content item is currently being displayed in the primary viewing window (e.g., the first viewing window 635) in FIG. 6KKK, the electronic device 500 forgoes decreasing the size of the first viewing window 635 below that shown in FIG. 6KKK.

FIGS. 6LLL-6OOO illustrate examples of displaying content items displayed within the Multiview user interface 632 displayed on the electronic device 500 in a cinema viewing mode. As shown in FIG. 6LLL, the Multiview user interface 632 includes the first viewing window 635 and the third viewing window 639b, as similarly discussed above. Additionally, as shown in FIG. 6LLL, the Multiview user interface 632 includes the handle affordance 655 discussed previously above. In some embodiments, the first viewing window 635 is playing back the live content item (e.g., Live Content A) and the third viewing window 639b is playing back the second content item (e.g., Item B).

In some embodiments, the electronic device 500 initiates display of the content items being played back in the Multiview user interface 632 in a cinema viewing mode in accordance with determining user inactivity (e.g., for a threshold amount of time). For example, as indicated in FIG. 6LLL, the electronic device 500 transitions to displaying the live content item and the second content item in the cinema viewing mode in accordance with a determination that the electronic device 500 does not detect user input (e.g., touch input or other input detected on the touchscreen 504, input detected via an input device in communication with the electronic device 500, or movement of the electronic device 500) for at least a first threshold amount of time (e.g., 0.5, 0.75, 1, 1.5, 2, 3, 4, 5, or 10 seconds) after or while displaying the content items, represented by time 652-1 in time bar 651.

From FIGS. 6LLL-6MMM, the electronic device 500 determines that the first threshold amount of time has elapsed without detecting user input, as indicated in the time bar 651 in FIG. 6MMM. Accordingly, in some embodiments, the electronic device 500 transitions to displaying the live content item in the first viewing window 635 and the second content item in the third viewing window 639b in the cinema viewing mode. In some embodiments, displaying the live content item and the second content item in the cinema viewing mode includes dimming/darkening a background of the Multiview user interface 632 (e.g., the portions of the Multiview user interface 632 surrounding and/or outside of the first viewing window 635 and the third viewing window 639b). Additionally, in some embodiments, displaying the live content item and the second content item in the cinema viewing mode includes increasing the sizes of the first viewing window 635 (e.g., thus increasing the scale at which the live content item is displayed) and the third viewing window 639b (e.g., thus increasing the scale at which the second content item is displayed) in the Multiview user interface 632 (e.g., to occupy greater portions of the physical touchscreen 504), as similarly described above with reference to FIG. 6PP. In some embodiments, as shown in FIG. 6MMM, displaying the live content item and the second content item in the cinema viewing mode includes ceasing display of user interface elements other than the first viewing window 635 and the third viewing window 639b in the Multiview user interface 632. For example, as shown in FIG. 6MMM, the electronic device 500 ceases display of the handle affordance 655 in the Multiview user interface 632. In some embodiments, if the electronic device 500 detects user input (e.g., such as a tap of a contact on the touchscreen 504) while the live content item and the second content item are being displayed in the cinema viewing mode, the electronic device 500 exits the cinema viewing mode. For example, the electronic device 500 transitions the display of the live content item and the second content item as displayed in FIG. 6LLL (e.g., and redisplays the handle affordance 655 and/or other user interface elements).

In some embodiments, the electronic device 500 transitions to displaying content items in the cinema viewing mode after a second threshold amount of time, greater than the first threshold amount of time, has elapsed without detecting user activity if the Multiview user interface 632 includes the available content region 633 discussed previously above. For example, in FIG. 6NNN, the electronic device 500 is concurrently displaying the first viewing window 635, the third viewing window 639b, and the available content region 633 in the Multiview user interface 633. Additionally, as discussed above, the Multiview user interface 633 includes the handle affordance 655. In some embodiments, the available content region 633 is displayed with slider affordance 657, as shown in FIG. 6NNN. For example, the slider affordance 657 is selectable to initiate expansion and/or minimization of the available content region 633 (e.g., downward movement of the slider affordance 657 (e.g., via a contact on the touchscreen 504) causes the available content region 633 to no longer be displayed in the Multiview user interface 632 or causes a smaller portion of the available content region 633 to be visible in the Multiview user interface 632 (e.g., depending on the magnitude of the movement of the slider affordance 657)). As mentioned above, while the available content region 633 is displayed in the Multiview user interface 632, the electronic device 500 transitions to displaying the live content item and the second content item in the cinema viewing mode in accordance with a determination that the electronic device 500 does not detect user input (e.g., touch input or other input detected on the touchscreen 504, input detected via an input device in communication with the electronic device 500, or movement of the electronic device 500) for at least a second threshold amount of time (e.g., 1, 2, 3, 4, 5, 8, 10, or 20 seconds) after or while displaying the display elements of FIG. 6NNN, for example, represented by time 652-2 in the time bar 651. For example, if the electronic device 500 determines that the first threshold amount of time (e.g., represented by time 652-1 in the time bar 651) elapses without detecting user input but determines that the second threshold amount of time has not yet elapsed without detecting user input, the electronic device 500 forgoes transitioning to the cinema viewing mode.

From FIGS. 6NNN-6OOO, the electronic device 500 determines that the second threshold amount of time has elapsed without detecting user input, as indicated in the time bar 651 in FIG. 6OOO. Accordingly, in some embodiments, the electronic device 500 transitions to displaying the live content item in the first viewing window 635 and the second content item in the third viewing window 639b in the cinema viewing mode. For example, as similarly discussed above, the electronic device 500 dims/darkens the background of the Multiview user interface 632 and ceases display of the handle affordance 655. Additionally, as shown in FIG. 6OOO, the electronic device 500 ceases display of the available content region 632 in the Multiview user interface 632.

FIG. 7 is a flow diagram illustrating a method 700 of facilitating control of playback of a live content item displayed in a playback user interface in accordance with some embodiments. The method 700 is optionally performed at an electronic device such as device 100, device 300, or device 500 as described above with reference to FIGS. 1A-1B, 2-3, 4A-4B and 5A-5C. Some operations in method 700 are, optionally combined and/or order of some operations is, optionally, changed.

As described below, the method 700 provides ways to facilitate efficient control of playback of live content displayed in a playback user interface. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 700 is performed by an electronic device (e.g., electronic device 514) in communication with a display generation component and one or more input devices (e.g., remote input device 510). For example, the electronic device is a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc.

In some embodiments, while displaying, via the display generation component, a live content item (e.g., a live-broadcast content item) in a playback user interface (e.g., a content player, such as a movie player or other media player), such as while displaying Live Content A in playback user interface 602 in FIG. 6A, wherein the playback user interface is configured to playback content (e.g., a movie, an episode of a television (TV) show, music, a podcast, etc.), the electronic device receives (702a), via the one or more input devices, a first input corresponding to a request to display one or more controls for controlling playback of the live content item, such as input provided by contact 603a as shown in FIG. 6A. For example, the electronic device is displaying a live-broadcast and/or live-streamed content item, such as a live-broadcast movie, TV episode, sporting event (e.g., a baseball game, basketball game, football game, soccer game, etc.), awards show, political debate (e.g., presidential debate), competition/game show, etc., in the playback user interface. In some embodiments, the live-broadcast and/or live-streamed content item is of a live event (e.g., an event happening live, at the current time) or of a previously-recorded live event (e.g., an event that happened in the past). In some embodiments, a current playback position within the live-broadcast content item is at the live edge. For example, portions of the live-broadcast content item beyond the live edge (e.g., scheduled to be played back at a future time from the current playback position) are not yet available for consumption (e.g., haven't yet been received/streamed by the electronic device from the content provider). In some embodiments, while displaying the live-broadcast content item in the playback user interface, the electronic device receives a request to display one or more controls for controlling playback of the live-broadcast content item. For example, the electronic device receives a tap detected on a touch-sensitive surface of the one or more input devices (e.g., on a remote input device in communication with the electronic device), such as touch sensitive surface 451 described with reference to FIG. 4, a click of the touch-sensitive surface, or a selection of a hardware button of a remote input device in communication with the electronic device, such as remote 510 described with reference to FIG. 5B. In some embodiments, the first input is detected via a touch screen of the electronic device (e.g., the touch screen is integrated with the electronic device, and is the display via which the playback user interface is being displayed). For example, the electronic device detects a tap or touch provided by an object (e.g., a finger of the user or a hardware input device, such as a stylus) via the touch screen. As discussed below, in some embodiments, the one or more controls for controlling playback of the live content item enable the user to pause, fast-forward, and/or rewind the live content item, select viewing options for the live content item, and/or cease display of the live content item (e.g., and/or initiate a process for selecting a different live content item for playback).

In some embodiments, in response to receiving the first input, the electronic device displays (702b), via the display generation component, a content player bar (e.g., content player bar 606 in FIG. 6B) for navigating through the live content item and a first visual indicator in the playback user interface (e.g., live indicator 605 in FIG. 6B), wherein the first visual indicator is displayed in a first visual state and the first visual indicator is separate from the content player bar, as similarly shown in FIG. 6B. For example, in response to receiving the first input, the electronic device displays the content player bar and the first visual indicator in a predetermined location in the playback user interface. In some embodiments, the content player bar is displayed over the live content item along a bottom portion of the live content item on the display (e.g., on the touch screen). In some embodiments, while the content player bar and the first visual indicator are displayed, the electronic device maintains playback of the live content item (e.g., continues playing the live-broadcast content item in the content player). In some embodiments, while the content player bar and the first visual indicator are displayed, the electronic device pauses playback of the live content item and displays representative content (e.g., an image or thumbnail) corresponding to the live content item. In some embodiments, portions of the content player bar that correspond to the portions of the live content item that have already been played back (e.g., irrespective of when the electronic device initiated playback of the live content item) are visually distinguished from portions of the content player bar that correspond to portions of the live content item that have not yet been played back (e.g., beyond the live edge). For example, the electronic device highlights/fills in (e.g., bubbles) the portions of the content player bar that correspond to the portions of the live content item that have already been played back. In some embodiments, an end of the highlighted/bubbled in portion of the content player bar indicates the live edge in the live-broadcast content item. In some embodiments, the first visual indicator is displayed above and separate from the content player bar in the playback user interface. For example, the first visual indicator is displayed above a left end or a right end of the content player bar in the playback user interface. In some embodiments, the first visual indicator corresponds to a “Live” status indicator. For example, the first visual indicator includes a “Live” text label. In some embodiments, displaying the first visual indicator in the first visual state indicates that the current playback position within the live-broadcast content item is currently at the live edge. For example, the first visual state includes a first color state, such that the first visual indicator is displayed with a first color (e.g., red, blue, yellow, orange, etc.) to indicate that the current playback position within the live-broadcast content item is currently at the live edge. In some embodiments, displaying the first visual indicator in the first visual state includes emphasizing the “Live” text label relative to the playback user interface. For example, the electronic device brightens and/or boldens the letters of the “Live” text label in the first visual indicator to indicate that the playback position within the live-broadcast content item is currently at the live edge. In some embodiments, as described in more detail below, the content player bar includes a visual indication of the current playback position within the content and one or more playback time indications that include time values based on the current playback position within the content. For example, the visual indication of the current playback position is displayed at the live edge within the content player bar.

In some embodiments, while displaying the content player bar and the first visual indicator in the first visual state in the playback user interface, the electronic device receives (702c), via the one or more input devices, a second input corresponding to a request to scrub through the live content item, such as input provided by contact 603c as shown in FIG. 6C. For example, while the current playback position within the live content item is at the live edge, the electronic device receives an input corresponding to a request to navigate backward through (e.g., rewind) the content. In some embodiments, the second input includes a swipe in a respective direction detected on a touch-sensitive surface of the one or more input devices. For example, the electronic device detects a leftward swipe of a finger of the user on the touch sensitive surface. In some embodiments, the second input includes a press of a hardware button of the one or more input devices. For example, the electronic device detects a press and/or a press and hold of a left arrow key on a remote input device in communication with the electronic device. In some embodiments, the second input includes movement detected on a touch screen of the electronic device directed to the content player bar in the playback user interface. For example, the electronic device detects a contact (e.g., a finger of the user) on the touch screen directed to the content player bar, followed by movement of the contact in a leftward direction along the content player bar. In some embodiments, as described in more detail below, the electronic device detects a selection of a navigation affordance displayed in the playback user interface. For example, the electronic device detects a selection of a backward navigation affordance displayed in the playback user interface with the content player bar and the first visual indication. In some embodiments, the electronic device restricts and/or prevents navigating forward in the live-broadcast content item beyond the live edge because portions of the live-broadcast content item beyond the live edge are not yet available for consumption by the user. For example, the electronic device effectively ignores input corresponding to a request to navigate forward in the live-broadcast content item beyond the live edge.

In some embodiments, in response to receiving the second input (702d), the electronic device updates (702e) a current playback position within the live content item in accordance with the second input, such as updating scrubber bar 608 within the content player bar 606 as shown in FIG. 6C. For example, the electronic device navigates backward through the content in accordance with the second input. In some embodiments, the electronic device updates display of the live-broadcast content item (and/or the representative content corresponding to the live-broadcast content item) in accordance with the update of the current playback position within the live-broadcast content item. For example, the electronic device initiates and/or returns to playback of the live-broadcast content item at the current playback position (and/or changes the representative content displayed in the playback user interface to correspond to the current playback position) that is updated in accordance with a magnitude (e.g., of speed and/or duration) of the second input. In some embodiments, as discussed in more detail below, the electronic device updates display of the visual indication of the current playback position in the content player bar in accordance with the update of the current playback position within the live-broadcast content item.

In some embodiments, the electronic device displays (702f) the first visual indicator in a second visual state, different from the first visual state, in the playback user interface, such as changing display of the live indicator 605 as shown in FIG. 6C. For example, the electronic device displays the first visual indicator in the second visual state to indicate that the current playback position within the live-broadcast content item is no longer at the live edge. In some embodiments, the second visual state includes a second color state, such that the first visual indicator is displayed with a second color (e.g., gray, black, etc.), different from the first color above, to indicate that the current playback position within the live-broadcast content item is not currently at the live edge. In some embodiments, displaying the first visual indicator in the second visual state includes deemphasizing the “Live” text label relative to the playback user interface. For example, the electronic device dims and/or darkens the letters of the “Live” text label in the first visual indicator to indicate that the playback position within the live-broadcast content item is not currently at the live edge. In some embodiments, displaying the first visual indicator in the second visual state includes ceasing display of the first visual indicator in the playback user interface. In some embodiments, as discussed in more detail below, if the electronic device receives an input corresponding to a request to navigate back to the live edge in the live-broadcast content item, the electronic device redisplays the first visual indicator in the first visual state discussed above to indicate that the current playback position is back at the live edge in the live-broadcast content item. In some embodiments, if the electronic device detects an input corresponding to a request to navigate forward in the live-broadcast content item beyond the live edge, the electronic device forgoes updating the current playback position within the live-broadcast content item in accordance with the input, as discussed above. Additionally, in some embodiments, the electronic device maintains display of the first visual indicator in the first visual state in the playback user interface. For example, the electronic device maintains display of the first visual indicator in the first visual state because the current playback position is still at the live edge in the live content item. Changing a visual appearance of a visual indicator in a playback user interface that is displaying a live-broadcast content item when an input scrubbing through the live-broadcast content item causes a current playback position within the live-broadcast content item to no longer be at the live edge facilitates discovery that the current playback position is no longer at the live edge and/or facilitates user input for navigating back to the live edge of the live-broadcast content item, thereby improving user-device interaction.

In some embodiments, the electronic device receives, via the one or more input devices, a respective input corresponding to a request to display a second content item in the playback user interface, wherein the second content item is not a live content item, as similarly described with reference to FIG. 6B. For example, before displaying the live content item in the playback user interface or while displaying the live content item in the playback user interface, the electronic device receives a respective input for causing playback of a second content item in the playback user interface. For example, the electronic device receives a selection of a representation of the second content item (e.g., in a user interface separate from the playback user interface, such as a media browsing application user interface that facilitates browsing of a plurality of content items that are available for playback at the electronic device). In some embodiments, the electronic device receives the respective input after navigating away from the playback user interface that is displaying the live content item. For example, the electronic device receives a selection of a “back” button or a “home” button on a remote input device in communication with the electronic device or a tap directed to a “back” option displayed in the playback user interface detected via a touch-sensitive surface of the one or more input devices (e.g., such as a trackpad or a touch screen of the electronic device), which causes the electronic device to display a plurality of representations of a plurality of content items (optionally available via the media browsing application discussed above). In some embodiments, the second content item is not a live content item (e.g., is not a content item currently being live broadcasted via a media provider of the content item). For example, the second content item is an on-demand content item (e.g., a content item available for purchase or streaming from a respective media provider at any time, optionally unlike a live content item).

In some embodiments, in response to receiving the respective input, the electronic device displays, via the display generation component, the second content item in the playback user interface. For example, as similarly described above, the electronic device initiates playback of the second content item in the playback user interface. In some embodiments, while displaying the second content item in the playback user interface, the electronic device receives, via the one or more input devices, a third input corresponding to a request to display one or more controls for controlling playback of the second content item, such as input 603a as shown in FIG. 6A. For example, while displaying the second content item in the playback user interface, the electronic device receives a request to display one or more controls for controlling playback of the second content item (e.g., for scrubbing through the second content item, pausing the second content item, displaying information associated with the second content item, and the like). In some embodiments, the third input has one or more characteristics of the second input described above for causing display of the one or more playback controls.

In some embodiments, in response to receiving the third input, the electronic device displays, via the display generation component, a content player bar (e.g., similar to content player bar 606 in FIG. 6B) for navigating through the second content item without displaying the first visual indicator in the playback user interface, as similarly described with reference to FIG. 6B. For example, in response to receiving the third input, the electronic device displays a content player bar with the second content item in the playback user interface, as similarly described above. In some embodiments, the content player bar has one or more characteristics of the content player bar described above. In some embodiments, in response to receiving the third input, the electronic device forgoes displaying the first visual indicator with the content player bar in the playback user interface. For example, as discussed above, the first visual indicator is displayed when a live content item is displayed in the playback user interface. As mentioned above, the second content item is optionally not a live content item (e.g., is not a live-broadcast content item). Accordingly, the electronic device optionally does not display the first visual indicator, which indicates that playback of a live content item is at the live edge within the live content item, with the content player bar in the playback user interface in response to receiving the third input. Forgoing display of a visual indicator in a playback user interface that is displaying a non-live content item in response to receiving an input for displaying one or more playback controls in the playback user interface facilitates discovery that the content item is a non-live content item and/or avoids potential confusion that would occur from displaying the visual indicator with a changed appearance, thereby improving user-device interaction.

In some embodiments, in response to receiving the first input, the electronic device displays, via the display generation component a first selectable option that is selectable to display information corresponding to the live content item, such as selectable option 610 in FIG. 6B. For example, the first selectable option is selectable to display one or more statistic and/or summary information corresponding to the live content item, as described in more detail below. In some embodiments, the first selectable option includes a text indication (e.g., a text label) indicating that the first selectable option is selectable to display the information (e.g., an “Info” text label).

In some embodiments, the electronic device displays a second selectable option that is selectable to display one or more representations of one or more second live content items, such as selectable option 614 in FIG. 6B. For example, the second selectable option is selectable to display one or more representations of one or more second live content items that are currently available for playback or will become available for playback in the future, as described in more detail below. In some embodiments, the second selectable option includes a text indication (e.g., a text label) indicating that the second selectable option is selectable to display the one or more representations of the one or more second live content items (e.g., a “More Games,” “More Live Content,” or “More TV” text label). In some embodiments, the one or more representations of the one or more second live content items include representative content corresponding to the one or more second live content items. For example, if the one or more second live content items include live sports games, the representative content includes the logos of the opposing sports teams, images of players from the sports teams, and/or a title of the sports game (e.g., “Team A at Team B”). In some embodiments, the one or more representations of the one or more second live content items include a start time of the one or more second live content items. For example, the start time refers to when the live content items first became available for playback and/or will become available for playback on the electronic device (e.g., based on scheduled broadcast times).

In some embodiments, the first selectable option and the second selectable option are displayed in a predefined region relative to the content player bar in the playback user interface, such as below the content player bar 606 in the playback user interface as shown in FIG. 6B. For example, the first selectable option and the second selectable option are displayed below the content player bar in the playback user interface, optionally toward a bottom portion of the playback user interface. In some embodiments, the first selectable option and the second selectable option are displayed as a row of selectable options below the content player bar in the playback user interface. Displaying selectable options with a content player bar in a playback user interface that is displaying a live content item in response to receiving an input for displaying one or more playback controls in the playback user interface facilitates discovery that additional information corresponding to the live content item is available for display in the playback user interface and/or facilitates user input for performing one or more actions in the playback user interface, thereby improving user-device interaction.

In some embodiments, the information corresponding to the live content item includes one or more statistics associated with the live content item, such as statistics included in information 621a-621c as shown in FIG. 6N. For example, the first selectable option discussed above is selectable to cause the electronic device to display one or more statistics associated with the live content item in the playback user interface. In some embodiments, the one or more statistics are based on the current playback position within the live content item. For example, if the live content item is a sports game, the one or more statistics include statistics of the sports game at a particular time in the sports game as dictated by the current playback position (e.g., information indicative of hits, runs, homeruns, strikeouts, and/or pitch count for a baseball game during a respective inning (e.g., the 7th inning) to which the current playback position corresponds). In some embodiments, the one or more statistics associated with the live content item are displayed along a bottom portion of the playback user interface (e.g., below the content player bar). In some embodiments, the one or more statistics are organized according to category (e.g., hits/runs statistics, pitcher statistics, and/or batter statistics for a live baseball game) and are displayed as a row along the bottom portion of the playback user interface. In some embodiments, the one or more statistics are (e.g., horizontally) scrollable in the playback user interface. For example, user input corresponding to a request to scroll through the one or more statistics (e.g., such as a swipe gesture detected via a touch-sensitive surface of the one or more input devices or a press of a navigation button of a remote input device in communication with the electronic device) causes the electronic device to scroll through the one or more statistics and reveal additional and/or previous statistics (e.g., from previous points in time during the live content item, such as in a previous inning for a baseball game). In some embodiments, the one or more statistics associated with the live content item are concurrently displayed with the live content item. For example, the one or more statistics remain displayed (e.g., and are updated) as the playback of the live content item progresses in the playback user interface.

In some embodiments, the one or more statistics associated with the live content item are updated based on the current playback position within the live content item, as similarly described with reference to FIG. 6N. For example, as described in more detail below, as the current playback position within the live content item is updated, the electronic device correspondingly updates the one or more statistics associated with the live content item based on events/highlights in the live content item. Displaying one or more statistics associated with a live content item in a playback user interface that is displaying the live content item in response to receiving an input selecting a selectable option in the playback user interface enables the user to consume additional information corresponding to the live content item while concurrently viewing the live content item in the playback user interface, which preserves a context of the current playback position within the live content item, thereby improving user-device interaction.

In some embodiments, before receiving the second input corresponding to the request to scrub through the live content item, the information corresponding to the live content item includes one or more first statistics associated with the live content item (e.g., one or more first statistics that are based on a playback position within the live content item before the second input is received) without including one or more second statistics, different from the one or more first statistics, associated with the live content item (e.g., one or more second statistics that are not based on the playback position within the live content item before the second input is received), such as the statistics included in the information 621a-621c in FIG. 6N. In some embodiments, in response to receiving the second input, the electronic device updates the information corresponding to the live content item to include the one or more second statistics associated with the live content item, such as updating the statistics included in the information 621a-621c as shown in FIG. 6O. For example, in response to receiving the input scrubbing through the live content item, the electronic device updates the information corresponding to the live content item to include the one or more second statistics. In some embodiments, the one or more first statistics are based on the live playback position within the live content item and are optionally displayed in the playback user interface before the second input is received. In some embodiments, the one or more second statistics are based on a respective playback position (e.g., a playback position that is chronologically located prior to the live playback position) in the live content item and is available, but not displayed, before the second input is received. In some embodiments, in response to receiving the second input that causes the updated current playback position to correspond to the respective playback position, the electronic device displays the one or more second statistics associated with the live content item in the playback user interface. In some embodiments, the electronic device ceases display of the one or more first statistics, or updates (e.g., changes) a portion of the one or more first statistics, when displaying the one or more second statistics in the playback user interface based on the updated current playback position. Updating one or more statistics associated with a live content item in a playback user interface that is displaying the live content item in response when an input scrubbing through the live content item causes a current playback position to change within the live content item enables the user to consume additional information corresponding to the live content item based on the updated current playback position while concurrently viewing the live content item at the updated current playback position in the playback user interface, which preserves a context of the current playback position within the live content item, thereby improving user-device interaction.

In some embodiments, in response to detecting the second input, in accordance with a determination that the second input corresponds to a request to scrub backward in the live content item (e.g., backward relative to the current playback position within the live content item), such as scrubbing backward within the live content item as shown in FIG. 6P, updating the current playback position within the live content item in accordance with the second input includes updating the current playback position to correspond to a first playback position within the live content item that is a past playback position relative to the current playback position when the second input was received, such as the past playback position indicated by the updated location of the scrubber bar 608 within the content player bar 606 as shown in FIG. 6P. For example, in response to receiving the second input, the electronic device navigates backward in the live content item, such that the current playback position is a past playback position relative to the current playback position. In some embodiments, the electronic device initiates playback of the live content item from the first playback position in the playback user interface.

In some embodiments, the one or more second statistics associated with the live content item are associated with the past playback position within the live content item, such as the statistics included in the information 621a-621c in FIG. 6P. For example, the information included in the one or more second statistics is based on the first playback position within the live content item. In some embodiments, as similarly discussed above, the electronic device displays the one or more second statistics, or updates display of a portion of the one or more first statistics, in the playback user interface while concurrently displaying the live content item. For example, the one or more second statistics displayed in the playback user interface include a subset of the one or more first statistics displayed when the second input is received, such that the one or more second statistics optionally includes less information than that included in the one or more first statistics (e.g., because the first playback position within the live content item is a past playback position relative to the playback position on which the one or more first statistics are based). As an example, if the live content item is a sports game (e.g., such as a baseball game) and the current playback position within the live content item when the second input is detected is before the live playback position within the live content item (e.g., at a time that is during the 2nd inning when the live playback position is during the 3rd inning), and the updated current playback position is farther back in the live content item (e.g., at a time during the 1st inning), the one or more second statistics are associated with the particular time at the past playback position (e.g., the electronic device displays game statistics such as total runs and hits, and/or player statistics such as hits, strikeouts, walks, and/or runs, for the particular time during the 1st inning of the game). As such, the one or more second statistics optionally include fewer statistics than the statistics associated with the previous current playback position (e.g., game statistics and/or player statistics from the 1st inning that do not include the previous statistics from the 2nd inning). Updating one or more statistics associated with a live content item in a playback user interface that is displaying the live content item in response when an input scrubbing backward through the live content item causes a current playback position to change within the live content item enables the user to consume additional information corresponding to the live content item based on the updated current playback position while concurrently viewing the live content item at the updated current playback position in the playback user interface, which preserves a context of the current playback position within the live content item, thereby improving user-device interaction.

In some embodiments, in response to detecting the second input, in accordance with a determination that the second input corresponds to a request to scrub forward in the live content item (e.g., forward relative to the current playback position within the live content item), such as scrubbing forward within the live content item as shown in FIG. 6O, updating the current playback position within the live content item in accordance with the second input includes updating the current playback position to correspond to a first playback position within the live content item that is a future playback position relative to the current playback position when the second input was received, such as the forward playback position indicated by the updated location of the scrubber bar 608 within the content player bar 606 as shown in FIG. 6O. For example, in response to receiving the second input, the electronic device navigates forward in the live content item, such that the current playback position is a future playback position relative to the current playback position. In some embodiments, the electronic device initiates playback of the live content item from the first playback position in the playback user interface.

In some embodiments, the one or more second statistics associated with the live content item are associated with the future playback position within the live content item, such as the statistics included in the information 621a-621c in FIG. 6O. For example, the information included in the one or more second statistics is based on the first playback position within the live content item. In some embodiments, as similarly discussed above, the electronic device displays the one or more second statistics, or updates display of a portion of the one or more first statistics, in the playback user interface while concurrently displaying the live content item. For example, the one or more second statistics displayed in the playback user interface include a subset of the one or more first statistics displayed when the second input is received, such that the one or more second statistics optionally includes more information than that included in the one or more first statistics (e.g., because the first playback position within the live content item is a future playback position relative to the playback position on which the one or more first statistics are based). As an example, as similarly discussed above, if the live content item is a sports game (e.g., such as a baseball game) and the current playback position within the live content item when the second input is detected is before the live playback position within the live content item (e.g., at a time that is during the 2nd inning when the live playback position is during the 3rd inning), and the updated current playback position is forward in the live content item (e.g., at a time during the 2nd inning that is later than the current playback position when the second input is detected), the one or more second statistics are associated with the particular time at the future playback position (e.g., the electronic device displays game statistics such as total runs and hits, and/or player statistics such as hits, strikeouts, walks, and/or runs, for the particular time during the 2nd inning of the game). As such, the one or more second statistics optionally include the statistics associated with the previous current playback position and additional statistics based on the portion of the live content item that is between the previous current playback position and the updated current playback position (e.g., game statistics and/or player statistics between the previous time in the 2nd inning and the current time in the 2nd inning). Updating one or more statistics associated with a live content item in a playback user interface that is displaying the live content item in response when an input scrubbing forward through the live content item causes a current playback position to change within the live content item enables the user to consume additional information corresponding to the live content item based on the updated current playback position while concurrently viewing the live content item at the updated current playback position in the playback user interface, which preserves a context of the current playback position within the live content item, thereby improving user-device interaction.

In some embodiments, the one or more representations of one or more second live content items include a first subset of the one or more second live content items that are currently available for playback in the playback user interface, such as Item A, Item B, and Item C in FIG. 6S, wherein selection of a respective representation of a respective live content item in the first subset of the one or more second live content items initiates playback of the respective live content item in the playback user interface, such as display of Item B in the playback user interface after selection of representation 623-2 in FIG. 6T. For example, in response to receiving a selection of the second selectable option in the playback user interface as described above, the electronic device displays the one or more representations of one or more second live content items that include the first subset of live content items that are currently available for playback. For example, if the electronic device receives a selection of a respective representation of a respective live content item in the first subset of the one or more second live content items, the electronic device ceases display of the live content item and displays the respective live content item in the playback user interface (e.g., at a current live playback position in the respective live content item). In some embodiments, the electronic device updates the first subset of the one or more second live content items in the playback user interface as additional/new live content items become available for playback on the electronic device. For example, the electronic device updates the first subset in the playback user interface to include additional representations of live content items as the live content items become available (e.g., based on a scheduled broadcast time).

In some embodiments, the one or more representations of one or more second live content items include a second subset of the one or more second live content items that will be available for playback in the future in the playback user interface, such as Item D and Item E in FIG. 6S. For example, the one or more representations of one or more second live content items include the second subset of live content items that are not currently available for playback on the electronic device, but will be available in the future (e.g., in 5, 10, 20, 30, or 45 minutes, or in 1, 2, 3, or 4 hours). In some embodiments, selection of a respective content item in the second subset of the one or more second live content items does not cause the electronic device to initiate playback of the respective content item (e.g., because the respective content item is not currently available). In some embodiments, selection of a respective live content item in the second subset of the one or more second live content items causes the electronic device to display one or more playback user interface objects (without initiating playback of the respective content item). For example, the electronic device displays a first option that is selectable to display additional information about the respective live content item (e.g., a location associated with the respective live content item, such as a stadium a sports game is going to be played at) and/or a second option that is selectable to add the respective live content item to a que of content items (e.g., a watchlist or Up Next que). In some embodiments, the second subset of the one or more second live content items are visually delineated from the first subset of the one or more second live content items in the playback user interface. For example, the one or more representations of the second live content items are displayed in a row below the content player bar, and the first subset is visually displayed separately from the second subset (e.g., are displayed with different visual appearances, such as in different colorations, shadings, highlighting, and/or sizes, and/or are visually separated by a boundary, such as a line or other visual element). In some embodiments, the first subset and/or the second subset of the one or more second live content items are included in the playback user interface because the first subset and/or the second subset of the one or more second live content items are available and/or will become available for playback from the same media provider of the live content item that is currently displayed in the playback user interface. For example, as similarly described above, because the user is entitled to view the live content item, the user is also entitled to view the one or more second live content items. In some embodiments, the first subset and/or the second subset of the one or more second live content items are included in the playback user interface because the first subset and/or the second subset of the one or more second live content items share one or more characteristics with the live content item. For example, the one or more second live content items are of a same genre (e.g., sports, action, comedy, horror, or drama), category (e.g., episodic content, movie content, musical content, and/or podcast content), and/or type (e.g., live content). In some embodiments, if a respective live content item in the second subset of the one or more second live content items becomes available for playback, the electronic device updates the one or more representations of the one or more second live content items such that a representation of the respective live content item is displayed with the first subset of the one or more second live content items (and is no longer displayed with the second subset of the one or more second live content items). Displaying one or more representations of one or more second live content items in a playback user interface that is displaying a live content item in response to receiving an input selecting a selectable option in the playback user interface facilitates discovery that additional live content items are available or will be available for playback in the playback user interface and/or reduces the number of inputs needed to initiate display of a different live content item in the playback user interface, thereby improving user-device interaction.

In some embodiments, the content player bar includes a respective playback time indication (e.g., real-world time indicator 609 in FIG. 6B) that is based on a time of day at the electronic device that the live content item was first available for playback in the playback user interface. For example, the respective playback time indication is based on the time of day that the live content item was first aired, streamed, and/or broadcast by a media provider of the live content item (e.g., a start time of the live content item). In some embodiments, the respective playback time indication is based on the time of day that the live content item was first available for playback irrespective of a time of day that the electronic device initiated playback of the live content item in the playback user interface (e.g., when the user of the electronic device began watching the live content item).

In some embodiments, the respective playback time indication is also based on the current playback position within the live content item, as indicated by scrubber bar 608 in FIG. 6B. For example, the respective playback time indication is also based on the current playback position within the live content item, which is not necessarily at the live edge within the live content item, as previously described above. In some embodiments, the current playback position is associated with a time of day at the electronic device. For example, the current live playback position within the live content item is associated with a current time of day at the electronic device (e.g., a current wall clock time). A current playback position that is not the live playback position within the live content item, such as a playback position in the past relative to the live playback position, is associated with a time of day at the electronic device that is between the time of day that the live content item was first available for playback and the current time of day at the electronic device. Accordingly, in some embodiments, the respective playback time indication is expressed as a respective time of day that is associated with the current playback position within the live content item relative to the time of day that the live content item was first available for playback at the electronic device (e.g., if the start time of the live content item is 3:10 PM, the respective time of day associated with the current playback position is later than 3:10 PM). Displaying a real-world time indicator that is based on a start time of a live content item and a current playback position within the live content item in a playback user interface provides a context for the current playback position relative to the start time of the live content item in terms of the time of day, which facilitates user understanding of the live content item in terms of the time of day, thereby improving user-device interaction.

In some embodiments, in response to detecting the second input, the electronic device updates the respective playback time indication in accordance with the updated current playback position within the live content item, such as updating the real-world time indicator 609 after scrubbing backward through the live content item as shown in FIG. 6C, wherein the updated respective playback time indication includes an updated time of day at the electronic device at which the playback of the live content item at the updated current playback position within the live content item was first available. For example, in response to receiving the input scrubbing through the live content item, the electronic device updates the respective playback time indication in accordance with the updated current playback position within the live content item. In some embodiments, the electronic device updates the respective time of day expressed by the updated respective playback time indication. For example, the electronic device updates the respective playback time indication to express (e.g., include and/or display) an updated time of day that is associated with the updated current playback position within the live content item relative to the time of day that the live content item was first available for playback at the electronic device. As an example, if the start time of the live content item is 3:10 PM, and the current time of day at the electronic device is 4:55 PM when the second input is received (e.g., which is associated with the live playback position), the updated respective playback time indication includes a label indicating that the updated current playback position was first available at 4:10 PM (e.g., if the input corresponds to a request to scrub backward within the live content item). Updating a real-world time indicator that is based on a start time of a live content item and a current playback position within the live content item in a playback user interface in response to an input scrubbing through the live content item that causes the current playback position to change provides an updated context for the updated current playback position relative to the start time of the live content item in terms of the time of day, which facilitates user understanding of the live content item in terms of the time of day, thereby improving user-device interaction.

In some embodiments, in response to detecting the second input, the electronic device displays, via the display generation component, a selectable option with the content player bar in the playback user interface (e.g., selectable option 620 in FIG. 6C), wherein the selectable option is selectable to move the current playback position to a live playback position within the live content item, wherein the selectable option was not displayed when the first visual indicator was displayed in the first visual state. For example, in response to receiving the input scrubbing through the live content item in the playback user interface, the electronic device displays a selectable option above the content player bar in the playback user interface that is selectable to move the current playback position to the live playback position within the live content item. As described previously above, the second input optionally corresponds to a request to navigate backward in the live content item, which causes the electronic device to move the current playback position away from the live edge within the live content item. In some embodiments, to avoid requiring the user to provide input scrubbing forward in the live content item all the way to the live edge, the electronic device displays the selectable option that is selectable to return the current playback position to the live edge, irrespective of how much time has elapsed since scrubbing backward in the live content item. In some embodiments, the selectable option is displayed in the playback user interface when the first visual indicator is displayed in the second visual state (e.g., because the current playback position is no longer the live playback position within the content). In some embodiments, the selectable option is not displayed before the electronic device detects the second input (e.g., because the current playback position is at the live playback position within the content). Displaying a selectable option that is selectable to move a current playback position within a live content item to a live playback position within the live content item in a playback user interface in response to an input scrubbing through the live content item that causes the current playback position to deviate from the live playback position reduces the number of inputs needed to return to the live playback position within the live content item and/or facilitates discovery that the scrubbing input has caused the current playback position to no longer be at the live playback position within the live content item, thereby improving user-device interaction.

In some embodiments, while displaying the content player bar with the selectable option in the playback user interface, the electronic device receives, via the one or more input devices, a third input corresponding to selection of the selectable option, such as input provided by contact 603d directed to the selectable option 620 as shown in FIG. 6D. In some embodiments, in response to receiving the third input, the electronic device updates the current playback position to the live playback position within the live content item, as similarly shown in FIG. 6E. For example, as described above, in response to receiving selection of the selectable option, the electronic device returns the current playback position to the live edge within the live content item in the playback user interface. In some embodiments, the electronic device moves the visual indication of the current playback position within the content player bar in response to receiving the third input. For example, the electronic device moves the visual indication of the current playback position to the live playback position within the content player bar, which is optionally located farther in the content player bar than when the second input was received (e.g., because the live playback position optionally advanced since the second input was received). Moving a current playback position within a live content item back to a live playback position within the live content item in a playback user interface in response to selection of a selectable option in the playback user interface reduces the number of inputs needed to return to the live playback position within the live content item, thereby improving user-device interaction.

In some embodiments, while displaying the content player bar that includes the selectable option in the playback user interface, the electronic device receives, via the one or more input devices, a third input corresponding to a request to scrub through the live content item, such as an input provided by contact 603d selecting the selectable option 620 as shown in FIG. 6D. For example, as similarly described above, the electronic device receives an input to navigate forward or backward relative to the current playback position within the live content item. In some embodiments, the third input has one or more characteristics of the second input described above.

In some embodiments, in response to receiving the third input, the electronic device updates the current playback position within the live content item in accordance with the third input (e.g., moving the current playback position within the live content item in accordance with the scrubbing input), as similarly shown in FIG. 6E, including, in accordance with a determination that the updated current playback position corresponds to the live playback position within the live content item, ceasing display of the selectable option in the playback user interface, such as ceasing display of the selectable option 620 as shown in FIG. 6E. For example, the current playback position when the third input is received is a past playback position relative to the live playback position. In some embodiments, the third input causes the current playback position to move up to the live edge within the live content item. In some embodiments, if the scrubbing through the live content item causes the updated current playback position to reach the live edge within the live content item, the electronic device ceases display of the selectable option in the playback user interface. For example, the selectable option is no longer available and selectable in the playback user interface to cause the electronic device to move the current playback position to the live playback position within the live content item (e.g., because the updated current playback position is already at the live edge). In some embodiments, the electronic device displays a visual indication that indicates the updated current playback position has reached the live playback position within the live content item. For example, when the electronic device ceases display of the selectable option in response to the third input, the electronic device displays a notification, a badge, or an icon that includes text indicating that the user is viewing the content at the live edge within the live content item (e.g., “You're all caught up”).

In some embodiments, in accordance with a determination that the updated current playback position does not correspond to the live playback position within the live content item, the electronic device maintains display of the selectable option in the playback user interface, such as maintaining display of the selectable option 620 after scrubbing forward in the live content item as shown in FIG. 6O. For example, the current playback position when the third input is received is a past playback position relative to the live playback position. In some embodiments, the third input causes the current playback position to navigate forward from the past playback position relative to the live playback position, but does not cause the current playback position to move up to the live edge within the live content item. Alternatively, in some embodiments, the third input causes the current playback position to move farther backward relative to the live playback position within the live content item. In some embodiments, if the scrubbing through the live content item does not cause the updated current playback position to reach the live edge within the live content item, the electronic device maintains display of the selectable option in the playback user interface. For example, as similarly described above, the selectable option is still available and selectable in the playback user interface to cause the electronic device to move the current playback position to the live playback position within the live content item (e.g., because the updated current playback position is not at the live edge). Ceasing display of a selectable option that is selectable to move a current playback position within a live content item to a live playback position within the live content item in a playback user interface in response to an input scrubbing through the live content item that causes the current playback position to correspond to the live playback position enables the selectable option, which no longer serves a purpose after the input, to cease being displayed automatically and/or facilitates discovery that the scrubbing input has caused the current playback position to be at the live playback position within the live content item, thereby improving user-device interaction.

In some embodiments, displaying the content player bar in the playback user interface includes displaying a first set of playback controls (e.g., within the content player bar or separate from the content player bar, such as above or below the content player bar in the playback user interface), including a first navigation option (e.g., first navigation affordance 615-1 in FIG. 6G) that is selectable to scrub backward in the live content (e.g., a backward option, such as a leftward arrow/affordance) by a predefined amount of time (e.g., 1, 3, 5, 10, 15, 20, 25, 30, 45, or 60 seconds). In some embodiments, in response to receiving the first input, such as contact 603f on touch screen 504 of electronic device 500 in FIG. 6F, the electronic device displays, via the display generation component, the first navigation option that is selectable to scrub backward in the live content by the predefined amount of time in the playback user interface, such as displaying the first navigation affordance 615-1 with the content player bar 606 as shown in FIG. 6G. For example, when the electronic device displays the content player bar and the first visual indication in the playback user interface in response to receiving the first input, the electronic device concurrently displays the first navigation option with the content player bar and the first visual indication in the playback user interface. In some embodiments, the first navigation option is repeatedly selectable to cause the electronic device to scrub backward in the live content item (e.g., rewind the live content item) by the predefined amount. For example, if the predefined amount is 20 seconds, selecting the first navigation option three times causes the electronic device to rewind the live content item by 20 seconds each of the three times the first navigation option is selected.

In some embodiments, the electronic device displays a second navigation option (e.g., a forward option, such as a rightward arrow/affordance) for scrubbing forward in the live content item (e.g., second navigation affordance 615-2 in FIG. 6G) by the predefined amount of time (e.g., 1, 3, 5, 10, 15, 20, 25, 30, 45, or 60 seconds) in the playback user interface, wherein the second navigation option is deactivated, as similarly shown in FIG. 6G. For example, the second navigation option is displayed adjacent to the first navigation option in the playback user interface in response to receiving the first input. In some embodiments, the second navigation option is deactivated. For example, the second navigation option is not selectable to cause the electronic device to scrub forward in the live content item by the predefined amount of time. As previously described above, when the electronic device receives the first input, the current playback position within the live content item is optionally at the live playback position within the live content item. In some embodiments, as described previously above, because the current playback position within the live content item is at the live playback position, the electronic device forgoes scrubbing forward in the live content item because portions of the live content item beyond (e.g., ahead of) the live edge are not yet available from the media provider of the live content item (e.g., have not yet been live broadcast by the media provider). Accordingly, the electronic device optionally deactivates the second navigation option to indicate that the second navigation option cannot be selected to scrub forward in the live content item while the current playback position is at the live edge. In some embodiments, the electronic device visually deemphasizes the second navigation option relative to the playback user interface to indicate that the second navigation option is deactivated. For example, the electronic device shades, dims, discolors, and/or decreases a size of the second navigation option. Deactivating a forward navigation option that is selectable to move a current playback position forward within a live content item by a predefined amount in a playback user interface when the current playback position is at a live playback position within the live content item facilitates discovery that the current playback position cannot be scrubbed past the live playback position within the live content item, thereby improving user-device interaction.

In some embodiments, in response to receiving the second input, such as input provided by contact 603h scrubbing through the live content item in FIG. 6H, the electronic device displays, via the display generation component, the first navigation option and the second navigation option in the playback user interface, such as display of the first navigation affordance 615-1 and the second navigation affordance 615-2 as shown in FIG. 6I, wherein the second navigation option is activated and selectable to scrub forward in the live content item by the predefined amount of time (e.g., 1, 3, 5, 10, 15, 20, 25, 30, 45, or 60 seconds), as similarly described with reference to FIG. 6I. For example, in response to receiving the input scrubbing through the live content item, the electronic device activates the second navigation option in the playback user interface. For example, as described above, the current playback position is at the live playback position within the live content item when the first input is received, and the electronic device does not scrub beyond the live playback position in the live content item. Accordingly, the second input optionally corresponds to a request to scrub backward in the live content item. In some embodiments, scrubbing backward in the live content item moves the current playback position to a past playback position relative to the current live playback position in the live content item. Accordingly, the updated current playback position after the second input is able to be scrubbed forward in the live content item, which causes the electronic device to activate the second navigation option. In some embodiments, while the second navigation option is active, the second navigation option is selectable to cause the electronic device to scrub forward in the live content item by the predefined amount, as similarly described above. In some embodiments, activating the second navigation option includes displaying the second navigation option with a same or similar visual appearance as the first navigation option discussed above to indicate that the second navigation option is active and selectable in the playback user interface. Activating a forward navigation option that is selectable to move a current playback position forward within a live content item by a predefined amount in a playback user interface in response to an input scrubbing through the live content item that causes the current playback position to no longer be at a live playback position within the live content item facilitates discovery that the current playback position is no longer at the live playback position within the live content item and/or reduces the number of inputs needed to scrub through the live content item, thereby improving user-device interaction.

In some embodiments, the content player bar includes a selectable option (e.g., selectable option 626 in FIG. 6V) that is selectable to display one or more viewing options for the live content item in the playback user interface (e.g., such as a full-screen viewing option, a picture-in-picture (PiP) viewing option, and/or a multi-view viewing option). In some embodiments, while displaying the content player bar that includes the selectable option, the electronic device receives, via the one or more input devices, a sequence of one or more inputs corresponding to selection of a first viewing option of the one or more viewing options for the live content item, such as input provided by contact 603w selecting the selectable option 626 and input provided by contact 603x selecting Multiview viewing option as shown in FIG. 6X. For example, while the content player bar is displayed in the playback user interface, the electronic device receives a selection (e.g., a press, tap, or click input) directed to the selectable option in the playback user interface. In some embodiments, in response to receiving the selection of the selectable option, the electronic device displays the one or more viewing options for the live content item in the playback user interface. For example, the one or more viewing options are displayed above or overlaid on the scrubber in the playback user interface. In some embodiments, the one or more viewing options are displayed in a menu in the playback user interface. In some embodiments, while displaying the one or more viewing options, the electronic device receives a (e.g., second) selection input (e.g., a press, tap, or click input) directed to a first viewing option of the one or more viewing options. In some embodiments, the first viewing option corresponds to the multi-view viewing option for the live content item.

In some embodiments, in response to receiving the third input, the electronic device ceases display of the playback user interface, as similarly shown in FIG. 6Y. For example, the electronic device ceases display of the playback user interface that is displaying the live content item, as similarly described above.

In some embodiments, the electronic device displays, via the display generation component, a respective user interface corresponding to the first viewing option, such as Multivew user interface 632 in FIG. 6Y, wherein the respective user interface is configurable to include a plurality of live content items, and displaying the respective user interface includes displaying the live content item in a playback region of the respective user interface, such as display of Live Content A in playback region 634 as shown in FIG. 6Y. For example, in response to receiving the selection of the multi-view viewing option of the one or more viewing options in the playback user interface, the electronic device displays a respective user interface corresponding to the multi-view viewing option (e.g., a multi-view user interface). In some embodiments, as described below, the respective user interface is configurable to include a plurality of live content items. For example, while the multi-view user interface is displayed, a plurality of live content items is able to be concurrently displayed in the playback region of the respective user interface. In some embodiments, when the electronic device displays the respective user interface, the electronic device displays the live content item in the playback region and resumes playback from the current live playback position within the live content item. In some embodiments, the live content item is displayed in a first viewing window within the playback region in the respective user interface. Displaying a live content item in a multi-view user interface in response to receiving a selection of a first viewing option of one or more viewing options for the live content item in a playback user interface that is displaying the live content item reduces the number of inputs needed to concurrently display the live content item with other content items in the multi-view user interface and/or facilitates discovery that the live content item is able to be concurrently viewed in the multi-view user interface with other content items, thereby improving user-device interaction.

In some embodiments, the respective user interface corresponding to the first viewing option includes one or more user interface objects corresponding to one or more respective content items, such as representations 636-1 to 636-5 of content items that are available for playback as shown in FIG. 6Y. For example, the multi-view user interface includes one or more user interface objects corresponding to one or more respective content items that are currently available for playback. In some embodiments, the one or more respective content items include live content items (e.g., live-broadcast content items, similar to the live content item). In some embodiments, the one or more respective content items include on-demand content items. In some embodiments, the one or more respective content items are available from the same media provider of the live content item (e.g., the user of the electronic device is entitled to watch the one or more respective content items, as similarly discussed above). In some embodiments, the one or more respective content items share one or more characteristics with the live content item. For example, the one or more respective content items are of a same genre (e.g., sports, action, comedy, horror, or drama), category (e.g., episodic content, movie content, musical content, and/or podcast content), and/or type (e.g., live content or on-demand content). In some embodiments, the one or more user interface objects are displayed in a row below the live content item in the playback region of the respective user interface.

In some embodiments, selection of a first user interface object of the one or more user interface objects that corresponds to a first content item of the one or more respective content items initiates playback of the first content item in the playback region of the respective user interface concurrently with the live content item in the playback region of the respective user interface, such as concurrent display of Item A with Live Content A in the playback region 634 after selection of representation 636-1 as shown in FIG. 6AA. For example, in response to receiving a selection of a first user interface object of the one or more user interface objects, the electronic device displays a first content item corresponding to the first user interface object in the playback region of the respective user interface concurrently with the live content item. In some embodiments, the live content item and the first content item are displayed adjacently in the playback region of the playback user interface. In some embodiments, the live content item is displayed in a primary view in the playback region. For example, the first viewing window that includes the live content item is displayed at a larger size than a second viewing window that includes the first content item in the playback region of the multi-view user interface. In some embodiments, as described below, a current focus is able to be moved between the first viewing window and the second viewing window to change the content item that is displayed in the primary view (e.g., at the larger size between the two). Displaying one or more user interface objects corresponding to one or more content items in a multi-view user interface, which is displaying a live content item, that are selectable to concurrently display the one or more content items with the live content item in the multi-view user interface reduces the number of inputs needed to concurrently display the live content item with other content items in the multi-view user interface and/or facilitates discovery that the live content item is able to be concurrently viewed in the multi-view user interface with other content items, thereby improving user-device interaction.

In some embodiments, the live content item has a current focus in the playback region in the respective user interface (e.g., as described above, the viewing window in which the live content item is displayed at a larger size than the one or more user interface objects in the multi-view user interface). In some embodiments, while displaying the respective user interface that includes the live content item and the one or more user interface objects corresponding to the one or more respective content items, the electronic device receives, via the one or more input devices, a request to move the focus from the live content item to the first user interface object corresponding to the first content item, such as input provided by contact 603y as shown in FIG. 6Y. For example, while the multi-view user interface is displayed, the electronic device receives an input moving the focus from the live content item to the first user interface object corresponding to the first content item in the multi-view user interface. In some embodiments, the input includes a downward swipe gesture detected via a touch-sensitive surface of the one or more input devices. In some embodiments, the input includes a press of a navigation option (e.g., a downward navigation button) of a remote input device in communication with the electronic device. In some embodiments, the input includes tap directed to the first user interface object detected via a touch screen of the electronic device.

In some embodiments, in response to receiving the request, the electronic device moves the current focus from the live content item in the playback region to the first user interface object, such as moving the current focus to the representation 636-1 as shown in FIG. 6Z. For example, the electronic device displays the first user interface object corresponding to the first content item with the current focus. In some embodiments, the electronic device displays the first user interface object with an indication of focus. For example, the first user interface object is displayed with visual emphasis relative to the other user interface objects in the one or more user interface objects (e.g., with bolding, highlighting, sparkling, and/or with a larger size). In some embodiments, the electronic device displays a visual element (e.g., a visual band) around the first user interface object in the respective user interface.

In some embodiments, the electronic device updates display, via the display generation component, of the playback region to concurrently include a placeholder indication of the first content item and the live content item, such as concurrently displaying visual indication 638a with the live content item in the playback region 634 as shown in FIG. 6Z. For example, the electronic device displays a placeholder indication of the first content item with the live content item in the playback region of the respective user interface. In some embodiments, the placeholder indication of the first content item indicates that the first content item will be concurrently displayed with the live content item in the playback region in response to further input (e.g., a selection of the first user interface object while the first user interface object has the current focus). For example, the first content item is displayed at a location of the placeholder indication in the playback region with respect to the live content item (e.g., adjacent to the live content item) in response to the further input. In some embodiments, displaying the placeholder indication of the first content item in the playback region includes reconfiguring, rearranging, and/or resizing the existing content items displayed in the playback region. For example, the electronic device reduces the size of the first viewing window in which the live content item is displayed when the placeholder indication of the first content item is displayed in the playback region. Additionally, the electronic device optionally changes the location at which the viewing window of the live content item is displayed in the playback region. For example, the electronic device shifts the live content item within the playback region when displaying the placeholder indication, such that the live content item is no longer centrally displayed within the playback region as previously discussed above. In some embodiments, the first viewing window in which the live content item is displayed is larger than the placeholder indication of the first content item, but smaller than before the focus was moved to the first user interface object in the respective user interface. In some embodiments, the first viewing window in which the live content item is displayed is the same size as the placeholder indication of the first content item in the respective user interface. In some embodiments, the size of the placeholder indication is the same as the size at which the first content item will be displayed in the playback region in response to further input (e.g., a selection of the first user interface object, as similarly discussed above). In some embodiments, because the playback region includes the placeholder indication after receiving the request, the arrangement and/or configuration of the content items included in the playback region of the respective user interface is different from that of the content items before the request is detected.

In some embodiments, while the first user interface object has the current focus, the first user interface object is selectable to concurrently display the live content item and the first content item in the playback region in the respective user interface (e.g., as described above), such as concurrently displaying Item A with the live content item in the playback region 6334 as shown in FIG. 6AA in response to a selection of representation 636-1 as shown in FIG. 6Z. In some embodiments, if the current focus is moved away from the first user interface object (e.g., back to the live content item in the playback region), the electronic device ceases display of the placeholder indication of the first content item in the playback region of the respective user interface. In some embodiments, if the current focus is moved away from the first user interface object to a second user interface object corresponding to a second content item, the electronic device replaces display of the placeholder indication of the first content item in the playback region with a placeholder indication of the second content item in the playback region, wherein the placeholder indication of the second content item and the live content item are concurrently displayed in the playback region of the respective user interface. Displaying a placeholder indication of a respective content item with a live content item in a multi-view user interface in response to an input moving a current focus from the live content item to a user interface object corresponding to the respective content item reduces facilitates discovery that a selection of the user interface object will cause the respective content item to be concurrently displayed with the live content item in the multi-view user interface and/or helps avoid unintentional display of the respective content item with the live content item in the multi-view user interface, thereby improving user-device interaction.

In some embodiments, while displaying the respective user interface that includes the live content item and the one or more user interface objects corresponding to the one or more respective content items, the electronic device receives, via the one or more input devices, a sequence of one or more inputs corresponding to selection of one or more content items of the one or more respective content items for playback, such as inputs selecting representations 636-1 and 636-2 as described with reference to FIG. 6Z and FIG. 6BB. For example, while displaying the multi-view user interface that includes the live content item in the playback region, the electronic device receives selection of one or more of the user interface objects corresponding to the one or more respective content items. As an example, the electronic device receives a selection of a first user interface object corresponding to a first content item, followed by a selection of a second user interface object corresponding to a second content item in the respective user interface. In some embodiments, as similarly described above, the electronic device receives the sequence of one or more inputs on a touch-sensitive surface of the one or more input devices, via a hardware button of a remote input device in communication with the electronic device, or on a touch screen of the electronic device.

In some embodiments, in response to receiving the sequence of one or more inputs, the electronic device updates display, via the display generation component, of the respective user interface to concurrently display the live content item and the one or more content items selected for playback in the playback region of the respective user interface, such as concurrently displaying the live content item, Item A and Item B in the playback region 634 as shown in FIG. 6CC. For example, in response to receiving the selection of the one or more of the user interface objects corresponding to the one or more respective content items, the electronic device initiates playback of the selected respective content items in the multi-view user interface. Following the example above, the electronic device optionally replaces display of the placeholder indication of the first content item with the first content item in a second viewing window and replaces display of a second placeholder indication of the second content item with the second content item in a third viewing window in the playback region of the respective user interface, while concurrently displaying the live content item in the first viewing window in the playback region. In some embodiments, the electronic device enables the user to select a predefined number (e.g., 3, 4, 5, 6, 8, or 10) of content items for playback in the playback in the playback region of the respective user interface. In some embodiments, the electronic device initiates playback of the one or more content items selected for playback at a current live playback position within the one or more content items. In some embodiments, as described in more detail below, the live content item and the one or more content items selected for playback are arranged in a predetermined viewing arrangement within the playback region of the respective user interface. In some embodiments, the electronic device maintains display of the one or more user interface objects (e.g., corresponding to the respective content items that were not selected for playback) in the respective user interface while concurrently displaying the live content item and the one or more content items selected for playback in the playback region. Concurrently displaying one or more content items with a live content item in a multi-view user interface in response to one or more inputs selecting the one or more content items for playback enables the user to concurrently view multiple content items and/or reduces the number of inputs needed to concurrently display the live content item with other content items in the multi-view user interface, thereby improving user-device interaction.

In some embodiments, updating display of the respective user interface to concurrently include the live content item and the one or more content items includes displaying the live content item and the one or more content items selected for playback in a predefined arrangement in the respective user interface, as similarly described with reference to FIG. 6CC, wherein the live content (Live Content A in FIG. 6CC) is displayed at a first predefined location in the respective user interface and a first content item (Item A in FIG. 6CC) of the one or more content items is displayed at a second predefined location, adjacent to the first predefined location, in the respective user interface, as similarly shown in FIG. 6CC. For example, as mentioned above, the electronic device displays the live content item and the one or more content items selected for playback in a predetermined viewing arrangement in the playback region of the multi-view user interface. In some embodiments, the predetermined viewing arrangement is a grid arrangement in the playback region of the respective user interface. For example, the electronic device displays the live content item at a first predefined location in the playback region and displays a first content item of the one or more content items at a second predefined location in the playback region. If the one or more content items selected for playback includes a second content item, the electronic device optionally displays the second content item at a third predefined location in the playback region, wherein the third predefined location is below the first predefined location and the second predefined location, and optionally centrally located relative to the first predefined location and the second predefined location, in the grid arrangement. Additionally, in the gird arrangement, the live content item and the first content item are optionally displayed at a same size at their respective locations in the playback region of the multi-view user interface. In some embodiments, the predefined viewing arrangement is a thumbnail layout in the playback region of the respective user interface. For example, the electronic device displays the live content item at a first predefined location in the playback region and displays the one or more content items selected for playback in a column adjacent to (e.g., to the right of) the first predefined location (e.g., such that the second predefined location is to the right of the first predefined location, and, optionally, a third predefined location (at which a second content item is displayed) is below the second predefined location (in a column)). Additionally, in the thumbnail arrangement, the live content item displayed at the first predefined location is optionally displayed at a first size, and the first content item displayed at the second predefined location is optionally displayed at a second size, smaller than the first size. In some embodiments, the respective user interface includes one or more selectable options for changing the predefined arrangement in the respective user interface. For example, at a top portion of the playback region, the electronic device displays a first selectable option corresponding to the grid arrangement discussed above and a second selectable option corresponding to the thumbnail arrangement discussed above (e.g., which are selectable to cause the electronic device to change the predefined arrangement accordingly). In some embodiments, the locations at which and/or the predefined viewing arrangement in which the content items are displayed in the playback region of the respective user interface are based on an order in which the content items are selected for playback. For example, because the live content item was being played back when the multi-view user interface was first displayed, the live content item is displayed at the first predefined location in the playback region of the multi-view user interface. Further, the first content item was optionally selected first among the one or more content items selected for playback, and is thus displayed at the second predefined location, adjacent to the first predefined location, in the playback region. In some embodiments, the locations at which and/or the predefined viewing arrangement in which the content items are displayed in the playback region of the respective user interface are based on a size of the playback region, which is optionally dependent on the display generation component via which the respective user interface is displayed. For example, the playback region of the respective user interface that is displayed via a touch screen of a mobile device is much smaller than the playback region of the respective user interface that is displayed via a television screen. Accordingly, the sizes at which the content items are played back in the playback region of the multi-view user interface and/or the number of content items that are (e.g., horizontally) across a given portion of the playback region optionally changes based on the size of the playback region. Concurrently displaying one or more content items with a live content item in predetermined viewing arrangement in a multi-view user interface in response to one or more inputs selecting the one or more content items for playback enables the user to concurrently view multiple content items and/or reduces the number of inputs needed to concurrently display the live content item with other content items in the multi-view user interface, thereby improving user-device interaction.

In some embodiments, while displaying the respective user interface that includes the live content item and the one or more content items selected for playback, such as Live Content A, Item A, and Item B in FIG. 6EE, in accordance with a determination that the live content item has focus in the respective user interface, as similarly shown in FIG. 6EE, the electronic device outputs audio corresponding to the live content item without outputting audio corresponding to a first content item of the one or more content items selected for playback, as similarly described with reference to FIG. 6EE. For example, after displaying the one or more content items selected for playback with the live content item in the playback region of the multi-view user interface, the electronic device determines that the live content item has the current focus in the respective user interface. In some embodiments, the live content item has the current focus because the focus was moved to the live content item after selecting the one or more content items for playback in the playback region (e.g., the electronic device received an input moving the current focus to the live content item, such as a swipe gesture detected via a touch-sensitive surface of the one or more input device or a press of a navigation button of a remote input device in communication with the electronic device). In some embodiments, while the live content item has the current focus in the respective user interface, the electronic device outputs audio corresponding to the live content item without outputting audio corresponding to the one or more content items selected for playback in the playback region. For example, the audio corresponding to the live content is the audio broadcast live from the media provider of the live content item. In some embodiments, the electronic device displays an audio indication in the respective user interface to indicate that the audio being output from the electronic device corresponds to the live content item. For example, the electronic device displays the audio indication overlaid on a portion of the viewing window in which the live content item is displayed or next to the viewing window in the playback region of the respective user interface. In some embodiments, the electronic device continues to play back the one or more content items in the playback region while the live content has the current focus. In some embodiments, while the live content item has the current focus in the respective user interface, the electronic device displays the live content item at a larger size than the one or more content items selected for playback (e.g., while maintaining the predetermined viewing arrangement described above).

In some embodiments, in accordance with a determination that the first content item has the focus in the respective user interface, the electronic device outputs the audio corresponding to the first content item without outputting audio corresponding to the live content item, as similarly described with reference to FIG. 6EE. For example, after displaying the one or more content items selected for playback with the live content item in the playback region of the multi-view user interface, the electronic device determines that the first content item has the current focus in the respective user interface. In some embodiments, the first content item has the current focus because the focus was moved to the first content item after selecting the one or more content items for playback in the playback region (e.g., the electronic device received an input moving the current focus to the first content item, such as a swipe gesture detected via a touch-sensitive surface of the one or more input device or a press of a navigation button of a remote input device in communication with the electronic device). In some embodiments, while the first content item has the current focus in the respective user interface, the electronic device outputs audio corresponding to the first content item without outputting audio corresponding to the live content item and others of the one or more content items selected for playback in the playback region. For example, the audio corresponding to the first content is the audio streamed (e.g., and/or broadcast live) from a media provider of the first content item. In some embodiments, as similarly described above, the electronic device displays an audio indication in the respective user interface to indicate that the audio being output from the electronic device corresponds to the first content item. In some embodiments, the electronic device continues to play back the live content item and the others of the one or more content items in the playback region while the first content has the current focus. In some embodiments, as similarly described above, while the first content item has the current focus in the respective user interface, the electronic device displays the first content item at a larger size than the live content item and the others of the one or more content items selected for playback (e.g., while maintaining the predetermined viewing arrangement described above). In some embodiments, if the user of the electronic device moves the current focus to another content item in the playback region (e.g., the live content item or a second content item), the electronic device outputs audio corresponding to the other content item (and ceases outputting audio corresponding to the first content item). Outputting audio corresponding to a respective content item of a plurality of content items concurrently displayed in a multi-view user interface when the respective content item has a current focus in the multi-view user interface helps avoid concurrent output of audio corresponding to the plurality of content items, which could be distracting and/or unpleasant for the user, while continuing to concurrently view multiple content items and/or reduces the number of inputs needed to output audio corresponding to a second respective content item of the plurality of content items concurrently displayed in the multi-view user interface, thereby improving user-device interaction.

In some embodiments, while displaying the respective user interface that includes the live content item and the one or more content items selected for playback, the electronic device receives, via the one or more input devices, a respective input corresponding to selection of a respective content item in the respective user interface, such as selection of Live Content A provided by contact 603ff as shown in FIG. 6FF. For example, as similarly described above, the electronic device receives a selection input directed to a respective content item displayed in the playback user interface of the respective user interface. In some embodiments, as previously described above, the respective input includes a tap gesture detected via a touch-sensitive surface of the one or more input devices, a click or press of a remote input device in communication with the electronic device, or a tap directed to the respective content item detected via a touch screen of the electronic device. In some embodiments, the respective content item has a current focus in the respective user interface, as similarly discussed above, when the respective input is received.

In some embodiments, in response to receiving the respective input, in accordance with a determination that the respective content item is the live content item (e.g., the selection input is directed to the live content item), the electronic device ceases display of the respective user interface, as similarly shown in FIG. 6GG. For example, the electronic device ceases display of the respective user interface that includes the live content item and the one or more content items selected for playback.

In some embodiments, the electronic device initiates playback of the live content item in the playback user interface, such as displaying the live content item in the playback user interface 602 as shown in FIG. 6GG. For example, the electronic device displays the live content item in the playback user interface described previously above. In some embodiments, the electronic device initiates playback of the live content item at the current playback position within the live content item when the respective input was received (e.g., which is optionally the current live playback position). In some embodiments the electronic device forgoes displaying the one or more content items selected for playback in the playback user interface while displaying the live content item in the playback user interface. In some embodiments, while the live content item is displayed in the playback user interface, if the electronic device receives an input corresponding to a request to redisplay the respective user interface (e.g., the multi-view user interface), the electronic device ceases display of the playback user interface and redisplays the respective user interface that includes the live content item and the one or more content items selected for playback in the playback region of the respective user interface. For example, in response to receiving selection of a back button/option, the electronic device redisplays the live content item and the one or more content items available for playback in the predetermined viewing arrangement described above in the playback region, wherein the live content item has the current focus (e.g., is displayed at a larger size than the other content items in the playback region and the electronic device is outputting audio corresponding to the live content item).

In some embodiments, in accordance with a determination that the respective content item is a first content item of the one or more content items (e.g., the selection input is directed to the first content item), the electronic device ceases display of the respective user interface (e.g., as previously described above). In some embodiments, the electronic device initiates playback of the first content item in the playback user interface, as similarly described with reference to FIG. 6FF. For example, the electronic device displays the first content item in the playback user interface described previously above. In some embodiments, the electronic device initiates playback of the first content item at the current playback position within the first content item when the respective input was received (e.g., which is optionally the current live playback position within the first content item if the first content item is a live content item). In some embodiments the electronic device forgoes displaying the live content item and others of the one or more content items selected for playback in the playback user interface while displaying the first content item in the playback user interface. In some embodiments, while the first content item is displayed in the playback user interface, if the electronic device receives an input corresponding to a request to redisplay the respective user interface (e.g., the multi-view user interface), the electronic device ceases display of the playback user interface and redisplays the respective user interface that includes the live content item and the one or more content items selected for playback in the playback region of the respective user interface, as similarly described above. For example, in response to receiving selection of a back button/option, the electronic device redisplays the live content item and the one or more content items available for playback in the predetermined viewing arrangement described above in the playback region, wherein the first content item has the current focus (e.g., is displayed at a larger size than the other content items in the playback region and the electronic device is outputting audio corresponding to the first content item). Displaying a respective content item of a plurality of content items concurrently displayed in a multi-view user interface in full screen in a playback user interface in response to receiving an input selecting the respective content item in the multi-view user interface enables the user to view the respective content item in full screen in the playback user interface, while maintaining a context of the plurality of content items previously concurrently displayed in the multi-view user interface, and/or reduces the number of inputs needed to display the respective content item in the playback user interface, thereby improving user-device interaction.

In some embodiments, while displaying the respective user interface that includes the live content item and the one or more content items selected for playback, the electronic device receives, via the one or more input devices, a respective input corresponding to a request to navigate away from the respective user interface, such as input provided by contact 603ii as shown in FIG. 6II. For example, while concurrently displaying the live content item and the one or more content items selected for playback in the playback region of the multi-view user interface, the electronic device receives an input navigating backward. In some embodiments, the respective input includes selection of a back or exit option displayed in the respective user interface (e.g., detected via a touch-sensitive surface of the one or more input devices). In some embodiments, the respective input includes press of a back or home button of a remote input device in communication with the electronic device. In some embodiments, the live content item has the current focus in the respective user interface when the respective input is received.

In some embodiments, in response to receiving the respective input, the electronic device ceases display of the respective user interface, as similarly shown in FIG. 6JJ. For example, the electronic device ceases display of the respective user interface that includes the live content item and the one or more content items selected for playback.

In some embodiments, the electronic device displays, via the display generation component, the live content item in the playback user interface at a live playback position within the live content item, such as display of the live content item in the playback user interface at the live playback position as shown in FIG. 6JJ. For example, the electronic device displays the live content item in the playback user interface described previously above. In some embodiments, the electronic device displays the live content item in the playback user interface (as opposed to a first content item of the one or more content items selected for playback) because the live content had the current focus in the respective user interface when the respective input above was received. In some embodiments, the electronic device displays the live content item in the playback user interface because the live content item was displayed in the live content item when the input that first caused display of the respective user interface (e.g., as described above) was received. In some embodiments, the electronic device initiates playback of the live content item at the current live playback position within the live content item (e.g., an up-to-date playback position based on data broadcast from the media provider of the live content item), as similarly described above. In some embodiments the electronic device forgoes displaying the one or more content items selected for playback in the playback user interface while displaying the live content item in the playback user interface. In some embodiments, exiting the respective user interface causes the electronic device to lose a context of the display of the one or more content items selected for playback. For example, if the user provides input for redisplaying the multi-view user interface (e.g., in the manner described above), the electronic device forgoes displaying the one or more content items that were selected for playback in the predetermined viewing arrangement in the playback region before the respective input above was received. In some embodiments, exiting the respective user interface does not cause the electronic to lose the context of the display of the one or more content items selected for playback. For example, if the user provides input for redisplaying the multi-view user interface, the electronic device redisplays the live content item concurrently with the one or more content items that were selected for playback in the predetermined viewing arrangement in the playback region before the respective input above was received. Displaying a live content item of a plurality of content items concurrently displayed in a multi-view user interface in a playback user interface in response to receiving an input navigating away from the multi-view user interface reduces the number of inputs needed to display the live content item at a current live playback position within the live content in the playback user interface, thereby improving user-device interaction.

In some embodiments, in response to receiving the first input, the electronic device displays a selectable option that is selectable to display one or more representations of one or more second live content items, such as selectable option 614 in FIG. 6Q, wherein the selectable option is displayed in a predefined region relative to the content player bar in the playback user interface. For example, as previously described above, the selectable option is selectable to display one or more representations of one or more second live content items that are currently available for playback or will become available for playback in the future. In some embodiments, as previously described above, the one or more representations of the one or more second live content items are displayed below the content player bar in the playback user interface (e.g., in a row configuration in the playback user interface) when the selectable option is selected. In some embodiments, the one or more second live content items have one or more characteristics of the one or more second live content items discussed above.

In some embodiments, while displaying the content player bar and the selectable option in the playback user interface, the electronic device receives, via the one or more input devices, an input of a first type directed to the selectable option, such as selection of the selectable option 614 provided by contact 603r as shown in FIG. 6R. For example, the electronic device detects a selection input directed to the selectable option in the playback user interface. In some embodiments, the electronic device detects the input of the first type via a touch-sensitive surface of the one or more input devices. For example, while the selectable option has the current focus, the electronic device detects a press on the touch-sensitive surface (e.g., of a remote input device). In some embodiments, the electronic device detects a tap directed to the selectable option via a touch screen of the electronic device.

In some embodiments, in response to receiving the input of the first type, the electronic device concurrently displays, via the display generation component, the one or more representations of the one or more second live content items with the live content item in the playback user interface, such as displaying the representations 623-1 to 623-5 of the plurality of content items as shown in FIG. 6KK. For example, as described above, the electronic device displays the one or more representations of the one or more second live content items below the content player bar in the playback user interface.

In some embodiments, while concurrently displaying the one or more representations of the one or more second live content items with the live content item, the electronic device receives, via the one or more input devices, an input of a second type, different from the first type, directed to a representation of a respective live content item of the one or more second live content items, such as input provided by contact 603kk in FIG. 6KK while the representation 623-1 has the current focus in the playback user interface. For example, the electronic device detects a press/tap and hold directed to the representation of the respective live content item in the playback user interface. In some embodiments, the electronic device detects the input of the second type via a touch-sensitive surface of the one or more input devices. For example, while the representation of the respective live content item has the current focus, the electronic device detects a press on the touch-sensitive surface (e.g., of a remote input device) for at least a threshold amount of time (e.g., 1, 2, 3, 4, 5, 8, 10, 12, or 15 seconds). In some embodiments, the electronic device detects a tap and hold directed to the representation of the respective live content item for the threshold amount of time via a touch screen of the electronic device.

In some embodiments, in response to receiving the input of the second type, the electronic device displays, via the display generation component, one or more viewing options for the respective live content item in the playback user interface, such as displaying viewing options in menu element 642 as shown in FIG. 6LL, wherein a first viewing option of the one or more viewing options for the respective live content item is selectable to display a respective user interface corresponding to the first viewing option, such as the Multiview user interface 632 in FIG. 6MM, including concurrently displaying the live content item and the respective live content item in a playback region of the respective user interface, such as concurrently displaying the live content item (Live Content A) and Item A in the playback region 634 as shown in FIG. 6MM, wherein the respective user interface is configurable to include a plurality of live content items. For example, in response to receiving the press/tap and hold directed to the representation of the respective live content item, the electronic device displays one or more viewing options for the respective live content item in the playback user interface. In some embodiments, the one or more viewing options are displayed in a menu adjacent to or overlaid on the representation of the respective live content item in the playback user interface. In some embodiments, the one or more viewing options includes a first viewing option that is selectable to display a respective user interface corresponding to the first viewing option, such as the multi-view user interface described above. In some embodiments, as similarly described above, in response to receiving a selection of the first viewing option, the electronic device concurrently displays the live content item and the respective live content item (e.g., separately) in a playback region in the multi-view user interface. In some embodiments, the respective live content item is displayed in a primary view (e.g., with a larger size than that of the live content item) in the playback region of the respective user interface, as similarly described above. In some embodiments, as discussed above, the respective user interface is configurable to include a plurality of live content items, such that a third, fourth, fifth, and/or sixth live content item are able to be selected for concurrent display with the live content item and the respective live content item in the respective user interface. Displaying viewing options for a respective live content item, which include an option for viewing the respective live content item in a multi-view user interface, in response to receiving a press and hold of a representation of the respective live content item in a playback user interface that is displaying a live content item reduces the number of inputs needed to concurrently display the respective live content item and the live content item in the multi-view user interface and/or facilitates discovery that the respective live content item and the live content item are able to be concurrently viewed in the multi-view user interface, thereby improving user-device interaction.

It should be understood that the particular order in which the operations in method 700 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 900, 1100, and/or 1200) are also applicable in an analogous manner to method 700 described above with respect to FIG. 7. For example, the operation of the electronic device facilitating control of playback of a live content item in a playback user interface, described above with reference to method 700, optionally has one or more of the characteristics of displaying key content corresponding to a live content item and/or displaying multiple content items in a Multiview user interface, described herein with reference to other methods described herein (e.g., methods 900, 1100, and/or 1200). For brevity, these details are not repeated here.

The operations in the information processing methods described above are, optionally, implemented by running one or more functional modules in an information processing apparatus such as general purpose processors (e.g., as described with respect to FIG. 1A-1B, 3, 5A-5H) or application specific chips. Further, the operations described above with reference to FIG. 7 are, optionally, implemented by components depicted in FIGS. 1A-1B. For example, receiving operations 702a and 702c, displaying operations 702b and 702f, and updating operation 702e, are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### User Interfaces of Key Content Corresponding to Live Content

Users interact with electronic devices in many different manners, including using an electronic device to interact with key content corresponding to live content in a key content user interface. In some embodiments, an electronic device is configurable to display a key content user interface that presents information corresponding to highlights associated with a live content item that is available for playback on the electronic device. The embodiments described below provide ways in which an electronic device presents and responds to user input directed to a key content user interface that includes key content corresponding to a live content item. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

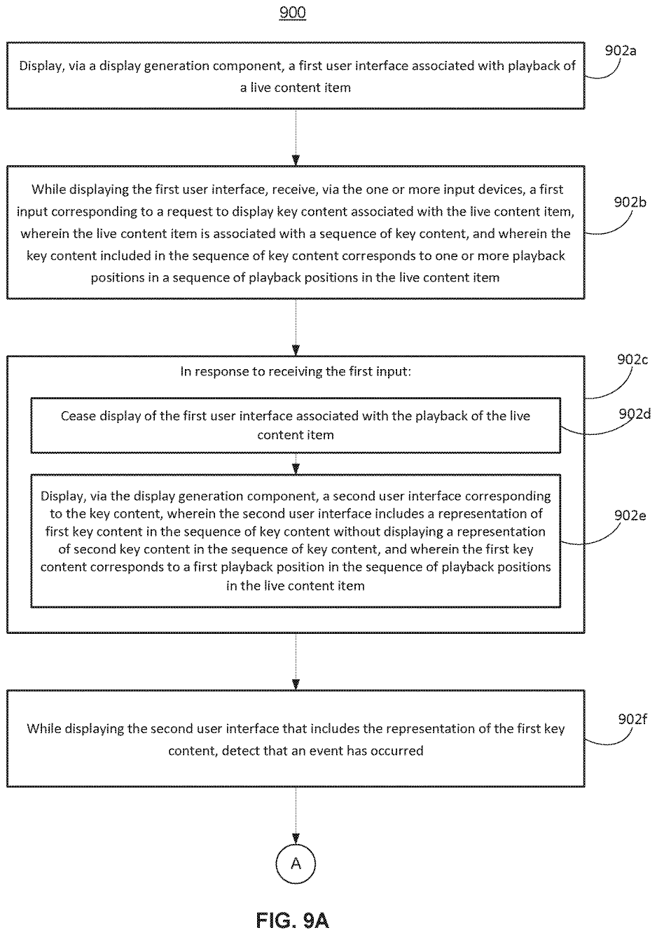

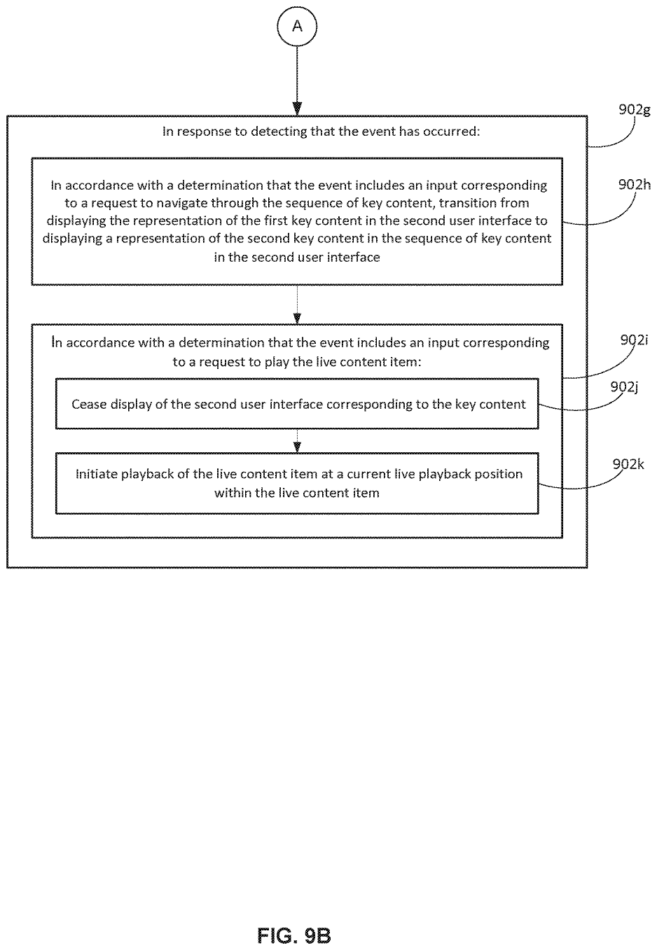

FIGS. 8A-8BB illustrate exemplary ways in which an electronic device facilitates interactions with key content corresponding to a live content item displayed in a key content user interface in accordance with some embodiments of the disclosure. The embodiments in these figures are used to illustrate the processes described below, including the processes described with reference to FIGS. 9A-9B.

FIGS. 8A-8L illustrate an electronic device 514 presenting user interfaces of key content corresponding to a live content item. FIG. 8A illustrates a user interface 842 (e.g., a canonical user interface displayed via a display of the electronic device 524) that is specific to a live content item (“Live Content A”). In some embodiments, the user interface 842 provides information associated with playback of the live content item. For example, as shown in FIG. 8A, the user interface 842 includes representative content corresponding to the live content item, such as an image of a particular scene, play, moment, etc. in the live content item, a video clip of a portion of the live content item, a trailer associated with the live content item, etc. Additionally, as shown in FIG. 8A, the user interface 842 optionally includes information 857 corresponding to the live content item. For example, the information 857 includes a summary or synopsis of the live content item. In some embodiments, the live content item corresponds to a sports game, such as a baseball game. In some embodiments, the live content item corresponds to a live-broadcast content item that is being broadcast to the electronic device 514 via a respective media provider of the live-broadcast content item, such as “Provider 1” indicated by indication 840. For example, the live content item corresponds to a sports game, a movie, a television show, a news program, or other content that is not available for playback at the electronic device 514 until it is broadcast/streamed by the respective media provider for consumption at the electronic device 514. It should be understood that, though FIGS. 8A-8L primarily make reference to key content corresponding to a live content item, in some embodiments, the key content alternatively corresponds to a non-live content item, such as on-demand content that is available on the electronic device, whether movies, television shows, or collections or sequences of segments of content from different content items (e.g., collections of movie clips, video clips, or the like) where key content could be an identified subset of those segments and the “playback position” in such a collection would correspond to the location of a particular segment in the collection or sequence of segments.

In some embodiments, the user interface 842 includes a first selectable option 846, as shown in FIG. 8A. In some embodiments, the first selectable option 846 is selectable to initiate playback of the live content item (e.g., in a playback user interface, as described in more detail herein later). In some embodiments, the user interface 842 is displaying the first selectable option 846 because the live content item is currently being aired/broadcasted by the respective media provider of the live contentment item and a user of the electronic device 514 is entitled to consume (e.g., view) the live content item at the electronic device 514 from the respective media provider of the live content item. For example, a user account associated with the user of the electronic device 514 is logged in on the electronic device 514, and the user account is authorized (e.g., via a subscription, a purchase, a rental, or other form of entitlement) to consume the live content item from the respective media provider. It should be understood that, in some embodiments, the playback user interface 842 is specific to content items other than live content items, such as on-demand content. Additional examples of live content items that can be associated with the user interface 842 are provided below with reference to method 900.

As shown in FIG. 8A, in some embodiments, the user interface 842 includes a second selectable option 848. In some embodiments, the second selectable option 848 is selectable to display key content corresponding to the live content item. For example, as described in more detail below, the second selectable option 848 is selectable to display a key content user interface that includes key content corresponding to the live content item. In some embodiments, as described below, the key content corresponding to the live content item includes highlights for the live content item, such as significant moments in the live content item. For example, because the live content item is a baseball game, the key content corresponding to the live content item includes game highlights, such as significant plays (e.g., hits, runs, strikeouts, etc.). Additional details regarding the key content are provided below with reference to method 900.

In some embodiments, as shown in FIG. 8A, the first selectable option 846 has a current focus in the user interface 842. In some embodiments, the electronic device 514 displays the first selectable option 846 with an indication of focus (e.g., a visual boundary, highlighting, shading, bolding, etc.). In FIG. 8A, while the first selectable option 846 has the current focus, the user provides a scrolling input (e.g., with contact 803a) directed to the user interface 842. For example, as shown in FIG. 8A, the electronic device 514 detects a tap, touch, press, or other input on touch-sensitive surface 451 of remote input device 510, followed by movement in a downward direction on the touch-sensitive surface 451.

In some embodiments, as shown in FIG. 8B, in response to receiving the scrolling input, the electronic device 514 moves the current focus in the user interface in accordance with the scrolling input. For example, as shown in FIG. 8B, the electronic device 514 moves the current focus from the first selectable option 846 to the second selectable option 848 in the user interface. In some embodiments, as similarly discussed above, the electronic device 514 displays the second selectable option 848 with an indication of focus in the user interface. In FIG. 8B, while the second selectable option 848 has the current focus, the electronic device 514 receives a selection (e.g., via contact 803b) of the second selectable option 848. For example, as shown in FIG. 8B, the electronic device 514 detects a tap, touch, press, or other input on the touch-sensitive surface 451 of the remote input device 510.

In some embodiments, in response to receiving the selection of the second selectable option 848, the electronic device 514 displays key content corresponding to the live content item, as mentioned previously above. For example, as shown in FIG. 8C, the electronic device 514 ceases display of the user interface specific to the live content item and displays key content user interface 844. In some embodiments, as shown in FIG. 8C, the key content corresponding to the live content item includes a sequence of key content. For example, in FIG. 8C, the electronic device 514 displays first key content (“Key Content 1”) of the sequence of key content in the key content user interface 844. As mentioned above, the key content optionally corresponds to highlights and/or significant moments in the live content item that have occurred prior to a live playback position in the live content item. In some embodiments, the key content displayed in the key content user interface 844 enables the user to gain an understanding of a context of the live content item before initiating playback of the live content item at the live playback position within the live content item by receiving an overview of the highlights of the live content item. In the example of FIG. 8C, because the live content item is optionally a baseball game, the first key content optionally corresponds to a first highlight or significant play in the baseball game, as discussed below.

As shown in FIG. 8C, in some embodiments, the key content user interface 844 includes representative content corresponding to the first key content (Key Content 1). For example, the key content user interface 844 includes an image, such as a still or screenshot of a player or players involved in the first key content, a video clip of the first key content (with or without audio), etc. Additionally, in some embodiments, as shown in FIG. 8C, the key content user interface 844 includes a title 849-1 of the first key content. For example, the title 849-1 includes text “Player A Hits a Homerun” as shown. Accordingly, the representative content corresponding to the first key content optionally includes an image or clip of Player A hitting the homerun. As shown in FIG. 8C, in some embodiments, the key content user interface 844 includes information 843-1 corresponding to the first key content. For example, as shown in FIG. 8C, the information 843-1 includes an indication of a number of the first key content in the sequence of key content (e.g., “1 of 5”). Additionally, the information 843-1 optionally includes an indication of a period/moment in the live content item at which the first key content occurred. For example, as shown in FIG. 8C, the information 843-1 includes an inning during which the first key content occurred in the live baseball game (e.g., “Top of the 1st”).

In some embodiments, as shown in FIG. 8C, the electronic device 514 displays selectable option 845 in the key content user interface 844. In some embodiments, the selectable option 845 is selectable to initiate playback of the live content item from the live playback position within the live content item. In some embodiments, as discussed in more detail below, the electronic device 514 displays the live content item in a playback user interface. In some embodiments, the electronic device 514 displays one or more navigation affordances in the key content user interface 844. For example, as shown in FIG. 8C, the key content user interface 844 includes a first navigation affordance 847-1. In some embodiments, the first navigation affordance 847-1 is selectable to advance forward in the sequence of key content and display second key content in the key content user interface 844.

In FIG. 8C, while the first key content is displayed in the key content user interface 844, the electronic device 514 receives a scrolling input (e.g., via contact 803c) directed to the key content user interface 844. For example, as shown in FIG. 8C, the electronic device 514 detects a tap, touch, press, or other input on the touch-sensitive surface 451 of the remote input device 510, followed by movement in a rightward direction on the touch-sensitive surface 451.

In some embodiments, as shown in FIG. 8D, in response to receiving the scrolling input, the electronic device 514 displays the first navigation affordance 847-1 with a current focus in the key content user interface 844. For example, as similarly discussed above, the electronic device 514 displays the first navigation affordance 847-1 with an indication of focus. In FIG. 8D, while the first navigation affordance 847-1 has the current focus in the key content user interface 844, the electronic device 514 receives a selection (e.g., via contact 803d) of the first navigation affordance 847-1. For example, the electronic device 514 detects a tap, touch, press, or other input on the touch-sensitive surface 451 of the remote input device 510, as shown in FIG. 8D.

In some embodiments, in response to receiving the selection of the first navigation affordance 847-1, the electronic device 514 displays second key content (“Key Content 2”) in the key content user interface 844, as shown in FIG. 8E. For example, as shown in FIG. 8E, the electronic device 514 ceases display of the first key content (Key Content 1) and transitions to displaying the second key content in the key content user interface 844. In some embodiments, the second key content is chronologically located after the first key content in the sequence of key content. In some embodiments, when the electronic device 514 displays the second key content, the electronic device replaces display of the representative content corresponding to the first key content with representative content corresponding to the second key content (e.g., an image or video clip associated with the second key content, as similarly described above). Additionally, as shown in FIG. 8E, the electronic device 514 optionally replaces the title 849-1 of the first key content with a title 849-2 of the second key content (e.g., “Player B Strikes out Player C”). Accordingly, in some embodiments, the representative content corresponding to the second key content includes an image or video clip of Player B and/or Player C.

In some embodiments, when the electronic device 514 displays the second key content in the key content user interface 844, the electronic device 514 also replaces display of the information 843-1 corresponding to the first key content with information 843-2 corresponding to the second key content. For example, as shown in FIG. 8E, the electronic device 514 updates the indication of the number of the second key content in the sequence of key content (e.g., to “2 of 5”) and/or updates the indication of the inning during the live baseball game in which the second key content occurred (e.g., “Top of the 1st”). As shown in FIG. 8E, in some embodiments, the electronic device 514 maintains display of the selectable option 845 in the key content user interface 844 when the second key content is displayed.

In some embodiments, when the electronic device transitions from displaying the first key content to displaying the second key content in the key content user interface 844, the electronic device 514 updates display of the one or more navigation affordances in the key content user interface 844. For example, as shown in FIG. 8E, the electronic device 514 displays a second navigation affordance 847-2 concurrently with the first navigation affordance 847-1 in the key content user interface 844. In some embodiments, the second navigation affordance 847-2 is selectable to navigate backward (e.g., chronologically) in the sequence of key content. For example, selection of the second navigation affordance 847-2 causes the electronic device 514 to redisplay the first key content discussed above in the key content user interface 844. Additionally, as similarly discussed above, the first navigation affordance 847-1 is selectable to optionally display third key content in the key content user interface 844, wherein the third key content is located chronologically after the second key content in the sequence of key content.

In some embodiments, the electronic device 514 automatically transitions from displaying the second key content in the key content user interface 844 to displaying the third key content in the key content user interface 844 after detecting that a threshold amount of time (e.g., 0.5, 1, 2, 3, 5, 10, 15, 30, 45, 60, or 120 seconds) has elapsed since displaying the second key content. For example, as shown in FIG. 8F, the electronic device 514 initiates elapsing of a timer corresponding to the threshold amount of time after the second key content is displayed in the key content user interface, as indicated by time marker 852-1 in time bar 851. In some embodiments, the electronic device 514 displays a visual indication 841 of the elapsing of the timer in the key content user interface 844, as shown in FIG. 8F. For example, if the electronic device 514 determines that the timer elapses (e.g., the threshold amount of time elapses) since displaying the second key content in the key content user interface 844 without detecting user input (e.g., a tap or touch via remote input device 510), the electronic device 514 automatically displays the third key content in the key content user interface 844.

In some embodiments, as shown in FIG. 8G, when the electronic device 514 determines that the threshold amount of time has elapsed since displaying the second key content in the key content user interface 844, as indicated by the time bar 851, the electronic device 514 displays the third key content (“Key Content 3”) in the key content user interface 844. For example, as similarly discussed above, the electronic device 514 ceases display of the second key content in the key content user interface 844 and displays the third key content. In some embodiments, when the electronic device 514 transitions from displaying the second key content to displaying the third key content in the key content user interface 844, the electronic device 514 ceases display of the visual indication 841 of the timer associated with the threshold amount of time discussed above, as shown in FIG. 8G.

As similarly discussed above, the electronic device 514 optionally displays representative content corresponding to the third key content (e.g., an image or video clip of the third key content). Additionally, as shown in FIG. 8G, in some embodiments, the electronic device 514 updates the title and the information corresponding to the key content in the key content user interface 844. For example, as shown in FIG. 8G, the electronic device 514 displays a title 849-3 corresponding to the third key content (e.g., “Player D Hits a Double”) in place of the title 849-2 corresponding to the second key content. Similarly, in some embodiments, as shown in FIG. 8G, the electronic device 514 updates the indication of the number of the third key content in the sequence of key content (e.g., to “3 of 5”) and/or the indication of the inning during the live baseball game in which the third key content occurred (e.g., to “Top of the 2nd”) in information 849-3. In some embodiments, as similarly discussed above, the electronic device 514 maintains display of the selectable option 845 in the key content user interface 844 when the third key content is displayed.

In some embodiments, the electronic device 514 dynamically updates the sequence of key content corresponding to the live content item. For example, the electronic device 514 updates the number of the sequence of key content based on real-time events (e.g., plays, hits, runs scored, etc.) occurring during the broadcast of the live baseball game. In some embodiments, in FIG. 8H, the electronic device 514 has transitioned from displaying the third key content in the key content user interface 844 to displaying fourth key content (“Key Content 4”). For example, the electronic device 514 is displaying the fourth key content in the key content user interface because the electronic device has received a selection of the first navigation affordance 847-1 as similarly described previously above or has determined that the threshold amount of time described previously above, as indicated by time marker 852-2 in the time bar 851, has elapsed since displaying the third key content in the key content user interface 844. As similarly discussed above, in FIG. 8H, the electronic device 514 is displaying representative content corresponding to the fourth key content (e.g., an image or video clip of the fourth key content) and has optionally updated the title of the key content to be a title 849-4 of the fourth key content (“Player D Scores a Run”).

As mentioned above, in some embodiments, the electronic device 514 dynamically updates the sequence of key content corresponding to the live content item. For example, the electronic device 514 periodically (e.g., every 15, 30, 45, 60, 120, 180, 240, etc. seconds) updates the key content included in the sequence of key content based on the broadcast of the live content item. As shown in FIG. 8H, when the electronic device 514 displays the fourth key content in the key content user interface, the electronic device 514 optionally updates the number of key content in the sequence of key content, as indicated in information 843-4 (e.g., “4 of 6”). For example, as shown in FIG. 8H, a total number of the sequence of key content has increased from “5” in FIG. 8G to “6” (in the information 843-4) when the fourth key content is displayed in the key content user interface 844. Accordingly, in some embodiments, a significant play has recently occurred (e.g., since the sequence of key content was last updated) in the live baseball game, which has been added as new key content (e.g., sixth key content) to the sequence of key content.

In FIG. 8H, while the fourth key content is displayed in the key content user interface 844, the electronic device 514 receives a scrolling input (e.g., via contact 803h) directed to the key content user interface 844. For example, as shown in FIG. 8H, the electronic device 514 detects a tap, touch, press, or other input on the touch-sensitive surface 451 of the remote input device 510, followed by downward movement on the touch-sensitive surface 451. In some embodiments, as shown in FIG. 8I, in response to receiving the scrolling input, the electronic device 514 moves the current focus to the selectable option 845 in the key content user interface 844. As similarly discussed above, in some embodiments, the selectable option 845 is displayed with an indication of focus in the key content user interface 844.

In FIG. 8I, while the selectable option 845 has the current focus in the key content user interface 844, the electronic device 514 receives a selection (e.g., via contact 803i) of the selectable option 845. For example, as shown in FIG. 8I, the electronic device 514 detects a tap, touch, press, or other input on the touch-sensitive surface 451 of the remote input device 510.

In some embodiments, as shown in FIG. 8J, in response to receiving the selection of the selectable option 845, the electronic device 514 initiates playback of the live content item from the live playback position within the live content item. For example, as shown in FIG. 8J, the electronic device 514 ceases display of the key content user interface 844 and displays the live content item in playback user interface 802. In some embodiments, the playback user interface 802 has one or more characteristics of playback user interface 602 described above with reference to the FIG. 6 series.

Additionally, in some embodiments, the electronic device 514 displays one or more controls for controlling playback of the live content item in the playback user interface 802. For example, as shown in FIG. 8J, the electronic device 514 displays content player bar 806 in the playback user interface (e.g., concurrently with the live content item in the playback user interface). In some embodiments, the electronic device 514 displays the content player bar 806 overlaid on the live content item as playback of the live content item continues to progress in the playback user interface. In some embodiments, the content player bar 806 includes a scrubber bar 808 that corresponds to a current playback position within the live content item. In some embodiments, input directed to the scrubber bar 808 and/or the content player bar 806 causes the electronic device 514 to navigate (e.g., scrub) through the live content item in the playback user interface. As shown in FIG. 8J, the scrubber bar 808 is optionally displayed with a real-world time indicator 809 that indicates a time of day at the electronic device 514 that corresponds to the current playback position of the scrubber bar 808. For example, as shown in FIG. 6B, the real-world time indicator 609 includes text expressing the time of day (“1:30 PM”) corresponding to the current playback position. In some embodiments, because the current playback position of the scrubber bar 808 within the live content item is at a live edge within the live content item (e.g., a most up to date playback position in the live content item provided (e.g., broadcasted) by the respective media provider of the live content item), the time of day indicated by the real-world time indicator 809 is a current time of day at the electronic device 514.

In some embodiments, the content player bar 806 further includes information associated with the live content item. For example, as shown in FIG. 8J, the content player bar 806 is displayed with an indication of a start time 811 (“1:00 PM”) of the live content item (e.g., a time of day at the electronic device 514 at which the live content was first aired/broadcasted). Additionally, as shown in FIG. 8J, the electronic device 514 optionally displays an indication of a sports league 807 (“League A”) with which the live content item, which is optionally a baseball game, is associated. In some embodiments, the content player bar 806 has one or more characteristics of the content player bar 606 described above with reference to the FIG. 6 series.

In some embodiments, as shown in FIG. 8J, the electronic device 514 displays selectable options 810-816 concurrently with the content player bar 806 in the playback user interface 802. In some embodiments, selectable option 810 has one or more characteristics of the selectable option 610 described above with reference to the FIG. 6 series. In some embodiments, selectable option 812 is selectable to display key content (e.g., described herein above) corresponding to the live content item, as discussed in more detail below. In some embodiments, selectable option 814 has one or more characteristics of the selectable option 614 described above with reference to the FIG. 6 series. In some embodiments, selectable option 816 has one or more characteristics of the selectable option 616 described above with reference to the FIG. 6 series.

In some embodiments, as shown in FIG. 8J, the content player bar 806 is displayed with a live indicator 805. In some embodiments, the live indicator 805 indicates that a live content item (e.g., a live-broadcast content item) is currently displayed in the playback user interface 802. In some embodiments, the live indicator 805 has one or more characteristics of live indicator 605 described above with reference to the FIG. 6 series.

In some embodiments, the electronic device 514 displays the live content item from the live playback position within the live content item (e.g., in the playback user interface 802) after reaching an end of the sequence of key content. For example, in FIG. 8K, the electronic device 514 is displaying sixth key content (“Key Content 6”) corresponding to the live content item in the key content user interface 844. As similarly discussed above, in some embodiments, the electronic device 514 displays representative content corresponding to the sixth key content (e.g., an image or video clip of the sixth key content), a title 849-6 of the sixth key content (e.g., “Player E Hits 2-Run Homerun”), and/or information 843-6 corresponding to the sixth key content. In some embodiments, the sixth key content is last/final key content in the sequence of key content. For example, as shown in FIG. 8K, the information 843-6 corresponding to the sixth key content 843-6 indicates that a number of the sixth key content is the last key content in the sequence of key content (e.g., “6 of 6”).

In FIG. 8K, the electronic device 514 detects an event that causes the electronic device to navigate forward (e.g., chronologically) in the sequence of key content while the sixth (and last) key content is displayed in the key content user interface 844. For example, as shown in FIG. 8K, the electronic device 514 detects a selection (e.g., via contact 803k on the touch-sensitive surface 451 of the remote input device 510) directed to the first navigation affordance 847-1 while the first navigation affordance 847-1 has the current focus in the key content user interface 844. Alternatively, as shown in FIG. 8K, the electronic device 514 optionally determines that the threshold amount of time described above, indicated by time marker 852 in the time bar 851, elapses since displaying the sixth key content in the key content user interface 844 (which optionally includes displaying the visual indication 841 of the timer associated with the elapsing of the threshold amount of time in the key content user interface 844).

In some embodiments, as shown in FIG. 8L, in response to detecting the event (e.g., the selection of the first navigation affordance 847-1 or the elapsing of the threshold amount of time, as indicated by the time marker 852 in the time bar 851), the electronic device 514, the electronic device 514 initiates display of the live content item from the live playback position within the live content item. For example, as similarly discussed above, the electronic device 514 ceases display of the key content user interface 844 and displays the live content item (Content A) in the playback user interface 802. In some embodiments, the electronic device 514 concurrently displays the content player bar 806 (and related user interface elements, such as elements 805, 807, 811, etc.) with the live content item in the playback user interface 802, as similarly discussed above.

FIGS. 8M-8S illustrate examples of the electronic device 514 displaying key content corresponding to a live content item in a playback user interface that is displaying the live content item. In FIG. 8M, the electronic device 514 is displaying the live content item (Content A) in the playback user interface 802 described previously above. Additionally, as shown in FIG. 8M, the electronic device 514 is optionally concurrently displaying content player bar 806 described previously above with the live content item in the playback user interface 802.

In FIG. 8M, while the content player bar 806 is displayed in the playback user interface 802, the electronic device 514 receives a scrolling input (e.g., via contact 803m) directed to the playback user interface 802. For example, as shown in FIG. 8M, the electronic device 514 detects a tap, touch, press, or other input on the touch-sensitive surface 451 of the remote input device 510, followed by downward (and rightward) movement on the touch-sensitive surface 451.

In some embodiments, in response to receiving the scrolling input, the electronic device 514 moves a current focus to the selectable option 812 in the playback user interface 802, as shown in FIG. 8N. In some embodiments, as similarly discussed above, the electronic device 514 displays the selectable option 812 with an indication of focus in the playback user interface 802. In FIG. 8N, while the selectable option 812 has the current focus in the playback user interface 802, the electronic device 514 receives a selection (e.g., via contact 803n) of the selectable option 812. For example, as shown in FIG. 8N, the electronic device 514 detects a tap, touch, press, or other input on the touch-sensitive surface 451 of the remote input device 510.

In some embodiments, as shown in FIG. 8O, in response to receiving the selection of the selectable option 812, the electronic device 514 displays one or more representations of key content corresponding to the live content item. For example, as shown in FIG. 8O, the electronic device 514 shifts the content player bar 806 (and related user interface elements) upward in the playback user interface and displays the one or more representations of the key content below the content player bar 806 in the playback user interface. In some embodiments, the key content corresponds to the key content described previously above.

In some embodiments, as shown in FIG. 8O, the one or more representations of the key content include a representation 852-1 of first key content, a representation 852-2 of second key content, a representation 852-3 of third key content, a representation 852-4 of fourth key content, and/or a representation 852-5 of fifth key content. In some embodiments, the one or more representations of the key content include representative content corresponding to the key content, such as an image or video clip of the key content, as similarly discussed above. In some embodiments, the one or more representations of the key content are displayed with a title of the key content and information that includes an indication of a period/moment during the live content item when the key content occurred, as similarly discussed above. For example, as shown in FIG. 8O, the representation 852-1 of the first key content is displayed with title 849-1 (“Player A Hits a Homerun) and information 849-1 (“Top of the 1st”), the representation 852-2 of the second key content is displayed with title 849-2 (“Player B Strikes Out Player C”) and information 849-2 (“Top of the 1st”), and so on. As shown in FIG. 8O, the titles and information displayed with the representations 852-1 to 852-5 of the key content corresponding to the live content item correspond to the titles and information described above and shown in the key content user interface 844.

In some embodiments, the one or more representations of the key content corresponding to the live content item are arranged chronologically in the playback user interface 802 in accordance with the sequence of key content described herein above. For example, in FIG. 8O, the representation 852-1 of the first key content is chronologically first in the sequence of key content and the representation 852-1 of the second key content is chronologically second in the sequence of key content (e.g., after the first key content), and so on. In some embodiments, the one or more representations of the key content corresponding to the live content item are selectable to display the selected key content in the key content user interface 844 described above. In some embodiments, the one or more representations of the key content are scrollable (e.g., horizontally scrollable) in the playback user interface to reveal additional representations of key content corresponding to the live content item. In FIG. 8O, the representation 852-1 of the first key content optionally has the current focus in the playback user interface. In some embodiments, as similarly discussed above, the representation 852-1 of the first key content is displayed with an indication of focus in the playback user interface.

In FIG. 8O, while the representation 852-1 of the first key content has the current focus in the playback user interface, the electronic device 514 receives a scrolling input (e.g., via contact 8030) for scrolling through the one or more representations of the key content corresponding to the live content item. For example, as shown in FIG. 8O, the electronic device 514 detects a tap, touch, press, or other input on the touch-sensitive surface 451 of the remote input device 510, followed by movement in a rightward direction on the touch-sensitive surface 451.

In some embodiments, in response to receiving the scrolling input, the electronic device 514 moves the current focus from the representation 852-1 of the first key content to the representation 852-2 of the second key content in the playback user interface, as shown in FIG. 8P. In some embodiments, as similarly discussed above, the electronic device 514 displays the representation 852-2 of the second key content with an indication of focus in the playback user interface. In FIG. 8P, while the representation 852-2 of the second key content has the current focus in the playback user interface, the electronic device 514 receives a selection (e.g., via contact 803p) of the representation 852-2. For example, as shown in FIG. 8P, the electronic device 514 detects a tap, touch, press, or other input on the touch-sensitive surface 451 of the remote input device 510.

In some embodiments, as shown in FIG. 8Q, in response to receiving the selection of the representation 852-2 of the second key content, the electronic device 514 displays the second key content (Key Content 2) in the key content user interface 844 previously described above. For example, as shown in FIG. 8Q, the electronic device 514 ceases display of the live content item in the playback user interface and displays the second key content in the key content user interface 844. In some embodiments, as similarly discussed above, the electronic device 514 displays representative content corresponding to the second key content (e.g., an image or video clip of the second key content), the title 849-2 of the second key content (“Player B Strikes Out Player C”), and/or information 849-3 corresponding to the second key content (e.g., an indication of a number of the second key content in the sequence of key content (“2 of 6”) and/or an inning in the live content item during which the second key content occurred (“Top of the 1st”)). As shown in FIG. 8Q, in some embodiments, the representative content, the title 849-2, and/or the information 849-2 corresponding to the second key content in the key content user interface 844 are the same as or similar to those included with the representation 852-2 of the second key content in the playback user interface in FIG. 8P. Additionally, as similarly discussed above, in some embodiments, the key content user interface 844 includes the selectable option 845 and the one or more navigation affordances (e.g., first navigation affordance 847-1 and second navigation affordance 847-2).

In FIG. 8R, the electronic device 514 has transitioned from displaying the second key content to displaying the third key content corresponding to the live content item in the key content user interface 844, as described similarly above. For example, as similarly discussed above, the electronic device 514 displays the third key content in the key content user interface 844 in response to detecting a selection (e.g., via input received on the touch-sensitive surface 451 of the remote input device 510) of the first navigation affordance 847-1 and/or in accordance with a determination that the threshold amount of time discussed above, as indicated by time marker 852 in the time bar 851, has elapsed since displaying the second key content in the key content user interface 844. In some embodiments, the third key content (e.g., including the representative content corresponding to the third key content, title 849-3 of the third key content, and/or information 843-3 corresponding to the third key content) displayed in the key content user interface 844 corresponds to the third key content described previously above. Additionally, in some embodiments, as shown in FIG. 8R, the representative content, the title 849-3, and/or the information 849-3 corresponding to the third key content in the key content user interface 844 are the same as or similar to those included with the representation 852-3 of the third key content in the playback user interface in FIG. 8P.

In some embodiments, the electronic device 514 initiates playback of the live content item from a playback position that is based on the key content that is currently displayed in the key content user interface 844 in response to receiving an input corresponding to a request to navigate away from the key content user interface 844. For example, in FIG. 8R, while the third key content is displayed in the key content user interface 844, the electronic device 514 receives an input corresponding to a request to navigate away from the key content user interface 844. As shown in FIG. 8R, the electronic device 514 detects a selection (e.g., a button press by contact 803r) of Menu button of the remote input device 510.

In some embodiments, as shown in FIG. 8S, in response to receiving the selection of the Menu button of the remote input device 510, the electronic device 514 initiates playback of the live content item at a playback position that is based on the third key content. For example, as shown in FIG. 8S, the electronic device 514 ceases display of the key content user interface 844 that is displaying the third key content corresponding to the live content item and displays the live content item (Content A) in the playback user interface 802 described above. Additionally, as shown in FIG. 8S, the electronic device 514 optionally concurrently displays the content player bar 806 with the live content item in the playback user interface 802.

As mentioned above, in some embodiments, the electronic device 514 initiates playback of the live content item from a playback position that is based on the third key content corresponding to the live content item. For example, the electronic device 514 initiates playback of the live content item at a playback position within the live content item at which the third key content occurred during the live broadcast of the live content item. Referring back to FIG. 8R, the information 843-3 corresponding to the third key content optionally indicates that the third key content occurred during the bottom of the 1st inning in the live baseball game. Accordingly, in FIG. 8S, the electronic device 514 optionally initiates playback of the live baseball game in the playback user interface 802 during the bottom of the 1st inning. As shown in FIG. 8S, the electronic device 514 optionally displays the scrubber bar 808 at a location within the content player bar 806 corresponding to the current playback position within the live content item. Additionally, as indicated by real-world time indicator 809, the third key content corresponding to the live content item occurred at 1:15 PM during the live broadcast of the live content item.

In some embodiments, the electronic device 514 updates display of the live indicator 805 in the playback user interface 802. For example, as shown in FIG. 8S, because the current playback position does not correspond to the live playback position within the live content item, the electronic device 514 changes an appearance of the live indicator 805 in the playback user interface 802, as similarly discussed above with reference to the FIG. 6 series. Additionally, in some embodiments, the electronic device 514 displays selectable option 820 (e.g., “Jump to Live” button) with the content player bar 806 (e.g., above the content player bar 606) in the playback user interface. In some embodiments, the selectable option 820 has one or more characteristics of the selectable option 620 described previously above with reference to the FIG. 6 series.

FIGS. 8T-8Z illustrate exemplary interactions with key content corresponding to a live content item displayed in a playback user interface on a second electronic device 500. FIG. 8T illustrates an electronic device 500 displaying a live content item (“Live Content A”) in a playback user interface 802 (e.g., via display 504). In some embodiments, the live content item corresponds to the live content item described above. In some embodiments, the playback user interface 802 has one or more characteristics of the playback user interface 802 described above. In some embodiments, the electronic device 500 is different from the electronic device 514 described above. For example, the electronic device 500 is a mobile electronic device, such as a smartphone. In some embodiments, the display 504 is a touch screen of the electronic device 500.

In FIG. 8T, the electronic device 500 receives an input by contact 803g (e.g., a tap or touch provided by an object, such as a finger or stylus) on the touch screen 504 directed to the live content item displayed in the playback user interface 802. In some embodiments, in response to receiving the input directed to the live content item on the touch screen 504, the electronic device 500 displays one or more controls for controlling playback of the live content item in the playback user interface, as similarly discussed above. As shown in FIG. 8U, the electronic device 500 displays content player bar 806 with the live content item (e.g., optionally an image of the live content item) in the playback user interface. In some embodiments, the content player bar 806 has one or more characteristics of the content player bar 806 described above. As shown in FIG. 8U, the content player bar 806 optionally includes scrubber bar 808. In some embodiments, the scrubber bar 808 has one or more characteristics of the scrubber bar 808 described above. In some embodiments, the electronic device 500 displays a title 813 of the live content item with the content player bar 806 in the playback user interface. For example, the electronic device 500 displays the title “Team A at Team B” of the live content item above the content player bar 806 in the playback user interface. Additionally as shown in FIG. 8U, the electronic device 500 optionally displays an indication of a start time 811 (“1:00 PM”) of the live content item and/or an indication of a sports league 807 (“League A”) with the content player bar 806 in the playback user interface. In some embodiments, the indications 811 and 807 have one or more characteristics of the indications 811 and 807 described above.

Additionally, in some embodiments, the electronic device 500 displays real-world time indicator 809 with the content player bar 806 in the playback user interface. In some embodiments, the real-world time indicator 809 has one or more characteristics of the real-world time indicator 809 described above. In some embodiments, the electronic device 500 selectable option 819 with the content player bar 806 in the playback user interface. In some embodiments, the selectable option 819 has one or more characteristics of selectable option 619 described above with reference to the FIG. 6. Additionally, as shown in FIG. 8U, the electronic device 500 optionally displays selectable option 826 with the content player bar 806 in the playback user interface. In some embodiments, the selectable option 826 has one or more characteristics of the selectable option 626 described above with reference to the FIG. 6 series.

In some embodiments, as shown in FIG. 8U, the electronic device 500 displays selectable options 810-816 with the content player bar 606 in the playback user interface. In some embodiments, the selectable options 810-816 have one or more characteristics of the selectable options 810-816 described above. Additionally, the electronic device 500 optionally displays the live indicator 805 with the content player bar 806 in the playback user interface. In some embodiments, the live indicator 805 has one or more characteristics of the live indicator 805 described above. In some embodiments, as shown in FIG. 8U, the electronic device 500 displays one or more playback controls with the content player bar 806 in the playback user interface. For example, as shown in FIG. 8U, the electronic device 500 displays a first navigation affordance 815-1, a playback affordance 817, and/or a second navigation affordance 815-2. In some embodiments, one or more playback controls have one or more characteristics of the one or more playback controls described above with reference to the FIG. 6 series.

In FIG. 8U, while the content player bar 806 is displayed in the playback user interface, the electronic device 500 receives a selection and hold directed to the scrubber bar 808 in the content player bar 806. For example, as shown in FIG. 8U, the electronic device 500 receives contact 803h (e.g., a tap or touch provided by an object) on the touch screen 504 corresponding to a location of the scrubber bar 808 in the playback user interface, followed by a hold of the contact 803h on the touch screen 504 (e.g., without movement of the contact 803h) for a threshold amount of time (e.g., 0.5, 1, 2, 3, 5, 10, 15, 20, 30, 45, etc. seconds).

In some embodiments, as shown in FIG. 8V, in response to receiving the selection and hold directed to the scrubber bar 808 in the content player bar 806, the electronic device 514 displays one or more indications of key content corresponding to the live content item in the playback user interface. For example, as shown in FIG. 8V, the electronic device 514 increases a size of the content player bar 806 (e.g., a height of the content player bar 806) and displays one or more indications 855 of key content corresponding to the live content item within the content player bar 806. In some embodiments, the key content corresponds to the key content described previously herein above. In some embodiments, the one or more indications 855 of the key content are selectable to display the selected key content in a key content user interface (e.g., such as key content user interface 844 described above), as described in more detail below.

In FIG. 8V, while the one or more indications 855 are displayed in the content player bar 806 in the playback user interface, the electronic device 514 detects movement of the contact 803v leftward on the touch screen 504. In some embodiments, the movement of the contact 803v on the touch screen is a continuation of the selection and hold input described above. In some embodiments, the movement of the contact 803v corresponds to a request to scrub through the live content item in the playback user interface.

In some embodiments, as shown in FIG. 8W, in response to receiving the input scrubbing through the live content item, the electronic device 500 scrubs backward through the live content item in accordance with the input. For example, as shown in FIG. 8W, the electronic device 500 moves the scrubber bar 808 leftward within the content player bar 606 based on the leftward movement of the contact 803v. In some embodiments, the electronic device 500 updates a current playback position within the live content item based on the movement of the scrubber bar 808 within the content player bar 606. For example, because the scrubber bar 808 is moved leftward and away from a live edge 818 within the content player bar 806, the updated current playback position does not correspond to the live playback position within the live content item. Accordingly, as similarly discussed above with reference to the FIG. 6 series, the electronic device 500 optionally changes an appearance of the live indicator 805 and displays selectable option 820 in the playback user interface. In some embodiments, the selectable option 820 has one or more characteristics of the selectable option 820 described above. Additionally, as shown in FIG. 8W, the electronic device 500 updates display of the real-world time indicator 809 in the playback user interface. For example, as similarly described above with reference to the FIG. 6 series, the real-world time indicator 809 is optionally updated to express a time of day that corresponds to the updated current playback position within the live content item (e.g., 1:20 PM).

Additionally, in some embodiments, the electronic device 500 activates the second navigation affordance 815-2 in the playback user interface. For example, as shown in FIG. 8W, the electronic device 500 adjusts display of the second navigation affordance 815-2 to indicate that the second navigation affordance 815-2 is active, as similarly described above with reference to the FIG. 6 series.

In some embodiments, when the electronic device 500 scrubs backward through the live content item, the electronic device 500 deactivates one or more of the one or more indications of key content in the content player bar 806 based on the updated current playback position within the live content item. For example, as shown in FIG. 8W, the electronic device adjusts display of an indication 855-5 of fifth key content and an indication 855-6 of sixth key content within the content player bar, such as adjusting a brightness, opacity, saturation, color, etc. of the indication 855-5 and the indication 855-6, to indicate that the indication 855-5 and the indication 855-6 are no longer selectable to display the fifth key content and the sixth key content, respectively. In some embodiments, the indication 855-5 of the fifth key content and the indication 855-6 of the sixth key content are deactivated in the content player bar 806 because the indications 855-5 and 855-6 are located ahead of (e.g., to the right of) the scrubber bar 808 in the content player bar 806. For example, the fifth key content and the sixth key content are associated with playback positions within the live content item that chronologically ahead of the updated current playback position within the live content item. In some embodiments, the electronic device 500 ceases display of the indication 855-5 of the fifth key content and the indication 855-6 of the sixth key content within the content player bar 806. Additionally, as shown in FIG. 8W, an indication 855-1 of first key content and an indication 855-2 of second key content remain active within the content player bar 806 (e.g., are not displayed with a changed appearance) because the indications 855-1 and 855-2 are located before (e.g., to the left of) the scrubber bar 808 in the content player bar 806.

In some embodiments, the electronic device 500 displays a preview of key content in response to receiving a selection and hold directed to an indication of the key content in the content player bar 806. For example, in FIG. 8X, while the one or more indications of key content are displayed within the content player bar 806, the electronic device 514 detects a selection (e.g., a tap, touch, or press) and hold provided by a contact on the touch screen 504 directed to an indication 855-4 of fourth key content corresponding to the live content item for a threshold amount of time (e.g., 0.5, 1, 2, 3, 4, 5, 10, 15, 20, 30, etc. seconds). In some embodiments, as shown in FIG. 8X, in response to receiving the selection and hold directed to the indication 855-4 of the fourth key content, the electronic device 500 displays a preview 856 of the fourth key content in the playback user interface. For example, as shown in FIG. 8X, the electronic device 500 displays the preview 856 overlaid on the content player bar 806 (and/or related user interface elements) in the playback user interface. In some embodiments, as shown in FIG. 8X, the preview 856 includes a title of the fourth key content (e.g., “Player D Scores a Run”).

In some embodiments, as mentioned previously above, an (e.g., active) indication of key content within the content player bar 806 is selectable to display the key content at the electronic device 500. In FIG. 8Y, the electronic device 500 receives a selection of the indication 855-2 of the second key content in the content player bar 806. For example, the electronic device 500 detects contact 803y (e.g., a tap or touch of an object) on the touch screen 504 at a location corresponding to the indication 855-2.

In some embodiments, in response to receiving the selection of the indication 855-2 of the second key content, the electronic device 500 displays the second key content in key content user interface 844. For example, as shown in FIG. 8Z, the electronic device 500 ceases display of the playback user interface and displays the second key content (Key Content 2) in the key content user interface 844. In some embodiments, the key content user interface 844 corresponds to the key content user interface 844 described above. In some embodiments, as shown in FIG. 8Z, the electronic device 500 displays representative content corresponding to the second key content (e.g., an image or video clip of the second key content), a title 849-2 of the second key content (“Player B Strikes Out Player C”), and/or information 843-2 corresponding to the second key content, as similarly discussed above. Additionally, as shown in FIG. 8Z, the key content user interface 844 optionally includes selectable option 845 and the one or more navigation affordances (e.g., first navigation affordance 847-1 and second navigation affordance 847-2), as similarly discussed above.

FIGS. 8AA-8PP illustrate examples of electronic device 514 updating display of key content corresponding to a live content item displayed in a playback user interface in response to input scrubbing through the live content item. In FIG. 8AA, the electronic device 514 is concurrently displaying the content player bar 806 with the live content item (Live Content A) in the playback user interface. As shown in FIG. 8AA, the current playback position within the live content item optionally is the live playback position within the content item. For example, in FIG. 8AA, the scrubber bar 808 is located at the live edge within the content player bar 806 in the playback user interface. Accordingly, as shown in FIG. 8AA, the electronic device 514 is optionally displaying the live indicator 805 in the first visual state described previously above in the playback user interface. Additionally, in some embodiments, as similarly described above, the time of day expressed by the real-world time indicator 809 corresponds to the live playback position within the live content item.

In FIG. 8AA, the electronic device 514 is displaying the one or more representations of key content corresponding to the live content item described previously above. For example, as shown in FIG. 8AA, the electronic device 514 is displaying the representation 852-2 of the first key content corresponding to the live content item, the representation 852-2 of the second key content, the representation 852-3 of the third key content, the representation 852-4 of the fourth key content, and the representation 852-5 of the fifth key content. Additionally, as shown in FIG. 8AA and as similarly described above, the representations 852-1 to 852-5 are optionally displayed with a title (e.g., such as title 849-1) and information (e.g., such as information 843-1) corresponding to their respective key content.

In some embodiments, the electronic device 514 displays the one or more representations of the key content corresponding to the live content item in the playback user interface based on the current playback position within the live content item. For example, in FIG. 8BB, the electronic device 514 has received an input (e.g., via contact 803bb) corresponding to a request to scrub through the live content item displayed in the playback user interface. As shown in FIG. 8BB, the electronic device 514 optionally detects a tap, touch, press, or other input on the touch-sensitive surface 451 of the remote input device 510, followed by movement in a leftward direction on the touch-sensitive surface 451.

As shown in FIG. 8BB, in some embodiments, in response to receiving the input scrubbing through the live content item, the electronic device 514 updates the current playback position within the live content item. For example, as shown in FIG. 8BB, the electronic device 514 moves the scrubber bar 808 leftward in the content player bar 806 based on the leftward movement of the contact 803bb. In some embodiments, as shown in FIG. 8BB and as previously discussed above, when the electronic device 514 scrubs through the live content item, the electronic device 514 updates the real-world time indication 809 based on the updated current playback position within the live content item (e.g., the scrubbed to location within the live content item was first aired/broadcasted at 1:13 PM). Additionally, as shown in FIG. 8BB, because the updated current playback position within the live content item is not the live playback position, the electronic device 514 displays the live indicator 805 in the second visual state as described previously herein and displays the selectable option 820 in the playback user interface.

In some embodiments, as shown in FIG. 8BB, the electronic device 514 updates display of the one or more representations of the key content corresponding to the live content item in the playback user interface. For example, in FIG. 8BB, the electronic device 514 deactivates the representations of key content that are ahead of the updated current playback position within the live content item. As shown in FIG. 8BB, the electronic device 514 optionally ceases display of the representations 852-3 to 852-5 in the playback user interface. As similarly described above with reference to FIG. 8W, the third, fourth, and fifth key content associated with the representations 852-3 to 852-5, respectively, are associated with playback positions within the live content item that are chronologically ahead of the updated current playback position within the live content item. Accordingly, the electronic device 514 ceases display of the representations 852-3 to 852-5 until the current playback position within the content item includes the playback positions associated with the third, fourth, and/or fifth key content, respectively. As shown in FIG. 8BB, the electronic device 514 optionally maintains display of the representation 852-1 of the first key content and the representation 852-2 of the second key content in the playback user interface because the playback positions associated with the first key content and the second key content are located behind the updated current playback position within the content item.

FIGS. 9A-9B is a flow diagram illustrating a method 900 of facilitating interactions with key content corresponding to a live content item displayed in a key content user interface in accordance with some embodiments of the disclosure. The method 900 is optionally performed at an electronic device such as device 100, device 300, or device 500 as described above with reference to FIGS. 1A-1B, 2-3, 4A-4B and 5A-5C. Some operations in method 900 are, optionally combined and/or order of some operations is, optionally, changed.

As described below, the method 900 provides ways to facilitate interaction with key content corresponding to a live content item. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 900 is performed by an electronic device (e.g., device 514) in communication with a display generation component and one or more input devices (e.g., remote input device 510). For example, the electronic device is a mobile device (e.g., a tablet, a smartphone, a media player, or a wearable device) including wireless communication circuitry. In some embodiments, the electronic device has one or more characteristics of electronic devices in method 700. In some embodiments, the display generation component has one or more characteristics of the display generation component in method 700. In some embodiments, the one or more input devices has one or more characteristics of the one or more input devices in method 700.

In some embodiments, the electronic device displays (902a), via the display generation component, a first user interface associated with playback of a live content item, such as user interface 842 in FIG. 8A). For example, the electronic device is displaying a user interface for initiating playback of the live content item and/or for controlling playback of the live content item. In some embodiments, as described in more detail below, the first user interface is a user interface specific to the live content item. For example, the first user interface includes one or more options for initiating playback of the live content item (e.g., from the live edge in the live content item, as similarly discussed in method 700) and/or for presenting information related to the live content item (e.g., a canonical user interface for the live content item that is a user interface of a content browsing and/or playback application from which playback of the live content item can be initiated), such as key content associated with the live content item as discussed below. In some embodiments, as described in more detail below, the first user interface is a playback user interface (e.g., a content player, such as a movie player or other media player) that is displaying the live content item. For example, the first user interface includes a content player bar and one or more controls for controlling playback of the live content item. In some embodiments, the first user interface has one or more characteristics of the playback user interface in method 700. In some embodiments, the live content item corresponds to a live-broadcast content item and/or a live-streamed content item, such as a live-broadcast movie, TV episode, sporting event, awards show, political debate (e.g., presidential debate), competition/game show, etc. In some embodiments, the live content item has one or more characteristics of live content items in method 700.

In some embodiments, while displaying the first user interface, the electronic device receives (902b), via the one or more input devices, a first input corresponding to a request to display key content associated with the live content item, such as input provided by contact 803b directed to selectable option 848 as shown in FIG. 8B, wherein the live content item is associated with a sequence of key content, and wherein the key content included in the sequence of key content corresponds to one or more playback positions in a sequence of playback positions in the live content item. For example, the key content associated with the live content item includes highlights and/or significant events corresponding to the live content item (e.g., portions or snippets of the live content item). In some embodiments, the sequence of key content corresponds to playback positions in the live content item at which the highlights and/or significant events occur in a timeline of the live content item. For example, if the live content item is a sports event (e.g., a baseball game), the key content associated with the live content item includes game highlights, such as significant and/or game-defining plays (e.g., hits, homeruns, strikeouts), and the sequence of the key content corresponds to particular times and/or intervals at which a particular game highlight occurred, such as a particular moment in time in a particular inning of the baseball game. Accordingly, the sequence of the key content is optionally chronological as defined by the chronological (in time) sequence of playback positions in the live content item. As another example, if the live content item is a political debate (e.g., a presidential debate), the key content associated with the live content item optionally includes debate highlights, such as significant and/or note-worthy statements made by the political candidates (e.g., the presidential nominees), and the sequence of the key content corresponds to particular times and/or intervals at which a particular debate highlight occurred, such as at a moment in which a particular question was asked by the debate moderator and/or an audience member and/or a moment in which a particular candidate begins answering the question. In some embodiments, while displaying the first user interface, the electronic device receives an input corresponding to a request to initiate display of the sequence of key content. For example, the electronic device detects a selection input directed to a selectable option displayed in the first user interface. As described below, if the first user interface is a user interface that is specific to the live content item (e.g., that is not currently displaying the live content item, but rather information corresponding to the live content item), the first input optionally includes selection of a selectable option that is selectable to cause the electronic device to display the sequence of key content. If the first user interface is a playback user interface that is displaying the live content item, the first input optionally includes selection of a selectable representation of first key content in the sequence of key content (e.g., displayed below the content player bar in the playback user interface), as discussed in more detail below. Alternatively, if the first user interface is the playback user interface that is displaying the live content item, the first input optionally includes selection of a selectable indication of one of the sequence of key content. For example, as described in more detail below, the content player bar in the playback user interface optionally includes a plurality of selectable indications corresponding to the sequence of key content. In some embodiments, the electronic device detects the first input via a touch-sensitive surface of the one or more input devices. For example, the electronic device detects a tap on the touch-sensitive surface of the one or more input devices directed to the first user interface. In some embodiments, the electronic device detects the first input via a remote input device in communication with the electronic device. For example, the electronic device detects a press/click of a hardware button on the remote input device. In some embodiments, the first input has one or more characteristics of inputs in method 700.

In some embodiments, in response to receiving the first input (902c), the electronic device ceases (902d) display of the first user interface associated with the playback of the live content item, as similarly shown in FIG. 8C. For example, the electronic device replaces display of the user interface that is specific to the live content item or the playback user interface that is displaying the live content item with a second user interface corresponding to the key content, as discussed below.

In some embodiments, the electronic device displays (902e), via the display generation component, a second user interface corresponding to the key content, such as key content user interface 844 in FIG. 8C, wherein the second user interface includes a representation of first key content in the sequence of key content (e.g., Key Content 1 in FIG. 8C) without displaying a representation of second key content in the sequence of key content, and wherein the first key content corresponds to a first playback position in the sequence of playback positions in the live content item. For example, the electronic device displays the second user interface corresponding to the key content, wherein the second user interface is configured to present representations of the key content in the sequence of key content. In some embodiments, the second user interface displays one representation of key content at a time. For example, the second user interface is currently displaying the representation of the first key content and is not displaying a representation of second key content in the sequence of key content (e.g., the representation of the first key content occupies all or a portion of the second user interface). As discussed above, in some embodiments, the sequence of key content corresponds to a sequence of playback positions in the live content item. For example, as similarly discussed above, the first key content corresponds to a first highlighted event of the live content item that is associated with the first playback position (e.g., occurred at a moment in time associated with the first playback position). In some embodiments, the representation of the first key content includes information associated with the first key content and/or the first playback position. For example, the representation of the first key content includes a title of the first key content, such as a title summarizing the highlighted event (e.g., game highlight, movie scene highlight, political debate highlight) associated with the first key content. Additionally, the representation of the first key content optionally includes representative content corresponding to the first key content, such as a preview of the first key content (e.g., an image or video clip of the live content item at the first playback position). For example, if the live content is a sports game (e.g., a baseball game), the representative content corresponding to the first key content includes an image of a sports player in the sports game and/or a video clip of the highlighted event in the sports game (e.g., an image of and/or a video clip of the baseball player hitting a homerun). In some embodiments, if the representative content corresponding to the first key content includes video of the highlighted event, the video is a recording of the highlighted event (e.g., if the first key content is a homerun by a baseball player in a baseball game, the video is a video recording of the baseball player hitting the homerun and subsequently running the bases). In some embodiments, the representation of the first key content includes a text label indicating a number of the sequence of key content. For example, the representation of the first key content includes a text label indicating a position of the first key content in the number of the sequence of key content (e.g., “Key Content 1 of 5”). In some embodiments, the representation of the first key content includes information indicative of the first playback position to which the first key content corresponds. For example, the representation of the first key content includes text indicating a particular moment or interval in the live content item at which the highlighted event corresponding to the first key content occurred. For example, if the live content item is a sports game (e.g., a baseball game), the representation of the first key content includes text indicating a relative time during the game the highlighted event occurred (e.g., a text label indicating the inning and/or real-world time during/at which a particular play (e.g., a homerun or strikeout) occurred). In some embodiments, the text label indicating a number of the sequence of key content and/or the information indicative of the first playback position are overlaid on the representative content corresponding to the first key content discussed above. In some embodiments, as discussed in more detail below, the electronic device is configured to display additional representations of key content in the sequence of key content (e.g., replace display of the representation of the first key content) in the second user interface.

In some embodiments, while displaying the second user interface that includes the representation of the first key content, the computer system detects (902f) that an event has occurred. For example, as discussed in more detail below, the electronic device detects an input directed to the second user interface. In some embodiments, the input includes a tap on a touch-sensitive surface of the one or more input devices. In some embodiments, the input includes a click/press of a hardware button on a remote input device in communication with the electronic device.

In some embodiments, in response to detecting that the event has occurred (902g), in accordance with a determination that the event includes an input corresponding to a request to navigate through the sequence of key content, such as input provided by contact 803d directed to first navigation affordance 847-1 as shown in FIG. 8D, the electronic device transitions (902h) from displaying the representation of the first key content in the second user interface to displaying a representation of the second key content in the sequence of key content in the second user interface, such as displaying second key content in the key content user interface 844 as shown in FIG. 8E. For example, the electronic device replaces display of the representation of the first key content with the representation of the second key content in the second user interface. In some embodiments, the representation of the first key content includes a selectable affordance that is selectable to cause the electronic device to transition the display of the representation of the first key content to the display of the representation of the second key content in the second user interface. For example, the representation of the first key content includes one or more navigation affordances (e.g., a left arrow and/or a right arrow) that are selectable navigate through the sequence of key content. In some embodiments, the electronic device displays the one or more selectable navigation affordances based on a position of the first key content within the sequence of key content, and/or whether additional key content is available beyond the first key content, as described in more detail below. In some embodiments, the input corresponding to the request to navigate through the sequence of key content includes selection of one of the selectable navigation affordances (e.g., a selection of the left arrow affordance or optionally the right arrow affordance) in the representation of the first key content. In some embodiments, the second key content is adjacent to (e.g., is positioned before or after) the first key content in the sequence of key content. In some embodiments, the second key content corresponds to a second playback position in the sequence of playback positions that is chronologically positioned before or after (e.g., optionally adjacent to) the first playback position to which the first key content corresponds. In some embodiments, as similarly discussed above, the representation of the second key content includes information associated with the second key content and/or the second playback position. In some embodiments, the representation of the second key content has one or more characteristics of the representation of the first key content discussed above. In some embodiments, as discussed in more detail below, the electronic device automatically transitions from displaying the representation of the first key content in the second user interface to displaying the representation of the second key content (e.g., in response to detecting a threshold amount of time (e.g., 1, 2, 3, 4, 5, 10, 15, 20, 30, 60, 90, or 120 seconds) has elapsed since initially displaying the representation of the first key content in the second user interface).

In some embodiments, in accordance with a determination that the event includes an input corresponding to a request to play the live content item (902i), such as selection of selectable option 845 provided by contact 803i as shown in FIG. 8I, the electronic device ceases (902j) display of the second user interface corresponding to the key content, as similarly shown in FIG. 8J. For example, the electronic device ceases display of the representation of the first key content in the sequence of key content. In some embodiments, the representation of the first key content includes a selectable option that is selectable to initiate playback of the live content item. In some embodiments, the electronic device displays and/or activates the selectable option in the representation of the first key content in accordance with a determination that the user is entitled to consume (e.g., view) the live content item on the electronic device. For example, the user is entitled to consume the live content item if the user is logged into a user account associated with the user on the electronic device and the user account has authorization from a media provider (e.g., based on the user's account credentials) to access the live content item from the media provider. In some embodiments, if the user is not entitled to consume the live content item on the electronic device, the electronic device forgoes displaying and/or activating the selectable option in the representation of the first key content. For example, the electronic device does not display the selectable option in the representation of the first key content and/or displays the selectable option in an inactive state (e.g., greyed out) indicating that the selectable option is not selectable to initiate playback of the live content item. Additionally, in some embodiments, if the user is not entitled to consume the live content item, the electronic device displays a second selectable option that is selectable to initiate a process for obtaining entitlement to consume the live content item (e.g., signing into a user account associated with the user on the electronic device and/or obtaining authorization from a media provider (e.g., purchasing a subscription from the media provider and/or providing access credentials to the media provider)). In some embodiments, the input corresponding to the request to play the live content item includes selection of the selectable option in the representation of the first key content.

In some embodiments, the electronic device initiates (902k) playback of the live content item at a current live playback position within the live content item, such as displaying the live content item (Live Content A) in playback user interface 802 as shown in FIG. 8J. For example, the electronic device replaces display of the second user interface that includes the representation of the first key content with a playback user interface that is configured to display (e.g., playback) the live content item. In some embodiments, if the first user interface is the playback user interface displaying the live content item when the first input was detected, the electronic device redisplays the first user interface (e.g., with an updated playback position in the live content item, such as updated to be the currently-live playback position in the live content item) in response to detecting the input corresponding to the request to play the live content item. In some embodiments, the electronic device displays the live content item in the playback user interface at the live edge. For example, the electronic device displays the live content item in the playback user interface at an up-to-date playback position in the live content item (e.g., based on streaming data provided by the media provider of the live content item). Navigating through a sequence of key content corresponding to a live content item or initiating playback of the live content enables the user to consume highlighted information included in the key content without consuming the live content item and/or enables the user to consume the highlighted information included in the key content that occurred before a current live playback position in the live content item to facilitate understanding of a status of the live content item before consuming the live content item at the current live playback position, thereby improving user-device interaction.

In some embodiments, the first user interface associated with the live content item is a user interface corresponding to the live content item that is accessible via a media browsing application and that does not include playback of the live content item, such as the user interface 842 in FIG. 8A. For example, as similarly discussed above, the first user interface is a canonical user interface for the live content item (e.g., a user interface of a content browsing and/or playback application from which playback of the live content item can be initiated) that does not currently include playback of the live content item (e.g., the canonical user interface is not a playback user interface described below). In some embodiments, the user interface corresponding to the live content item includes representative content corresponding to the live content item, such as an image, video clip, audio clip, and the like, that provides visual context of the live content item. In some embodiments, as described below, the user interface corresponding to the live content item includes one or more selectable options that are selectable to cause the electronic device to perform one or more actions associated with the live content item (e.g., initiating playback of the live content item and/or displaying key content corresponding to the live content item). In some embodiments, the media browsing application facilitates quick browsing of content that is available for consumption on the electronic device. For example, while displaying a media browsing application user interface, the computer system displays a plurality of representations of content and corresponding information to enable the user to select a particular content item for playback. In some embodiments, the user interface corresponding to the live content is displayed in response to navigation to a particular content category within the media browsing application user interface (e.g., in response to navigating to a “Sports” tab in the media browsing application user interface if the live content item is a sports game).

In some embodiments, the user interface corresponding to the live content item includes a first selectable option (e.g., selectable option 848 in FIG. 8A) that is selectable to display the key content associated with the live content item. For example, the user interface corresponding to the live content item (e.g., the canonical user interface for the live content) includes a first selectable option that is selectable to cause the electronic device to display the key content associated with the live content, including displaying the second user interface, as similarly described above. In some embodiments, the first selectable option includes a textual indication (e.g., “Key Content,” or “Catch Up”) that indicates the key content is available for the live content item, and that selection of the first selectable option will cause the electronic device to display the second user interface corresponding to the key content.

In some embodiments, the first input includes selection of the first selectable option, such as selection of the selectable option 848 provided by contact 803b as shown in FIG. 8B. For example, as similarly described above, the electronic device detects a selection of the first selectable option. In some embodiments, the electronic device detects the selection via a remote input device in communication with the electronic device. For example, the electronic device detects a press of a hardware button on the remote input device while the first selectable option has focus. In some embodiments, the electronic device detects the selection via a touch-sensitive surface of the one or more input devices. For example, the electronic device detects a tap on a touch screen of the electronic device directed to the first selectable option and/or on a track pad in communication with the electronic device directed to the first selectable option. Initiating display of a sequence of key content corresponding to a live content item via a user interface corresponding to the live content item enables the user to consume highlighted information included in the key content without consuming the live content item to facilitate understanding of a status of the live content item before consuming the live content item at the current live playback position, thereby improving user-device interaction.

In some embodiments, the user interface corresponding to the live content item further includes a second selectable option (e.g., selectable option 846 in FIG. 8A) that is selectable to initiate playback of the live content item at the current live playback position within the live content item. For example, the user interface corresponding to the live content item (e.g., the canonical user interface for the live content item) also includes a second selectable option that is selectable to play the live content item on the electronic device. In some embodiments, as similarly described above, initiating playback of the live content item includes ceasing display of the user interface corresponding to the live content item and displaying a playback user interface that displays the live content item. In some embodiments, the electronic device displays the live content item in the playback user interface at an up-to-date playback position in the live content item (e.g., based on streaming data provided by the media provider of the live content item), as similarly described above. Initiating playback of a live content item via a user interface corresponding to the live content item reduces the number of inputs needed to consume the live content item at the current live playback position and/or enables the user to easily initiate playback of the live content after consuming highlighted information included in key content corresponding to the live content item that occurred before the current live playback position in the live content item, thereby improving user-device interaction.

In some embodiments, the first user interface associated with the live content item is a playback user interface that is configured to playback content, such as playback user interface 802 in FIG. 8M. For example, as similarly described above, the first user interface is a playback user interface that is displaying the live content item. In some embodiments, the current playback position in the live content item is at the live playback position in the live content item (e.g., an up-to-date playback position in the live content item (e.g., based on streaming data provided by the media provider of the live content item)), as similarly described above. In some embodiments, the current playback position in the live content item is before the live playback position in the live content item (e.g., as a result of scrubbing backward through (e.g., rewinding) the live content item). In some embodiments, the playback user interface has one or more characteristics of the playback user interface in method 700.

In some embodiments, the live content item is displayed in the playback user interface, as similarly shown in FIG. 8M. In some embodiments, the playback user interface includes a content player bar (e.g., content player bar 806) for navigating through the live content item. For example, the electronic device is concurrently displaying the content player bar and the live content item in the playback user interface. In some embodiments, the content player bar is displayed over the live content item along a bottom portion of the live content item on the display (e.g., on the touch screen). In some embodiments, the content player bar is displayed in the playback user interface in response to receiving an input corresponding to a request to display the content player bar (e.g., a tap or press detected via a touch-sensitive surface or a remote input device in communication with the electronic device). In some embodiments, while the content player bar is displayed, the electronic device maintains playback of the live content item (e.g., continues playing the live-broadcast content item in the content player). In some embodiments, while the content player bar is displayed, the electronic device pauses playback of the live content item and displays representative content (e.g., an image or thumbnail) corresponding to the live content item in the playback user interface. In some embodiments, portions of the content player bar that correspond to the portions of the live content item that have already been played back (e.g., irrespective of when the electronic device initiated playback of the live content item) are visually distinguished from portions of the content player bar that correspond to portions of the live content item that have not yet been played back (e.g., beyond the live edge). For example, the electronic device highlights/fills in (e.g., bubbles) the portions of the content player bar that correspond to the portions of the live content item that have already been played back. In some embodiments, an end of the highlighted/bubbled in portion of the content player bar indicates the live edge in the live-broadcast content item. In some embodiments, the content player bar includes a visual indication (e.g., a play head) of the current playback position within the content. In some embodiments, as described in more detail below, the content player bar includes one or more indications of the key content that allow the user to access the sequence of key content via the content player bar in the playback user interface. In some embodiments, the content player bar has one or more characteristics of the content player bar in method 700. Displaying a live content item in a playback user interface that includes a content player bar enables the user to consume highlighted information included in key content, via the content player bar, that occurred before a current live playback position in the live content item to facilitate understanding of a status of the live content item before consuming the live content item at the current live playback position, thereby improving user-device interaction.

In some embodiments, the content player bar (e.g., content player bar 806 in FIG. 8U) includes a visual indication of a current playback position within the live content item, such as scrubber bar 808 in FIG. 8U. For example, the content player bar includes a play head that indicates the current playback position within the live content item. In some embodiments, the visual indication is selectable to initiate scrubbing through the live content item. For example, a press and hold of a contact directed to the visual indication (e.g., detected via a touch-sensitive surface in communication with the electronic device, such as a touch screen) followed by movement of the contact causes the electronic device to scrub through the live content item. In some embodiments, a location of the visual indication within the content player bar updates in accordance with updates to the current playback position within the live content item. For example, if the current playback position changes due to input scrubbing through the live content item (e.g., rewinding or fast forwarding through the live content item), the electronic device moves the visual indication within the content player bar to correspond to the current playback position in the live content item.

In some embodiments, the content player bar includes one or more indications of the sequence of key content, such as indications 855 of key content in FIG. 8V, wherein one or more locations of the one or more indications of the sequence of key content within the content player bar correspond to the one or more playback positions in the sequence of playback positions in the live content item. For example, the content player bar in the playback user interface includes one or more indications (e.g., graphical markers, such as dots, dashes, and/or lines) of the key content in the sequence of key content. In some embodiments, the one or more indications of the sequence of key content are displayed in the content player bar at one or more locations that correspond to the one or more playback positions in the sequence of playback positions with which the sequence of key content corresponds. For example, a first indication of the one or more indications of the sequence of key content corresponds to first key content in the sequence of key content and is located at a first location in the content player bar that corresponds to a first playback position in the one or more playback positions at which the first key content occurred within the live content item. Accordingly, as described in more detail below, an input directed to the first indication corresponding to the first key content causes the electronic device to display the second user interface corresponding to the sequence of key content. Displaying a live content item in a playback user interface that includes a content player bar enables the user to consume highlighted information included in key content, via one or more indications of the key content in the content player bar, that occurred before a current live playback position in the live content item to facilitate understanding of a status of the live content item before consuming the live content item at the current live playback position, thereby improving user-device interaction.

In some embodiments, the first input includes selection of a first indication of the one or more indications of the sequence of key content in the content player bar that corresponds to the first key content, such as selection of indication 855-2 of key content provided by contact 803y as shown in FIG. 8Y. For example, as similarly described above, the electronic device receives a selection input directed to the first indication corresponding to the first key content in the content player bar in the playback user interface. In some embodiments, the electronic device receives an input corresponding to a request to navigate to the one or more indications before receiving the selection of the first indication of the one or more indications. For example, while the content player bar is displayed in the playback user interface, the electronic device receives a navigation input (e.g., a downward swipe gesture detected via a touch-sensitive surface of the one or more input devices, a tap directed to the first indication detected via a touch screen of the electronic device, or a press of a hardware button of a remote input device in communication with the electronic device for navigating downward in the playback user interface). In some embodiments, in response to receiving the navigation input, the electronic device moves a current focus to the first indication in the content player bar. For example, the electronic device displays the first indication with an indication of focus, such as with bolding/highlighting, displaying the first indication at a larger size, changing a coloration of the first indication, and/or displaying a visual element (e.g., a band/border) around the first indication. In some embodiments, while the first indication in the content player bar has the focus, the electronic device receives the first input selecting the first indication. In some embodiments, the selection input directed to the first indication has one or more characteristics of input described above. In some embodiments, while the first indication in the content player bar has the focus, an input navigating laterally moves the current focus to a second indication (e.g., corresponding to second key content) in the content player bar. For example, a leftward/rightward navigation input (e.g., a left/right swipe gesture detected via a touch-sensitive surface of the one or more input devices, a tap directed to the second indication detected via a touch screen of the electronic device, or a press of a hardware button of a remote input device in communication with the electronic device for navigating leftward/rightward in the playback user interface) causes the electronic device to move the current focus to the second indication in the content player bar. Displaying a live content item in a playback user interface that includes a content player bar enables the user to consume highlighted information included in key content, in response to selection of an indication of the key content in the content player bar, that occurred before a current live playback position in the live content item to facilitate understanding of a status of the live content item before consuming the live content item at the current live playback position, thereby improving user-device interaction.

In some embodiments, the one or more playback positions in the sequence of playback positions in the live content item include a first subset of playback positions within the live content item that are located before the current playback position within the live content item, such as indications 855-1 and 855-2 shown in FIG. 8W. For example, as described above, portions of the content player bar that correspond to the portions of the live content item that have already been played back (e.g., optionally irrespective of the live playback position within the live content item) are visually distinguished from portions of the content player bar that correspond to portions of the live content item that have not yet been played back (e.g., beyond the live edge and/or beyond the current playback position). In some embodiments, the first subset of playback positions within the live content are located within the portions of the content player bar that correspond to the portions of the live content item that have already been played back.

In some embodiments, the one or more playback positions in the sequence of playback positions in the live content item include a second subset of playback positions within the live content item that are located after the current playback position within the live content item, such as indications 855-5 and 855-6 shown in FIG. 8W. For example, the second subset of playback positions in the live content are located after the first subset of playback positions discussed above. In some embodiments, the second subset of playback positions within the live content are located within the portions of the content player bar that correspond to the portions of the live content item that have not yet been played back (e.g., relative to the current playback position within the live content).

In some embodiments, displaying the one or more indications of the sequence of key content in the content player bar includes displaying a first subset of the one or more indications that correspond to the first subset of playback positions in the live content item, such as displaying the indications 855-1 and 855-2 as shown in FIG. 8W. For example, the electronic device displays the first subset of the one or more indications within the portions of the content player bar that correspond to the portions of the live content item that have already been played back. In some embodiments, the first subset of the one or more indications that correspond to the first subset of playback positions in the live content item are displayed with a first visual prominence relative to the content player bar in the playback user interface. For example, the first subset of the one or more indications are displayed and/or are displayed with the first visual prominence to indicate that the indications in the first subset of the one or more indications are selectable to display key content corresponding to the indications.

In some embodiments, forgoing display of a second subset of the one or more indications that correspond to the second subset of playback positions in the live content item, such as deactivating the indications 855-5 and 855-6 as described with reference to FIG. 8W. For example, the electronic device does not display the second subset of the one or more indications within the portions of the content player bar that correspond to the portions of the live content item that have not yet been played back (e.g., chronologically come after the first subset of the one or more indications). In some embodiments, the second subset of the one or more indications that correspond to the second subset of playback positions in the live content item are displayed with a second visual prominence, different from the first visual prominence, relative to the content player bar in the playback user interface. For example, the second subset of the one or more indications are not displayed or are visually deemphasized (e.g., displayed with a greyed out/shaded or dashed appearance) to indicate that the indications in the second subset of the one or more indications are not selectable to display key content corresponding to the indications. In some embodiments, if an advance of the current playback position in the live content item causes the portions of the content player bar that correspond to the portions of the live content item that have already been played back to include one or more first indications in the second subset of the one or more indications (e.g., compared to before the advance of the current playback position), the electronic device updates display of the one or more first indications in the second subset of the one or more indications. For example, the electronic device displays the one or more first indications in the content player bar and/or displays the one or more first indications with the first visual prominence described above. Visually differentiating one or more indications of key content that includes highlighted information in a live content item in a content player bar based on a current playback position within the live content item facilities discover that the highlighted information in the key content is available and/or facilitates user input for displaying the highlighted information included in the key content, which facilitates understanding of a status of the live content item, thereby improving user-device interaction.

In some embodiments, before displaying the content player bar in the playback user interface that is displaying the live content item, the electronic device receives, via the one or more input devices, an input corresponding to a request to display the content player bar while the playback user interface is displayed, such as input provided by contact 803t on the touch screen 504 as shown in FIG. 8T. For example, as similarly described above, the content player bar is not concurrently displayed with the live content item in the playback user interface without receiving user input corresponding to a request to display the content player bar in the playback user interface. In some embodiments, the input includes a tap detected on a touch-sensitive surface of the one or more input devices (e.g., on a remote input device in communication with the electronic device), a click of the touch-sensitive surface, or a selection of a hardware button of a remote input device in communication with the electronic device. In some embodiments, the first input is detected via a touch screen of the electronic device. For example, the electronic device detects a tap or touch provided by an object (e.g., a finger of the user or a hardware input device, such as a stylus) via the touch screen while the live content item is displayed.

In some embodiments, in response to receiving the input, the electronic device displays, via the display generation component, the content player bar that includes the one or more indications of the sequence of key content in the playback user interface, such as the content player bar 806 in FIG. 8V, wherein the current playback position within the live content does not correspond to the live playback position within the live content when the input is received. For example, the electronic device concurrently displays the content player bar with the live content item in the playback user interface. In some embodiments, when the input requesting display of the content player bar is received, the current playback position within the live content item is not at the live edge within the live content item. Accordingly, when the content player bar including the one or more indications of the sequence of key content is displayed in the playback user interface, the second subset of the one or more indications is optionally not displayed in the content player bar because the current playback position within the live content was not at the live edge (e.g., is at a playback position that is before the live edge) when the input was received. For example, the second subset of the one or more indications are not displayed or are visually deemphasized (e.g., displayed with a greyed out/shaded or dashed appearance) to indicate that the indications in the second subset of the one or more indications are not selectable to display key content corresponding to the indications, as discussed above. In some embodiments, if the current playback position in the live content is at the live edge when the input corresponding to the request to display the scrubber is received, the electronic device does not forgo displaying any of the one or more indications of the sequence of key content (e.g., because, currently in the broadcast of the live content item at the live edge, no key content has been created for the live content item beyond the live playback position). Visually differentiating one or more indications of key content that includes highlighted information in a live content item in a content player bar based on a current playback position within the live content item relative to the live playback position facilities discovery that the highlighted information in the key content is available and/or facilitates user input for displaying the highlighted information included in the key content, which facilitates understanding of a status of the live content item, thereby improving user-device interaction.

In some embodiments, while displaying the content player bar that includes the one or more indications of the sequence of key content, the electronic device receives, via the one or more input devices, an input corresponding to a request to move a current focus to a respective indication of the one or more indications in the content player bar, such as indication 855-4 in FIG. 8X. For example, the live content item has the current focus when the input is received. In some embodiments, a respective option (e.g., a play/pause button or a navigation option) in the content player bar has the current focus when the input is received. In some embodiments, the input includes a swipe gesture detected on a touch sensitive surface of the one or more input devices (e.g., a touch sensitive surface of a remote input device in communication with the electronic device). In some embodiments, the input includes a press on a navigation button (e.g., a downward arrow) of a remote input device in communication with the electronic device. In some embodiments, the input includes a tap detected on a touch sensitive surface of the one or more input devices (e.g., detected on a touch screen of the electronic device) directed to the respective indication in the content player bar.

In some embodiments, in response to receiving the input, the electronic device moves the current focus to the respective indication in the content player bar, as similarly shown in FIG. 8X. For example, the electronic device displays the respective indication with an indication of the current focus. In some embodiments, moving the current focus to the respective indication includes displaying a graphical element around a boundary of the respective indication (e.g., boldening/highlighting a perimeter of the respective indication). In some embodiments, moving the current focus to the respective indication includes displaying the respective indication with visual prominence relative to the user interface objects (e.g., selectable options and/or indications) of the content player bar. For example, the respective indication is displayed at a larger size than before the electronic device received the input, with increased brightness or color saturation, and/or with an animation effect (e.g., a sparkling or glistening effect).

In some embodiments, the electronic device displays, via the display generation component, information corresponding to respective key content in the sequence of key content that is associated with the respective indication in the playback user interface, such as information included in preview 856 in FIG. 8X, without displaying the second user interface corresponding to the key content. For example, when the electronic device moves the current focus to the respective indication in the content player bar, the electronic device displays information corresponding to the respective key content associated with the respective indication in the content player bar. In some embodiments, the information corresponding to the respective key content includes one or more statistics of the live content item that are associated with a respective playback position in the live content item that corresponds to the respective key content. For example, if the live content item is a live sports game, the one or more statistics included in the information corresponding to the respective key content refers to a number of runs, baskets, or touchdowns scored during a respective time in the live sports game (e.g., inning or quarter in the live sports game), as similarly described above. In some embodiments, the information corresponding to the respective key content includes representative content corresponding to the key content, such as an image, video clip, and/or audio recording of the respective key content, as similarly described above. In some embodiments, the information corresponding to the respective key content includes a number of the respective key content in the sequence of key content (e.g., “Key Content 2 of 10”), as similarly described above. In some embodiments, the electronic device displays the information corresponding to the respective key content without displaying the second user interface corresponding to the key content. For example, the electronic device forgoes ceasing display of the playback user interface and displaying the second user interface that includes a representation of the respective key content in response to receiving the input. Displaying information corresponding to respective key content that includes highlighted information in a live content item in response to input moving a current focus to respective indication of the respective key content a content player bar facilitates understanding of a status of the live content item without ceasing playback of the live content item and/or facilities user input for displaying a user interface corresponding to the respective key content, thereby improving user-device interaction.

In some embodiments, the playback user interface includes a selectable option (e.g., selectable option 812 in FIG. 8M) that is selectable to display one or more respective representations of key content in the sequence of key content in a predefined region relative to the content player bar (e.g., below the content player bar) in the playback user interface. For example, when the electronic device displays the content player bar in the playback user interface, the electronic device also displays a selectable option that is selectable to display the one or more respective representations of the key content in the sequence of key content below the content player bar. In some embodiments, the respective representations of the key content include representative content corresponding to the key content, such as an image or video clip of the key content, and/or a title/name of the key content. In some embodiments, the one or more respective representations of the key content are selectable to cause the electronic device to display the second user interface corresponding to the key content, as described below. In some embodiments, the one or more respective representations of the key content are scrollable within the playback user interface. For example, an input corresponding to a request to scroll through the one or more respective representations of the key content (e.g., such as a tap and swipe gesture detected on a touch-sensitive surface or a press of a navigation button of a remote input device in communication with the electronic device) causes the electronic device to (e.g., horizontally) scroll through the one or more respective representations in the playback user interface in accordance with the input.

In some embodiments, the first input includes a sequence of one or more inputs corresponding to a selection of a first respective representation of the first key content in the predefined region in the playback user interface, such as selection of the selectable option 812 provided by contact 803n as shown in FIG. 8N and selection of representation 852-2 of second key content provided by contact 803p as shown in FIG. 8P. For example, the electronic device receives a selection of the selectable option in the playback user interface, followed by a selection of a first respective representation of the first key content of the one or more respective representations of the key content. In some embodiments, as similarly described above, in response to detecting the first input, the electronic device ceases display of the playback user interface (e.g., including the live content item, the content player bar, and the one or more respective representations of the key content) and displays the second user interface corresponding to the key content that includes the representation of the first key content. Displaying a user interface corresponding to key content that includes highlighted information in a live content item in response to input selecting a respective representation of the key content displayed in a playback user interface that is displaying the live content item reduces the number of inputs needed to display the user interface corresponding to the key content, which facilitates understanding of a status of the live content item, and/or enables the input causing display of the user interface corresponding to the key content to be received without ceasing playback of the live content item, thereby improving user-device interaction.

In some embodiments, the second user interface corresponding to the key content includes one or more navigation options that are selectable to navigate through the sequence of key content, such as the first navigation affordance 847-1 in FIG. 8C. For example, the one or more navigation options include a forward option (e.g., displayed visually as a rightward (e.g., “Next”) indication) and/or a backward option (e.g., displayed visually as a leftward (e.g., “Previous”) indication). In some embodiments, a first navigation option (e.g., the forward option) of the one or more navigation options is selectable to cause the electronic device to navigate forward through the sequence of key content in the second user interface. In some embodiments, a second navigation option (e.g., the backward option) of the one or more navigation options is selectable to cause the electronic device to navigate backward through the sequence of key content in the second user interface. In some embodiments, the one or more navigation options are selectively displayed in the second user interface based on the number of the key content in the sequence of key content. For example, if the first key content is chronologically first in the sequence of key content, the second user interface does not include the second navigation option (e.g., the backward option). If the key content is chronologically last in the sequence of key content, the second user interface optionally does not include the first navigation option (e.g., the forward option).

In some embodiments, the input corresponding to the request to navigate through the sequence of key content includes selection of a first navigation option of the one or more navigation options displayed with the representation of the first key content in the second user interface, such as selection of the first navigation affordance 847-1 provided by contact 803d as shown in FIG. 8D. For example, the electronic device detects selection of the first navigation option in the second user interface that causes the electronic device to transition from displaying the representation of the first key content to displaying the representation of the second key content in the second user interface, as similarly described above. In some embodiments, selection of the first navigation option causes the electronic device to navigate forward in the sequence of key content (e.g., such that the second key content chronologically follows the first key content, or to navigate backward in the sequence of key content (e.g., such that the second key content chronologically precedes the first key content), as similarly discussed above. Navigating through a sequence of key content corresponding to a live content item by selecting a navigation option enables the user to consume highlighted information included in the key content without consuming the live content item and/or enables the user to consume the highlighted information included in the key content that occurred before a current live playback position in the live content item to facilitate understanding of a status of the live content item before consuming the live content item at the current live playback position, thereby improving user-device interaction.

In some embodiments, a representation of respective key content (e.g., including the representation of the first key content and the representation of the second key content) in the sequence of key content includes representative content corresponding to the respective key content, as described with reference to FIG. 8C. For example, as similarly described above, the representative content corresponding to the respective key content includes a preview of the respective key content (e.g., an image, video clip, and/or audio recording of the live content item at a respective playback position within the live content item).

In some embodiments, the representation of respective key content in the sequence of key content includes an identifier of the respective key content, such as title 849-1 of the first key content in FIG. 8C. For example, as similarly described above, the identifier of the respective key content includes a name or title of the respective key content. In some embodiments, the identifier is expressed as a textual phrase summarizing the respective key content (e.g., in a handful of words). For example, if the live content item is a sports game, the identifier of the respective key content summarizes a key play in the sports game (e.g., “First-baseman John Smith Hits a Solo Home Run”).

In some embodiments, the representation of respective key content in the sequence of key content includes information corresponding to the respective key content, such as information 843-1 corresponding to the first key content in FIG. 8C. For example, the information corresponding to the key content includes a live event time within the respective key content at which the respective key content occurred and/or a number of the respective key content in the sequence of key content, as described below. Displaying a representation of respective key content corresponding to a live content item that includes highlighted information included in the key content without consuming the live content item enables the user to consume the highlighted information that occurred before a current live playback position in the live content item to facilitate understanding of a status of the live content item before consuming the live content item at the current live playback position, thereby improving user-device interaction.

In some embodiments, the information corresponding to the respective key content includes a time indication that indicates a time at which the respective key content occurred in the live content item, such as “Top of the 1st” shown in information 843-1 in FIG. 8C. For example, the time indication is expressed as a time of day in the live content item at which the respective key content occurred (e.g., “3:35 PM”). In some embodiments, the time indication is expressed as a unit in the representation of the respective key content. For example, if the live content is a sports game, the time indication is expressed as a unit of play in the sports game (e.g., “4th inning” or “3rd quarter”). If the live content item is a live-broadcast of a movie or television episode, the time indication is expressed as a unit of structure (e.g., “Chapter 2” or “Act 3”).

In some embodiments, the information corresponding to the respective key content includes a number of the respective key content in the sequence of key content, such as “1 of 5” shown in the information 843-1 in FIG. 8C. For example, as similarly described above, the number of the respective key content in the sequence of key content is expressed as a text label indicating a position of the respective key content in the sequence of key content (e.g., “Key Content 2 of 5”). In some embodiments, if the sequence of key content only includes first key content, the electronic device forgoes displaying the number of the respective key content in the second user interface. Displaying a representation of respective key content corresponding to a live content item that includes highlighted information included in the key content without consuming the live content item enables the user to consume the highlighted information that occurred before a current live playback position in the live content item to facilitate understanding of a status of the live content item before consuming the live content item at the current live playback position, thereby improving user-device interaction.

In some embodiments, while displaying the representation of the second key content in the sequence of key content in the second user interface in accordance with the determination that the event includes the input corresponding to a request to navigate through the sequence of key content, the electronic device detects that a threshold amount of time (e.g., 1, 2, 3, 5, 10, 12, 15, 20, 30, 45, or 60 seconds) has elapsed since displaying the representation of the second key content in the second user interface, as indicated by time marker 852-1 in time bar 851 in FIG. 8G. For example, while displaying the representation of the second key content in the second user interface, the electronic device detects that the threshold amount of time has elapsed without detecting an input directed to the representation of the second key content. For example, during the elapsing of the threshold amount of time, the electronic device does not detect a selection of a navigation option (previously described above) that causes the electronic device to transition from displaying the representation of the second key content to displaying the representation of third key content in the second user interface.

In some embodiments, in response to detecting that the threshold amount of time has elapsed, the electronic device transitions from displaying the representation of the second key content in the second user interface to displaying a representation of third key content in the sequence of key content in the second user interface, such as displaying fourth key content (Key Content 4) in the key content user interface 844 as shown in FIG. 8G. For example, after detecting that the threshold amount of time has elapsed, the electronic device automatically transitions from displaying the representation of the second key content to displaying the representation of the third key content in the second user interface. In some embodiments, as similarly described above, the third key content is adjacent to (e.g., is positioned before or after) the second key content in the sequence of key content. In some embodiments, the third key content corresponds to a third playback position in the sequence of playback positions that is chronologically positioned before or after (e.g., optionally adjacent to) the second playback position to which the second key content corresponds. In some embodiments, as similarly discussed above, the representation of the third key content includes information associated with the third key content and/or the third playback position. In some embodiments, the representation of the third key content has one or more characteristics of the representation of the first key content discussed above. Automatically navigating through a sequence of key content corresponding to a live content item in response to detecting a threshold amount of time has elapsed since displaying the key content enables the user to consume highlighted information included in the key content without providing input for navigating through the sequence of key content and/or enables the user to consume the highlighted information included in the key content that occurred before a current live playback position in the live content item to facilitate understanding of a status of the live content item before consuming the live content item at the current live playback position, thereby improving user-device interaction.

In some embodiments, the threshold amount of time (e.g., 1, 2, 3, 5, 10, 12, 15, 20, 30, 45, or 60 seconds) is associated with a timer for transitioning from displaying the representation of the second key content to displaying the representation of the third key content (e.g., the electronic device displays the representation of the third key content in the second user interface after the timer elapses). In some embodiments, after displaying the representation of the second key content in the second user interface, the electronic device concurrently displays, via the display generation component, a visual indication of an elapsing of the timer (e.g., visual indication 841 in FIG. 8F) with the representation of the second key content in the second user interface. For example, the electronic device displays a visual indication of a countdown of the timer in the second user interface indicating a time (e.g., which is equal to the threshold amount of time described above) until the display of the representation of the second key content will be transitioned to display of the representation of the third key content in the second user interface after displaying the representation of the second key content. In some embodiments, the visual indication is displayed with (e.g., adjacent to, above, or below) or is displayed within a portion of or overlaid on the representation of the second key content in the second user interface. In some embodiments, the timer can be paused and/or reset in the second user interface in response to receiving an input while the representation of the second key content is displayed. For example, the electronic device forgoes transitioning from displaying the representation of the second key content to displaying the representation of the third key content if the electronic device detects a tap on a touch-sensitive surface of the one or more input devices before the timer elapses. Displaying a visual indication of a timer while with a sequence of key content corresponding to a live content item navigating through the sequence of key content facilitates discovery that the sequence of key content will automatically be navigated through once the timer elapses and/or enables the user to selectively prevent navigation through the sequence of content, thereby improving user-device interaction.

In some embodiments, while displaying the representation of the third key content in the sequence of key content in the second user interface, such as while displaying sixth key content in the key content user interface 844 in FIG. 8K, the electronic device detects that a second event has occurred, such as selection of the first navigation affordance 847-1 or elapsing of the timer associated with the threshold amount of time (e.g., indicated by the time marker 852) in FIG. 8K. For example, while displaying the representation of the third key content in the second user interface, the electronic device detects that the threshold amount of time (e.g., 1, 2, 3, 5, 10, 12, 15, 20, 30, 45, or 60 seconds) has elapsed since displaying the representation of the third key content. In some embodiments, the electronic device receives a selection (e.g., a tap on a touch-sensitive surface or press of a hardware button on a remote input device in communication with the electronic device) of a first navigation option (e.g., a forward option) displayed with the representation of the third key content in the second user interface.

In some embodiments, in response to detecting that the second event has occurred, in accordance with a determination that the third key content is a last key content that is available in the sequence of key content (e.g., the third key content is chronologically positioned last in the sequence of key content that is available based on the live playback position within the live content item (e.g., based on streaming data provided by the media provider of the live content item)), in accordance with a determination that the second event includes an elapsing of the threshold amount of time (e.g., 1, 2, 3, 5, 10, 12, 15, 20, 30, 45, or 60 seconds) since displaying the representation of the third key content in the second user interface or that the second event includes an input corresponding to a request to navigate further in the sequence of key content (e.g., selection of the first navigation option, as described above), the electronic device ceases display of the second user interface corresponding to the key content, as similarly shown in FIG. 8L. For example, the electronic device ceases display of the representation of the third key content in the sequence of key content.

In some embodiments, the electronic device initiates playback of the live content item at the current live playback position within the live content item, such as displaying the live content item (Live Content A) in the playback user interface 802 as shown in FIG. 8L. For example, as similarly described above, the electronic device replaces display of the second user interface that includes the representation of the third key content with a playback user interface that is configured to display (e.g., playback) the live content item. In some embodiments, the electronic device displays the live content item in the playback user interface at the live edge. For example, the electronic device displays the live content item in the playback user interface at an up-to-date playback position in the live content item (e.g., based on streaming data provided by the media provider of the live content item), as similarly described above. Initiating playback of a live content after reaching an end of a sequence of key content that includes highlighted information enables the user to automatically consume the live content item at the current live playback position after obtaining an understanding of the status of the live content item from the sequence of key content and/or reduces the number of inputs needed to play the live content item after reaching the end of the sequence of key content, thereby improving user-device interaction.

In some embodiments, the sequence of key content is updated periodically (e.g., each time a predefined unit of time elapses, such as every 30 seconds, every minute, every two minutes, every five minutes, or every ten minutes) during playback of the live content item, as described with reference to FIG. 8H, and the second key content is a last key content that is available in the sequence of key content when the event occurs (e.g., the second key content is chronologically positioned last in the sequence of key content that is available based on the live playback position within the live content item (e.g., based on streaming data provided by the media provider of the live content item)). In some embodiments, while displaying the representation of the second key content in the sequence of key content in the second user interface in accordance with the determination that the event includes the input corresponding to a request to navigate through the sequence of key content, the electronic device receives, via the one or more input devices, an input corresponding to a request to navigate further in the sequence of key content, such as a selection of the first navigation affordance 847-1 in FIG. 8G. For example, while displaying the representation of the second key content in the second user interface, the electronic device receives a selection of the first navigation option (e.g., the forward option), as described above. As similarly described above, the first navigation option is optionally selectable to navigate forward in the sequence of key content.

In some embodiments, in response to receiving the input, in accordance with a determination that updating the sequence of key content causes third key content to be available in the sequence of key content since detecting that the event has occurred (e.g., the second key content is no longer chronologically positioned last in the sequence of key content that is available based on the live playback position within the live content item after the sequence of key content is updated), the electronic device transitions from displaying the representation of the second key content in the second user interface to displaying a representation of the third key content in the sequence of key content in the second user interface, such as display of fourth key content (Key Content 4) in the key content user interface 844 as shown in FIG. 8H, wherein the third key content is the last key content that is available in the sequence of key content (e.g., the third key content is chronologically positioned last in the sequence of key content that is available based on the live playback position within the live content item). In some embodiments, the third key content was not yet available when the event causing display of the representation of the second key content in the second user interface occurred. In some embodiments, updating the sequence of key content causes the third key content to be added to and newly available in the sequence of key content. For example, the third key content is added to the sequence of key content because a new key event/highlight occurred in the live content item (e.g., a new homerun being hit in a live baseball game) since a last update of the sequence of key content. In some embodiments, as similarly described above, in response to receiving the input, the electronic device transitions from displaying the representation of the second key content to displaying the representation of the third key content in the second user interface because the third key content has become available between detecting the event and receiving the input above. In some embodiments, as described above, if updating the sequence of key content does not cause third key content to be available in the sequence of key content since detecting the event has occurred (e.g., such that the second key content remains the last key content that is available in the sequence of key content), the electronic device forgoes transitioning from displaying the representation of the second key content to displaying the representation of the third key content. Rather, as previously described above, in some embodiments, the electronic device initiates playback of the live content item at the current live playback position in the live content item in response to receiving the input. Periodically updating a sequence of key content corresponding to a live content item as the live content item progresses enables the user to continue consuming highlighted information included in the key content without consuming the live content item and/or enables the user to consume the highlighted information included in the key content that occurred before a current live playback position in the live content item to facilitate understanding of a status of the live content item before consuming the live content item at the current live playback position, thereby improving user-device interaction.

In some embodiments, while displaying the representation of the second key content in the sequence of key content in the second user interface in accordance with the determination that the event includes the input corresponding to a request to navigate through the sequence of key content, such as while displaying third key content (Key Content 3) in the key content user interface 844 in FIG. 8R, the electronic device receives, via the one or more input devices, an input corresponding to a request to navigate away from the second user interface, such as input provided by contact 803r as shown in FIG. 8R. For example, while displaying the representation of the second key content in the second user interface, the electronic device receives an input navigating backward from the second user interface. In some embodiments, the input does not correspond to selection of the one or more navigation options displayed in the second user interface described above. For example, the input includes selection of a “Back” or “Exit” affordance displayed in a predefined location in the second user interface (e.g., in a top left corner of the second user interface). In some embodiments, the input includes a press of a “Back” or “Home” button on a remote input device in communication with the electronic device.

In some embodiments, in response to receiving the input, the electronic device ceases display of the second user interface corresponding to the key content (e.g., as similarly described above). In some embodiments, the electronic device initiates playback of the live content item at a respective playback position in the sequence of playback positions in the live content item, such as display of the live content item in the playback user interface 802 as shown in FIG. 8S, wherein the respective playback position corresponds to the second key content. For example, as similarly described above, the electronic device replaces display of the second user interface that includes the representation of the second key content with a playback user interface that is configured to display (e.g., playback) the live content item. In some embodiments, the electronic device displays the live content item in the playback user interface at a respective playback position that corresponds to the second key content. For example, the electronic device initiates playback of the live content item at a playback position within the live content at which the second key content occurred during the broadcast of the live content item (e.g., that is optionally different from (e.g., chronologically before) the live playback position within the live content item). Initiating playback of a live content at a respective playback position that corresponds to respective key content in a sequence of key content that includes highlighted information in the live content item after exiting display of a representation of the respective key content enables the user to automatically consume the live content item at the respective playback position after obtaining an understanding of the status of the live content item from the respective key content and/or reduces the number of inputs needed to play the live content item at the respective playback position, thereby improving user-device interaction.

It should be understood that the particular order in which the operations in method 900 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 1100, and/or 1200) are also applicable in an analogous manner to method 900 described above with respect to FIG. 9. For example, the operation of the electronic device displaying key content corresponding to a live content item, described above with reference to method 900, optionally has one or more of the characteristics of facilitating control of playback of a live content item displayed in a playback user interface, described herein with reference to other methods described herein (e.g., methods 700, 1100, and/or 1200). For brevity, these details are not repeated here.

The operations in the information processing methods described above are, optionally, implemented by running one or more functional modules in an information processing apparatus such as general purpose processors (e.g., as described with respect to FIG. 1A-1B, 3, 5A-5C) or application specific chips. Further, the operations described above with reference to FIGS. 9A-9B are, optionally, implemented by components depicted in FIGS. 1A-1B. For example, displaying operations 902a, 902e, and 902h, receiving operation 902b, detecting operation 902f, and playback operation 902k, are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### User Interfaces of Insights Corresponding to Content

Users interact with electronic devices in many different manners, including using an electronic device to control playback of items of content, including live content, in a playback user interface and/or display insights corresponding to the items of content in the playback user interface. In some embodiments, an electronic device is configurable to display insights in the form of information, statistics, widgets, and/or images that enhance a user's viewing and interaction with a content item that is currently displayed in the playback user interface. The embodiments described below provide ways in which an electronic device displays and presents insights corresponding to content items, including live content items and on-demand content items, in a playback user interface using a content player bar and associated controls. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

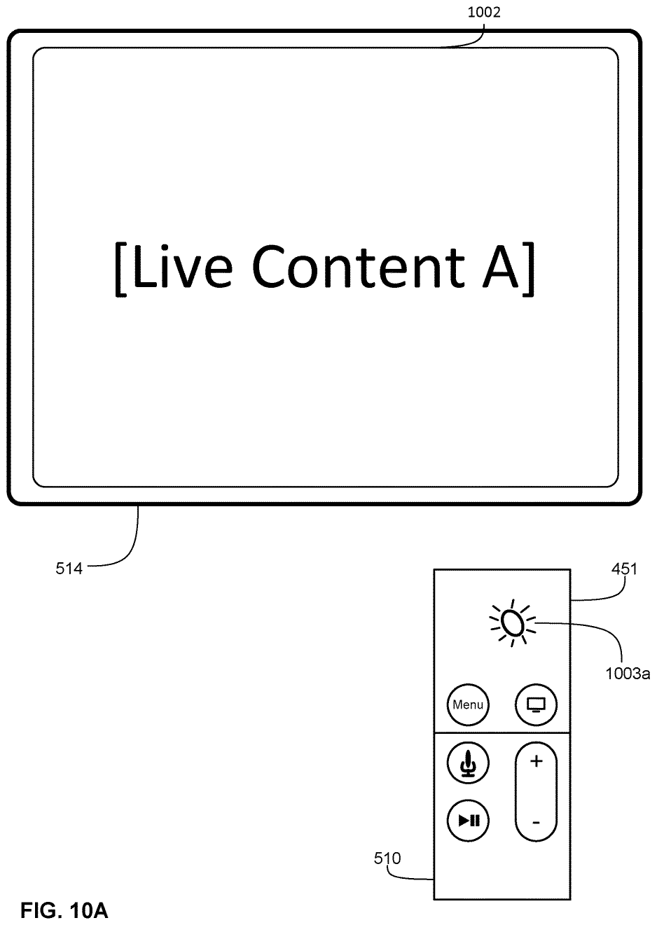

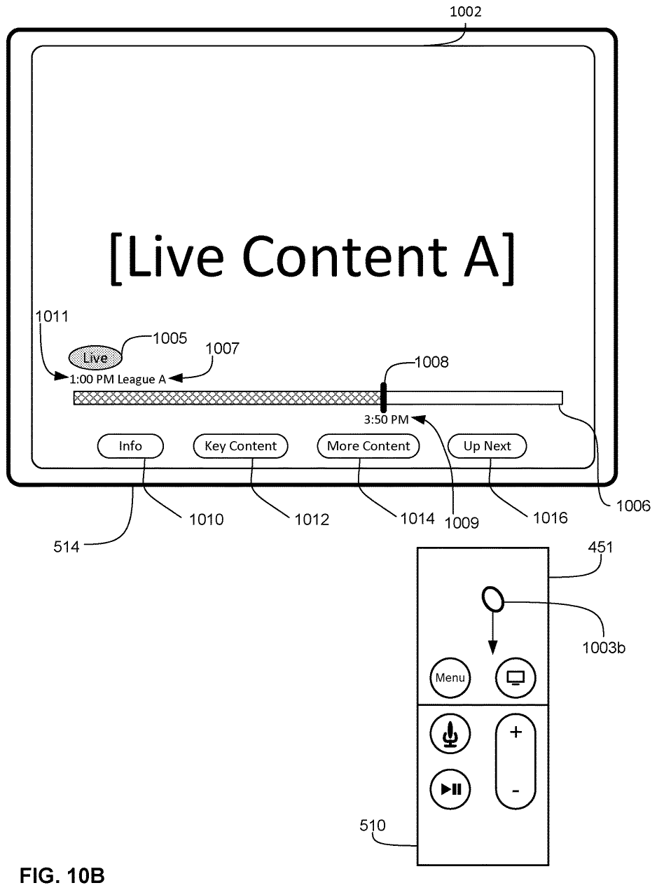

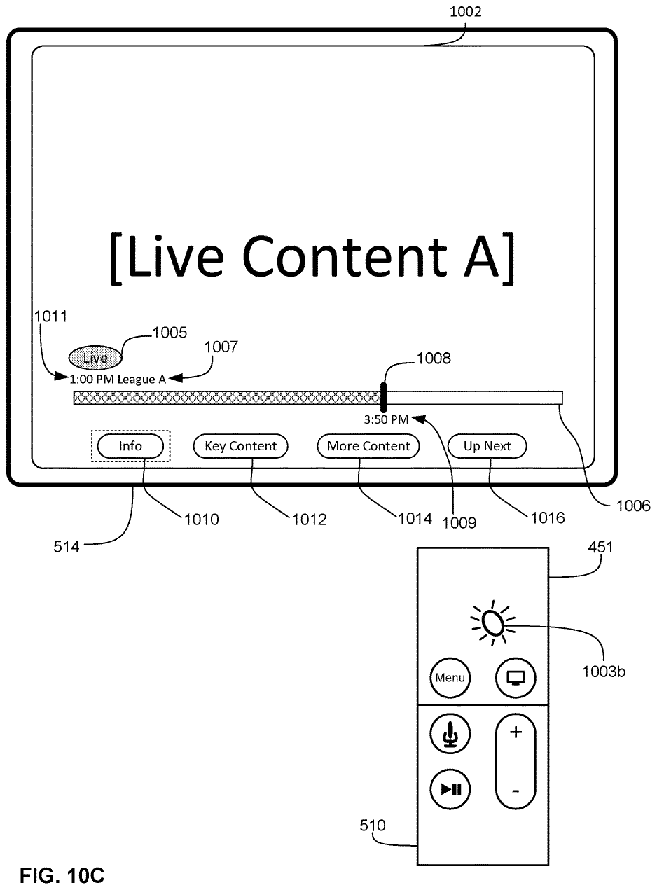

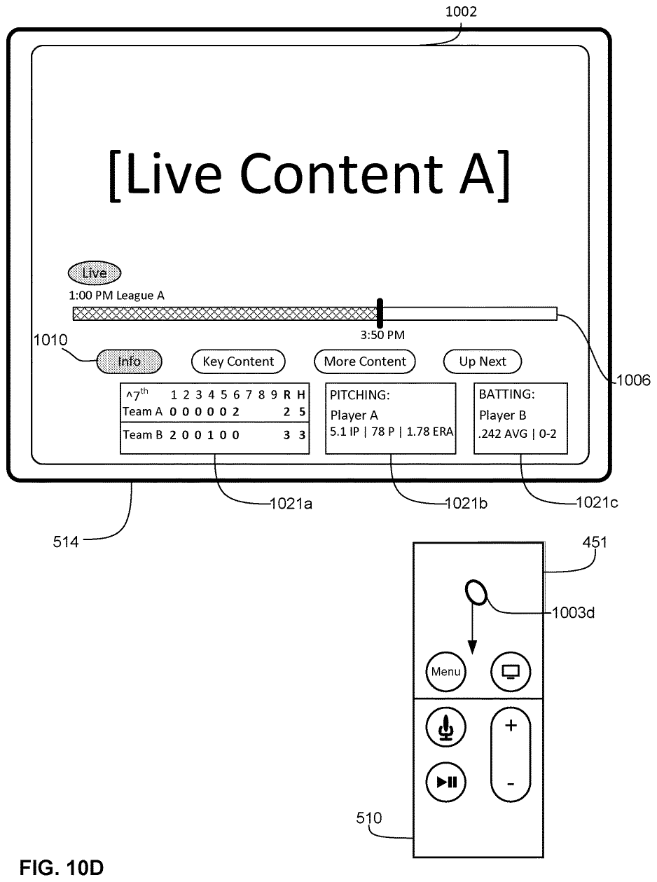

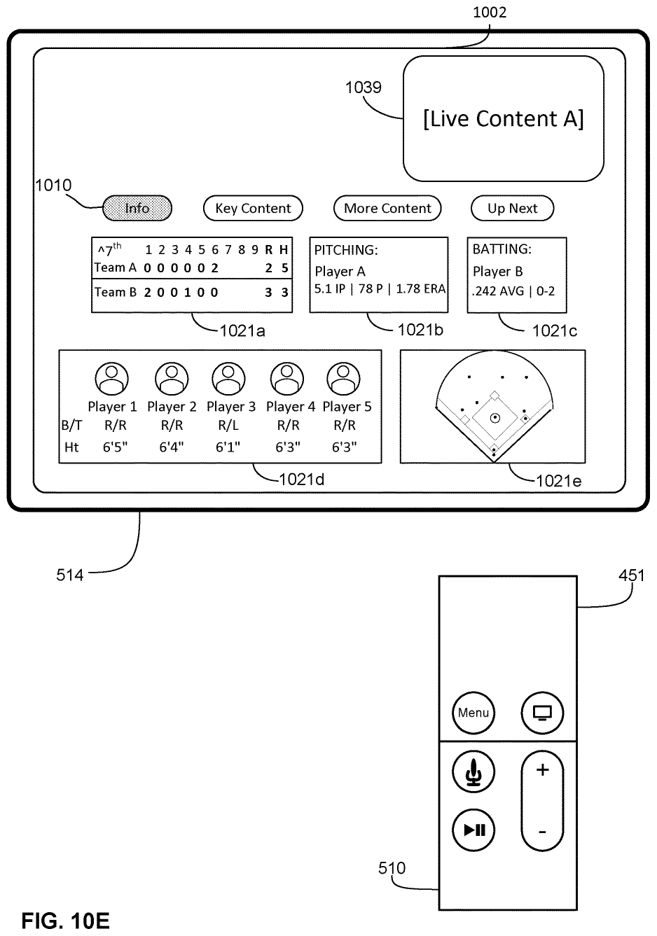

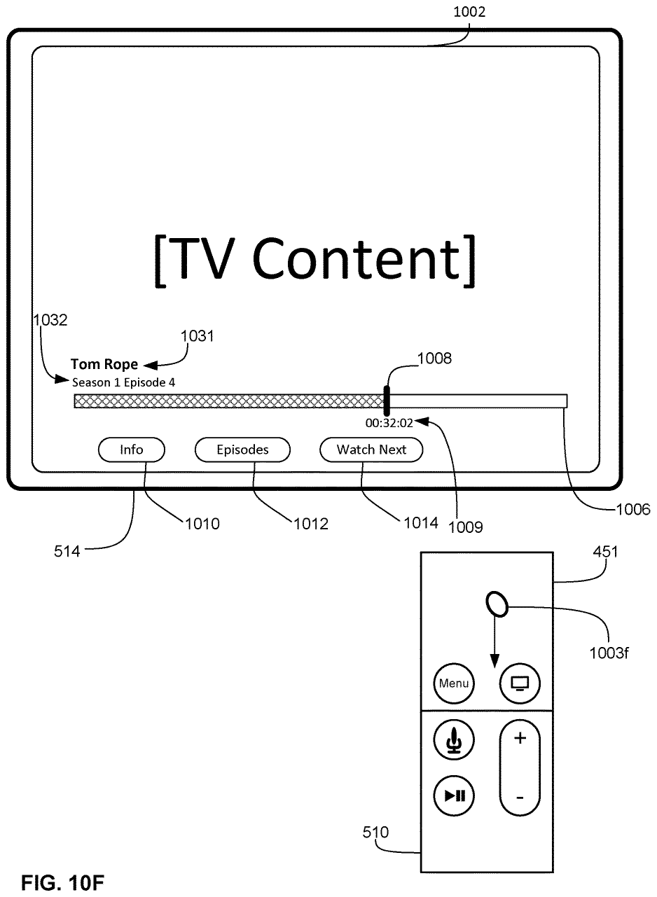

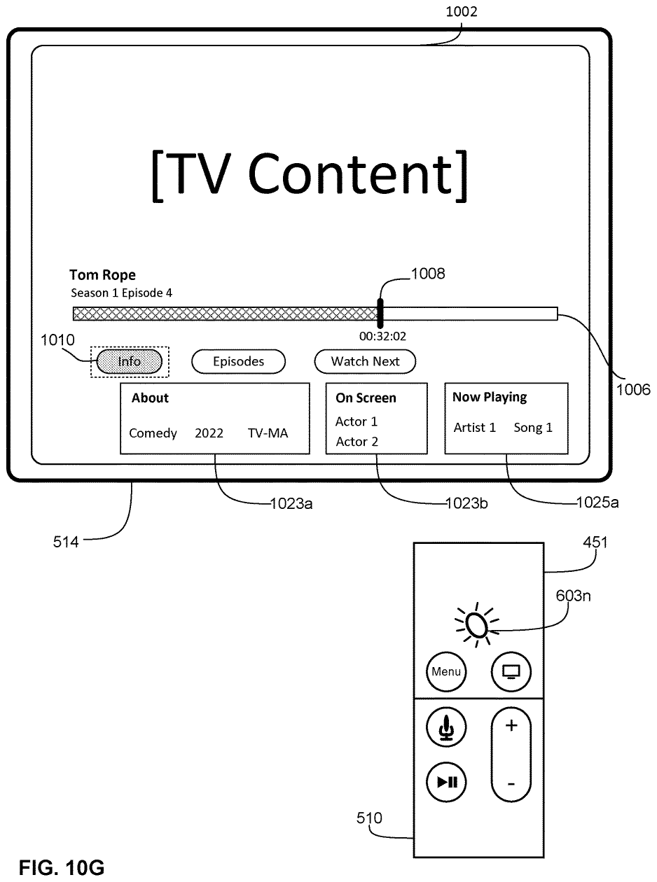

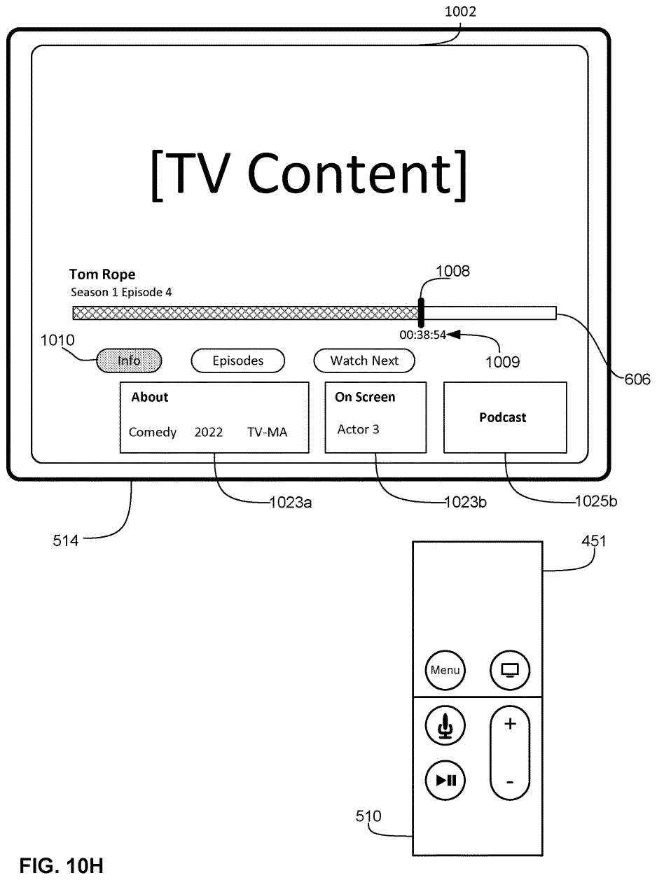

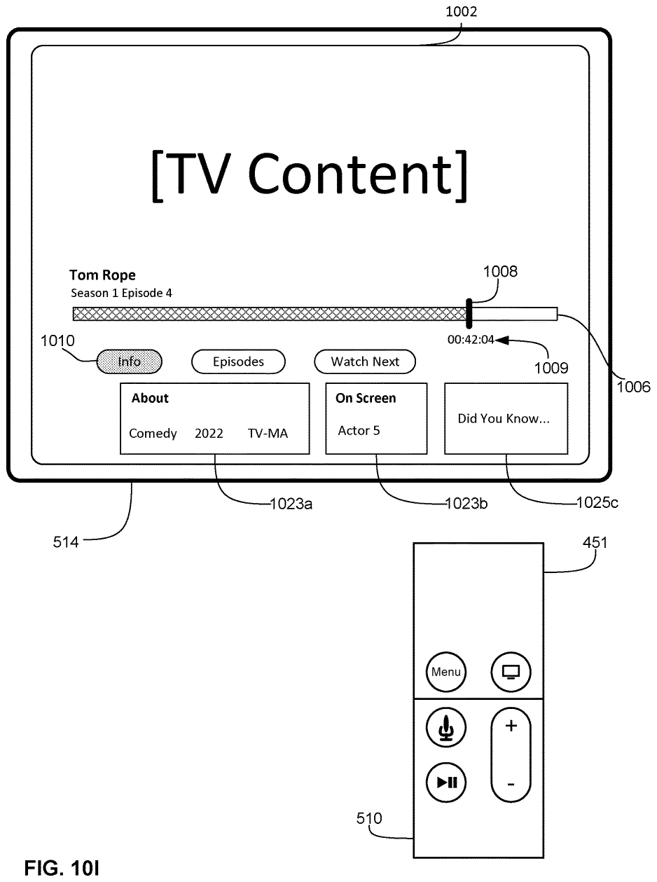

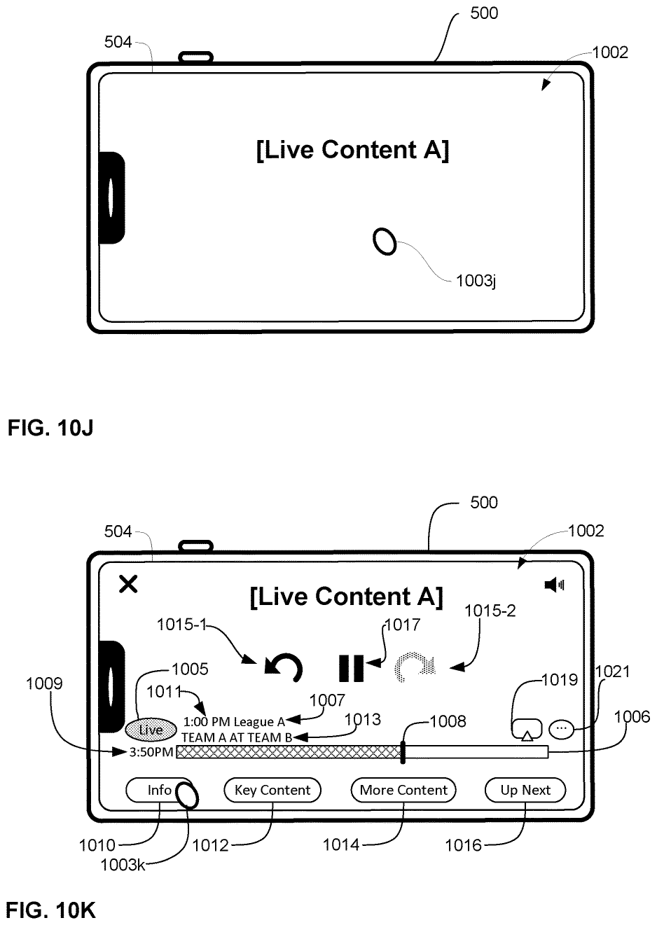

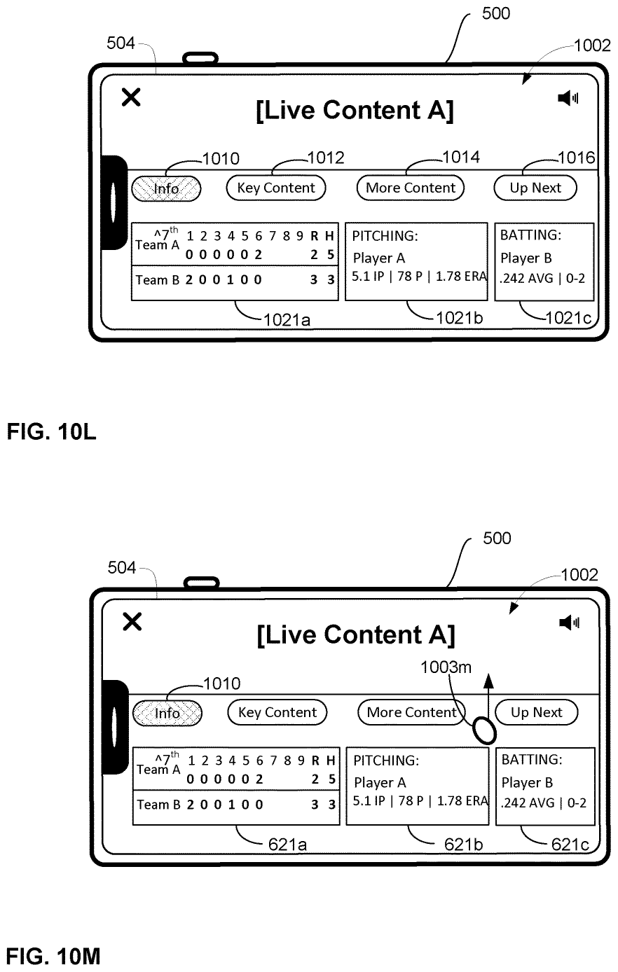

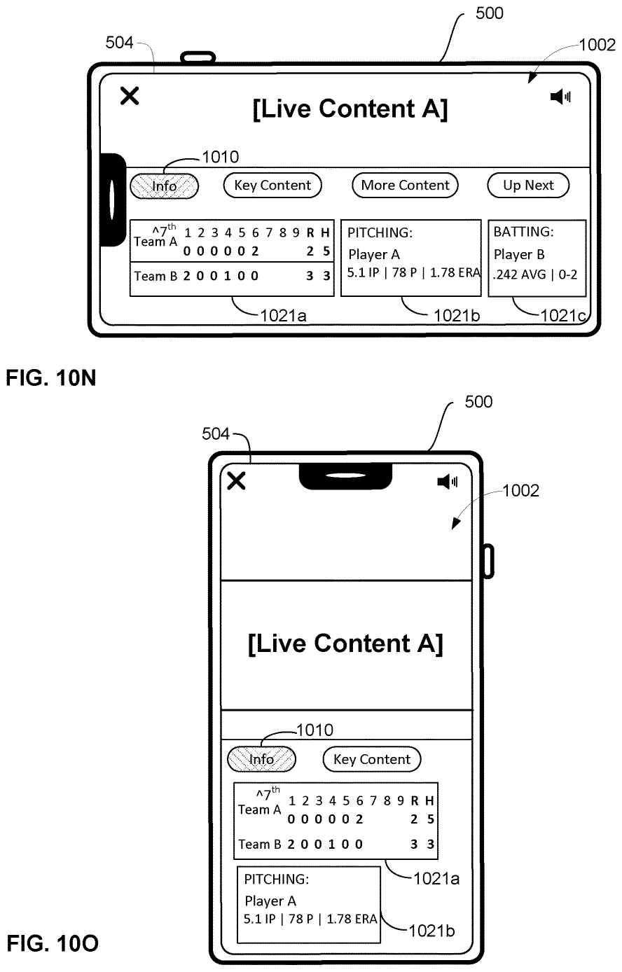

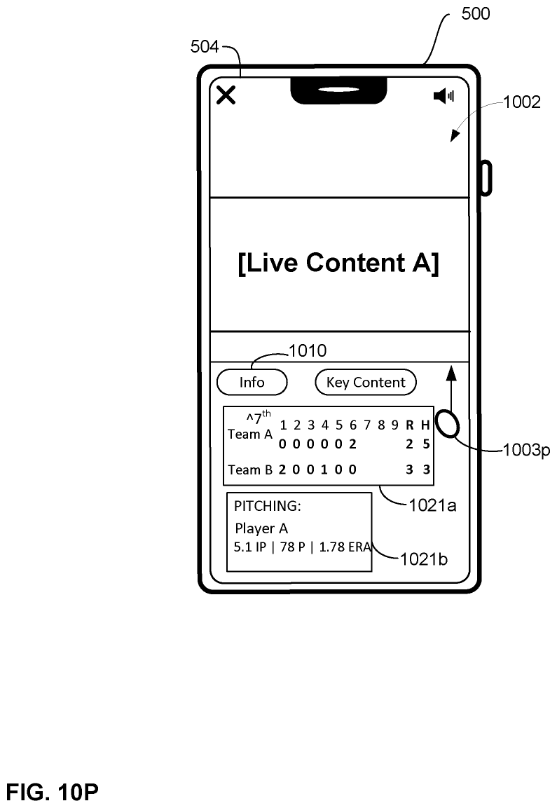

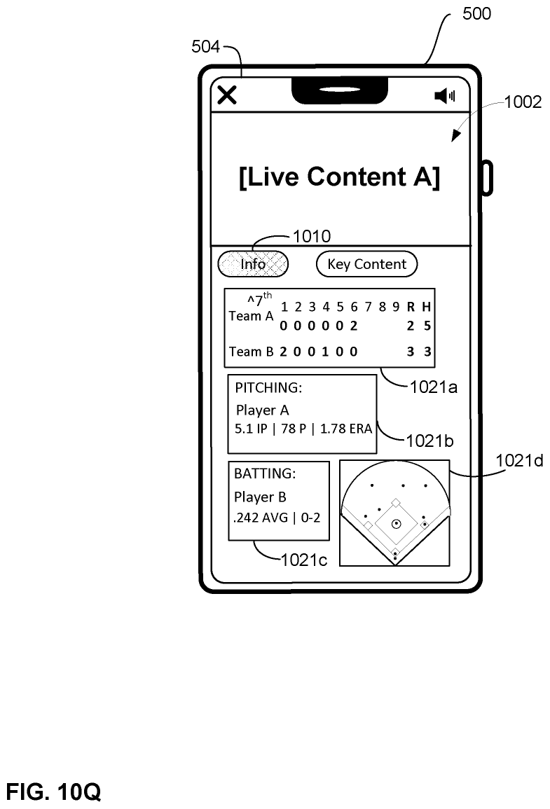

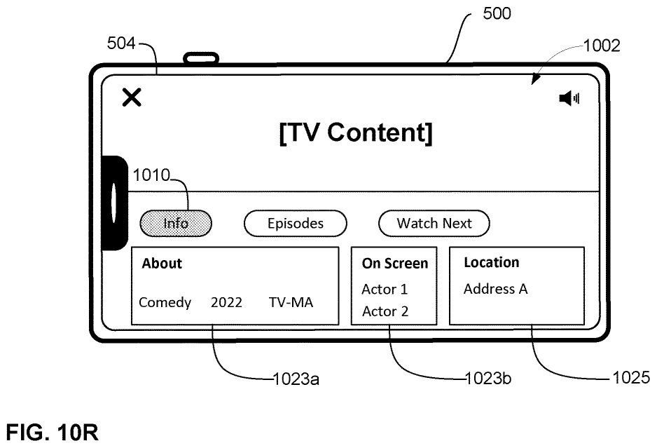

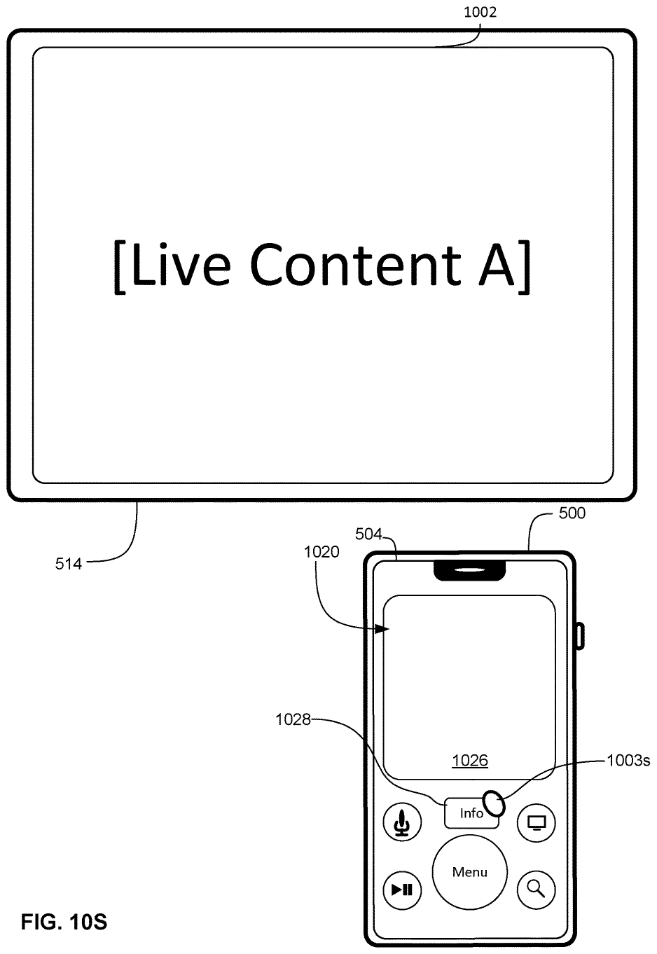

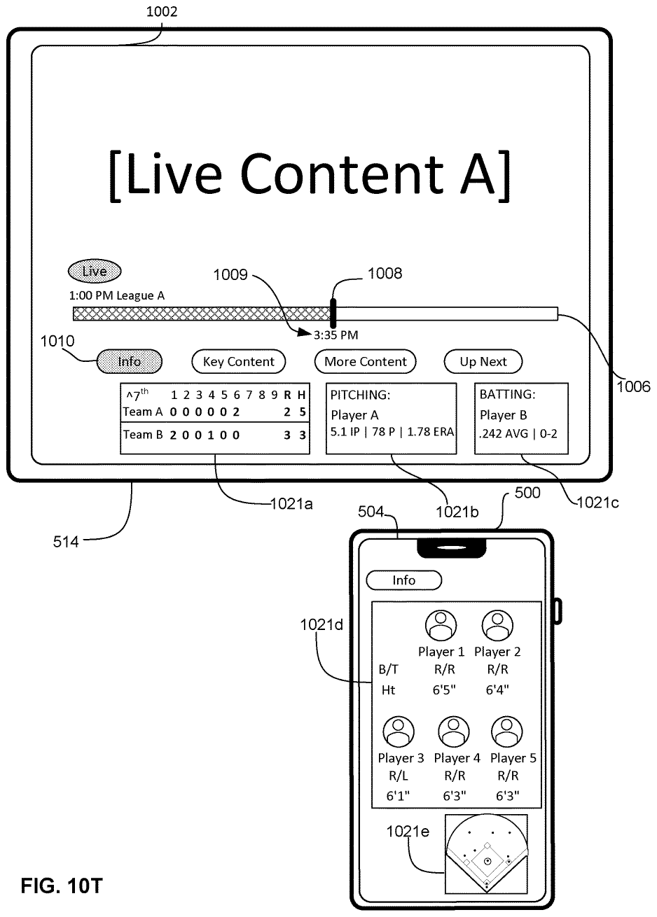

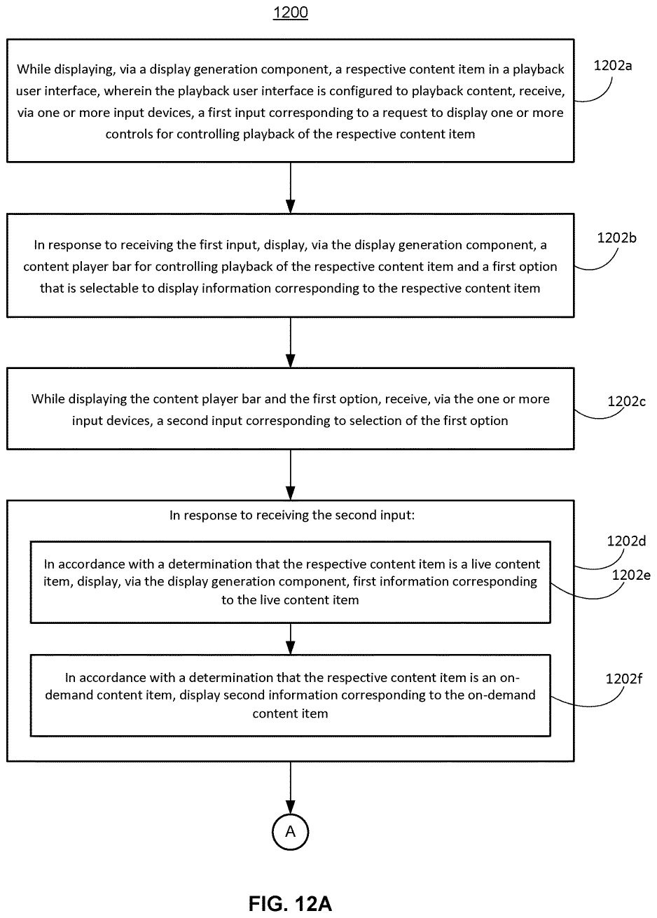

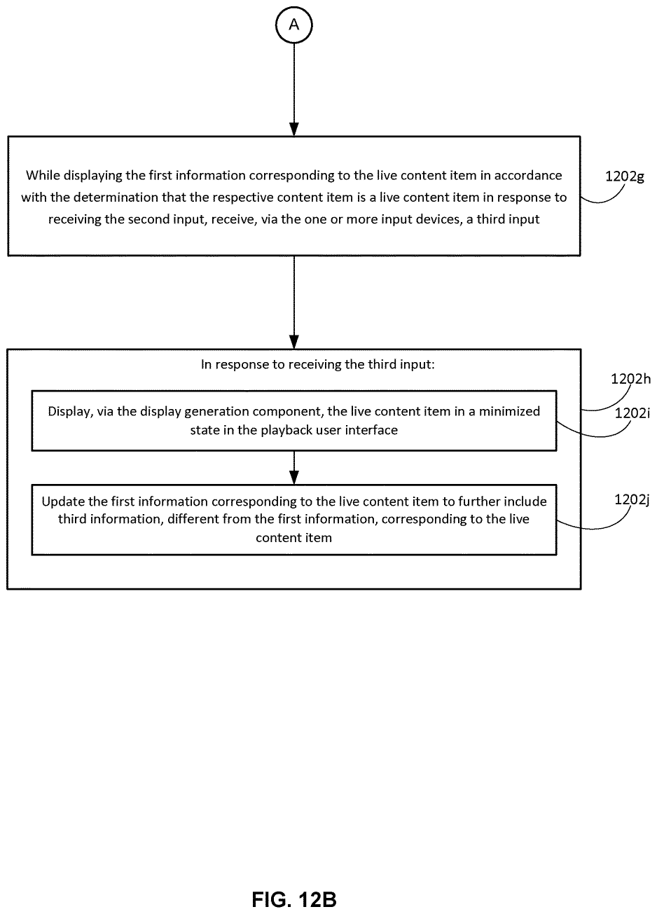

FIGS. 10A-10T illustrate exemplary ways in which an electronic device facilitates display of insights corresponding to a content item displayed in a playback user interface in accordance with some embodiments of the disclosure. The embodiments in these figures are used to illustrate the processes described below, including the processes described with reference to FIGS. 12A-12B.

FIGS. 10A-10I illustrate an electronic device 514 presenting user interfaces associated with displaying insights corresponding to content items being played back in a playback user interface. FIG. 10A illustrates a playback user interface 1002 (e.g., displayed via a display of the electronic device 514). As shown in FIG. 10A, the playback user interface 1002 is optionally displaying a live content item (“Live Content A”). In some embodiments, the live content item corresponds to a sports game, such as a baseball game. In some embodiments, the playback user interface 1002 corresponds to the playback user interface 602 and/or 802 discussed above. In some embodiments, the live content item has one or more characteristics of the live content items described previously above. Additional examples of live content items that can be displayed in the playback user interface 1002 are provided below with reference to method 1200.

As shown in FIG. 10A, the user provides a selection (e.g., with contact 1003a) directed to the live content item in the playback user interface 1002. For example, as shown in FIG. 10A, the electronic device 514 detects a tap, touch, press, or other input on touch-sensitive surface 451 of remote input device 510 while the live content item is displayed in the playback user interface 1002. In some embodiments, the selection corresponds to a request to display one or more controls for controlling playback of the live content item in the playback user interface 1002.

In some embodiments, as shown in FIG. 10B, in response to receiving the selection directed to the live content item in the playback user interface, the electronic device 514 displays one or more controls for controlling playback of the live content item in the playback user interface 1002. For example, as shown in FIG. 10B, the electronic device 514 displays content player bar 1006 in the playback user interface (e.g., concurrently with the live content item in the playback user interface). In some embodiments, the electronic device 514 displays the content player bar 1006 overlaid on the live content item as playback of the live content item continues to progress in the playback user interface. In some embodiments, the content player bar 1006 corresponds to content player bar 606 and/or 806 described previously above.

In some embodiments, as shown in FIG. 10B and as similarly discussed previously herein, the electronic device 514 displays a plurality of selectable options (e.g., tabs) with the content player bar 1006 in the playback user interface. For example, as shown in FIG. 10B, the electronic device 514 displays the selectable options 1010-1016 below the content player bar 1006 in the playback user interface. In some embodiments, the plurality of selectable options includes a first selectable option 610, a second selectable option 612, a third selectable option 614, and/or a fourth selectable option 616. In some embodiments, the first selectable option 610 is selectable to display information associated with the current playback position within the live content item (e.g., indicated by the location of the scrubber bar 608 in the content player bar 606), such as statistics and other information, as described in more detail below. In some embodiments, the first selectable option 1010, the second selectable option 1012, the third selectable option 1014, and/or the fourth selectable option 1016 correspond to first selectable option 610, second selectable option 612, third selectable option 614, and/or fourth selectable option 616 discussed previously above. Descriptions for live indicator 1005, information 1007 and 1011, scrubber bar 1008, and/or real-world time indicator 1009 are provided above with respect to the corresponding elements in the FIG. 6 series.

In FIG. 10B, the electronic device 514 detects the user scroll (e.g., using contact 1003b) downward in the playback user interface 1002. For example, as shown in FIG. 10B, the electronic device 514 detects the contact 1003b (e.g., a tap, touch, selection, or other input) on the touch-sensitive surface 451 of the remote input device 510, followed by downward movement of the contact 1003b while the content player bar 1006 (and related user interface objects) is concurrently displayed with the live content item in the playback user interface 1002.

In some embodiments, in response to receiving the downward scroll, the electronic device 514 moves a current focus to the first selectable option 1010, as shown in FIG. 10C. In some embodiments, the electronic device 514 displays the first selectable option 1010 with an indication of focus (e.g., a visual boundary, highlighting, shading, bolding, etc.). In FIG. 10C, while the first selectable option 1010 has the current focus in the playback user interface 1002, the electronic device 514 detects a selection of the first selectable option 610. For example, as shown in FIG. 10C, the electronic device 514 detects contact 1003b (e.g., a tap, touch, selection, or other input) on the touch-sensitive surface 451 of the remote input device 510.

In some embodiments, as shown in FIG. 10D, in response to receiving the selection of the first selectable option 1010, the electronic device 514 displays information 1021 associated with the live content item in the playback user interface. For example, as shown in FIG. 10D, the electronic device 514 shifts the content player bar 1006 (and associated user interface objects) upward in the playback user interface and displays a first information element 1021a, a second information element 1021b, and/or a third information element 1021c. As previously described above with reference to FIG. 10A, the live content item optionally corresponds to a sports game. In FIG. 10D, the live content item optionally corresponds to a baseball game. Accordingly, in some embodiments, the information 1021 includes statistics corresponding to the baseball game and/or one or more players actively participating in the baseball game. In some embodiments, the information 1021 has one or more characteristics of information 621 described previously above. It should be understood that the information illustrated in FIG. 10D is exemplary and that additional or alternative types of information can be presented for different types of live content items.

In some embodiments, the electronic device 514 displays additional insights that supplement the information 1021 in the playback user interface 1002 in response to detecting an input corresponding to a request to scroll (e.g., further) downward in the playback user interface 1002. In FIG. 10D, the electronic device detects the user scroll (e.g., using contact 1003d) downward in the playback user interface 1002. For example, as shown in FIG. 10D, the electronic device 514 detects the contact 1003d (e.g., a tap, touch, selection, or other input) on the touch-sensitive surface 451 of the remote input device 510, followed by movement of the contact 1003d downward on the touch-sensitive surface 451.

In some embodiments, as shown in FIG. 10E, in response to receiving the downward scroll, the electronic device 514 updates the information 1021 associated with the live content item in the playback user interface 1002 to include additional insights corresponding to the live content item. For example, as shown in FIG. 10E, the electronic device 514 shifts the plurality of selectable options, including the first selectable option 1010, further upward in the playback user interface 1002 and displays a fourth information element 1021d and a fifth information element 1021e. As previously described above, the insights provided by the fourth information element 1021d and the fifth information element 1021e correspond to the baseball game of FIG. 10D. In some embodiments, the information included in the fourth information element 1021d and the fifth information element 1021e is displayed and/or updated based on a current playback position (e.g., indicated by the scrubber bar 1008 in FIG. 10D) within the live content item, as discussed in more detail below.

In some embodiments, as shown in FIG. 10E, the fourth information element 1021d provides insight into individual statistics/information for individual members of the baseball team(s) participating in the baseball game. For example, the fourth information element 1021d includes individual statistics for players on one or both teams participating in the baseball game. In some embodiments, the individual statistics for the players are updated based on a progression of the baseball game. For example, if the particular players playing in the baseball game changes, the fourth information element 1021d is updated to include individual statistics for new and/or alternative players who are now participating in the baseball game. In some embodiments, as shown in FIG. 10E, the individual statistics correspond to batting and throwing information for each player (e.g., Player 1 bats right (“R”) and throws right (e.g., using their right hand, (“R”)), Player 3 bats right and throws left (e.g., using their left hand, (“L”)), etc.) and height information for each player (e.g., Player 1 is 6′5″ tall, Player 2 is 6′4″ tall, etc.). It should be understood that the information illustrated in the fourth information element 1021d in FIG. 10E is exemplary and that additional or alternative types of information can be presented for different types of live content items.

In some embodiments, as shown in FIG. 10E, the fifth information element 1021e provides insight into a venue/field of the baseball game and/or player positions/roles relative to the venue/field of the baseball game. For example, the fifth information element 1021e includes a visual representation of the baseball field (e.g., including infield and outfield) on which the baseball game is being played (e.g., a photograph of the baseball field, a schematic view of the baseball field, a cartoon representation of the baseball field, etc.). Additionally, in some embodiments, as shown in FIG. 10E, the fifth information element 1021e includes visual indications of player positions overlaid on the visual representation of the baseball field. For example, the fifth information element 1021e includes dots, circles, markings, flags, or other indications of the positions in a baseball game (e.g., generally), such as pitcher, catcher, first baseman, shortstop, center fielder, etc. In some embodiments, the visual indications of player positions include textual indications of which particular players, such as Players 1-5 in the fourth information element 1021d, are currently playing which positions (e.g., Player 1 is the pitcher, Player 2 is the catcher, etc.). For example, the textual indications are displayed as text labels including the name, initial, picture, etc. of the player overlaid on the visual representation of the baseball field near the corresponding visual indication of the player's corresponding position (e.g., text label of the name of Player 1 is displayed adjacent to the dot/circle representing the pitcher's position on the pitcher's mound). In some embodiments, the visual indications of player positions are updated based on a progression of the baseball game. For example, if the particular players playing in the baseball game changes, the fifth information element 1021e is updated to include textual indications in the visual representation of the baseball field for new and/or alternative players who are now participating in the baseball game. It should be understood that the information illustrated in the fifth information element 1021e in FIG. 10E is exemplary and that additional or alternative types of information can be presented for different types of live content items (e.g., a visual representation of a basketball court for a live basketball game).

FIGS. 10F-10I illustrate examples of electronic device 514 presenting user interfaces that include insights corresponding to on-demand content items configured to be played back in a playback user interface. In FIG. 10F, the electronic device 514 is concurrently displaying the content player bar 1006 with an on-demand content item (e.g., TV Content) in the playback user interface 1002. In the example of FIG. 10F, the on-demand content item corresponds to an episode of a television show. For example, as shown in FIG. 10F, the content player bar 1006 includes a first indication 1031 of the television show to which the current episode belongs (e.g., Tom Rope) and a second indication 1032 of the current season number/name and/or episode number/name of the current episode that is being played back in the playback user interface 1002 (e.g., “Season 1, Episode 4”). In some embodiments, as similarly discussed above, as shown in FIG. 10F, the electronic device 514 is displaying the first selectable option 1010, the second selectable option 1012, the third selectable option 1014, and the fourth selectable option 1014 in the playback user interface 1002. Additionally, in some embodiments, as shown in FIG. 10F, time indicator 1009 indicates that 32 minutes and 2 seconds (e.g., 00:32:02) has elapsed within the on-demand content item since playback was first initiated (e.g., relative to a beginning of the on-demand content item).

In FIG. 10F, while displaying the playback user interface 1002 that includes the content player bar 1006 (and related user interface objects), the electronic device 514 detects the user scroll (e.g., using contact 1003f) downward in the playback user interface 1002. For example, as shown in FIG. 10F, the electronic device 514 detects the contact 1003f (e.g., a tap, touch, selection, or other input) on the touch-sensitive surface 451 of the remote input device 510, followed by downward movement of the contact 1003f while the content player bar 606 (and related user interface objects) is concurrently displayed with the on-demand content item in the playback user interface 1002.

In some embodiments, as shown in FIG. 10F, in response to receiving the downward scroll, the electronic device 514 moves a current focus to the first selectable option 1010 in the playback user interface 1002, and in response to detecting a selection of the first selectable option 1010, the electronic device 514 displays insights corresponding to the on-demand content item in the playback user interface 1002. For example, as shown in FIG. 10G, in response to detecting a tap of contact 1003n on the touch-sensitive surface 451 of the remote input device 510 while the first selectable option 1010 has the current focus, the electronic device 514 displays information 1023 in the playback user interface 1002. In some embodiments, as shown in FIG. 10G, the electronic device 514 shifts the content player bar 1006 (and associated user interface objects) upward in the playback user interface and displays a first information element 1023a, a second information element 1023b, and a dynamic module 1025a that are associated with the on-demand content item (e.g., the episode of the TV show Tom Rope). As discussed below, the first information element 1023a, the second information element 1023b, and the dynamic module 1025a provide insight into one or more aspects of the on-demand content item, such as a current scene in the on-demand content item.

In some embodiments, the first information element 1023a provides general information about the on-demand content item that is currently being played back in the playback user interface 1002. For example, as shown in FIG. 10G, the information element 1023a includes a genre of the TV show (e.g., Comedy), a year in which the TV show first aired and/or was first produced (e.g., 2022), and a rating of the TV show (e.g., TV-MA (mature)). It should be understood that the information illustrated in the first information element 1023a in FIG. 10G is exemplary and that additional or alternative types of information can be presented corresponding to the on-demand content item, such as a description/synopsis for the TV show and/or the episode of the TV show that is currently being played back in the playback user interface 1002.

In some embodiments, the second information element 1023b provides information corresponding to one or more actors associated with the on-demand content item. For example, as shown in FIG. 10G, the second information element 1023b provides a list of actors in the current scene of the TV show episode that is being played back in the playback user interface 1002, such as Actor 1 and Actor 2. In some embodiments, the list of actors is accompanied by an image (e.g., photograph, sketch, cartoon, etc.) corresponding to the actors (e.g., adjacent to each actor's name). It should be understood that the information illustrated in the second information element 1023b in FIG. 10G is exemplary and that additional or alternative types of information can be presented corresponding to the on-demand content item, such as a list of crew associated with the TV show and/or a director and/or producer of the TV show that is currently being played back in the playback user interface 1002.

In some embodiments, the dynamic module 1025a provides interactive content that corresponds to the on-demand content item. For example, as shown in FIG. 10G, the dynamic module 1025a includes information corresponding to a song that is currently being played within the TV show episode (e.g., in the background of the current scene in the TV show episode). In some embodiments, as shown in FIG. 10G, the dynamic module 1025a is selectable within the playback user interface 1002 to initiate a process to add the song (e.g., Song 1) for later playback and/or to save the song to the electronic device 514. For example, if the electronic device 514 detects a selection of the dynamic module 1025a, the electronic device 514 initiates a process to play the song and/or to add the song to a playlist within a music player application running on the electronic device 514.

In some embodiments, the insights included in the first information element 1023a, the second information element 1023b, and/or the dynamic module 1025a are configured to be updated based on a progression of the current playback position within the on-demand content item. For example, as shown in FIG. 10H, the scrubber bar 1008 has advanced positions within the content player bar 1006, indicating that the current playback position within the on-demand content item has progressed since its previous location in FIG. 10G. Additionally, as shown in FIG. 10H, the time indicator 1009 indicates that thirty-eight minutes and fifty-four seconds (e.g., 00:38:54) has elapsed relative to the beginning of the playback of the on-demand content item (e.g., which is about six minutes later than the time indicator 1009 in FIG. 10G).

In some embodiments, as shown in FIG. 10H, when the playback of the on-demand content item progresses in the playback user interface, the electronic device 514 updates display of the second information element 1023b. For example, as shown in FIG. 10H, the second information element 1023b includes an indication of a third actor (e.g., Actor 3) who is currently on screen in the TV show episode (and optionally who was not previously on screen as indicated in the second information element 1023b in FIG. 10G). Additionally, in some embodiments, as shown in FIG. 10H, when the playback of the on-demand content item progresses in the playback user interface 1002, the electronic device 514 updates display of dynamic module 1025b. For example, as shown in FIG. 10H, the dynamic module 1025b includes an indication of a podcast that is supplemental to and/or accompanying the TV show (e.g., a podcast associated with a same media provider of the TV show). In some embodiments, the dynamic module 1025b is selectable to initiate a process to initiate playback of the podcast at the electronic device 514 and/or to add the podcast to a library of podcasts associated with an audio provider application running on the electronic device 514.

In FIG. 10I, the scrubber bar 1008 has advanced further within the content player bar 1006 relative to FIG. 10H, indicating that the current playback position within the on-demand content item has progressed since its previous location in FIG. 10G. Additionally, as shown in FIG. 10I, the time indicator 1009 indicates that forty-two minutes and four seconds (e.g., 00:42:04) has elapsed relative to the beginning of the playback of the on-demand content item (e.g., which is about three minutes later than the time indicator 1009 in FIG. 10H).

In some embodiments, as shown in FIG. 10I, when the playback of the on-demand content item progresses in the playback user interface, the electronic device 514 updates display of the second information element 1023b. For example, as shown in FIG. 10I, the second information element 1023b includes an indication of a fifth actor (e.g., Actor 5) who is currently on screen in the TV show episode (and optionally who was not previously on screen as indicated in the second information element 1023b in FIGS. 10G and 10H). Additionally, in some embodiments, as shown in FIG. 10I, when the playback of the on-demand content item progresses in the playback user interface 1002, the electronic device 514 updates display of dynamic module 1025C. For example, as shown in FIG. 10I, the dynamic module 1025c includes an indication of a “fun fact” or similar type of information that is supplemental to the TV show (e.g., a fun fact associated with the production (e.g., filming, casting, writing, etc.) of the TV show and/or a fun fact associated with a particular actor in the TV show). In some embodiments, the dynamic module 1025c is selectable to initiate a process to view additional fun facts or other trivia associated with the TV show, such as via a web-browsing application and/or a media provider application running on the electronic device 514.

FIGS. 10J-10R illustrate exemplary interactions with insights corresponding to content items displayed in a playback user interface on a second electronic device 500. FIG. 10J illustrates an electronic device 500 displaying a live content item (“Live Content A”) in a playback user interface 1002 (e.g., via touchscreen 504). In some embodiments, the live content item corresponds to the live content item described above. In some embodiments, the playback user interface 1002 has one or more characteristics of the playback user interface 1002 described above. In some embodiments, the electronic device 500 is different from the electronic device 514 described above. For example, the electronic device 500 is a mobile electronic device, such as a smartphone having an integrated touchscreen 504.

In FIG. 10J, the electronic device 500 receives an input by contact 1003j (e.g., a tap or touch provided by an object, such as a finger or stylus) on the touchscreen 504 directed to the live content item displayed in the playback user interface 1002. In some embodiments, in response to receiving the input directed to the live content item on the touchscreen 504, the electronic device 500 displays one or more controls for controlling playback of the live content item in the playback user interface, as similarly discussed above. As shown in FIG. 10K, the electronic device 500 displays content player bar 1006 with the live content item (e.g., optionally an image of the live content item) in the playback user interface. In some embodiments, the content player bar 1006 and related user interface objects (e.g., live indicator 1005, scrubber bar 1008, information 1013, etc.) have one or more characteristics of the content player bar 1006 and related user interface objects described above. Additionally, in some embodiments, as shown in FIG. 10K, the electronic device 500 displays selectable options 1010-1016 with the content player bar 1006 in the playback user interface 1002. In some embodiments, the selectable options 1010-1016 have one or more characteristics of the selectable options 1010-1016 described above.

In FIG. 10K, while displaying the content player bar 1006 and the selectable options 1010-1016 in the playback user interface 1002, the electronic device 500 detects an input corresponding to selection of the first selectable option 1010. For example, as shown in FIG. 10K, the electronic device 500 detects a tap of contact 1003k directed to the first selectable option 1010 on the touchscreen 504.

In some embodiments, as shown in FIG. 10L, in response to detecting the selection of the first selectable option 1010, the electronic device 500 displays information 1021 corresponding to the live content item, as similarly discussed above. For example, as shown in FIG. 10L, the electronic device 500 ceases display of the content player bar 1006 and displays first information element 1021a, second information element 1021b, and third information element 1021c that include statistics associated with the live baseball game displayed in the playback user interface 1002. In some embodiments, the information 1021 corresponds to the information 1021 discussed above.

In some embodiments, display of insights corresponding to a content item that is displayed in the playback user interface 1002 at the electronic device 500 is based on an orientation of the electronic device 500 (e.g., relative to gravity). For example, as shown in FIG. 10M, the electronic device 500 is displaying the information 1021 in the playback user interface 1002 while the orientation of the electronic device 500 is a landscape orientation (e.g., relative to gravity). In FIG. 10M, the electronic device 500 detects an input corresponding to a request to scroll downward in the playback user interface 1002. For example, as shown in FIG. 10M, the electronic device 500 detects contact 1003m on the touchscreen 504 of the electronic device 500, followed by movement of the contact 1003m upward on the touchscreen 504, while displaying the information 1021 while the electronic device 500 is in the landscape orientation.

In some embodiments, as shown in FIG. 10N, in response to detecting the input corresponding to the request to scroll downward in the playback user interface 1002, the electronic device 500 forgoes scrolling downward in the playback user interface 1002. For example, as shown in FIG. 10N, the electronic device 500 forgoes displaying additional insights (e.g., information) corresponding to the live content item in the playback user interface 1002. In some embodiments, as mentioned above, the electronic device 500 restricts display of additional insights corresponding to the live content item based on the orientation of the electronic device 500. For example, as shown in FIG. 10N, because the electronic device 500 is in the landscape orientation when the scrolling input discussed above is detected, the electronic device 500 forgoes scrolling the playback user interface 1002 downward, and thus forgoes displaying additional insights corresponding to the live content item. In some embodiments, in FIG. 10N, the information 1021 is horizontally scrollable, rather than vertically scrollable, while the electronic device 500 has the landscape orientation relative to gravity, to reveal the additional insights corresponding to the live content item (e.g., fourth information element 1021d and fifth information element 1021e discussed previously above).

In some embodiments, as discussed below, if the electronic device 500 has a portrait orientation (e.g., relative to gravity), the playback user interface 1002 is vertically scrollable to display additional insights corresponding to the live content item. For example, as shown in FIG. 10O, the electronic device 500 is displaying the playback user interface 1002 that includes the information 1021 discussed previously above while the electronic device 500 is in the portrait orientation (e.g., relative to gravity).

In FIG. 10P, the electronic device 500 detects an input corresponding to a request to scroll downward in the playback user interface 1002 while the electronic device 500 is in the portrait orientation. For example, as shown in FIG. 10P, the electronic device 500 detects contact 1003p on the touchscreen 504, followed by movement of the contact 1003p upward on the touchscreen while the playback user interface 1002 is displayed.

In some embodiments, as shown in FIG. 10Q, in response to detecting the input for scrolling downward in the playback user interface 1002 while the electronic device 500 has the portrait orientation, the electronic device 500 scrolls downward in the playback user interface 1002 and reveals additional information (e.g., insights) corresponding to the playback user interface 1002. For example, as shown in FIG. 10Q, the electronic device shifts the live content item upward in the playback user interface 1002 (e.g., while maintaining playback of the live content item) and displays the third information element 1021c and the fourth information element 1021d in the playback user interface 1002. In some embodiments, as shown in FIG. 10Q, the information 1021 is displayed vertically (e.g., as a scrollable list of information) within the playback user interface 1002. In some embodiments, the fourth information element 1021d corresponds to the fourth information element 1021d described above.

The interactions with insights corresponding to the live content item at the electronic device 500 discussed above also apply for on-demand content items that are displayed in the playback user interface 1002 at the electronic device 500. For example, in FIG. 10R, the electronic device 500 is displaying an on-demand content item (e.g., TV Content) in the playback user interface 1002. In some embodiments, when insights corresponding to the on-demand content item are displayed in the playback user interface 1002, as shown in FIG. 10R, the insights are similarly scrollable in the manner discussed above based on the orientation of the electronic device 500. For example, in FIG. 10R, because the electronic device 500 has the landscape orientation, the first information element 1023a, the second information element 1023b, and dynamic module 1025 (e.g., which includes an indication of a current location associated with a current scene in the TV show episode) are not vertically scrollable in the playback user interface 1002, as similarly discussed above.

FIGS. 10S-10T illustrate examples of electronic device 514 presenting user interfaces associated with display of insights corresponding to a live content item that is displayed in a playback user interface. In FIG. 10S, the electronic device 514 is displaying a live content item (e.g., Live Content A) in the playback user interface 1002, as similarly discussed above. Additionally, in some embodiments, as shown in FIG. 10S, the electronic device 514 is in communication with a second electronic device 500 previously discussed above. For example, in FIG. 10S, the electronic device 500 is a mobile device, such as a smartphone, that includes touchscreen 504.

In some embodiments, as shown in FIG. 10S, the electronic device 500 is displaying a remote-control user interface 1020 that is configurable to control the electronic device 514. For example, input detected via the touchscreen 504 of the electronic device 500 directed to the remote-control user interface 1020 is transmitted (e.g., as input data) to the electronic device 514 (e.g., for controlling playback of the live content item in the playback user interface 1002). In some embodiments, as shown in FIG. 10S, the remote-control user interface 1020 has a plurality of controls that are similar and/or that correspond to the physical buttons of the remote input device 510 discussed herein above. Additionally, as shown in FIG. 10S, the remote-control user interface 1020 includes touch input region 1026 that is similar in functionality to the touch-sensitive surface 451 of the remote input device 510 discussed above.

In some embodiments, as shown in FIG. 10S, the remote-control user interface 1020 also includes selectable option 1028. In some embodiments, the selectable option 1028 is similar in functionality to the first selectable option 1010 discussed above. For example, the selectable option 1028 is selectable to display insights corresponding to the live content item (e.g., via the display of the electronic device 514 and/or via the touchscreen 504 of the electronic device 500).

In FIG. 10S, while the electronic device 514 is displaying the live content item in the playback user interface and while the electronic device 500 is displaying the remote-control user interface 1020, the electronic device 500 detects a selection of the selectable option 1028 in the remote-control user interface 1020. For example, as shown in FIG. 10S, the electronic device 500 detects a tap of contact 1003s directed to the selectable option 1028 on the touchscreen 504.

In some embodiments, as shown in FIG. 10T, in response to detecting the selection of the selectable option 1028 in the remote-control user interface 1020, the electronic device 500 displays insights corresponding to the live content item. For example, as shown in FIG. 10T, the electronic device 500 displays, via the touchscreen 504, fourth information element 1021d and fifth information element 1021e discussed previously above (e.g., in place of or within the remote-control user interface 1020). In some embodiments, when the electronic device 500 detects the selection of the selectable option 1028, the electronic device 500 transmits an indication to the electronic device 514 that the selection of the selectable option 1028 has been detected. In some embodiments, as shown in FIG. 10T, in response to detecting the indication from the electronic device 500, the electronic device 514 updates the playback user interface 1002 to include information corresponding to the live content item. For example, as similarly discussed above and as shown in FIG. 10T, the electronic device 514 displays the content player bar 1006 in the playback user interface and displays first information element 1021a, second information element 1021b, and third information element 1021c discussed previously above below the content player bar 1006 in the playback user interface 1002. In some embodiments, the information that is displayed at the electronic device 514 (e.g., the information elements 1021a-1021c) is concurrently displayed with the information that is displayed at the electronic device 500 (e.g., the information elements 1021d-1021e). In some embodiments, in response to detecting the selection of the selectable option 1028, the electronic device 500 displays the insights corresponding to the live content item without the electronic device 514 also displaying any insights corresponding to the live content item.

It should be understood that the display of the insights for the live content item via the remote-control user interface 1020 in the manner discussed above similarly applies for the display of insights for on-demand content items that are played back in the playback user interface 1002 at the electronic device 514.

FIG. 11 is a flow diagram illustrating a method 1100 of facilitating interactions with content items displayed in a multi-view viewing mode in accordance with some embodiments of the disclosure. The method 1100 is optionally performed at an electronic device such as device 100, device 300, or device 500 as described above with reference to FIGS. 1A-1B, 2-3, 4A-4B and 5A-5C. Some operations in method 1100 are, optionally combined and/or order of some operations is, optionally, changed.

As described below, the method 1100 provides ways to facilitate interaction with content items displayed in a multi-view viewing mode. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 1100 is performed by an electronic device (e.g., device 514) in communication with a display generation component and one or more input devices (e.g., remote input device 510). For example, the electronic device is a mobile device (e.g., a tablet, a smartphone, a media player, or a wearable device) including wireless communication circuitry. In some embodiments, the electronic device has one or more characteristics of electronic devices in methods 700, 900, and/or 1200. In some embodiments, the display generation component has one or more characteristics of the display generation component in methods 700, 900, and/or 1200. In some embodiments, the one or more input devices has one or more characteristics of the one or more input devices in method 700, 900, and/or 1200.

In some embodiments, while displaying, via the display generation component, a first live content item (e.g., a first live-broadcast content item) in a playback user interface (e.g., a content player, such as a movie player or other media player), wherein the playback user interface is configured to playback content (e.g., a movie, an episode of a television (TV) show, music, a podcast, etc.), the electronic device receives (1102a), via the one or more input devices, a first sequence of one or more inputs corresponding to a request to concurrently display the first live content item and a second live content item, different from the first live content item, in a multi-view viewing mode, such as via contact 603nn detected via remote input device 510 for adding a second content item (e.g., Item B) and a third content item (e.g., Item C) for playback in the multi-view viewing mode. In some embodiments, the first live content item has one or more characteristics of live content items as described with reference to methods 700, 900, and/or 1200. In some embodiments, the playback user interface has one or more characteristics of the playback user interface in methods 700, 900, and/or 1200. In some embodiments, the first sequence of one or more inputs includes a first input corresponding to a request to display one or more controls for controlling playback of the first live content item. For example, the electronic device receives a tap detected on a touch-sensitive surface of the one or more input devices (e.g., on a remote input device in communication with the electronic device), such as touch sensitive surface 451 described with reference to FIG. 4, a click of the touch-sensitive surface, or a selection of a hardware button of a remote input device in communication with the electronic device, such as remote 510 described with reference to FIG. 5B. In some embodiments, the first input is detected via a touch screen of the electronic device (e.g., the touch screen is integrated with the electronic device, and is the display via which the playback user interface is being displayed). In some embodiments, the first input has one or more characteristics of inputs described with reference to methods 700, 900, and/or 1200. In some embodiments, in response to receiving the first input, the electronic device displays a content player bar for navigating through the first live content item that includes a selectable option that is selectable to initiate display of the first live content item in one or more viewing modes, including the multi-view viewing mode. In some embodiments, the content player bar has one or more characteristics of the content player bar described with reference to methods 700, 900, and/or 1200. In some embodiments, the content player bar including the selectable option is already displayed in the playback user interface when the first sequence of one or more inputs is received. In some embodiments, while the content player bar including the selectable option is displayed, the first sequence of one or more inputs includes a second input corresponding to a selection of a multi-view viewing mode option for the first live content item, such as the inputs described with reference to method 700. In some embodiments, in response to receiving the second input of the first sequence of one or more inputs, the electronic device displays a user interface corresponding to the multi-view viewing mode (e.g., a multi-view user interface) that is configurable to include a plurality of live content items (e.g., concurrent display of a plurality of live content items, including the first live content item). In some embodiments, the multi-view user interface has one or more characteristics of the multi-view user interface described above with reference to method 700. In some embodiments, when the electronic device displays the multi-view user interface, the electronic device displays the first live content item in a playback region of the user interface. In some embodiments, the playback region has one or more characteristics of the playback region of the multi-view user interface described above with reference to method 700. In some embodiments, when the electronic device displays the respective user interface, the electronic device displays the live content item in the playback region and resumes playback from the current live playback position within the live content item. In some embodiments, the live content item is displayed in a first viewing window within the playback region in the multi-view user interface. In some embodiments, as similarly described with reference to method 700, the multi-view user interface includes one or more user interface objects corresponding to one or more respective content items (e.g., live content items and/or on-demand content items) that are currently available for playback at the electronic device (e.g., while in the multi-view viewing mode). In some embodiments, the one or more user interface objects corresponding to the one or more respective content items are displayed (e.g., as a row) in a non-playback region below the playback region (e.g., an Add More region below the playback region in the multi-view user interface). In some embodiments, the one or more user interface objects of the multi-view user interface have one or more characteristics of the one or more user interface objects of the multi-view user interface described above with reference to method 700. In some embodiments, the first sequence of one or more inputs includes a third input corresponding to a selection of a respective user interface object of the one or more user interface objects that corresponds to the second live content item.

In some embodiments, in response to receiving the first sequence of one or more inputs (e.g., such as the third input discussed above), the electronic device displays (1102b), via the display generation component, a user interface corresponding to the multi-view viewing mode (e.g., Multiview user interface 632 in FIG. 6OO), wherein the user interface is configurable to include a plurality of live content items (e.g., as described above) and displaying the user interface includes concurrently displaying the first live content item and the second live content item in a playback region of the user interface, and wherein the first live content item is displayed at a first size and the second live content item is displayed at a second size, different from the first size. For example, the electronic device concurrently plays back the first live content item and the second live content item in the playback region of the user interface. In some embodiments, the first live content item and the second live content item are displayed adjacently in the playback region of the respective user interface. In some embodiments, the first live content item is displayed in a primary view in the playback region. For example, the first viewing window discussed above that includes the first live content item is displayed at a larger size than a second viewing window that includes the second content item in the playback region of the multi-view user interface (e.g., such that the first size is larger than the second size). Additionally, in some embodiments, the first live content item is displayed with one or more first visual characteristics and the second live content item is displayed with one or more second visual characteristics, optionally different from the one or more first visual characteristics. For example, the electronic device displays the first live content item with a first amount of translucency, a first amount of brightness, a first coloration, and/or a first amount of saturation in the playback region, and displays the second live content item with a second amount of translucency (e.g., different from the first amount of translucency), a second amount of brightness (e.g., different from the first amount of brightness), a second coloration (e.g., different from the first coloration), and/or a second amount of saturation (e.g., different from the first amount of saturation). In some embodiments, as similarly described above with reference to method 700, a current focus is able to be moved between the first viewing window and the second viewing window to change the content item that is displayed in the primary view (e.g., at the larger size between the two). Accordingly, in the playback region of the multi-view user interface, if the second viewing window that includes the second live content item has the current focus, the second viewing window is displayed at a larger size than the first viewing window that includes the first live content item (e.g., such that the second size is larger than the first size). In some embodiments, as similarly described above with reference to method 700, while a respective content item has the current focus (e.g., such as the first live content item as discussed above), if the electronic device detects a selection input (e.g., similar to the input discussed above), the electronic device displays the respective content item at a larger size (e.g., a full-screen size) in the multi-view user interface and ceases display of other content items (e.g., including the second live content item).

In some embodiments, while concurrently displaying the first live content item at the first size and the second live content item at the second size in the playback region of the user interface corresponding to the multi-view viewing mode (e.g., and while concurrently playing back the first live content item and the second live content item), the electronic device detects (1102c) a threshold amount of time (e.g., 1, 2, 3, 5, 10, 15, 30, 60, 90, 180, etc. seconds) has elapsed without receiving user input (e.g., via the one or more input devices of the electronic device), such as threshold time 652-1 indicated in time bar 651 in FIG. 6PP. For example, while concurrently displaying the first live content item and the second live content item in the playback user interface of the multi-view application, the electronic device detects the display generation component (e.g., the display or touch screen of the electronic device) go idle due to a lack of input that would otherwise cause one or more elements of the display generation component to be updated in accordance with the input. In some embodiments, when the electronic device detects the threshold amount of time elapse without receiving user input, one of the live content items has the current focus. For example, the first live content item, which is displayed at the first (e.g., larger) size in the playback user interface, has the current focus when the electronic device detects the threshold amount of time elapse.

In some embodiments, in response to detecting that the threshold amount of time has elapsed without receiving user input, the electronic device displays (1102d), via the display generation component, the first live content item and the second live content item at a third size (e.g., different from the first size and/or the second size) in the playback region of the user interface, such as display of the content items in the first viewing window 635, the second viewing window 639a and the third viewing window 639b at the same size in the playback region 634 of the Multiview user interface 632. For example, the electronic device displays an animation of the first viewing window that includes the first live content item and the second viewing window that includes the second live content item gradually changing to have the third size in the playback region. In some embodiments, the third size is larger than the first size and the second size discussed above. For example, when the first live content item and the second live content item are both displayed at the third size in the playback region of the multi-view user interface, the first live content item and the second live content item occupy greater portions of the playback region and thus the display generation component, such that the first live content item and the second live content item are larger than before detecting that the threshold amount of time has elapsed. Alternatively, in some embodiments, the third size is the same as the first size or the third size is the same as the second size. In some embodiments, while the first live content item and the second live content item are displayed at the third size in the playback region of the user interface, neither of the live content items has the current focus in the playback region. For example, because the first live content item and the second live content item are displayed at the same size in the playback region, neither content item is displayed in the primary view discussed above. In some embodiments, while the first live content item and the second live content item are displayed at the third size in the playback region, if the electronic device receives user input (e.g., such as a tap or touch of a button or touch-sensitive surface of a remote device or a tap or touch of a touch screen of the electronic device), the electronic device restores the first live content item and the second live content item to their previous respective sizes. For example, the first live content item is redisplayed at the first size in the playback region and the second live content item is redisplayed at the second size in the playback region. Additionally, in some embodiments, the content item that is displayed in the primary viewing window within the playback region of the multi-view user interface would have the current focus in the multi-view user interface. For example, in response to receiving the user input, the electronic device displays the first live content item with the current focus because the first live content item is displayed in the primary viewing window and/or because the first live content item had the focus prior to detecting the threshold amount of time discussed above elapse. In some embodiments, while concurrently displaying the first live content item and the second live content item in the playback region as discussed above, if the electronic device receives user input before the threshold amount of time has elapsed, the electronic device forgoes displaying the first live content item and the second live content item at the third size in the playback region of the multi-view user interface. While a first live content item and a second live content item are displayed at different sizes in a multi-view user interface, displaying the first live content and the second live content item at the same size in response to detecting a threshold amount of time elapse without receiving user input enables the first live content item and the second live content item to both be displayed at optimal viewing sizes in the multi-view user interface without requiring user input, which helps improve a viewing experience of the user, thereby improving user-device interaction.

In some embodiments, while concurrently displaying the first live content item at the first size and the second live content item at the second size in the playback region of the user interface corresponding to the multi-view viewing mode, the first live content item has a current focus in the playback region of the user interface, such as display of first viewing window 635 that is displaying the live content item with the current focus as shown in FIG. 6QQ. In some embodiments, the electronic device displays the first live content item with an indication of focus. For example, the first live content item is displayed with visual emphasis relative to the second live content item in the multi-view user interface (e.g., with bolding, highlighting, sparkling, and/or with a larger size, as discussed below). In some embodiments, the electronic device displays a visual element (e.g., a visual band) around the first live content item in the multi-vie user interface. In some embodiments, while the first live content item has the current focus in the playback region of the user interface, the first live content item is selectable to display the first live content item in full screen in the multi-view user interface. For example, if the electronic device detects a selection input via the one or more input devices (e.g., a tap of a contact on a touch-sensitive surface or press of a hardware button) while the first live content item has the current focus, the electronic device displays the first live content item at a size occupying (e.g., an entirety of) the display generation component, and optionally similarly displays a different live content item at the size occupying the display generation component instead if that different content item has the current focus when the selection input is detected.

In some embodiments, the first size is larger than the second size, such as the first viewing window 635 being larger than the second viewing window 639a as shown in FIG. 6QQ. For example, as described above, the viewing window in which the first live content item is displayed at a larger size than the second live content item in the multi-view user interface. In some embodiments, as similarly discussed above, the first live content item is displayed with the current focus (e.g., at the first size) because the first live content item was being played back in the playback user interface prior to the first sequence of one or more inputs being detected. Displaying a first live content item at a larger size than a second live content item when the first live content item has the current focus in a multi-view user interface reduces the number of inputs needed to display the first live content item at an enlarged size in the multi-view user interface and/or facilitates discovery that moving the focus will cause other content items to be displayed at the enlarged size in the multi-view user interface, thereby improving user-device interaction.

In some embodiments, while concurrently displaying the first live content item at the first size and the second live content item at the second size in the playback region of the user interface corresponding to the multi-view viewing mode, the electronic device receives, via the one or more input devices, a request to move the focus from the first live content item to the second live content item, such as swipe of contact 603dd on touch-sensitive surface 451 of the remote input device 510 as shown in FIG. 6DD. For example, while the multi-view user interface is displayed, the electronic device receives an input moving the focus from the viewing window in which the first live content item is displayed to the viewing window in which the second live content item is displayed in the multi-view user interface. In some embodiments, the input includes a swipe gesture in a respective direction (e.g., horizontally or vertically) detected via a touch-sensitive surface of the one or more input devices. In some embodiments, the input includes a press of a navigation option (e.g., an arrow key) of a remote input device in communication with the electronic device. In some embodiments, the input includes tap directed to the second live content item detected via a touch screen of the electronic device.

In some embodiments, in response to receiving the request, the electronic device moves the current focus from the first live content item in the playback region to the second live content item, such as displaying live content item in the first viewing window 635 with the current focus in the playback region 634 as shown in FIG. 6EE. For example, the electronic device displays the viewing window in which the second live content item is displayed with the current focus. In some embodiments, the electronic device displays the second live content item with an indication of focus. For example, the second live content item is displayed with visual emphasis relative to the first live content item in the multi-view user interface (e.g., with bolding, highlighting, sparkling, and/or with a larger size). In some embodiments, the electronic device displays a visual element (e.g., a visual band) around the second live content item in the multi-view user interface.

In some embodiments, the electronic device concurrently displays the second live content item at the first size and the first live content item at the second size in the playback region of the user interface. For example, as similarly discussed above, the second live content item is displayed at the enlarged size in the multi-view user interface when the current focus is moved to the second live content item. Displaying a second live content item at a larger size than a first live content item after the current focus is moved to the second live content item in a multi-view user interface reduces the number of inputs needed to display the second live content item at an enlarged size in the multi-view user interface and/or facilitates discovery that moving the focus causes other content items to be displayed at the enlarged size in the multi-view user interface, thereby improving user-device interaction.

In some embodiments, while concurrently displaying the first live content item at the first size and the second live content item at the second size in the playback region of the user interface corresponding to the multi-view viewing mode, the first live content item and the second live content item are displayed in a first predefined arrangement in the playback region, such as an arrangement of the content items in the playback region 634 as shown in FIG. 6UU. For example, as similarly described with reference to method 700, the electronic device displays the first live content item and the second live content item in a predetermined viewing arrangement in the playback region of the multi-view user interface. In some embodiments, the predefined arrangement is a grid arrangement in the playback region of the multi-view user interface. For example, the electronic device displays the first live content item at a first predefined location in the playback region and displays the second live content item at a second predefined location in the playback region.

In some embodiments, while concurrently displaying the first live content item and the second live content item in the first predefined arrangement in the playback region of the user interface, the electronic device receives, via the one or more input devices, a second sequence of one or more inputs corresponding to selection of a third live content item, different from the first live content item and the second live content item, for playback in the playback region of the user interface, such as via contact 603uu on the touch-sensitive surface 451 of the remote input device 510. For example, while displaying the multi-view user interface that includes the first live content item and the second live content item in the playback region, the electronic device receives selection of one or more of the user interface objects corresponding to the one or more respective content items described previously above. As an example, the electronic device receives a selection of a respective user interface object corresponding to a third live content item. In some embodiments, as similarly described above, the electronic device receives the second sequence of one or more inputs on a touch-sensitive surface of the one or more input devices, via a hardware button of a remote input device in communication with the electronic device, or on a touch screen of the electronic device. In some embodiments, the second sequence of one or more inputs has one or more characteristics of the first sequence of one or more inputs discussed above.

In some embodiments, in response to receiving the sequence of one or more inputs, the electronic device updates display, via the display generation component, of the user interface to concurrently display the first live content item, the second live content item, and the third live content item in the playback region of the user interface, wherein the first live content item, the second live content item, and the third live content item are displayed in a second predefined arrangement, different from the first predefined arrangement, in the playback region of the user interface, such as an arrangement of the content items in the playback region 634 as shown in FIG. 6VV. For example, as similarly discussed above, in response to receiving the selection of the respective user interface object corresponding to the third live content item, the electronic device initiates playback of the third live content item in the multi-view user interface. In some embodiments, the electronic device optionally displays the third live content item at a third predefined location in the playback region, wherein the third predefined location is below the first predefined location and the second predefined location discussed above, and optionally centrally located relative to the first predefined location and the second predefined location, in the grid arrangement. Additionally, in the gird arrangement, while the first live content item is displayed with the current focus (e.g., at the largest size), the second live content item and the third live content item are optionally displayed at a same size at their respective locations in the playback region of the multi-view user interface. In some embodiments, if a fourth live content item is selected for playback in the playback region of the multi-view user interface, the fourth live content item is displayed beside the third live content item in the playback region (e.g., at a fourth predefined location beside the third predefined location discussed above) and optionally at a same size as the second live content item and the third live content item in the grid arrangement. In some embodiments, the predefined viewing arrangement is a thumbnail layout in the playback region of the user interface. For example, the electronic device displays the first live content item at a first predefined location in the playback region and displays the second live content item and the third live content item in a column adjacent to (e.g., to the right of) the first predefined location (e.g., such that the second predefined location is to the right of the first predefined location, and, optionally, the third predefined location (at which the third live content item is displayed) is below the second predefined location (in a column)). Additionally, in the thumbnail arrangement, the first live content item displayed at the first predefined location is optionally displayed at a largest size, and the second live content item and the third live content item are displayed at a same smaller size. In some embodiments, if a fourth live content item is selected for playback in the playback region of the multi-view user interface, the fourth live content item is displayed below the third live content item in the column of content items in the playback region (e.g., at a fourth predefined location below the third predefined location discussed above) and optionally at a same size as the second live content item and the third live content item in the thumbnail arrangement. In some embodiments, the multi-view user interface includes one or more selectable options for changing the predefined arrangement in the multi-view user interface, as previously described with reference to method 700. In some embodiments, the locations at which and/or the predefined viewing arrangement in which the live content items are displayed in the playback region of the multi-view user interface are based on an order in which the live content items are selected for playback, as previously described above with reference to method 700. In some embodiments, the locations at which and/or the predefined viewing arrangement in which the content items are displayed in the playback region of the respective user interface are based on a size of the playback region, which is optionally dependent on the display generation component via which the respective user interface is displayed. For example, the playback region of the respective user interface that is displayed via a touch screen of a mobile device is much smaller than the playback region of the respective user interface that is displayed via a television screen. Accordingly, the sizes at which the live content items are played back in the playback region of the multi-view user interface and/or the number of content items that are (e.g., horizontally) across a given portion of the playback region optionally changes based on the size of the playback region. Additionally, the positions (e.g., the predefined locations discussed above) at which the first and second live content items are displayed in the playback region of the multi-view user interface changes/shifts when the third live content item (and subsequent live content items) are added for playback in the multi-view user interface. Concurrently displaying live content items in a predetermined viewing arrangement in a multi-view user interface in response to one or more inputs selecting the live content items for playback enables the user to concurrently view multiple content items and/or reduces the number of inputs needed to concurrently display the live content items in the multi-view user interface, thereby improving user-device interaction.

In some embodiments, before receiving the sequence of one or more inputs, the first live content item has a current focus in the playback region of the user interface corresponding to the multi-view viewing mode (e.g., the first live content item is displayed with an indication of focus and/or is displayed at an enlarged size (e.g., the first size) in the playback region as similarly discussed above), and the second sequence of one or more inputs includes a first input corresponding to a request to move the focus from the first live content item to a user interface object corresponding to the third live content item in the user interface, such as display of representation 636-5 in the available content region 633 with the current focus as shown in FIG. 6UU, wherein selection of the user interface object initiates playback of the third live content item in the playback region of the user interface, such as playback of third content item in the playback region 634 as shown in FIG. 6VV. For example, as previously discussed above, the user interface object corresponding to the third live content item is displayed below the playback region in the user interface and is included in one or more user interface objects corresponding to one or more content items that are available for playback in the multi-view user interface. In some embodiments, as similarly discussed above, the one or more content items corresponding to the one or more user interface objects are displayed in an Add More region below the playback region in the multi-view user interface. In some embodiments, displaying the one or more user interface objects corresponding to the one or more content items in the Add More region does not include playing back the one or more content items in the Add More region (rather, as discussed herein, such content items are, if selected, played back in the playback region of the multi-view user interface).

In some embodiments, the second sequence of one or more inputs includes a second input (e.g., after the first input and while the user interface object corresponding to the third live content item has the current focus) corresponding to selection of the user interface object corresponding to the third live content item in the user interface, such as via tap of contact 603uu on the touch-sensitive surface 451 of the remote input device 510. For example, as previously discussed herein, the electronic device detects a tap or touch of a contact on a touch-sensitive surface of the one or more input devices (e.g., such as a remote controller or via a touchscreen of the electronic device). In some embodiments, as discussed above, the electronic device detects the second input via a hardware button of a hardware input device (e.g., remote controller, mouse, keyboard, etc.). Concurrently displaying live content items in a predetermined viewing arrangement in a multi-view user interface in response to one or more inputs selecting the live content items for playback from one or more user interface objects corresponding to the live content items enables the user to concurrently view multiple content items and/or reduces the number of inputs needed to concurrently display the live content items in the multi-view user interface, thereby improving user-device interaction.

In some embodiments, in response to receiving the first input of the second sequence of one or more inputs, the electronic device moves the current focus from the first live content item to the user interface object corresponding to the third live content item in the user interface corresponding to the multi-view viewing mode (e.g., as similarly discussed above), such as display of representation 636-2 with the current focus as shown in FIG. 6NN. In some embodiments, the electronic device updates display, via the display generation component, of the playback region to concurrently include the first live content item, the second live content item, and a placeholder indication of the third live content item, such as display of visual indication 638b of the second content item in the playback region 634 as shown in FIG. 6NN. For example, before receiving the second input selecting the user interface object corresponding to the third live content item and while the user interface object corresponding to the third live content item has the current focus, the electronic device displays a placeholder indication of the third live content item concurrently with the first live content item and the second live content item. In some embodiments, the placeholder indication of the first content item indicates that the third live content item will be concurrently displayed with the first live content item and the second live content item in the playback region in response to further input (e.g., the second input discussed above). For example, the third live content item is displayed at a location of the placeholder indication in the playback region with respect to the live content item (e.g., adjacent to the live content item) in response to the second input selecting the user interface object corresponding to the third live content item. In some embodiments, displaying the placeholder indication of the third live content item in the playback region includes reconfiguring, rearranging, and/or resizing the existing content items displayed in the playback region, as similarly described with reference to method 700. For example, the electronic device reduces the sizes of the viewing windows in which the first live content item and the second live content item are displayed when the placeholder indication of the third live content item is displayed in the playback region. Additionally, the electronic device optionally changes the locations at which the viewing windows of the first live content item and the second live content item are displayed in the playback region. For example, the electronic device shifts the first live content item and/or the second live content item within the playback region when displaying the placeholder indication to have the second predefined arrangement discussed previously above. In some embodiments, because the playback region includes the placeholder indication after receiving the first input of the second sequence of one or more inputs, the arrangement and/or configuration of the live content items included in the playback region of the multi-view user interface is different from that of the live content items before the first input is receive. In some embodiments, after the third live content item is selected for playback in the playback region as discussed above, the first, second, and third live content items are displayed in the second predefined arrangements, the same as that of the first live content item, the second live content item, and the placeholder indication before the third live content item is selected. Displaying a placeholder indication of a third live content item with a first live content item and a second live content item in a multi-view user interface in response to an input moving a current focus from the first live content item to a user interface object corresponding to the third live content item facilitates discovery that a selection of the user interface object will cause the third live content item to be concurrently displayed with the first live content item and the second live content item in the multi-view user interface and/or helps avoid unintentional display of the third live content item with the live content items in the multi-view user interface, thereby improving user-device interaction.

In some embodiments, while concurrently displaying the first live content item and the second live content item in the playback region of the user interface corresponding to the multi-view viewing mode, the electronic device receives, via the one or more input devices, an input corresponding to a request to display one or more viewing options for a respective content item (e.g., the first live content item or the second live content item), such as selection of TV button via contact 603qq on the remote input device 510 as shown in FIG. 6QQ. For example, the electronic device receives a selection and hold input directed to the respective content item (e.g., a tap of a contact directed to the respective content item that is detected via a touch-sensitive surface of the one or more input devices and maintaining the contact on the touch-sensitive surface for a threshold amount of time (e.g., 0.25, 0.5, 0.75, 1, 1.5, 2, 3, 5, etc. seconds)). In some embodiments, the input is detected via a hardware input device (e.g., a remote controller) in communication with the electronic device. For example, the electronic device detects a press of a hardware button on the remote controller for the threshold amount of time discussed above while the respective content item has the current focus in the multi-view user interface. In some embodiments, the one or more viewing options for the respective content item include a first option for repositioning the respective content item within the playback region, a second option for removing/ceasing display of the respective content item in the playback region, and a third option for displaying the respective content item in full screen in the playback user interface previously discussed above. For example, selection of the first option initiates a process for shifting an arrangement of the live content items within the playback region, such as swapping positions of the first live content item and the second live content item in the playback region, or moving the respective content item to a new location in the playback region that is currently not occupied by a content item in the multi-view user interface. Selection of the second option optionally causes the electronic device to cease display of the respective content item in the playback user interface and update the predefined arrangement of the other live content items in the playback region of the multi-view user interface, as similarly discussed in more detail later. In some embodiments, selection of the third option causes the electronic device to cease displaying the multi-view user interface (e.g., including other live content items in the playback region) and display the respective content item in the playback user interface discussed previously above, as similarly discussed in more detail below.

In some embodiments, in response to receiving the input, in accordance with a determination that the respective content item is the first live content item, the electronic device displays, via the display generation component, one or more viewing options for the first live content item in the user interface, such as display of viewing options 661-1-661-3 as shown in FIG. 6RR, (e.g., the one or more viewing options discussed above but specific to the first live content item). In some embodiments, the one or more viewing options are displayed overlaid on the first live content item in the playback region of the multi-view user interface. For example, the one or more viewing options are displayed over a corner or along an edge of the first live content item in the playback region. In some embodiments, the one or more viewing options are displayed adjacent to (e.g., and outside of) the first live content item in the playback region. In some embodiments, the one or more viewing options are displayed as a menu or list in the multi-view user interface. In some embodiments, an indication of focus is movable among the one or more viewing options to facilitate selection of one of the one or more viewing options, as similarly discussed above.

In some embodiments, in accordance with a determination that the respective content item is the second live content item, the electronic device displays one or more viewing options for the second live content item in the user interface (e.g., the one or more viewing options discussed above but specific to the second live content item), such as display of viewing options 661-1-661-3 as shown in FIG. 6RR. Displaying one or more viewing options for a live content item of a plurality of content items that are being played back in a multi-view user interface in response to receiving an input directed to the live content reduces the number of inputs needed to select a viewing option of the one or more viewing options, which also reduces the number of inputs needed to perform an operation associated with the selected viewing option, thereby improving user-device interaction.

In some embodiments, while concurrently displaying the first live content item and the second live content item in the playback region of the user interface corresponding to the multi-view viewing mode, the electronic device receives, via the one or more input devices, a second sequence of one or more inputs corresponding to a request to select one or more live content items for playback in the playback region of the user interface, such as selection of a fifth content item (e.g., Item E) via contact 603vv on the touch-sensitive surface 451 of the remote input device 510 as shown in FIG. 6VV. For example, while displaying the multi-view user interface that includes the first live content item and the second live content item in the playback region, the electronic device receives selection of one or more of the user interface objects corresponding to the one or more content items discussed previously above. As an example, the electronic device receives a selection of a first user interface object corresponding to a third live content item, optionally followed by a selection of a second user interface object corresponding to a fourth live content item in the user interface, and so on. In some embodiments, as similarly described above, the electronic device receives the second sequence of one or more inputs on a touch-sensitive surface of the one or more input devices, via a hardware button of a remote input device in communication with the electronic device, or on a touch screen of the electronic device.

In some embodiments, in response to receiving the sequence of one or more inputs, in accordance with a determination that selecting the one or more live content items for playback in the playback region of the user interface would cause a number of live content items concurrently displayed in the playback region to exceed a threshold number (e.g., 4, 5, 6, 8, 10, 12, etc.), the electronic device forgoes updating display of the user interface to concurrently display the first live content item, the second live content item, and the one or more live content items selected for playback in the playback region of the user interface, such as forgoing adding the fifth content item for playback in the playback region 634 as shown in FIG. 6WW. In some embodiments, the threshold number above is determined based on a size of the playback region, which is optionally dependent upon a size of the display generation component (e.g., such as the size of the touchscreen of the electronic device). For example, an integrated display of a desktop computer is larger than the touchscreen of a mobile smartphone. Accordingly, the playback region of the multi-view user interface that is displayed on the integrated display of the desktop computer would be larger than the playback region of the multi-view user interface that is displayed on the touch screen of the electronic device, which optionally causes the threshold number for the playback region displayed on the integrated display of the desktop computer to be larger than the threshold number for the playback region displayed on the touch screen of the smartphone (e.g., by 1, 2, 3, 4, etc.). In some embodiments, the electronic device concurrently displays the first live content item, the second live content item, and a subset of the one or more live content items selected for playback in the playback region until the number of live content items concurrently displayed in the playback region reaches the threshold number above. For example, if selecting the first user interface object corresponding to the third live content item discussed above and selecting the second user interface object corresponding to the fourth live content item discussed above causes the number of live content items to reach the threshold number, but not exceed it, the electronic device updates display of the user interface to concurrently display the first live content item, the second live content item, the third live content item, and the fourth live content item in the playback region. However, if the electronic device detects a selection of a third user interface object corresponding to a fifth live content item that, if displayed, would cause the number of live content items in the playback region to exceed the threshold number, the electronic device forgoes updating display of the user interface to also include the fifth live content item in the playback region.

In some embodiments, the electronic device presents an indication (e.g., a notification) that the threshold number of live content items concurrently displayed in the playback region of the user interface has been reached, such as display of notification 641 as shown in FIG. 6WW. For example, the electronic device displays a notification containing a message stating that no more content items can currently be added for display in the playback region of the user interface. In some embodiments, the indication prompts/invites the user to remove (e.g., cease display of) one or more of the live content items currently displayed in the playback region to allow the selected one or more live content items to be displayed in the playback region. For example, a respective live content item can be removed from the playback region using any one of the methods discussed later below. In some embodiments, the indication is presented along with audio and/or haptic feedback, such as a chime, ring, or other sound and/or a vibration of a motor within a hardware input device in communication with the electronic device. In some embodiments, in accordance with a determination that selecting the one or more live content items for playback in the playback region of the user interface would not cause the number of live content items concurrently displayed in the playback region to exceed the threshold number above, the electronic device updates display of the user interface to concurrently display the first live content item, the second live content item, and the one or more live content items selected for playback in the playback region of the user interface. Presenting an indication that a threshold number of live content items is currently displayed in a playback region of a multi-view user interface in response to detecting an input corresponding to a request to add one or more additional content items for display in the playback region facilitates discovery that the threshold number of live content items has been reached and/or facilitates user input for removing one or more of the live content items in the playback region to allow for the addition of one or more of the additional content items in the playback region, thereby improving user-device interaction.

In some embodiments, while concurrently displaying the first live content item and the second live content item in the playback region of the user interface corresponding to the multi-view viewing mode, the electronic device detects, via a touch-sensitive surface of the electronic device, a swipe of a contact (e.g., a finger of a hand of the user or a tip of a stylus) on the touch-sensitive surface in a respective direction directed to the first live content item, such as swipe of contact 603ddd-ii on touchscreen 504 directed to the second viewing window 639a that is displaying the first content item. For example, the electronic device receives a swipe gesture/input on a touchscreen of the electronic device at a location of the touchscreen corresponding to the first live content item. In some embodiments, the swipe of the contact is detected while the contact is at least partially detected over a portion of the first live content item that is being displayed on the touchscreen of the electronic device. Alternatively, in some embodiments, the electronic device detects the swipe of the contact on a touch-sensitive surface of a trackpad or remote controller while the first live content item has the current focus in the playback region.

In some embodiments, in response to detecting the swipe of the contact on the touch-sensitive surface, in accordance with a determination that the respective direction is a first direction, the electronic device ceases display, in the playback region of the user interface, of the first live content item, such as ceasing display of the first content item in the playback region 634 as shown in FIG. 6EEE. For example, the electronic device removes the first live content item from the playback region of the multi-view user interface, such that the first live content item is no longer being played back in the multi-view user interface. In some embodiments, the first direction is based on a position of the first live content item relative to the closest edge of the display generation component to the first live content item. For example, if the first live content item is displayed in a first position that is closest to a left edge of the display generation component, the first direction is leftward on the touch-sensitive surface. Alternatively, in some embodiments, if the first live content item is displayed in a second position that is closest to a right edge of the display generation component, the first direction is rightward on the touch-sensitive surface.

In some embodiments, the electronic device displays, via the display generation component, the second live content item at a fourth size, greater than the first size, the second size, and the third size, such as displaying the first viewing window 635 in which the live content item is displayed at an increased size in the playback region 634 as shown in FIG. 6EEE. For example, the electronic device maintains display of the second live content item in the playback region and increases the size of the second live content item in the multi-view user interface. In some embodiments, because the second live content item is now the sole content item being played back in the multi-view user interface, the electronic device displays the second live content item at a size corresponding to a size of the playback region (e.g., the fourth size). Additionally, when the first live content item is removed from the playback region, the second live content item is displayed with the current focus, such that that audio being output corresponds to the second live content item, as previously discussed above. In some embodiments, in accordance with a determination that the respective direction is a second direction, different from the first direction, the electronic device forgoes ceasing display of the first live content item in the playback region of the user interface. For example, the electronic device maintains concurrent display of the first live content item at the first size and the second live content item at the second size. In some embodiments, the electronic device performs an alternative operation in accordance with the determination that the respective direction is the second direction. For example, the electronic device scrolls the user interface in response to detecting the swipe of the contact on the touch-sensitive surface (e.g., scrolls upward in the user interface if the second direction is upward on the touchscreen or scrolls downward in the user interface if the second direction is downward on the touchscreen). As another example of the alternative operation, the electronic device moves (e.g., rearranges) the first live content item within the playback region (e.g., swaps positions of the first live content item and the second live content item in the playback region). Ceasing displaying a live content item of a plurality of content items concurrently displayed in a multi-view user interface in response to receiving a swipe gesture directed to the live content item in the multi-view user interface reduces the number of inputs needed to cease display of the live content item in the multi-view user interface, thereby improving user-device interaction.

In some embodiments, the user interface corresponding to the multi-view viewing mode includes one or more user interface objects corresponding to one or more content items (e.g., as previously discussed above), including a first user interface object corresponding to the first live content item and a second user interface object corresponding to the second live content item, such as representations 636-1 and 636-2 in the available content region 633 in FIG. 6DDD. In some embodiments, as similarly discussed above, the one or more content items corresponding to the one or more user interface objects are displayed in an Add More region below the playback region in the multi-view user interface. In some embodiments, displaying the one or more user interface objects corresponding to the one or more content items in the Add More region does not include playing back the one or more content items in the Add More region (rather, as discussed herein, such content items are, if selected, played back in the playback region of the multi-view user interface). In some embodiments, because the first live content item and the second live content item are being played back in the playback region of the multi-view user interface, the first user interface object and the second user interface object are displayed with an indication that the first live content item and the second live content item have already been selected for playback in the playback region. For example, the first user interface object and the second user interface object are displayed with a checkmark indication, bolding and/or highlighting, a coloration effect, decreased brightness, etc. indicating that the first live content item and the second live content item have been selected for playback in the playback region of the multi-view user interface. Accordingly, others of the one or more user interface object corresponding to other content items that have not been selected for playback in the playback region are optionally not displayed with such an indication in the multi-view user interface.

In some embodiments, while concurrently displaying the first live content item and the second live content item in the playback region of the user interface, the electronic device receives, via the one or more input devices, an input corresponding to selection of a respective user interface object of the one or more user interface objects, such as a tap of contact 603ddd-i directed to the first representation 636-1 as shown in FIG. 6DDD. For example, the electronic device receives an input selecting the first user interface object corresponding to the first live content item, the second user interface object corresponding to the second live content item, or a third user interface object corresponding to a third live content item (e.g., not currently displayed in the playback region of the user interface). In some embodiments, the input corresponding to the selection of the respective user interface object has one or more characteristics of selection inputs discussed previously above.

In some embodiments, in response to receiving the input, in accordance with a determination that the respective user interface object is the first user interface object, the electronic device ceases display, in the playback region of the user interface, of the first live content item, such as ceasing display of the first content item in the playback region 634 as shown in FIG. 6EEE. For example, the electronic device removes the first live content item from the playback region such that the first live content item is no longer being played back in the multi-view user interface (and optionally no longer has the current focus in the playback region).

In some embodiments, the electronic device displays, via the display generation component, the second live content item at a fourth size, greater than the first size, the second size, and the third size, such as displaying the first viewing window 635 in which the live content item is displayed at an increased size in the playback region 634 as shown in FIG. 6EEE. For example, the electronic device maintains display of the second live content item in the playback region and increases the size of the second live content item in the multi-view user interface. In some embodiments, because the second live content item is now the sole content item being played back in the multi-view user interface, the electronic device displays the second live content item at a size corresponding to a size of the playback region (e.g., the fourth size). Additionally, when the first live content item is removed from the playback region, the second live content item is displayed with the current focus, such that that audio being output corresponds to the second live content item, as previously discussed above.

In some embodiments, in accordance with a determination that the respective user interface object is the second user interface object, the electronic device ceases display, in the playback region of the user interface, of the second live content item (e.g., as similarly discussed above but specific to the second live content item). In some embodiments, the electronic device displays, via the display generation component, the first live content item at the fourth size (e.g., as similarly discussed above but specific to the first live content item), such as displaying the third viewing window 639b in which the second content item is displayed at an increased size in the playback region 634 as shown in FIG. 6EEE. In some embodiments, as similarly discussed herein, in response to receiving the input, in accordance with a determination that the respective user interface object is a third user interface object corresponding to a third live content item that is not currently displayed in the playback region of the user interface, the electronic device updates display of the user interface to concurrently display the first live content item, the second live content item, and the third live content item in the playback region. For example, because the third live content item was not being played back in the playback region of the multi-view user interface when the input discussed above was received, the electronic device does not cease displaying either of the first live content item or the second live content item. Ceasing displaying a live content item of a plurality of content items concurrently displayed in a multi-view user interface in response to receiving a selection of a user interface object corresponding to the live content item reduces the number of inputs needed to cease display of the live content item in the multi-view user interface, thereby improving user-device interaction.

In some embodiments, while concurrently displaying the first live content item and the second live content item in the playback region of the user interface corresponding to the multi-view viewing mode, the electronic device concurrently detects, via a touch-sensitive surface of the electronic device, movement of a first contact (e.g., a first finger of a hand of the user or a tip of a first stylus) and movement of a second contact (e.g., a second finger of the hand of the user or a tip of a second stylus) on the touch-sensitive surface in different (e.g., opposing) directions directed to the first live content item, such as movement of contacts 603eee on the touchscreen 504 directed to the third viewing window 639b in which the second content item is displayed as shown in FIG. 6EEE. For example, the electronic device receives a pinch to zoom gesture/input on a touchscreen of the electronic device at a location of the touchscreen corresponding to the first live content item. In some embodiments, the movement of the first contact and the movement of the second contact are detected while the first contact and the second contact are at least partially detected over a portion of the first live content item that is being displayed on the touchscreen of the electronic device. Alternatively, in some embodiments, the electronic device detects the movement of the first contact and the movement of the second contact on a touch-sensitive surface of a trackpad or remote controller while the first live content item has the current focus in the playback region.

In some embodiments, in response to concurrently detecting the movement of the first contact and the movement of the second contact on the touch-sensitive surface, the electronic device ceases display of the user interface corresponding to the multi-viewing mode, such as ceasing display of the Multiview user interface 632 as shown in FIG. 6FFF. For example, the electronic device ceases display of the multi-view user interface that includes the first live content item and the second live content item. In some embodiments, the electronic device gradually increases the size of the first live content item in accordance with the movements of the first and second contacts before ceasing display of the multi-view user interface.

In some embodiments, the electronic device initiates playback of the first live content item in the playback user interface, such as display of the second content item in the playback user interface 602 as shown in FIG. 6FFF. For example, the electronic device displays the first live content item in full screen (e.g., at a size larger than the size that the first live content item was displayed in the multi-view user interface (optionally the first or the second size discussed above)) in the playback user interface described previously above. In some embodiments, the electronic device initiates playback of the first live content item at the current playback position within the first live content item when the pinch to zoom input described above was received (e.g., which is optionally the current live playback position). In some embodiments the electronic device forgoes displaying the second live content item in the playback user interface while displaying the first live content item in the playback user interface. In some embodiments, while the first live content item is displayed in the playback user interface, if the electronic device receives an input corresponding to a request to redisplay the multi-view user interface, the electronic device ceases display of the playback user interface and redisplays the multi-view user interface that concurrently includes the first live content item and the second live content item selected for playback in the playback region of the multi-view user interface. For example, in response to receiving selection of a back button/option, the electronic device redisplays the first live content item and the second live content item in the first predetermined viewing arrangement described above in the playback region, wherein the first live content item has the current focus (e.g., is displayed at a larger size (e.g., the first size) than the second live content item (e.g., displayed at the second size) in the playback region and the electronic device is outputting audio corresponding to the first live content item). Displaying a live content item of a plurality of content items concurrently displayed in a multi-view user interface in full screen in a playback user interface in response to receiving an input zooming into the live content item in the multi-view user interface enables the user to view the live content item in full screen in the playback user interface, while maintaining a context of the plurality of content items previously concurrently displayed in the multi-view user interface, and/or reduces the number of inputs needed to display the live content item in the playback user interface, thereby improving user-device interaction.

In some embodiments, the user interface corresponding to the multi-view viewing mode includes one or more user interface objects corresponding to one or more content items (e.g., as similarly discussed above), including a first user interface object corresponding to the first live content item and a second user interface object corresponding to the second live content item, such as representations 636-1 and 636-2 in the available content region 633 in FIG. 6BBB. In some embodiments, while concurrently displaying the first live content item at a first location and the second live content item at a second location, different from the first location, in the playback region of the user interface, the electronic device receives, via the one or more input devices, respective input that corresponds to selection of a third user interface object of the one or more user interface objects corresponding to a third live content item of the one or more content items, such as representation 636-2 corresponding to the second content item (e.g., Item B) in FIG. 6BBB. For example, the electronic device detects a contact (e.g., of a finger of a hand of the user or a tip of a stylus) on a touch-sensitive surface of the electronic device, such as a touchscreen of the electronic device, at a location corresponding to the third user interface object corresponding to the third live content item. In some embodiments, the electronic device detects a press of a hardware button of a hardware input device in communication with the electronic device that corresponds to a selection of the third user interface object. In some embodiments, as similarly discussed above, the one or more content items corresponding to the one or more user interface objects, including the first user interface object, the second user interface object, and the third user interface object, are displayed in an Add More region below the playback region in the multi-view user interface. In some embodiments, displaying the one or more user interface objects corresponding to the one or more content items in the Add More region does not include playing back the one or more content items in the Add More region (rather, as discussed herein, such content items are, if selected, played back in the playback region of the multi-view user interface).

In some embodiments, the respective input corresponds to movement of the third user interface object within the user interface to a third location, different from the first location and the second location in the playback region (e.g., after selecting and/or while the third user interface object remains selected in the multi-view user interface), such as movement of contact 603bbb on the touchscreen 504 from the representation 636-2 to the playback region 634 as shown in FIG. 6BBB. For example, while the contact is placed on the touch-sensitive surface at the location corresponding to the third user interface object, the electronic device detects movement of the contact on the touch-sensitive surface without detecting lift-off of the contact from the touch-sensitive surface. In some embodiments, the movement of the contact on the touch-sensitive surface is in a direction of the third location relative to the location of the third user interface object in the multi-view user interface. In some embodiments, the electronic device detects the movement via a hardware input device in communication with the electronic device. For example, the electronic device detects a press and hold of a navigation button (e.g., an arrow key) for moving the third user interface object toward the third location in the playback region. Accordingly, in some embodiments, the respective input corresponds to a select and drag input/gesture. In some embodiments, during the movement of the third user interface object, the electronic device displays a shadow representation of the third user interface object (e.g., at the location of the contact) that moves toward the third location in accordance with the respective input.

In some embodiments, in response to receiving the respective input (e.g., after detecting lift-off of the contact from the touch-sensitive surface discussed above), the electronic device updates display, via the display generation component, of the user interface to concurrently display the first live content item at the first location, the second live content item at the second location, and the third live content item at the third location in the playback region, such as display of a third viewing window 639b that is displaying the second content item in the playback region 634 as shown in FIG. 6CCC. For example, as similarly discussed above, the electronic device updates the arrangement of the first live content item and the second live content item to accommodate display of the third live content item in the playback region of the multi-view user interface. In some embodiments, as similarly discussed herein, the electronic decreases a size of the first live content item and the second live content item in the playback region when the third live content item is displayed. Accordingly, as discussed herein, in some embodiments, the electronic device adds/selects a live content item for display in the playback region of the multi-view user interface in response to detecting a selection of a user interface object corresponding to the live content item from the one or more user interface objects discussed above or a select and drag of the user interface object to the playback region in the multi-view user interface. Concurrently displaying live content items in a playback region of a multi-view user interface in response to detecting a selection of a respective user interface object corresponding to a respective live content item, followed by movement of the respective user interface object toward the playback region, enables the user to concurrently view multiple content items and/or reduces the number of inputs needed to concurrently display the live content items in the playback region of the multi-view user interface, thereby improving user-device interaction.

In some embodiments, while receiving the respective input that corresponds to movement of the third user interface object within the user interface corresponding to the multi-view viewing mode, the electronic device updates display, via the display generation component, of the user interface to concurrently include the first live content item at the first location, the second live content item at the second location, and one or more placeholder indications of the third live content item at one or more respective locations, including the third location, of the playback region, such as display of visual indication 638a of the second content item in the playback region 634 as shown in FIG. 6BBB. For example, after detecting the selection of the third user interface object and before and/or during the movement of the third user interface object in the multi-view user interface, the electronic device displays a first placeholder indication at the third location in the playback region and optionally displays one or more second placeholder indications at one or more second locations in the playback region (e.g., depending on a size of the playback region and/or a number of content items already displayed in the playback region). In some embodiments, the one or more placeholder indications provide visual indications of placement locations in the playback region at which the third live content item is able to be displayed. For example, if, when the electronic device receives the respective input discussed above, the playback region has two available placement locations in the playback region (e.g., determined based on the size of the playback region and the number of content items currently displayed in the playback region), the electronic device displays a first placeholder indication and a second placeholder indication at the two available placement locations in the playback region. In some embodiments, while the one or more placeholder indications are displayed in the playback region of the multi-view user interface, the electronic device displays the first live content item, the second live content item, and the one or more placeholder indications in a predetermined arrangement in the playback region (e.g., corresponding to a predetermined arrangement of content items in which a number of the content items is equal to a number of the first live content item, the second live content item, and the one or more placeholder indications), as similarly discussed above. Accordingly, in some embodiments, the movement of the third user interface object to the third location in the playback region includes movement of the third user interface object at least partially over one of the one or more placeholder indications. In some embodiments, after receiving the respective input (e.g., after detecting lift-off of the contact from the touch-sensitive surface discussed above), when the electronic device displays the third live content item at the third location, the electronic device ceases displaying the one or more placeholder indications in the playback region, where the third location is a same location as that of one of the one or more placeholder indications discussed above. Displaying one or more placeholder indications of a third live content item with a first live content item and a second live content item in a multi-view user interface in response to an input selecting and moving a user interface object corresponding to the third live content item within the multi-view user interface provides visual indications of available placement locations for the third live content item in the multi-view user interface and/or helps avoid unintentional display of the third live content item with the live content items in the multi-view user interface, thereby improving user-device interaction.

In some embodiments, the playback user interface includes a content player bar for navigating through the first live content item (e.g., content player bar 606 in FIG. 6W), the content player bar including a selectable option that is selectable to display one or more viewing options (e.g., selectable option 626 in FIG. 6W), including a first viewing option corresponding to the multi-view viewing mode (e.g., Multiview option in FIG. 6X), for the first live content item in the playback user interface (e.g., such as a full-screen viewing option, a picture-in-picture (PiP) viewing option, and/or the multi-view viewing option as similarly discussed above). In some embodiments, the first live content item is displayed at a fourth size, larger than the first size, the second size, and the third size, in the playback user interface, such as display of the live content item in the full screen mode in the playback user interface 602 as shown in FIG. 6X. For example, before the electronic device receives the first sequence of one or more inputs discussed previously above, the first live content item is displayed at the fourth size, which is optionally a full-screen or expanded viewing size (e.g., occupying an entirety or significant portion (e.g., 75, 80, 85, 90, 95, etc. % of the display generation component), in the playback user interface.

In some embodiments, the first sequence of one or more inputs includes selection of the first viewing option of the one or more viewing options for the first live content item, such as via a tap of contact 603x on the touch-sensitive surface 451 of the remote input device 510. For example, while the content player bar is displayed in the playback user interface, the electronic device receives a selection (e.g., a press, tap, or click input) directed to the selectable option in the playback user interface. In some embodiments, in response to receiving the selection of the selectable option, the electronic device displays the one or more viewing options for the first live content item in the playback user interface. For example, the one or more viewing options are displayed above or overlaid on the scrubber in the playback user interface. In some embodiments, the one or more viewing options are displayed in a menu in the playback user interface. In some embodiments, while displaying the one or more viewing options, the electronic device receives a (e.g., second) selection input (e.g., a press, tap, or click input) directed to the first viewing option of the one or more viewing options.

In some embodiments, in response to receiving the selection of the first viewing option (e.g., and before receiving subsequent input of the first sequence of one or more inputs selecting the second live content item for display in the playback region of the multi-view user interface), the electronic device ceases display of the playback user interface, such as ceasing display of the playback user interface 602 as shown in FIG. 6Y. For example, the electronic device ceases display of the playback user interface that is displaying the first live content item, as similarly described above.

In some embodiments, the electronic device displays, via the display generation component, the user interface corresponding to the multi-view viewing mode, including displaying the first live content item at a fifth size, smaller than the fourth size, in the playback region (e.g., without also displaying the second live content item in the playback region of the user interface), such as displaying the live content item in first viewing window 635 in the playback region 634 as shown in FIG. 6Y. For example, in response to receiving the selection of the multi-view viewing option of the one or more viewing options in the playback user interface, the electronic device displays the user interface corresponding to the multi-view viewing mode discussed previously above. In some embodiments, when the first live content item is displayed in the multi-view user interface, the first live content item is displayed at a smaller size than in the playback user interface. In some embodiments, as described above, the user interface is configurable to include a plurality of live content items, including the second live content item. For example, after displaying the first live content item at the fifth size in the playback region, the electronic device receives input of the first sequence of one or more inputs that selects the second live content item for playback in the playback region of the user interface, such as selection of a user interface object corresponding to the second live content item as similarly discussed above. Displaying a live content item in a multi-view user interface in response to receiving a selection of a first viewing option of one or more viewing options for the live content item in a playback user interface that is displaying the live content item reduces the number of inputs needed to concurrently display the live content item with other content items in the multi-view user interface and/or facilitates discovery that the live content item is able to be concurrently viewed in the multi-view user interface with other content items, thereby improving user-device interaction.

In some embodiments, the playback user interface includes a selectable option that is selectable to display one or more representations of one or more respective live content items, such as third selectable option 614 in FIG. 6JJ. For example, as previously described above with reference to method 700, the selectable option is selectable to display one or more representations of one or more additional live content items that are currently available for playback or will become available for playback in the future. In some embodiments, as previously described above with reference to method 700, the one or more representations of the one or more respective live content items are displayed below the content player bar in the playback user interface (e.g., in a row configuration in the playback user interface) when the selectable option is selected. In some embodiments, the one or more respective live content items have one or more characteristics of the one or more second live content items of method 700.

In some embodiments, in response to receiving the first sequence of one or more inputs that includes an input of a first type directed to the selectable option, the electronic device concurrently displays, via the display generation component, the one or more representations of the one or more respective live content items with the first live content item in the playback user interface, such as display of representations 623-1-623-5 in the playback user interface 602 as shown in FIG. 6KK. For example, as described above with reference to method 700, the electronic device displays the one or more representations of the one or more respective live content items below the content player bar in the playback user interface. In some embodiments, the first sequence of one or more inputs discussed above includes a selection input directed to the selectable option in the playback user interface. In some embodiments, the electronic device detects the input of the first type via a touch-sensitive surface of the one or more input devices. For example, while the selectable option has the current focus, the electronic device detects a press on the touch-sensitive surface (e.g., of a remote input device). In some embodiments, the electronic device detects a tap directed to the selectable option via a touch screen of the electronic device.

In some embodiments, while concurrently displaying the one or more representations of the one or more respective live content items with the first live content item, the electronic device receives, via the one or more input devices, an input of a second type, different from the first type, of the first sequence of one or more inputs directed to a representation of the second live content item of the one or more respective live content items, such as tap and hold of contact 603kk on touch-sensitive surface 451 of the remote input device 510 as shown in FIG. 6KK. For example, the electronic device detects a press/tap and hold directed to the representation of the second live content item in the playback user interface. In some embodiments, the electronic device detects the input of the second type via a touch-sensitive surface of the one or more input devices. For example, while the representation of the second live content item has the current focus, the electronic device detects a press on the touch-sensitive surface (e.g., of a remote input device) for at least a threshold amount of time (e.g., 1, 2, 3, 4, 5, 8, 10, 12, or 15 seconds). In some embodiments, the electronic device detects a tap and hold directed to the representation of the second live content item for the threshold amount of time via a touch screen of the electronic device.

In some embodiments, in response to receiving the input of the second type, the electronic device displays, via the display generation component, one or more viewing options for the second live content item in the playback user interface, such as display of viewing options in menu 642 as shown in FIG. 6LL, wherein a first viewing option of the one or more viewing options for the second live content item is selectable to display the user interface corresponding to the multi-view viewing mode (e.g., Multiview option in FIG. 6LL), including concurrently displaying the first live content item at the first size and the second live content item at the second size in the playback region of the user interface. For example, in response to receiving the press/tap and hold directed to the representation of the second live content item, the electronic device displays one or more viewing options for the second live content item in the playback user interface. In some embodiments, the one or more viewing options are displayed in a menu adjacent to or overlaid on the representation of the second live content item in the playback user interface. In some embodiments, the one or more viewing options includes a first viewing option that is selectable to display the multi-view user interface described above. In some embodiments, as similarly described above, in response to receiving a selection of the first viewing option, the electronic device concurrently displays the first live content item and the second live content item (e.g., separately) in the playback region in the multi-view user interface. In some embodiments, the first live content item is displayed in a primary view (e.g., with the first size) in the playback region of the user interface while the second live content item is displayed in a secondary view (e.g., with the second size), as similarly described above. Displaying viewing options for a respective live content item, which include an option for viewing the respective live content item in a multi-view user interface, in response to receiving a press and hold of a representation of the respective live content item in a playback user interface that is displaying a live content item reduces the number of inputs needed to concurrently display the respective live content item and the live content item in the multi-view user interface and/or facilitates discovery that the respective live content item and the live content item are able to be concurrently viewed in the multi-view user interface, thereby improving user-device interaction.

In some embodiments, the user interface corresponding to the multi-view mode includes one or more user interface objects corresponding to one or more content items (e.g., as previously discussed above), including a first user interface object corresponding to the first live content item and a second user interface object corresponding to the second live content item, such as representations 636-1 and 636-2 in the available content region 633 in FIG. 6DDD, and the first user interface object and the second user interface object are displayed at prioritized positions within the one or more user interface objects (e.g., at leftmost positions within the available content region 633 as shown in FIG. 6DDD). For example, because the first live content item and the second live content item are being played back in the playback region of the multi-view user interface, the first user interface object corresponding to the first live content item and the second user interface object corresponding to the second live content item are displayed at first positions among the one or more user interface objects. In some embodiments, the one or more user interface objects are displayed as a row of selectable objects below the playback region of the multi-view user interface as previously discussed above. In some embodiments, as similarly discussed above, the one or more content items corresponding to the one or more user interface objects are displayed in an Add More region below the playback region in the multi-view user interface. In some embodiments, displaying the one or more user interface objects corresponding to the one or more content items in the Add More region does not include playing back the one or more content items in the Add More region (rather, as discussed herein, such content items are, if selected, played back in the playback region of the multi-view user interface). In some embodiments, displaying the first user interface object and the second user interface object at the prioritized positions within the one or more user interface objects includes displaying the first user interface object and the second user interface object at leftmost positions (e.g., as chronologically first and second) within the row.

In some embodiments, while concurrently displaying the first live content item and the second live content item in the playback region of the user interface, the electronic device receives, via the one or more input devices, a respective input corresponding to a request to navigate away from the user interface, such as movement of the contacts 603eee directed to the third viewing window 639b in the playback region 634. For example, while concurrently displaying the first live content item and the second live content item in the playback region of the multi-view user interface, the electronic device receives an input navigating backward. In some embodiments, the respective input includes selection of a back or exit option displayed in the user interface (e.g., detected via a touch-sensitive surface of the one or more input devices). In some embodiments, the respective input includes press of a back or home button of a remote input device in communication with the electronic device. In some embodiments, the first live content item has the current focus in the user interface when the respective input is received.

In some embodiments, in response to receiving the respective input, the electronic device ceases display of the user interface corresponding to the multi-view viewing mode. For example, the electronic device ceases display of the multi-view user interface that is playing back the first live content item and the second live content item. In some embodiments, the electronic device displays, via the display generation component, the first live content item in the playback user interface at a live playback position within the first live content item, such as display of the second content item in the playback user interface 602 as shown in FIG. 6FFF. For example, the electronic device redisplays the first live content item in the playback user interface described previously above. In some embodiments, the electronic device displays the first live content item in the playback user interface (as opposed to the second live content item) because the first live content had the current focus in the multi-view user interface when the respective input above was received. In some embodiments, the electronic device displays the first live content item in the playback user interface because the first live content item was displayed in the playback user interface when the input that first caused display of the multi-view user interface (e.g., the first sequence of one or more inputs described above) was received. In some embodiments, the electronic device initiates playback of the first live content item at the current live playback position within the first live content item (e.g., an up-to-date playback position based on data broadcast from the media provider of the first live content item), as similarly described above. In some embodiments the electronic device forgoes displaying the second live content item in the playback user interface while displaying the first live content item in the playback user interface. In some embodiments, exiting the multi-view user interface causes the electronic device to lose a context of the display of the second live content item selected for playback in the playback region of the multi-view user interface. For example, if the user provides input for redisplaying the multi-view user interface (e.g., as discussed below), the electronic device forgoes displaying the second live content item that was previously selected for playback in the predetermined viewing arrangement in the playback region before the respective input above was received.

In some embodiments, while displaying the first live content item in the playback user interface, the electronic device receives, via the one or more input devices, a second sequence of one or more inputs corresponding to a request to concurrently display the first live content item and a third live content item, different from the first live content item and the second live content item, in the multi-view viewing mode, such as movement of contact 603bbb on the touchscreen 504 directed to the representation 636-2 as shown in FIG. 6BBB. In some embodiments, the second sequence of one or more inputs has one or more characteristics of the first sequence of one or more inputs discussed above (e.g., but specific to the display of the first live content item and the third live content item).

In some embodiments, in response to receiving the second sequence of one or more inputs, the electronic device concurrently displays, via the display generation component, the first live content item and the third live content item in the user interface corresponding to the multi-view viewing mode (e.g., as similarly discussed above), such as displaying the third viewing window 639b in the playback region 634 as shown in FIG. 6CCC, wherein the first user interface object corresponding to the first live content item and a third user interface object of the one or more user interface objects that corresponds to the third live content item are displayed at the prioritized positions within the one or more user interface objects (e.g., within the Add More region below the playback region as similarly discussed above), such as display of the representation 636-2 at the prioritized position in the available content region 633 as shown in FIG. 6CCC. For example, when the electronic device redisplays the multi-view user interface that includes the first live content item and the third live content item that are concurrently displayed in the playback region, the electronic device updates an arrangement of the one or more user interface objects such that the first user interface object corresponding to the first live content item and the third user interface object corresponding to the third live content item are displayed at the leftmost (or other prioritized) positions in the row of the one or more user interface objects. In some embodiments, the second user interface object is no longer displayed at one of the prioritized positions within the one or more user interface objects because the second live content item corresponding to the second user interface object is no longer being played back in the playback region of the multi-view user interface. Updating display of one or more user interface objects corresponding to one or more content items in a multi-view user interface when redisplaying a first live content item in a playback region of the multi-view user interface after previously navigating away from the multi-view user interface reduces enables the one or more user interface objects to be updated automatically and/or provides visual feedback regarding the content items that have been selected for played back in the multi-view user interface, thereby improving user-device interaction.

It should be understood that the particular order in which the operations in method 1100 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 900, and/or 1200) are also applicable in an analogous manner to method 1100 described above with respect to FIG. 11. For example, the operation of the electronic device displaying content items in a Multiview user interface, described above with reference to method 1100, optionally has one or more of the characteristics of facilitating control of playback of a live content item displayed in a playback user interface, described herein with reference to other methods described herein (e.g., methods 700, 900, and/or 1200). For brevity, these details are not repeated here.

The operations in the information processing methods described above are, optionally, implemented by running one or more functional modules in an information processing apparatus such as general purpose processors (e.g., as described with respect to FIG. 1A-1B, 3, 5A-5C) or application specific chips. Further, the operations described above with reference to FIG. 11 are, optionally, implemented by components depicted in FIGS. 1A-1B. For example, displaying operations 1102a, 1102b, and 1102d, and receiving operation 902c are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

FIGS. 12A-12B are a flow diagram illustrating a method 1200 of facilitating display of insights corresponding to a content item displayed in a playback user interface in accordance with some embodiments of the disclosure. The method 1200 is optionally performed at an electronic device such as device 100, device 300, or device 500 as described above with reference to FIGS. 1A-1B, 2-3, 4A-4B and 5A-5C. Some operations in method 1200 are, optionally combined and/or order of some operations is, optionally, changed.

As described below, the method 1200 provides ways to facilitate display of insights corresponding to content. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 1200 is performed by an electronic device (e.g., device 514) in communication with a display generation component and one or more input devices (e.g., remote input device 510). For example, the electronic device is a mobile device (e.g., a tablet, a smartphone, a media player, or a wearable device) including wireless communication circuitry. In some embodiments, the electronic device has one or more characteristics of electronic devices in methods 700, 900, and/or 1100. In some embodiments, the display generation component has one or more characteristics of the display generation component in methods 700, 900, and/or 1100. In some embodiments, the one or more input devices has one or more characteristics of the one or more input devices in methods 700, 900, and/or 1100.

In some while displaying, via the display generation component, a respective content item in a playback user interface (e.g., playback user interface 1002 in FIG. 10A), wherein the playback user interface is configured to playback content (e.g., a movie, an episode of a television (TV) show, a sporting event, music, a podcast, etc.), the electronic device receives (1202a), via the one or more input devices, a first input corresponding to a request to display one or more controls for controlling playback of the respective content item, such as a tap of contact 1003a on touch-sensitive surface 451 of remote input device 510. In some embodiments, the respective content item has one or more characteristics of content items discussed above with reference to methods 700, 900, and/or 1100. In some embodiments, the playback user interface has one or more characteristics of the playback user interface in methods 700, 900, and/or 1100. In some embodiments, the first input includes a tap detected on a touch-sensitive surface of the one or more input devices (e.g., on a remote input device in communication with the electronic device), such as touch sensitive surface 451 described with reference to FIG. 4, a click of the touch-sensitive surface, or a selection of a hardware button of a remote input device in communication with the electronic device, such as remote 510 described with reference to FIG. 5B. In some embodiments, the first input is detected via a touch screen of the electronic device (e.g., the touch screen is integrated with the electronic device, and is the display via which the playback user interface is being displayed). In some embodiments, the first input has one or more characteristics of the inputs for requesting display of the one or more controls for controlling playback of the respective content item as described with reference to methods 700 and/or 1100. In some embodiments, the one or more controls for controlling playback of the respective content item have one or more characteristics of the one or more controls described with reference to methods 700 and/or 1100.

In some embodiments, in response to receiving the first input, the electronic device displays (1202b), via the display generation component, a content player bar for controlling playback of the respective content item (e.g., content player bar 1006 in FIG. 10B) and a first option that is selectable to display information corresponding to the respective content item, such as first selectable option 1010 in FIG. 10B. In some embodiments, the content player bar has one or more characteristics of the content player bar discussed above with reference to methods 700, 900, and/or 1100. In some embodiments, the first option is displayed in a predefined region relative to the content player bar in the playback user interface. For example, as similarly described with reference to method 700, the first option is displayed below the content player bar in the playback user interface, optionally toward a bottom portion of the playback user interface. In some embodiments, the first option includes a text indication (e.g., a text label) indicating that the first option is selectable to display the information corresponding to the respective content item (e.g., an “Info” text label). In some embodiments, the first option has one or more characteristics of selectable options that are selectable to display information corresponding to content items described with reference to method 700. In some embodiments, as described below, the information corresponding to the respective content item is specific to the respective content item and is configured to change/update based on playback of the respective content item.

In some embodiments, while (optionally concurrently) displaying the content player bar and the first option, the electronic device receives (1202c), via the one or more input devices, a second input corresponding to selection of the first option, such as a tap of contact 1003c on the touch-sensitive surface 451 of the remote input device 510 as shown in FIG. 10C. For example, while a focus is on the first option in the playback user interface, the electronic device detects a tap or press of a button or on a touch-sensitive surface of a remote input device as similarly discussed above. In some embodiments, the second input includes a tap or touch on a touch screen of the electronic device at a location corresponding to the first option. In some embodiments, the second input has one or more characteristics of selection inputs in methods 700, 900, and/or 1100.

In some embodiments, in response to receiving the second input (1202d), in accordance with a determination that the respective content item is a live content item (e.g., a live-broadcast and/or live-streamed content item, such as the live content items discussed above with reference to methods 700, 900, and/or 1100), such as the live content item (e.g., Live Content A) being played back in playback user interface 1002 in FIG. 10C), the electronic device displays (1202e), via the display generation component, first information corresponding to the live content item (e.g., first information 1021 as shown in FIG. 10D). For example, if a live content item is being played back in the playback user interface, the first option discussed above is selectable to cause the electronic device to display one or more statistics associated with the live content item in the playback user interface. In some embodiments, the one or more statistics are based on a current playback position within the live content item. For example, if the live content item is a sports game, the one or more statistics include statistics of the sports game at a particular time in the sports game as dictated by the current playback position (e.g., information indicative of hits, runs, homeruns, strikeouts, and/or pitch count for a baseball game during a respective inning (e.g., the 7th inning) to which the current playback position corresponds), as similarly described above with reference to method 700. In some embodiments, the one or more statistics associated with the live content item are displayed along a bottom portion of the playback user interface (e.g., below the content player bar). In some embodiments, the one or more statistics are organized according to category (e.g., hits/runs statistics, pitcher statistics, and/or batter statistics for a live baseball game) and are displayed as a row along the bottom portion of the playback user interface. In some embodiments, the one or more statistics are (e.g., horizontally) scrollable in the playback user interface, as similarly described above with reference to method 700. In some embodiments, the one or more statistics associated with the live content item are concurrently displayed with the live content item in the playback user interface.

In some embodiments, in accordance with a determination that the respective content item is an on-demand content item (e.g., a content item available from a respective media provider and that the user of the electronic device is entitled to watch, such as the on-demand content items discussed above with reference to methods 700 and/or 900), such as the television show (e.g., TV Content) being played back in the playback user interface 1002 in FIG. 10H, the electronic device displays (1202f) second information corresponding to the on-demand content item, such as information 1023 as shown in FIG. 10H. For example, if an on-demand content item is being played back in the playback user interface, the first option is selectable to cause the electronic device to display a description of the on-demand content item, indications of one or more persons associated with the on-demand content item, and/or a dynamic module corresponding to the on-demand content item. As an example, if the on-demand content item is a television show, the second information corresponding to the on-demand content item includes information identifying the television show (e.g., a title of the television show, the current episode of the television show (e.g., episode number), and/or a title of the current episode), a list of actors/actresses and/or other persons involved with the television show (e.g., cast and crew of the television show, including a director and/or producer), a description (e.g., synopsis) of the current episode of the television show, and/or a dynamic module for the current episode of the television show. In some embodiments, as described in more detail hereinafter, the dynamic module includes interactive information that updates based on the current playback position within the on-demand content item. For example, the dynamic module includes an indication of a current song that is playing in the episode, and the indication is optionally selectable to initiate a process to play the song and/or add the song to a playlist or to add the song for future playback (e.g., via a content application different from the application via which the respective content item is being played). Additional details regarding the dynamic module are provided below. As similarly discussed above, the second information corresponding to the on-demand content item is based on a current playback position within the on-demand content item. In some embodiments, the second information corresponding to the on-demand content item is displayed similarly in the playback user interface as the first information discussed above (e.g., below the content player bar in the playback user interface as discussed above).

In some embodiments, while displaying the first information corresponding to the live content item in accordance with the determination that the respective content item is a live content item in response to receiving the second input, the electronic device receives (1202g), via the one or more input devices, a third input (e.g., scrolling and/or tabbing in an upward or downward direction within the playback user interface), such as a swipe of contact 1003d on the touch-sensitive surface 451 of the remote input device 510. For example, the electronic device detects a downward or upward swipe on a touch-sensitive surface of a remote input device that is in communication with the electronic device. In some embodiments, the third input includes a swipe gesture (e.g., of a contact, such as a finger) in a downward or upward direction on a touch screen of the electronic device. In some embodiments, the third input includes a selection of a button on the remote input device corresponding to a request to tab downward or upward in the playback user interface (e.g., such as a downward key on the remote input device). In some embodiments, the third input has one or more characteristics of the inputs described with reference to methods 700, 900, and/or 1100. In some embodiments, the upward or downward scrolling/tabbing gesture included in the third input is different from a direction that the first information corresponding to the live content item or the second information corresponding to the live content item is scrollable within the playback user interface. For example, as discussed above, the first information and/or the second information is horizontally scrollable (e.g., in response to a leftward or rightward) in the playback user interface while the third input includes a vertical scroll/tab (e.g., the electronic device either scrolls the first or second information, or performs the operations described below as being in response to the third input, depending on the direction of the input received while the first or second information is displayed).

In some embodiments, in response to receiving the third input (1202h), the electronic device displays (1202i), via the display generation component, the live content item in a minimized state in the playback user interface, such as display of the live content item in minimized viewing window 1039 as shown in FIG. 10E. For example, while the first live content item is displayed in the playback user interface prior to the first electronic device receiving the third input, the first live content item is displayed at a first size in the playback user interface (e.g., while the content player bar discussed above is also displayed in the playback user interface (e.g., overlaid on the first live content item)). In some embodiments, in response to receiving the third input, the electronic device minimizes the live content item, such that the live content item is displayed at a second size, smaller than the first size, in the playback user interface. In some embodiments, while the live content item is displayed in the second size in the playback user interface, the electronic device maintains (e.g., continues) playback of the live content item. In some embodiments, when the live content item is displayed in the minimized state in the playback user interface, the electronic device displays the live content item at a predetermined region of the display generation component. For example, the live content item is displayed at the second size (e.g., in a minimized window) at a top region of the display of the electronic device, at a corner of the display, along a side edge of the display, among other possibilities. Additionally, in some embodiments, when the live content item is displayed in the minimized state in the playback user interface, the electronic device ceases display of the content player bar discussed above. In some embodiments, as described in more detail hereinafter, the display of the live content item in the minimized state in the playback user interface depends on an orientation of the electronic device (e.g., relative to the force of gravity).

In some embodiments, the electronic device updates (1202j) the first information corresponding to the live content item to further include third (e.g., additional and/or supplemental) information, different from the first information, corresponding to the live content item (e.g., the third information is not displayed and/or is not visible in the playback user interface prior to receiving the third input), such as information elements 1021d and 1021e as shown in FIG. 10E. For example, the electronic device shifts/moves the first information upward on the display of the electronic device and displays (e.g., reveals) the third information on the display. In some embodiments, when the electronic device displays the third information corresponding to the live content item in the playback user interface, the third information occupies portions of the playback user interface that were previously occupied by the live content item (e.g., before displaying the live content item in the minimized state). In some embodiments, as similarly described with reference to the first information, the third information is specific to the live content item and is based on the current playback position within the live content item. For example, as discussed above, if the live content item is a sports game, the third information includes information that is supplemental to the one or more statistics discussed above, such as a representation of a field or court of the sports game (e.g., baseball field, football field, basketball court, tennis court, etc.), one or more indications of sports players participating in the sports game, optionally labeled overlaid on the representation of the field/court, statistics for the individual players participating in the sports game, and/or a listing of players on each team competing in the sports game. In some embodiments, the third information corresponding to the live content item is scrollable within the playback user interface. For example, as described in more detail below, depending on an orientation of the electronic device relative to the force of gravity, the third information is scrollable vertically (e.g., as a list) or horizontally (e.g., as a row). In some embodiments, while displaying the second information corresponding to the on-demand content item in accordance with the determination that the respective content is an on-demand content item in response to receiving the second input, if the electronic device receives an input scrolling and/or tabbing in a downward or upward direction within the playback user interface as discussed above, the electronic device displays the on-demand content item in the minimized state in the playback user interface as discussed above. Additionally, in some embodiments, the electronic device updates the second information corresponding to the on-demand content item to further include additional and/or supplemental information corresponding to the on-demand content item (e.g., additional and/or supplemental to the second information discussed above). For example, as discussed above, if the on-demand content item is an episode of a television show, the electronic device displays additional information that is specific to the on-demand content item and that is based on the current playback position within the on-demand content item, such as indications of additional episodes in the television show (e.g., past episodes and future episodes), a fuller listing of the cast and crew of the television show, and/or suggested content items for playback (e.g., suggested based on user watch history, genre of the television show, media provider for the television show, etc.). Displaying varying amounts of information specific to a content item in a playback user interface that is displaying the content item in response to receiving inputs directed to the playback user interface enables the user to consume additional information corresponding to the content item while concurrently viewing the content item in the playback user interface, which preserves a context of the current playback position within the content item while enhancing a user's viewing experience of the content item via the information, thereby improving user-device interaction.

In some embodiments, in accordance with the determination that the respective content item is a live content item, the first information corresponding to the live content item includes one or more statistics associated with the live content item that are updated based on a current playback position within the live content item (e.g., as similarly discussed above), such as statistics included in the information elements 1021a-1021c in FIG. 10D. In some embodiments, as the current playback position within the live content item is updated, the electronic device correspondingly updates the one or more statistics associated with the live content item based on events/highlights in the live content item, as similarly discussed above with reference to method 700. Displaying varying amounts of information specific to a live content item in a playback user interface that is displaying the live content item in response to receiving inputs directed to the playback user interface enables the user to consume additional information corresponding to the live content item while concurrently viewing the live content item in the playback user interface, which preserves a context of the current playback position within the live content item while enhancing a user's viewing experience of the live content item via the information, thereby improving user-device interaction.

In some embodiments, in accordance with the determination that the respective content item is an on-demand content item, the second information corresponding to the on-demand content item includes a description of the on-demand content item, such as the description of the TV show included in information element 1023a in FIG. 10G. For example, as previously discussed above, the electronic device displays a synopsis or summary for the on-demand content item, such as a summary for an episode of a television show, a movie, a short film, a rerun or recording of an event, such as a sporting event, competition, awards show, etc. In some embodiments, the description of the on-demand content item is displayed as one or more sentences of text (e.g., in a paragraph form) or as a bulleted/numbered list within the playback user interface.

In some embodiments, the second information includes one or more indications of one or more persons associated with the on-demand content item, such as the list of actors in the TV show included in information element 1023b in FIG. 10G. For example, as previously discussed above, the electronic device displays indications (e.g., textual indications, such as a listing of) a cast (e.g., actors, actresses, extras, etc.) and/or crew (e.g., writers, set designers, animators, graphical artists, etc.) for the on-demand content item, a director and/or producer for the on-demand content item, sports players and/or sports managers, news anchors, talk show hosts, etc. In some embodiments, the one or more indications of the one or more persons include a name of the one or more persons, an image of the one or more persons, and/or a title of the one or more persons (e.g., title indicating Actor, Actress, Director, Writer, etc.). In some embodiments, the one or more indications of the one or more persons is updated based on the current playback position within the on-demand content item. For example, if the one or more indications of the one or more persons associated with the on-demand content item correspond to the cast of the on-demand content item, the electronic device (e.g., periodically, such as with each scene change or after a set time, such as every 1, 2, 5, 8, 10, etc. minutes) updates the one or more indications of the one or more persons associated with the on-demand content item to correspond to the crew of the on-demand content item.

In some embodiments, the second information includes a user interface object corresponding to a dynamic module that is updated based on a current playback position within the on-demand content item, such as dynamic module 1025a as shown in FIG. 10G. In some embodiments, as discussed below, the dynamic module is associated with one or more applications running on the electronic device. Accordingly, in some embodiments, the information presented via the user interface object is drawn from and/or provided by the one or more applications with which the dynamic module is associated, as discussed in more detail below. In some embodiments, the information presented via the user interface object is configured to be changed as playback of the on-demand content item progresses. For example, the information provided by the user interface object is based on a particular scene or moment within the on-demand content item and changes when a following scene within the on-demand content item begins. Accordingly, in some embodiments, as detailed below, the information and/or content included in the user interface object corresponding to the dynamic module is configured to be changed and/or updated based on playback of the on-demand content item (e.g., changes in the playback position within the on-demand content item and/or changes in the type of content-such as different types of information displayed in the user interface object corresponding to the dynamic module for different types of content (movies, television shows, news programming, or sporting events). In some embodiments, as similarly discussed above, the second information is displayed overlaid over a portion (e.g., a bottom portion) of the on-demand content item, optionally below the content player bar discussed above. In some embodiments, the description of the on-demand content item, the one or more indications, and the user interface object corresponding to the dynamic module are displayed as a row of information within the playback user interface. Alternatively, in some embodiments, as similarly discussed below, the description of the on-demand content item, the one or more indications, and the user interface object corresponding to the dynamic module are displayed as a (e.g., vertically) scrollable list/column of information within the playback user interface. Displaying varying amounts of information specific to an on-demand content item in a playback user interface that is displaying the on-demand content item in response to receiving inputs directed to the playback user interface enables the user to consume additional information corresponding to the on-demand content item while concurrently viewing the on-demand content item in the playback user interface, which preserves a context of the current playback position within the on-demand content item while enhancing a user's viewing experience of the on-demand content item via the information, thereby improving user-device interaction.

In some embodiments, the dynamic module is associated with a music player application, as similarly described with reference to FIG. 10G. For example, the dynamic module of the playback user interface is configured to communicate with a music player application configured to run on the electronic device. In some embodiments, as discussed below, the dynamic module is configured to receive data corresponding to a music library within the music player application, such as songs, playlists, artists, composers, etc. that are saved and/or downloaded within the music player application and/or that are available for streaming via the music player application.

In some embodiments, the user interface object includes an indication of respective music associated with the on-demand content item based on the current playback position within the on-demand content item, such as an indication of Song 1 as shown in the dynamic module 1025a in FIG. 10G. For example, the electronic device displays the user interface object with an image associated with a particular song, playlist, artist, composer, etc. that is associated with the on-demand content item, such as an album or song cover, artist or composer photograph, live concert screenshot or highlight reel, etc. In some embodiments, the user interface object includes a title of the song, playlist, album, artist, composer, etc. In some embodiments, the electronic device displays the indication of the respective music within the user interface object because the respective music is currently being output as audio within the on-demand content item. For example, if a particular song is being played in the background of a particular scene of a movie or TV episode, or is being overlaid with narration from a character, narrator, sports caster, etc. within the on-demand content item, the user interface object includes an image corresponding to the song and a title of the song. In some embodiments, the user interface object is selectable to add the song to a respective playlist within the music player application, such as an Up Next playlist or queue, to save the song to a music library for the user within the music player application, and/or is selectable to initiate playback of the song via the music player application. For example, in response to receiving a selection of the user interface object, the electronic device ceases display of the playback user interface and displays a music player user interface associated with the music player application, and initiates playback of the song. Displaying an indication of music that is associated with an on-demand content item in a playback user interface that is displaying the on-demand content item in response to receiving inputs directed to the playback user interface enables the user to consume information corresponding to the music while concurrently viewing the on-demand content item in the playback user interface, which preserves a context of the current playback position within the on-demand content item while enhancing a user's viewing experience of the on-demand content item via the information, and/or reduces the number of inputs needed to save the song for later consumption, thereby improving user-device interaction.

In some embodiments, the dynamic module is associated with a maps application, as similarly described with reference to FIG. 10R. For example, the dynamic module of the playback user interface is configured to communicate with a maps application configured to run on the electronic device. In some embodiments, as discussed below, the dynamic module is configured to receive location data, navigation data, and/or other geographical data corresponding to a plurality of destinations (e.g., locations of businesses, restaurants, shopping malls, landmarks, hiking trails, people, etc.) that are accessible via the maps application.

In some embodiments, the user interface object includes an indication of a respective destination associated with the on-demand content item based on the current playback position within the on-demand content item, such as indication of Address A in the dynamic module 1025 in FIG. 10R. For example, the electronic device displays the user interface object with an image associated with a particular destination that is associated with the on-demand content item, such as a photograph of the destination, a representation (e.g., drawing, painting, sketch, etc.) of the destination, a postcard associated with the destination, a highlight reel for the destination, etc. In some embodiments, the user interface object includes a name of the destination and/or other identifying information associated with the destination, such as a nickname, address, acronym, etc. In some embodiments, the electronic device displays the indication of the respective destination within the user interface object because the respective destination is currently being showcased within the on-demand content item. For example, if the current scene within the on-demand content item takes place at a particular destination or the actors, narrators, talk show hosts, etc. state the name of or discussed details pertaining to a particular destination, the user interface object includes an image corresponding to the destination and a name and/or other identifying information (e.g., address) of the destination. In some embodiments, the user interface object is selectable to launch the maps application and display additional information corresponding to the destination via the maps application. For example, in response to receiving a selection of the user interface object, the electronic device ceases display of the playback user interface and displays a maps user interface associated with the maps application that includes an indication (e.g., icon or bubble) of the destination overlaid on a map of a physical region surrounding the destination, an address associated with the destination, contact information associated with the destination, and/or an option that is selectable to initiate navigation to the destination. Displaying an indication of music that is associated with an on-demand content item in a playback user interface that is displaying the on-demand content item in response to receiving inputs directed to the playback user interface enables the user to consume information corresponding to the music while concurrently viewing the on-demand content item in the playback user interface, which preserves a context of the current playback position within the on-demand content item while enhancing a user's viewing experience of the on-demand content item via the information, and/or reduces the number of inputs needed to save the song for later consumption, thereby improving user-device interaction.

In some embodiments, the dynamic module is associated with an audio-programming application, as similarly described with reference to FIG. 10H. For example, the dynamic module of the playback user interface is configured to communicate with an audio-programming application configured to run on the electronic device, such as a podcasts application, an audiobook application, a news application, and/or a wellness application that is configured to provide audio-based content. In some embodiments, as discussed below, the dynamic module is configured to receive data corresponding to podcasts, audiobooks, talk shows, audio-based presentations, radio shows, meditations, etc. that are saved and/or downloaded within the audio-programming application and/or that are available for streaming via the audio-programming application.

In some embodiments, the user interface object includes an indication of a respective audio program associated with the on-demand content item based on the current playback position within the on-demand content item, such as an indication of Podcast in the dynamic module 1025b as shown in FIG. 10H. For example, the electronic device displays the user interface object with an image associated with a particular podcast, audiobook, talk show, presentation, radio show, meditation, etc. that is associated with the on-demand content item, such as an album cover, photograph, screenshot or highlight reel, etc. In some embodiments, the user interface object includes a title of the respective audio program, such as a name and/or provider of the podcast, audiobook, talk show, presentation, radio show, meditation, etc. In some embodiments, the electronic device displays the indication of the respective audio program within the user interface object as a suggestion of supplemental content for the on-demand content item. For example, if the on-demand content item is associated with a partner podcast (e.g., a podcast produced by a partner producer or a same producer of the on-demand content item), the user interface object includes an image corresponding to the podcast and a title of the podcast. As another example, if the on-demand content item is based on (e.g., the screenplay for the on-demand content item was adapted from) a literary work (e.g., a book or series of books or short stories), the user interface object includes an image corresponding to an audiobook for the literary work and a title of the audiobook. In some embodiments, the user interface object is selectable to launch the audio-programming application and display additional information corresponding to the respective audio program. For example, in response to receiving a selection of the user interface object, the electronic device ceases display of the playback user interface and displays a podcasts user interface associated with a podcasts application that includes enables the user to add a podcast associated with the on-demand content item to a library of podcasts within the podcasts application and/or initiate a process to listen to the podcast. Displaying an indication of an audio program that is associated with an on-demand content item in a playback user interface that is displaying the on-demand content item in response to receiving inputs directed to the playback user interface enables the user to consume information corresponding to the audio program while concurrently viewing the on-demand content item in the playback user interface, which preserves a context of the current playback position within the on-demand content item while enhancing a user's viewing experience of the on-demand content item via the information, and/or reduces the number of inputs needed to save the audio program for later consumption, thereby improving user-device interaction.

In some embodiments, the user interface object includes an indication of one or more facts associated with the on-demand content item based on the current playback position within the on-demand content item, such as fun facts as indicated in the dynamic module 1025c as shown in FIG. 10I. For example, the electronic device displays the user interface object with “fun facts” (e.g., trivia) and/or quotes from one or more persons associated with the on-demand content item. In some embodiments, the indication of the one or more facts associated with the on-demand content item is displayed based on data received from a content provider application (e.g., network application) for the on-demand content item or from a web browsing application configured to run on the electronic device. In some embodiments, the user interface object includes text of the one or more facts, along with an image or other visual representation corresponding to the one or more facts. In some embodiments, the electronic device displays the indication of the one or more facts associated with the on-demand content item within the user interface object based on a current scene in the on-demand content item. For example, if a particular actor (or sports player, talk show host, news anchor, etc.) is present in the current scene of a movie or TV episode (or sports event, awards show, etc.), the user interface object includes a famous or iconic quote belonging to or pertaining to the actor. As another example, the user interface object includes a fun fact from filming and/or production of the movie or TV episode that involves the actor. In some embodiments, the user interface object is selectable to display additional facts corresponding to the on-demand content item, such as a biography for the on-demand content item or a particular person associated with the on-demand content item, within a user interface of a content provider application for the on-demand content item or a web-browsing application. In some embodiments, as the current playback position within the on-demand content item changes (e.g. progresses or updates in response to user input (e.g., scrubbing input)), the information provided within the user interface object changes as well. For example, for a first scene within the on-demand content item, the user interface object includes an indication of music or a location associated with the on-demand content item, as previously discussed above, and when the current playback position changes such that a second scene, different from the first scene, in the on-demand content item has begun, the electronic device optionally updates the user interface object to include an indication of the one or more facts associated with the on-demand content item as described above. Displaying an indication of facts that are associated with an on-demand content item in a playback user interface that is displaying the on-demand content item in response to receiving inputs directed to the playback user interface enables the user to consume information corresponding to the on-demand content item while concurrently viewing the on-demand content item in the playback user interface, which preserves a context of the current playback position within the on-demand content item while enhancing a user's viewing experience of the on-demand content item via the information, thereby improving user-device interaction.

In some embodiments, the first information corresponding to the live content item includes one or more first statistics associated with the live content item (e.g., one or more first statistics that are based on a playback position within the live content item before the third input is received, such as the current playback position within the live content item) without including one or more second statistics, different from the one or more first statistics, associated with the live content item (e.g., one or more second statistics that are not based on the playback position within the live content item before the third input is received), such as the statistics included in the information elements 621a-621c in FIG. 6N. In some embodiments, while displaying the content player bar and the first information corresponding to the live content item in accordance with the determination that the respective content item is a live content item in response to receiving the second input, the electronic device receives, via the one or more input devices, a fourth input corresponding to a request to scrub through the live content item, such as movement of contact 603o on the touch-sensitive surface 451 of the remote input device 510 as shown in FIG. 6O. For example, while the current playback position within the live content item is at the live edge, the electronic device receives an input corresponding to a request to navigate backward through (e.g., rewind) the content. In some embodiments, the fourth input includes a swipe in a respective direction (e.g., leftward) detected on a touch-sensitive surface of the one or more input devices. In some embodiments, the fourth input includes a press of a hardware button of the one or more input devices. In some embodiments, the fourth input includes movement detected on a touch screen of the electronic device directed to the content player bar in the playback user interface. In some embodiments, as described in more detail below, the electronic device detects a selection of a navigation affordance displayed in the playback user interface. In some embodiments, the electronic device restricts and/or prevents navigating forward in the live-broadcast content item beyond the live edge because portions of the live-broadcast content item beyond the live edge are not yet available for consumption by the user. In some embodiments, the fourth input has one or more characteristics of inputs for scrubbing through content items as discussed in method 700.

In some embodiments, in response to receiving the fourth input, the electronic device updates a current playback position within the live content item in accordance with the fourth input, such as moving scrubber bar 608 within content player bar 606 indicating a change in the current playback position within the live content item as shown in FIG. 6P. For example, the electronic device navigates backward through the live content item in accordance with the fourth input. In some embodiments, the electronic device updates display of the live content item (and/or the representative content corresponding to the live content item) in accordance with the update of the current playback position within the live content item. For example, the electronic device initiates and/or returns to playback of the live content item at the current playback position (and/or changes the representative content displayed in the playback user interface to correspond to the current playback position) that is updated in accordance with a magnitude (e.g., of speed and/or duration) of the fourth input.

In some embodiments, the electronic device updates the first information corresponding to the live content item to include the one or more second statistics associated with the live content item, such as display of updated statistics in information elements 621a-621c as shown in FIG. 6P. For example, in response to receiving the input scrubbing through the live content item, the electronic device updates the information corresponding to the live content item to include the one or more second statistics. In some embodiments, the one or more first statistics are based on the live playback position within the live content item and are optionally displayed in the playback user interface before the fourth input is received. In some embodiments, the one or more second statistics are based on a respective playback position (e.g., a playback position that is chronologically located prior to the live playback position) in the live content item and is available, but not displayed, before the fourth input is received. In some embodiments, the electronic device ceases display of the one or more first statistics, or updates (e.g., changes) a portion of the one or more first statistics, when displaying the one or more second statistics in the playback user interface based on the updated current playback position. In some embodiments, updating the first information has one or more characteristics of updating information corresponding to a content item based on changes in the current playback position within the content item as discussed in method 700. It should be understood that, alternatively, in some embodiments, if the second information corresponding to the on-demand content item is displayed in the playback user interface when the fourth input is received, the electronic device updates the second information based on the updated playback position within the on-demand content item in a similar manner as discussed above. For example, the electronic device updates the information included in the user interface object associated with the dynamic module as previously discussed above. Updating information associated with a live content item in a playback user interface that is displaying the live content item when an input scrubbing through the live content item causes a current playback position to change within the live content item enables the user to consume additional information corresponding to the live content item based on the updated current playback position while concurrently viewing the live content item at the updated current playback position in the playback user interface, which preserves a context of the current playback position within the live content item, thereby improving user-device interaction.

In some embodiments, in accordance with the determination that the respective content item is a live content item, the third information corresponding to the live content item includes a representation of a venue of the live content item, such as a representation of a baseball field as indicated in information element 1021e in FIG. 10E. For example, the electronic device displays a sports stadium (e.g., baseball stadium/field or football stadium/field), a sports court (e.g., basketball court or tennis court), a concert venue (e.g., a theater, amphitheater, or stadium), a track, a field, a golf course, etc. at which the live content item is currently taking place. In some embodiments, the representation of the venue of the live content item is a two-dimensional (e.g., top-down) view of the venue. In some embodiments, the representation of the venue is a three-dimensional representation (e.g., rendered in two-dimensions in such a way to visually appear to be three-dimensional on the display generation component). In some embodiments, the representation of the venue is a life-like (e.g., picturesque) rendering of the venue (e.g., provided with an amount of detail akin to a photograph of the venue). In some embodiments, the representation of the venue is a computer-generated diagramed rendering (e.g., a less detailed representation) of the venue.

In some embodiments, the third information includes a plurality of indications of a plurality of participants in the live content item, such as baseball players indicated in information element 1021d in FIG. 10E. For example, the electronic device displays a plurality of circles, bubbles, dots, etc. representing the plurality of participants in the live content item, such as sports players participating in the live content item, performers, coaches/managers, band members, speakers, etc. that are involved directly or indirectly with the live content item. As an example, if the live content item is a baseball game, the plurality of participants includes baseball players who are actively or participating or have actively participated in the baseball game, as well as baseball players who are members on a particular team but who are not participating or are not going to participate in the baseball game. In some embodiments, if the live content item is a baseball game, the plurality of indications of the plurality of participants are provided for both teams competing in the baseball game. In some embodiments, the plurality of indications includes a name of the corresponding participant in the live content item and/or a position/role of the corresponding participant, such as, for example, in a baseball game, pitcher, catcher, batter, first baseman, etc. In some embodiments, the plurality of indications includes an image of the corresponding participant in the live content item, such as a photograph of the participant, a sketch or cartoon representation of the participant, a textual representation (e.g., initials) of the participant, etc. In some embodiments, the plurality of indications of the plurality of participants are displayed overlaid on the representation of the venue discussed above. For example, if the live content item is a baseball game, the plurality of indications is displayed on the representation of the venue at locations corresponding to the positions of the baseball players in the baseball game. As an example, an indication of the pitcher would be displayed over the pitcher's mound in the representation of the baseball field, and an indication of the batter would be displayed beside the home plate in the representation of the baseball field. In some embodiments, the plurality of indications changes based on the current playback position within the live content item. For example, if the live content item is a track and field event, such as a 100 m race, for a first race in the track and field event, a first plurality of indications of a first plurality of racers is displayed on a representation of the track, and after the first race is complete, the electronic device updates the representation of the track to include a second plurality of indications of a second plurality of racers who are competing in a second race, after the first race.

In some embodiments, the third information includes one or more statistics for one or more of the plurality of participants in the live content item, such as statistics for the baseball players as indicated in the information element 1021d as shown in FIG. 10E. In some embodiments, as described above, the first information corresponding to the live content item includes one or more statistics corresponding to the live content item. For example, if the live content item is a baseball game, the one or more statistics includes a current score (e.g., number of runs for each team), a number of hits, an indication of a current inning, as well as pitching statistics for the current pitcher and batting statistics for the current batter. In some embodiments, the third information includes one or more statistics for other players in the baseball game that are not already included in the first information discussed above. For example, the one or more statistics for the one or more of the plurality of participants correspond to individual player statistics for the baseball players other than the pitcher and the batter who are participating in the baseball game, such as player hits, runs, outs, walks, as well as overall standings (e.g., player average compared to other players of the same position (e.g., first baseman, right fielder, second baseman, etc.)) in the baseball league. As similarly discussed above, the one or more statistics for the one or more of the plurality of participants in the live content item are configured to be updated based on the current playback position (e.g., based on a progression of the playback position and/or input for scrubbing the live content item) within the live content item. Displaying varying amounts of information specific to a live content item in a playback user interface that is displaying the live content item in response to receiving inputs directed to the playback user interface enables the user to consume additional information corresponding to the live content item while concurrently viewing the live content item in the playback user interface, which preserves a context of the current playback position within the live content item while enhancing a user's viewing experience of the live content item via the additional information, thereby improving user-device interaction.

In some embodiments, in response to receiving the third input, the electronic device ceases display of the content player bar in the playback user interface, such as ceasing display of the content player bar 1006 as shown in FIG. 10E. For example, in response to receiving the third input, the electronic device shifts the first information or the second information upward in the playback user interface to display the third information or the fourth information discussed above, depending on whether the respective content item is a live content item or an on-demand content item, respectively. In some embodiments, the because the electronic device displays the respective content item in the minimized state within the playback user interface to account for (e.g., provide space for) the display of the third information or the fourth information, the electronic device ceases display of the content player bar, rather than reducing the size of the content player bar to fit over the minimized display of the respective content item. Accordingly, if the electronic device receives an input for ceasing display of the third information or the fourth information, such as a request to navigate backward in the playback user interface (e.g., selection of a back or home button in the playback user interface or on a hardware input device in communication with the electronic device, or a swipe gesture detected on a touch-sensitive surface), the electronic device ceases display of the third information or the fourth information and redisplays the content player bar in the playback user interface (e.g., overlaid on the respective content item, which is redisplayed in the full screen state in the playback user interface). Ceasing display of a content player bar for controlling playback of a content item when additional information specific to the content item is displayed in a playback user interface that is displaying the content item in response to receiving inputs directed to the playback user interface helps avoid overcrowding in the playback user interface and/or avoids conflicting/overlapping display of the content player bar and the additional information, thereby improving user-device interaction.

In some embodiments, in response to receiving the third input, the electronic device displays the live content item in the minimized state in the playback user interface is in accordance with a determination that one or more criteria are satisfied, including a criterion that is satisfied when the electronic device (e.g., and thus the display generation component) has a first orientation (e.g., a landscape orientation) relative to gravity (or some other reference, such as a planar surface below the electronic device (e.g., a floor/ground or tabletop below the electronic device)), such as the landscape orientation of electronic device 500 relative to gravity as shown in FIG. 10L. For example, the one or more criteria are satisfied if the electronic device has a horizontally aligned orientation relative to gravity, such that a length of the display generation component is larger/longer than a height of the display generation component relative to gravity. In some embodiments, while the electronic device, and thus the display generation component (e.g., because the display generation component is a touchscreen or other integrated display of the electronic device), has the first orientation relative to gravity, an available amount of display area of the display generation component is sufficient to display (e.g., all portions of) the third information and/or the first information in the playback user interface while the live content item is displayed in the minimized state in the playback user interface. In some embodiments, as discussed below, the one or more criteria are not satisfied in accordance with a determination that the electronic device has a second orientation, different from (e.g., normal to), the first orientation relative to gravity, as discussed in more detail below. Displaying a content item in a minimized state in a playback user interface when additional information specific to the content item is displayed in the playback user interface that is displaying the content item if the electronic device has a first orientation relative to gravity helps avoid overcrowding in the playback user interface in view of available display area of the display generation component of the electronic device while the electronic device is in the first orientation and/or enables the playback user interface to be updated automatically based on changes in orientation of the electronic device, thereby improving user-device interaction.

In some embodiments, in response to receiving the third input, in accordance with a determination that the one or more criteria are not satisfied because the electronic device (e.g., and thus the display generation component) has a second orientation (e.g., a portrait orientation), different from the first orientation, relative to gravity, such as the portrait orientation of the electronic device 500 relative to gravity in FIG. 10O, the electronic device forgoes displaying the live content item in the minimized state in the playback user interface. For example, the one or more criteria are not satisfied if the electronic device has a vertically aligned orientation relative to gravity, such that the length of the display generation component is smaller/shorter than the height of the display generation component relative to gravity. In some embodiments, the second orientation is normal to (or optionally within a threshold amount of being normal to, such as 1, 2, 5, 8 10, 15, etc. degrees) the first orientation discussed above. In some embodiments, the electronic device maintains display of the live content item in a non-minimized state (e.g., such that the size of the live content item is not decreased in the playback user interface as described previously above). For example, prior to receiving the third input, the live content item is displayed at a first size at a central location of the display generation component while the electronic device has the second orientation. In some embodiments, after receiving the third input, the electronic device maintains display of the live content item at the first size and shifts the live content item upward in the playback user interface on the display generation component, such that the live content item occupies a top portion of the display generation component (e.g., to accommodate display of the third information in the playback user interface, as discussed below).

In some embodiments, the electronic device displays the third information corresponding to the live content item as a (e.g., horizontally and/or vertically) scrollable list of information below the live content item in the playback user interface, such as display of the information 1021 as a scrollable list of information elements as shown in FIG. 10Q. In some embodiments, the electronic device displays the third information as a scrollable list of information if the electronic device has the second orientation relative to gravity because, while having the second orientation, an available amount of display area of the display generation component is insufficient for displaying (e.g., all portions of) the third information in the playback user interface while the live content item is displayed in the playback user interface in the non-minimized state. For example, when the third information is displayed, a first set of statistics is displayed, and, when the electronic device detects a swipe gesture (e.g., a downward swipe gesture) or other input for navigating downward in the playback user interface, the electronic device scrolls the third information upward in the playback user interface to reveal/display a second set of statistics corresponding to the live content item, such as one of the statistics described previously above. In some embodiments, while the third information is scrolled in the playback user interface, the electronic device maintains display of the live content item, without scrolling the live content item. For example, the live content item remains docked at a top portion (e.g., a top half, a top third, a top quarter, etc.) of the display generation component. Additionally, in some embodiments, because the live content item remains displayed in the non-minimized state as discussed above, the electronic device maintains display of the content player bar in the playback user interface (e.g., the content player bar is displayed overlaid along a bottom portion of the live content item in the playback user interface). In some embodiments, if the third information corresponding to the live content item is displayed in the playback user interface in response to the third input while the orientation of the electronic device is the second orientation, if the electronic device detects movement (e.g., rotation) of the electronic device that causes the electronic device to have the first orientation discussed above, the electronic device updates display of the playback user interface such that the live content item is displayed in the minimized state as discussed above. Maintaining display of a content item in a non-minimized state in a playback user interface when additional information specific to the content item is displayed in the playback user interface that is displaying the content item if the electronic device has a second orientation relative to gravity enables the user to consume additional information corresponding to the content item while concurrently viewing the content item in the playback user interface in view of available display area of the display generation component of the electronic device while the electronic device is in the second orientation and/or enables the playback user interface to be updated automatically based on changes in orientation of the electronic device, thereby improving user-device interaction.

In some embodiments, updating the first information corresponding to the live content item to further include the third (e.g., additional and/or supplemental) information corresponding to the live content item in response to receiving the third input includes, in accordance with a determination that the electronic device (e.g., and thus the display generation component) has a respective orientation (e.g., a portrait orientation, as similarly discussed above) relative to gravity (or some other reference, such as a planar surface below the electronic device (e.g., a floor/ground or tabletop below the electronic device)), such as the portrait orientation of the electronic device 500 relative to gravity as shown in FIG. 10P, displaying the third information corresponding to the live content item as a scrollable list of information below the live content item in the playback user interface (e.g., as similarly discussed above), such as display of the information 1021 as a scrollable list of information elements as shown in FIG. 10Q. For example, a swipe gesture detected on a touch-sensitive surface of the electronic device, such as a touchscreen of the electronic device, that is in an upward or downward direction causes the electronic device to scroll the third information on the playback user interface, as similarly discussed above. Additionally, in some embodiments, if the electronic device detects a swipe on the touch-sensitive surface of the electronic device that is in a leftward or rightward direction, the electronic device replaces the third information in the playback user interface with alternative information/user interface objects. For example, in response to a rightward or leftward swipe on the touchscreen of the electronic device, the electronic device replaces the information corresponding to the live content item with one or more representations of one or more second live content items, such as the one or more representations of the one or more second live content items described in method 700. In some embodiments, before the third information corresponding to the live content item is displayed in the playback user interface in response to receiving the third input, the playback user interface includes a second option that is selectable to display the one or more representations of the one or more second live content items. In some embodiments, in response to receiving the third input, in accordance with a determination that the electronic device has a second orientation (e.g., a landscape orientation as similarly discussed above), different from the respective orientation, relative to gravity, the electronic device forgoes displaying the third information as a scrollable list of information. For example, the third information is displayed as stationary and/or docked pieces of information below the live content item in the playback user interface. In some embodiments, the electronic device forgoes displaying the third information as a scrollable list of information if the electronic device has the second orientation relative to gravity because, while having the second orientation, an available amount of display area of the display generation component is sufficient to display (e.g., all portions of) the third information in the playback user interface. Displaying varying amounts of information specific to a live content item as a scrollable list of information in a playback user interface that is displaying the live content item if the electronic device has a respective orientation relative to gravity enables the user to consume additional information corresponding to the content item while concurrently viewing the content item in the playback user interface in view of available display area of the display generation component of the electronic device while the electronic device is in the respective orientation and/or enables the playback user interface to be updated automatically based on changes in orientation of the electronic device, thereby improving user-device interaction.

In some embodiments, the electronic device is in further communication with a second electronic device (e.g., electronic device 500 in FIG. 10S) that is configured to display (e.g., via a second display generation component in communication with the second electronic device) a remote-control user interface, such as remote-control user interface 1020 in FIG. 10S. For example, the second electronic device is a mobile device, such as a smartphone, tablet, wearable device, etc., that is configured to communicate with the electronic device. In some embodiments, the second electronic device has one or more characteristics of the electronic device. In some embodiments, the remote-control user interface includes a plurality of controls, in the form of selectable and/or interactive options/elements, for providing input to the electronic device. For example, selection of a respective option in the remote-control user interface causes the second electronic device to transmit input data that is received by the electronic device, which causes the electronic device to perform a respective operation associated with the respective option. In some embodiments, the plurality of controls includes playback controls, similar to the playback controls discussed above with reference to the playback user interface. In some embodiments, the remote-control user interface is displayed via a touchscreen of the second electronic device. In some embodiments, the remote-control user interface includes a touch input region that is configured to receive touch input for navigating within the playback user interface. For example, a swipe gesture detected in the touch input region of the remote-control user interface displayed at the second electronic device is received as input at the electronic device for moving a current focus in the playback region and/or scrubbing through the respective content item displayed in the playback user interface. In some embodiments, the remote-control user interface provides a same or similar functionality as a physical remote controller in communication with the electronic device. For example, a plurality of the controls of the remote-control user interface are also provided (e.g., in a same or similar fashion) as the controls of the physical remote controller. In some embodiments, the remote-control user interface is configured to be displayed at the second electronic device while the electronic device is actively displaying content, such as the playback user interface (or some other user interface). In some embodiments, one or more of the inputs discussed above are detected via the remote-control user interface displayed at the second electronic device. For example, the first input discussed above corresponds to a tap on the touchscreen of the second electronic device at a location corresponding to the touch input region of the remote-control user interface. In some embodiments, the second input discussed above corresponds to a swipe gesture (e.g., upward or downward) detected via the touchscreen of the second electronic device at a location corresponding to the touch input region of the remote-control user interface.

In some embodiments, the electronic device is configured to receive (e.g., via one or more second input devices in communication with the second electronic device) input from the second electronic device corresponding to input that is directed to the remote-control user interface displayed at (e.g., via a second display generation component in communication with) the second electronic device, as similarly described with reference to FIG. 10S. For example, as discussed above, input directed to the remote-control user interface that is detected by (e.g., one or more input devices of) the second electronic device is transmitted to the electronic device for interacting with the playback user interface displayed at the electronic device. In some embodiments, a subset of the plurality of controls discussed above included in the remote-control user interface are selectable and/or otherwise interactive to provide input solely to the second electronic device, rather than also to the electronic device, as discussed in more detail below. Displaying varying amounts of information specific to a content item in a playback user interface that is displaying the content item in response to receiving inputs directed to the playback user interface that are detected via a remote-control user interface displayed at a second electronic device enables the user to consume additional information corresponding to the content item while concurrently viewing the content item in the playback user interface, which preserves a context of the current playback position within the content item while enhancing a user's viewing experience of the content item via the information, thereby improving user-device interaction.

In some embodiments, the remote-control user interface includes a selectable option that is selectable to cause the second electronic device to, in accordance with the determination that the respective content item is a live content item, display (e.g., via a second display generation component in communication with the second electronic device) fourth information corresponding to the live content item in the remote-control user interface, such as selectable option 1028 in FIG. 10S. For example, the selectable option of the remote-control user interface is similar to the first option discussed above that is displayed in the playback user interface at the electronic device. In some embodiments, the fourth information corresponding to the live content item is a subset of the first information discussed previously above. For example, the fourth information displayed in the remote-control user interface corresponds to one or more first statistics associated with the live content item and the first information displayed in the playback user interface at the electronic device includes the one or more first statistics as well as one or more second statistics (e.g., that are not displayed in the remote-control user interface). In some embodiments, the fourth information corresponds to the third information (e.g., supplemental information) discussed previously above. For example, in response to receiving a selection of the selectable option, the second electronic device displays the third information corresponding to the live content item discussed above while the electronic device is displaying the first information discussed above. In some embodiments, the fourth information includes the first information and the third information. For example, the second electronic device displays the first information and the third information as a scrollable list of information in the remote-control user interface, and the electronic device does not display any information corresponding to the live content item via the display generation component. In some embodiments, while displaying the remote-control user interface that includes the fourth information, the second electronic device maintains display of at least a subset of the plurality of controls discussed above. For example, the remote-control user interface still includes playback controls for controlling playback of the live content item in the playback user interface, as similarly discussed above.

In some embodiments, the remote-control user interface includes a selectable option that is selectable to cause the second electronic device to, in accordance with the determination that the respective content item is an on-demand content item, display fifth information corresponding to the on-demand content item in the remote-control user interface (e.g., as similarly discussed above with reference to the live content item but specific to the on-demand content item), such as selectable option 1028 in FIG. 10S Displaying varying amounts of information specific to a content item in a playback user interface that is displaying the content item and/or a remote-control user interface in response to receiving input directed to the remote-control user interface displayed at a second electronic device enables the user to consume additional information corresponding to the content item via the remote-control user interface while concurrently viewing the content item in the playback user interface, which preserves a context of the current playback position within the content item while enhancing a user's viewing experience of the content item via the information, thereby improving user-device interaction.

In some embodiments, while the second electronic device is displaying the first information corresponding to the live content item in accordance with the determination that the respective content item is the live content item, the electronic device is displaying, in the playback user interface, the live content item, such as the live content item that is being played back in the playback user interface 1002 in FIG. 10S. For example, while the statistics corresponding to the live content item are displayed on a screen (e.g., touchscreen) of the second electronic device, the live content item continues to be played back in the playback user interface at the electronic device.

In some embodiments, while the second electronic device is displaying the second information corresponding to the on-demand content item in accordance with the determination that the respective content item is the on-demand content item, the electronic device is displaying, in the playback user interface, the on-demand content item, such as the on-demand content item that is being played back in the playback user interface 1002 in FIG. 10F. For example, while the information corresponding to the on-demand content item are displayed on a screen (e.g., touchscreen) of the second electronic device, the on-demand content item continues to be played back in the playback user interface at the electronic device. Displaying varying amounts of information specific to a content item in a playback user interface that is displaying the content item and/or a remote-control user interface in response to receiving input directed to the remote-control user interface displayed at a second electronic device enables the user to consume additional information corresponding to the content item via the remote-control user interface while concurrently viewing the content item in the playback user interface, which preserves a context of the current playback position within the content item while enhancing a user's viewing experience of the content item via the information, thereby improving user-device interaction.

In some embodiments, the second electronic device displays the remote-control user interface without concurrently displaying the respective content item, such as the electronic device 500 forgoing display of the live content item as shown in FIG. 10S. For example, because the second electronic device is functioning as a remote input device (e.g., via the remote-control user interface) for the electronic device, the second electronic device is not also displaying the respective content item (e.g., the live content item or the on-demand content item) in the remote-control user interface. In some embodiments, the respective content item is configurable to be played back via a different user interface of the second electronic device, such as a playback user interface associated with a content player application running on the second electronic device (while the remote-control user interface is not displayed). Displaying a remote-control user interface at a second electronic device that does not include a content item that is currently displayed in a playback user interface at a first electronic device avoids duplicate display of the content item, which helps reduce user confusion and/or distraction, thereby improving user-device interaction, and/or helps improve power efficiency at the second electronic device.

It should be understood that the particular order in which the operations in method 1200 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 900, and/or 1100) are also applicable in an analogous manner to method 1200 described above with respect to FIG. 12. For example, the operation of the electronic device displaying insights corresponding to content items in a playback user interface, described above with reference to method 1200, optionally has one or more of the characteristics of facilitating control of playback of a live content item displayed in a playback user interface and/or displaying multiple content items in a Multiview user interface, described herein with reference to other methods described herein (e.g., methods 700, 900, and/or 1100). For brevity, these details are not repeated here.

The operations in the information processing methods described above are, optionally, implemented by running one or more functional modules in an information processing apparatus such as general purpose processors (e.g., as described with respect to FIG. 1A-1B, 3, 5A-5C) or application specific chips. Further, the operations described above with reference to FIG. 12 are, optionally, implemented by components depicted in FIGS. 1A-1B. For example, displaying operations 1202b, 1202e, 1202f, 1202i, and 1202j and receiving operations 1202a, 1202c, and 1202g are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology potentially involves the gathering and use of data available from specific and legitimate sources to display content or suggest content for display to users. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information, usage history, handwriting styles, etc.

The present disclosure recognizes that the use of such personal information data in the present technology can be used to the benefit of users. For example, the personal information data can be used to automatically perform operations with respect to suggesting content items for consumption. Accordingly, use of such personal information data enables users to enter fewer inputs to perform an action with respect to displaying and interacting with content. Further, other uses for personal information data that benefit the user are also contemplated by the present disclosure. For instance, user preferences may be used to identify content items suggested for consumption by the user.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the user is able to configure one or more electronic devices to change the discovery or privacy settings of the electronic device. For example, the user can select a setting that only allows an electronic device to access certain of the user's preferences when suggesting content items for consumption.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content items for consumption can be suggested based on aggregated non-personal information data or a bare minimum amount of personal information, such as the user preferences being handled only on the user's device or other non-personal information.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device in communication with a display generation component and one or more input devices:
while displaying, via the display generation component, a respective content item in a playback user interface, wherein the playback user interface is configured to playback content, receiving, via the one or more input devices, a first input corresponding to a request to display one or more controls for controlling playback of the respective content item;
in response to receiving the first input, displaying, via the display generation component, a content player bar for controlling playback of the respective content item and a first option that is selectable to display information corresponding to the respective content item;
while displaying the content player bar and the first option, receiving, via the one or more input devices, a second input corresponding to selection of the first option;
in response to receiving the second input:
in accordance with a determination that the respective content item is a live content item, displaying, via the display generation component, first information corresponding to the live content item; and
in accordance with a determination that the respective content item is an on-demand content item, displaying second information corresponding to the on-demand content item;
while displaying the first information corresponding to the live content item in accordance with the determination that the respective content item is a live content item in response to receiving the second input, receiving, via the one or more input devices, a third input; and
in response to receiving the third input:
displaying, via the display generation component, the live content item in a minimized state in the playback user interface; and
updating the first information corresponding to the live content item to further include third information, different from the first information, corresponding to the live content item.

2. The method of claim 1, wherein, in accordance with the determination that the respective content item is a live content item, the first information corresponding to the live content item includes:
one or more statistics associated with the live content item that are updated based on a current playback position within the live content item.

3. The method of claim 1, wherein, in accordance with the determination that the respective content item is an on-demand content item, the second information corresponding to the on-demand content item includes:
a description of the on-demand content item;
one or more indications of one or more persons associated with the on-demand content item; and
a user interface object corresponding to a dynamic module that is updated based on a current playback position within the on-demand content item.

4. The method of claim 3, wherein:
the dynamic module is associated with a music player application; and
the user interface object includes an indication of respective music associated with the on-demand content item based on the current playback position within the on-demand content item.

5. The method of claim 3, wherein:
the dynamic module is associated with a maps application; and
the user interface object includes an indication of a respective destination associated with the on-demand content item based on the current playback position within the on-demand content item.

6. The method of claim 3, wherein:
the dynamic module is associated with an audio-programming application; and
the user interface object includes an indication of a respective audio program associated with the on-demand content item based on the current playback position within the on-demand content item.

7. The method of claim 3, wherein the user interface object includes an indication of one or more facts associated with the on-demand content item based on the current playback position within the on-demand content item.

8. The method of claim 1, wherein the first information corresponding to the live content item includes one or more first statistics associated with the live content item without including one or more second statistics, different from the one or more first statistics, associated with the live content item, the method further comprising:
while displaying the content player bar and the first information corresponding to the live content item in accordance with the determination that the respective content item is a live content item in response to receiving the second input, receiving, via the one or more input devices, a fourth input corresponding to a request to scrub through the live content item; and
in response to receiving the fourth input:
updating a current playback position within the live content item in accordance with the fourth input; and updating the first information corresponding to the live content item to include the one or more second statistics associated with the live content item.

9. The method of claim 1, wherein, in accordance with the determination that the respective content item is a live content item, the third information corresponding to the live content item includes:
a representation of a venue of the live content item;
a plurality of indications of a plurality of participants in the live content item; and
one or more statistics for one or more of the plurality of participants in the live content item.

10. The method of claim 1, further comprising:
in response to receiving the third input:
ceasing display of the content player bar in the playback user interface.

11. The method of claim 1, wherein:
in response to receiving the third input:
displaying the live content item in the minimized state in the playback user interface is in accordance with a determination that one or more criteria are satisfied, including a criterion that is satisfied when the electronic device has a first orientation relative to gravity.

12. The method of claim 11, further comprising:
in response to receiving the third input, in accordance with a determination that the one or more criteria are not satisfied because the electronic device has a second orientation, different from the first orientation, relative to gravity:
forgoing displaying the live content item in the minimized state in the playback user interface; and
displaying the third information corresponding to the live content item as a scrollable list of information below the live content item in the playback user interface.

13. The method of claim 1, wherein updating the first information corresponding to the live content item to further include the third information corresponding to the live content item in response to receiving the third input includes:
in accordance with a determination that the electronic device has a respective orientation relative to gravity, displaying the third information corresponding to the live content item as a scrollable list of information below the live content item in the playback user interface.

14. The method of claim 1, wherein:
the electronic device is in further communication with a second electronic device that is configured to display a remote-control user interface; and
the electronic device is configured to receive input from the second electronic device corresponding to input that is directed to the remote-control user interface displayed at the second electronic device.

15. The method of claim 14, wherein the remote-control user interface includes a selectable option that is selectable to cause the second electronic device to:
in accordance with the determination that the respective content item is a live content item, display fourth information corresponding to the live content item in the remote-control user interface; and
in accordance with the determination that the respective content item is an on-demand content item, display fifth information corresponding to the on-demand content item in the remote-control user interface.

16. The method of claim 15, wherein:
while the second electronic device is displaying the first information corresponding to the live content item in accordance with the determination that the respective content item is the live content item, the electronic device is displaying, in the playback user interface, the live content item; and
while the second electronic device is displaying the second information corresponding to the on-demand content item in accordance with the determination that the respective content item is the on-demand content item, the electronic device is displaying, in the playback user interface, the on-demand content item.

17. The method of claim 15, wherein the second electronic device displays the remote-control user interface without concurrently displaying the respective content item.

18. An electronic device, comprising:
one or more processors;
memory; and
one or more programs, wherein the one or more programs are stored in the memory and configured to be executed by the one or more processors, the one or more programs including instructions for:
while displaying, via a display generation component, a respective content item in a playback user interface, wherein the playback user interface is configured to playback content, receiving, via one or more input devices, a first input corresponding to a request to display one or more controls for controlling playback of the respective content item;
in response to receiving the first input, displaying, via the display generation component, a content player bar for controlling playback of the respective content item and a first option that is selectable to display information corresponding to the respective content item;
while displaying the content player bar and the first option, receiving, via the one or more input devices, a second input corresponding to selection of the first option;
in response to receiving the second input:
in accordance with a determination that the respective content item is a live content item, displaying, via the display generation component, first information corresponding to the live content item; and
in accordance with a determination that the respective content item is an on-demand content item, displaying second information corresponding to the on-demand content item;
while displaying the first information corresponding to the live content item in accordance with the determination that the respective content item is a live content item in response to receiving the second input, receiving, via the one or more input devices, a third input; and
in response to receiving the third input:
displaying, via the display generation component, the live content item in a minimized state in the playback user interface; and
updating the first information corresponding to the live content item to further include third information, different from the first information, corresponding to the live content item.

19. A non-transitory computer readable storage medium storing one or more programs, the one or more programs comprising instructions, which when executed by one or more processors of an electronic device, cause the electronic device to perform a method comprising:
while displaying, via a display generation component, a respective content item in a playback user interface, wherein the playback user interface is configured to playback content, receiving, via one or more input devices, a first input corresponding to a request to display one or more controls for controlling playback of the respective content item;
in response to receiving the first input, displaying, via the display generation component, a content player bar for controlling playback of the respective content item and a first option that is selectable to display information corresponding to the respective content item;
while displaying the content player bar and the first option, receiving, via the one or more input devices, a second input corresponding to selection of the first option;
in response to receiving the second input:
in accordance with a determination that the respective content item is a live content item, displaying, via the display generation component, first information corresponding to the live content item; and
in accordance with a determination that the respective content item is an on-demand content item, displaying second information corresponding to the on-demand content item;
while displaying the first information corresponding to the live content item in accordance with the determination that the respective content item is a live content item in response to receiving the second input, receiving, via the one or more input devices, a third input; and
in response to receiving the third input:
displaying, via the display generation component, the live content item in a minimized state in the playback user interface; and
updating the first information corresponding to the live content item to further include third information, different from the first information, corresponding to the live content item.
